(19) United States
(12) Patent Application Publication
(10) Pub. No.: US 2025/0204311 A1
(43) Pub. Date: Jun. 26, 2025

(54) MOWER

(71) Applicant: Greenworks (Jiangsu) Co., Ltd, Changzhou (CN)

(72) Inventors: Qunli Wei, Changzhou (CN); Dongdong Shi, Changzhou (CN); Qinghua Shi, Changzhou (CN); Chris Eichel, Mooresville, NC (US); Chenghai Ning, Changzhou (CN); Yansheng Sun, Changzhou (CN); Nick Suchoza, Mooresville, NC (US); Hui Chen, Changzhou (CN); Jing Wang, Changzhou (CN); Jiafu Xue, Changzhou (CN); Paulius Bulovas, Jönköping (SE); Jaquline Hultman, Huskvarna (SE); Tao Yu, Changzhou (CN); Min Ding, Changzhou (CN); Yu Mei, Changzhou (CN); Fei Zhu, Changzhou (CN); Shiyuan Ding, Changzhou (CN); Yueyue Xu, Changzhou (CN); Xiazi Li, Changzhou (CN); Tao Wang, Changzhou (CN); Naixin Gao, Changzhou (CN); Zhiyuan Li, Changzhou (CN)

(21) Appl. No.: 19/080,798

(22) Filed: Mar. 15, 2025

Related U.S. Application Data
(63) Continuation of application No. PCT/CN2023/119054, filed on Sep. 15, 2023.

(30) Foreign Application Priority Data
Sep. 16, 2022 (CN) 202211131924.6
Sep. 16, 2022 (CN) 202211131936.9
Sep. 16, 2022 (CN) 202211131983.3
Sep. 16, 2022 (CN) 202211131985.2
Sep. 16, 2022 (CN) 202211132242.7
Sep. 16, 2022 (CN) 202222456692.3
Sep. 16, 2022 (CN) 202222457245.X
Sep. 16, 2022 (CN) 202222463616.5
Sep. 16, 2022 (CN) 202222464012.2
Sep. 16, 2022 (CN) 202222464407.2
Sep. 16, 2022 (CN) 202222464517.9
Sep. 16, 2022 (CN) 202222464795.4
Sep. 16, 2022 (CN) 202222464944.7
Sep. 16, 2022 (CN) 202222465612.0
Sep. 16, 2022 (CN) 202222467150.6
Dec. 19, 2022 (CN) 202211639732.6
Dec. 19, 2022 (CN) 202223422873.0
Jun. 29, 2023 (CN) 202321711252.6

(51) Int. Cl. A01D 34/74; A01D 34/00; A01D 34/66; A01D 34/78; A01D 43/077; A01D 69/02; A01D 75/20; A01D 101/00

(52) U.S. Cl. CPC A01D 34/74; A01D 34/008; A01D 34/667; A01D 34/78; A01D 43/077; A01D 69/02; A01D 75/20; A01D 2101/00

(57) ABSTRACT

A mower includes a frame, a cutting deck assembly and a walking mechanism. The cutting deck assembly is mounted on the frame. The walking mechanism is mounted on the frame and includes a front wheel assembly and a rear wheel assembly. The frame includes a front frame and a rear frame. The front frame is detachably connected with the rear frame. The front frame is provided with the front wheel assembly, and the rear frame is provided with the rear wheel assembly. When the cutting deck assembly needs to be replaced to meet use requirements, the front frame and the rear frame of appropriate specifications are first selected to be fixed to ensure that the cutting deck assembly has a suitable mounting size, so that the suitable cutting deck assembly may be replaced in different working environments to meet the use requirements of a variety of environments.

### CROSS REFERENCE TO RELATED APPLICATION

The present application is a continuation Application of PCT application No. PCT/CN2023/119054 filed on Sep. 15, 2023, which claims the benefit of CN202211132242.7 filed on Sep. 16, 2022, CN202222465612.0 filed on Sep. 16, 2022, CN202222467150.6 filed on Sep. 16, 2022, CN202222464944.7 filed on Sep. 16, 2022, CN202222464012.2 filed on Sep. 16, 2022, CN202222464795.4 filed on Sep. 16, 2022, CN202222463616.5 filed on Sep. 16, 2022, CN202222464407.2 filed on Sep. 16, 2022, CN202211131983.3 filed on Sep. 16, 2022, CN202211131985.2 filed on Sep. 16, 2022, CN202222464517.9 filed on Sep. 16, 2022, CN202211131936.9 filed on Sep. 16, 2022, CN202211131924.6 filed on Sep. 16, 2022, CN202222457245.X filed on Sep. 16, 2022, CN202222456692.3 filed on Sep. 16, 2022, CN202211639732.6 filed on Dec. 19, 2022, CN202223422873.0 filed on Dec. 19, 2022, and CN202321711252.6 filed on Jun. 29, 2023. All the above are hereby incorporated by reference for all purposes.

### TECHNICAL FIELD

The disclosure relates to a technical field of mower, especially relates to a mower.

### BACKGROUND

In the process of using garden tools, it is necessary to replace the working parts of different specifications according to different use environments to meet the use requirements of different working environments. Such as mower, after the front wheel and the rear wheel of the conventional mower are mounted on the frame, the wheelbase between the front wheel and the rear wheel cannot be changed, and the cutting deck is mounted at the bottom of the mower frame. Since the wheelbase is determined, the specification of the cutting deck can only be selected within the wheelbase range. On one hand, the size of the cutting deck is less selective, and it is impossible to replace the more suitable cutting deck according to the terrain and other working environments, and on the other hand, the wheelbase is fixed, and the cutting deck cannot be well matched with the mower under this wheelbase, which results in the inability to work optimally.

Therefore, a mower that may be easily replaced with different specifications of cutting decks is needed to meet different use requirements.

### SUMMARY

The disclosure provides a mower to improve a technical problem of the conventional mower with a fixed wheelbase and being unable to replace appropriate cutting deck assembly as needed.

The disclosure provides the mower. The mower includes a frame, a cutting deck and a walking mechanism. The cutting deck is mounted on the frame. The walking mechanism is mounted on the frame and includes a front wheel assembly and a rear wheel assembly. The frame includes a front frame and a rear frame. The front frame is detachably connected with the rear frame. The front frame is provided with the front wheel assembly, and the rear frame is provided with the rear wheel assembly.

In an embodiment of the disclosure, the front frame includes a first cross beam and a first connecting part, the first connecting part extends along a forward direction and from two ends of the first cross beam, and two of the first connecting parts are respectively provided with the front wheel assembly.

In an embodiment of the disclosure, a front end of the first connecting part is provided with an assembling tube that is vertically downward, and the front wheel assembly is assembled on the assembling tube so that the front wheel rotates around an axis that is perpendicular to an axis of the assembling tube.

In an embodiment of the disclosure, both sides of a rear end of the front frame are provided with a U-shaped groove, a front end of the rear frame includes two square tubes, the square tube is inserted into the groove to fix the front frame and the rear frame.

In an embodiment of the disclosure, two first clamping boards are arranged on both sides of the rear end of the front frame, a bottom surface of the two first clamping boards is provided with a second clamping board, the first clamping boards and the second clamping board enclose the groove, corresponding positions of side walls of the square tube and the first clamping board are provided with a first through hole, and a connecting bolt penetrates through the first through hole to connect and fix the front frame and the rear frame.

In an embodiment of the disclosure, the cutting deck assemble includes a cutting deck, the cutting deck is installed at a bottom of the frame, and a minimum distance between the cutting deck and the front wheel is from 10 mm to 60 mm.

In an embodiment of the disclosure, the cutting deck assemble includes the cutting deck, the cutting deck is installed at a bottom of the frame, and a minimum distance between the cutting deck and the rear wheel is from 10 mm to 60 mm.

In an embodiment of the disclosure, the mower further includes a battery, a first placing area is arranged on the frame, and the battery is fixed in the first placing area.

In an embodiment of the disclosure, the first placing area is provided with a plurality of the first mounting hole, and the batteries with different specifications are matched with different first mounting holes.

In an embodiment of the disclosure, the mower includes a driving seat, a walking mechanism and a cutting deck assembly. The driving seat is arranged on the frame. The walking mechanism further includes a driving motor. The front wheel assembly includes a front wheel. The front wheel includes a first front wheel and a second front wheel. The rear wheel assembly includes a rear wheel. The driving motor drives the front wheel and/or the rear wheel. The cutting deck assembly is mounted on the frame. The cutting deck assembly includes a cutting deck, a cutting motor and a cutting blade. The cutting blade includes a first cutting blade and a second cutting blade. Projections projected along a longitudinal direction of the mower, if a projection of the first front wheel overlaps at least partially with a projection of a rotation area of the first cutting blade, a projection of an axis of a rotating shaft of the first cutting blade is located on a side of the projection of the first front wheel away from a projection of a lawn discharging port; if a projection of the second front wheel overlaps at least partially with a projection of a rotation area of the second cutting blade, a projection of an axis of a rotating shaft of the second cutting blade is located on a side of the projection of the second front wheel away from the projection of the lawn discharging port.

In an embodiment of the disclosure, the front wheel assembly includes a front fork rotatably mounted on the frame and a front wheel mounted on the front fork, a front end of the front fork is provided with a wheel protective board, and a front end of the wheel protective board extends beyond the front wheel.

In an embodiment of the disclosure, the cutting deck assembly includes a cutting deck, a height adjustment device and a self-locking mechanism. The cutting deck is connected with the frame through the height adjustment device. The height adjustment device includes a first connecting rod and a second connecting rod. Both of the first connecting rod and the second connecting rod is rotatably connected with the frame. The first connecting rod and the second connecting rod are rotatably connected with the cutting deck respectively. The first connecting rod and the second connecting rod are simultaneously connected with a same third connecting rod. The self-locking mechanism includes a self-locking rod arranged on the height adjustment device and a self-locking component rotatably connected with the frame. A self-locking groove is arranged on the self-locking component, and the self-locking rod enters the self-locking groove to limit a movement of the self-locking rod.

In an embodiment of the disclosure, the self-locking component is provided with a holding part. The self-locking component is rotatably connected with the frame by the rotating shaft, the holding part and the self-locking groove are arranged on both sides of the rotating shaft, and when the self-locking component rotates in a direction away from the self-locking rod, the self-locking groove releases the self-locking rod to enable the self-locking rod to return to its original position.

In an embodiment of the disclosure, a tail of the mower is provided with a first charging port, and the first charging port is at an angle of 15 degrees to 30 degrees with a ground.

In an embodiment of the disclosure, the first charging port is provided with a reversible charging port cover.

In an embodiment of the disclosure, an anti-roll frame is rotatably mounted on the frame. The anti-roll frame is switchable between a first position and a second position. When the anti-roll frame is erected on a side of the driving seat, and is higher than a top of a driver's head in an operating state in the first position, so as to protect the driver when the frame rolls over; and the anti-roll frame is folded relative to the frame in the second position in order to reduce a storage volume of the mower.

In an embodiment of the disclosure, the mower includes the battery. The first placing area is arranged on the frame. The first seating area is located below the driving seat and extends to a rear end of the frame. The first placing area is provided with the plurality of first mounting holes, and the batteries with different specifications are matched with different first mounting holes.

In an embodiment of the disclosure, a front end of the frame is provided with an accessory connecting part.

In an embodiment of the disclosure, the driving motor is connected with the rear wheel. The rear wheel assembly includes a parking releasing mechanism, and the parking releasing mechanism includes a braking plate and a hand-held releasing part. The hand-held releasing part is rotatably arranged on a side of the braking plate away from the rear wheel. When the hand-held releasing part is rotated to a releasing state, the hand-held releasing part partially extends to a side of the braking plate close to the rear wheel, so that the braking plate is pushed away from the driving motor.

In an embodiment of the disclosure, the cutting deck is arranged at the bottom of the frame, and the minimum distance between the cutting deck and the front wheel is from 10 mm to 60 mm.

In an embodiment of the disclosure, a tail of the mower is provided with a storage device, the storage device includes an upper storage platform, a lower storage cavity, and the storage platform is rotatably connected with the frame and seals the storage cavity.

In an embodiment of the disclosure, the mower includes a casing and a control assembly. A tail part of the casing encloses a cavity with an opening upward, and the cavity is provided with a control assembly. A top surface of the cavity is detachably connected with the storage device, and after the storage device is removed, the control assembly may be taken and placed by the opening on the cavity.

In an embodiment of the disclosure, the mower includes an operating device. The operating device includes two operating handles, and the two operating handles respectively control a rotating speed of a same side of the driving motor, in order to control a rotation of the front wheel and/or the rear wheel. The two operating handles are respectively provided with a cutting blade speed regulation key and a walking speed regulation key.

In an embodiment of the disclosure, the cutting deck assembly includes a motor controller. There is a plurality of cutting motors, and the plurality of the cutting motors is all electrically connected with the motor controller. One motor controller controls the plurality of the cutting motors to rotate.

In an embodiment of the disclosure, the cutting deck assembly includes the cutting deck, the height adjustment device and the locking device. The height adjustment device connects the cutting deck with the frame to adjust a height of the cutting deck. The height adjustment device includes a first connecting rod and a second connecting rod, the first connecting rod and the second connecting rod are rotatably connected with the frame, and the first connecting rod and the second connecting rod each is rotatably connected with the cutting deck respectively. After the cutting part is adjusted to different heights through the height adjustment device, a movement of the cutting deck is limited by the locking device.

In an embodiment of the disclosure, the height adjustment device further includes the third connecting rod. The third connecting rod is rotatably connected with a side of the first connecting rod away from the cutting deck and a side of the second connecting rod away from the cutting deck respectively.

In an embodiment of the disclosure, the height adjustment device includes the self-locking mechanism. The self-locking mechanism includes the self-locking rod and the self-locking component. The self-locking component is hinged with the frame, the self-locking component is provided with the self-locking groove, and the self-locking rod and the self-locking groove are matched with each other to limit a downward movement of the cutting deck.

In an embodiment of the disclosure, the self-locking component is rotatably connected with the frame through the rotating shaft. A center of gravity of the self-locking component is located on one side of the rotating shaft close to the self-locking rod, the frame is provided with a limiting device, and the limiting device limits the self-locking component from rotating in a direction towards the self-locking rod.

In an embodiment of the disclosure, the limiting device is a limiting part arranged on the frame, the limiting part extends out to the frame, a bottom of the self-locking component is provided with a protrusion away from the self-locking rod, and the protrusion touches a bottom of the limiting part to limit the self-locking component from rotating toward the self-locking rod.

In an embodiment of the disclosure, the locking device includes a blocking plate and a limiting board, the limiting board is fixed with the frame, the limiting board is provided with a plurality of limiting holes, the limiting hole is matched with a limiting rod, the limiting rod is inserted into different limiting holes to be matched with the blocking plate to keep the cutting deck at different distances from ground.

In an embodiment of the disclosure, an edge of the limiting hole is provided with a protruding clamping hole, a side wall of the limiting rod is provided with a clamping block, and the clamping hole is matched with the clamping block.

In an embodiment of the disclosure, the cutting deck assembly includes a shock absorbing device, a first end of the shock absorbing device is fixed with the frame, and a second end of the shock absorbing device is connected with the height adjustment device. A force of the shock absorbing device acting on the height adjustment device is opposite to a force of the cutting deck assembly acting on the height adjustment device.

In an embodiment of the disclosure, a first end of the first connecting rod away from the cutting deck is provided with a pedal rod. An end part of the first connecting rod is provided with a plurality of pedal mounting holes, and the pedal rod is matched with different pedal mounting holes to adjust a position of the pedal rod on the first connecting rod.

In an embodiment of the disclosure, the cutting deck assembly includes the cutting deck, the cutting part and the cutting baffle. The cutting deck is mounted on the frame of the mower. The cutting part is arranged on the cutting deck and includes the cutting motor and the cutting blade driven by the cutting motor. The cutting baffle is detachably fixed at a bottom of the cutting deck. The cutting baffle defines a cutter accommodating cavity, and the cutting blade is arranged in the cutter accommodating cavity.

In an embodiment of the disclosure, the cutting baffle includes an edge blocking board and a middle blocking board. One side of an accommodating cavity formed by the edge blocking board is provided with the lawn discharging port. The lawn discharging port is arranged on a side or a rear side of a forward direction of the cutting deck, and the discharged lawn may be avoided from splashing on a staff through a mode of side discharging, which may affect the staff.

In an embodiment of the disclosure, the middle blocking board is arranged in an area enclosed by the edge blocking board. The middle blocking board and the edge blocking board enclose a plurality of accommodating cavities, and the cutting blades are arranged in the accommodating cavities.

In an embodiment of the disclosure, there are three cutting blades. The three cutting blades are arranged in a triangular pattern.

In an embodiment of the disclosure, the lawn discharging port is provided at a lawn discharging cover, and an opening of the lawn discharging cover becomes larger from an inside of the cutting deck to an outside of the cutting deck, which is convenient for a discharging of broken lawn and avoids an accumulation of the broken lawn.

In an embodiment of the disclosure, the cutting motor penetrates the cutting deck, and the cutting deck at a contact between the cutting motor and the cutting deck is provided with a plurality of ventilation holes. When air flow passes in the ventilation hole, heat around the cutting motor will be taken away, so as to avoid a problem of a heat accumulation caused by a sealed contact position between the cutting motor and the cutting deck, and improve a heat dissipation effect of the cutting motor.

In an embodiment of the disclosure, a front end of the frame is provided with a roller.

In an embodiment of the disclosure, a height of the cutting baffle near the front wheel of the mower from the ground is greater than a height of the cutting baffle near the rear wheel of the mower.

In an embodiment of the disclosure, the cutting blade is provided with a lawn pushing part, and the lawn pushing part is arranged on a back side of the cutting blade in a cutting direction. A rotating rear edge of the cutting blade bends downward to form the lawn pushing part, thereby forming a front end of the cutting blade to cut the lawn, and the lawn pushing part at a rear side takes the cut lawn away, so as to realize a directional discharging of the lawn after mowing.

In an embodiment of the disclosure, the mower includes the anti-roll frame. The anti-roll frame is rotatably mounted on the frame on a side of the driving seat and is provided with the first position and the second position. When the anti-roll frame is in the first position, it is fixed to stand next to the driving seat, and is higher than the top of a driver's head in the operating state, so as to protect the driver when the frame rolls over; when the anti-roll frame is in the second position, it is folded relative to the frame to reduce the storage volume of the mower.

In an embodiment of the disclosure, a storage groove is arranged on the frame, and the anti-roll frame is clamped into the storage groove when at the second position.

In an embodiment of the disclosure, the anti-roll frame is locked at the first position and/or the second position through a locking structure.

In an embodiment of the disclosure, the locking structure includes a locking pin and an anti-loosening locking body arranged on the locking pin, and an anti-loss pulling structure is arranged between the frame and the locking pin, and/or between the frame and the anti-loosening locking body.

In an embodiment of the disclosure, the anti-loss pulling structure includes a pulling wire and a pulling wire through hole, the pulling wire through hole is arranged on the frame, the pulling wire is threaded in the pulling wire through hole, and two ends of the pulling wire are respectively connected with the locking pin and the anti-loosening locking body. The locking pin and the anti-loosening locking body block on two sides of the pulling wire through hole respectively.

In an embodiment of the disclosure, two sides of the anti-roll frame are respectively rotatably connected through a bolt assembly, the two sides of the anti-roll frame are provided with the anti-loss pulling structure, and the pulling wire through hole is arranged on a gasket in the bolt assembly.

In an embodiment of the disclosure, when the anti-roll frame is in the first position, it tilts 5 degrees to 10 degrees toward a head part of the frame from bottom to top.

In an embodiment of the disclosure, a position where the anti-roll frame is in contact with the storage groove is provided with a shock absorbing body and/or a protective body, and a lighting assembly is mounted on the anti-roll frame.

In an embodiment of the disclosure, two sides of the frame are symmetrically provided with a second mounting frame, and the two sides of the anti-roll frame are coaxially rotatably connected with the second mounting frames on both sides respectively. A height of the second mounting frame is lower than a height of the driving seat.

In an embodiment of the disclosure, the anti-roll frame is provided with the protective body that prevents a head of the driver from touching when the frame rolls over.

In an embodiment of the disclosure, the mower includes the frame, the walking wheel, the cutting deck assembly, a cutting motor and the storage platform. The walking wheel is mounted at the bottom the frame. The cutting deck assembly is mounted on the frame. The cutting deck assembly is provided with a cutting blade. The mowing motor is connected with the cutting blade to drive the cutting blade to rotate for mowing. The mowing motor is mounted on the frame. The storage platform is arranged on the frame. The mower further includes a walking motor. The walking motor drives a movement of the walking wheels, so that the mower may walk.

In an embodiment of the disclosure, the mower further includes the walking motor, a battery assembly and a controller. The walking motor drives the walking wheel to move, thereby realizing a walking of the mower. The battery assembly is electrically connected with the mowing motor, the walking motor and the controller respectively, and the controller is further electrically connected with the walking motor and the mowing motor respectively.

In an embodiment of the disclosure, the mower is a riding mower, the frame is provided with the driving seat, the storage platform is mounted at a tail of the frame, and the tail of the frame is provided with the storage cavity. An opening of the storage cavity is facing upward, and the storage platform is located at the opening of the storage cavity. The storage platform and the storage cavity form an upper and lower two-layer storage structure, the storage platform is used to place items with larger volume or shape, such as ropes, buckets, etc.; the storage cavity is used to accommodate some small items, such as mobile phones, power banks, pads, etc.

In an embodiment of the disclosure, a cushion block is arranged on an opening edge of the storage cavity. A function of the cushion block is to separate a casing of the storage cavity and the storage platform. The mower will cause a vibration of the storage platform in a process of mowing, and the cushion block can effectively prevent the storage platform from causing wear to an edge of the storage cavity by arranging the cushion block between the storage platform and the storage cavity.

In an embodiment of the disclosure, a boss is arranged at a position corresponding to the cushion block of the storage platform, and the boss protrudes towards the cushion block. The boss and the cushion block can effectively increase a height of the storage cavity, thereby increasing an accommodating space of the storage cavity.

In an embodiment of the disclosure, the storage platform is rotatably mounted at the tail of the frame and is located behind the driving seat. A rotatable mounting allows the storage platform to be lifted from a top of the storage cavity, enable it to be easier to pick up and place items in the storage cavity.

In an embodiment of the disclosure, a supporting bracket is arranged on the tail of the frame, and the storage platform is rotatably mounted on the supporting bracket. A connecting component is arranged between the supporting bracket and the storage platform, a first end of the connecting component is mounted on the supporting bracket, and a second end of the connecting component is mounted on the storage platform. The supporting bracket is provided with a pin hole, and the first mounting hole is correspondingly arranged on the storage platform. A pin bolt passes through the pin hole and the first mounting hole, so that the storage platform is rotatably connected with the supporting bracket.

In an embodiment of the disclosure, the supporting bracket includes a supporting rod and the second mounting frame. The frame is provided with an inserting groove, the supporting rod is inserted into the inserting groove, and the second mounting frame is arranged at an end part of the supporting rod. The supporting rod is connected with the second mounting frame by bolt. A first end of the second mounting frame is connected with the supporting rod, and a second end of the second mounting frame is connected with an anti-roll frame. The pin hole is arranged on the supporting rod.

In an embodiment of the disclosure, the supporting bracket is further provided with the connecting hole, and a second mounting hole is arranged on the storage platform. A first end of the connecting component is mounted on the connecting hole, and a second end of the connecting component is mounted on the second mounting hole. A main function of the connecting component is to enhance a load-bearing capacity of the storage platform, and in addition, the connecting component also has a limiting function.

In an embodiment of the disclosure, the connecting component is a rope, and the rope may be directly mounted in the connecting hole and the second mounting hole. But in order to avoid a wear and tear to the rope caused by the connecting hole or the second mounting hole, the pin bolt or the bolt is mounted in the connecting hole and the second mounting hole respectively, and an end of the rope is provided with a ring buckle, and the ring buckle is mounted on the pin bolt or the bolt, so that the wear to the rope can be effectively reduced.

In an embodiment of the disclosure, the storage platform is provided with a flange, the flange is located on a rear edge of the storage platform, and the flange can effectively increase a strength of the storage platform and the load-bearing capacity of the storage platform.

In an embodiment of the disclosure, a plurality of friction protrusions is arranged on the storage platform. A center part of each friction protrusion is provided with a through hole, and the through hole is mainly set up for two purposes: firstly, it can effectively reduce a weight of a storage board, and secondly, the through hole can play a role of ventilation in order to maintain a dryness of the storage cavity.

In an embodiment of the disclosure, the mower further includes the casing mounted on the frame, the casing is provided with a cup groove, which is located next to the driving seat. The casing is further provided with a port, and an upper part of the port is covered with a dust-proof cover, and the dust-proof cover is mounted on the casing through a torsion spring. The dust-proof cover can effectively protect the port. The port may be a USB port, a type-c port and a micro port and so on.

In an embodiment of the disclosure, the casing is provided with the operating device, the operating device is provided with an operating key, and the operating key is used to realize an operation of the mower, such as a speed or a light of the mower, etc. The operating device is further provided with a display screen. The display screen is tilted arranged.

In an embodiment of the disclosure, the driving seat is provided with a seat belt and a seat belt buckle, and the seat belt and the seat belt buckle are respectively located on two sides of the driving seat. Seat belts can ensure a safety of the staff. The two sides of the driving seat are provided with an armrest, and the armrests are provided with a cushion to increase comfort.

In an embodiment of the disclosure, the walking wheel includes the front wheel assembly and the rear wheel assembly, the front wheel assembly is a universal wheel, and the rear wheel assembly is driven by the walking motor. A radius of the front wheel assembly is less than a radius of the rear wheel assembly. The large radius of the rear wheel assembly ensures that the mower has enough horsepower.

In an embodiment of the disclosure, a lawn outlet of the cutting deck assembly is provided with the lawn discharging cover, and two sides of the lawn discharging cover are provided with a flange that bends downward. A function of the lawn discharging cover is to drain lawn clippings at the lawn outlet, and the flange on both sides of the lawn discharging cover can effectively prevent the lawn clippings from flying during a discharging process.

In an embodiment of the disclosure, the lawn discharging cover is rotatably mounted on the frame, and the torsion spring is arranged between the frame and the lawn discharging cover. The lawn clippings carry moisture and may easily stick to an inside of the lawn discharging cover, so when it is necessary to clean the inside of the lawn discharging cover, the lawn discharging cover needs to be turned over and cleaned. After cleaning, the lawn discharging cover is reset under an action of the torsion spring.

In an embodiment of the disclosure, the lawn discharging cover is mounted on the frame by two mounting plates. A plurality of bolts are arranged between the two mounting plates, the lawn discharging cover is positioned between the two mounting plates, and the two mounting plates are rotatably mounted on the frame.

In an embodiment of the disclosure, the mower is a standing mower, the storage platform is arranged in a middle part of the frame, the storage platform is provided with the connecting plate, and the connecting plate is connected with the frame. The connecting plate can effectively increase a firmness of the storage platform.

In an embodiment of the disclosure, three flanges are arranged on the storage platform. The three flanges enclose the storage platform into a frame body with one side opening, which enables it to be easy to store things and increase the strength of the storage platform. The storage platform is provided with the friction protrusion, the friction protrusion protrudes upward, and a through hole is arranged in the friction protrusion. The through holes can reduce the weight of the entire storage platform and facilitate heat dissipation for electrical equipment (e.g., motors, control panels, batteries, etc.) below the storage platform.

In an embodiment of the disclosure, the casing is mounted on the frame. The driving seat is mounted on the frame. The battery is mounted on the frame and located inside the casing, and at least part of the battery is located below the driving seat. The controller is electrically connected with the battery and the electrical equipment of the mower respectively, and the controller is mounted inside the casing and located at a tail of the casing.

In an embodiment of the disclosure, the casing includes a first housing, the first housing encloses an inner cavity at the tail of the frame, the controller is located in the inner cavity, and the inner cavity is opened upwards to take and place the controller. The inner cavity is located under a rear and lower part of the driving seat, and the controller can be mounted and disassembled through an upward opening of the inner cavity, thus facilitating maintenance.

In an embodiment of the disclosure, the tail of the casing is concave inward to define a concave area. The casing further includes a tail cover, and the tail cover is detachably mounted in the concave area. The concave area can form a mounting space to mount the tail cover, so that an outer surface of the tail cover fits to upper and lower edges of the concave area to maintain aesthetics. At the same time, the tail cover can also play a protective role in the first housing. In addition, product identification information, such as product identifications or product labels, may also be set on the tail cover.

In an embodiment of the disclosure, the first housing is provided with the cup groove, which is located next to the driving seat. The casing is further provided with the port, and an upper part of the port is covered with the dust-proof cover, and the dust-proof cover is mounted on the housing through the torsion spring. The dust-proof cover can effectively protect the port. The port may be the USB port, the type-c port and the micro port and so on.

In an embodiment of the disclosure, the first housing is provided with an operating deck, the operating deck is provided with the operating key, and the operating key is used to realize the operation of the mower, such as the speed or the light of the mower, etc. The operating deck is further provided with the display screen. The display screen is tilted arranged.

In an embodiment of the disclosure, the driving seat is provided with the seat belt and the seat belt buckle, and the seat belt and the seat belt buckle are respectively located on the two sides of the driving seat. The seat belt can ensure the safety of the staff. The two sides of the driving seat are provided with the armrest, and the armrests are provided with the cushion to increase comfort.

In an embodiment of the disclosure, the walking wheel includes the front wheel assembly and the rear wheel assembly, the front wheel assembly is a universal wheel, and the rear wheel assembly is driven by the walking motor. The radius of the front wheel assembly is less than the radius of the rear wheel assembly. The large radius of the rear wheel assembly ensures that the mower has enough horsepower.

In an embodiment of the disclosure, the lawn outlet of the cutting deck assembly is provided with the lawn discharging cover, and the two sides of the lawn discharging cover are provided with the flange that bends downward. The function of the lawn discharging cover is to drain lawn clippings at the lawn outlet, and the flange on both sides of the lawn discharging cover can effectively prevent the lawn clippings from flying during the discharging process.

In an embodiment of the disclosure, the lawn discharging cover is rotatably mounted on the frame, and the torsion spring is arranged between the frame and the lawn discharging cover. The lawn clippings carry moisture and may easily stick to the inside of the lawn discharging cover, so when it is necessary to clean the inside of the lawn discharging cover, the lawn discharging cover needs to be turned over and cleaned. After cleaning, the lawn discharging cover is reset under the action of the torsion spring.

In an embodiment of the disclosure, the lawn discharging cover is mounted on the frame by two mounting plates. The plurality of bolts are arranged between the two mounting plates, the lawn discharging cover is positioned between the two mounting plates, and the two mounting plates are rotatably mounted on the frame.

In an embodiment of the disclosure, the casing includes a second housing, and the second housing is arranged on the first housing and covers the opening. The second housing can be removed from the first housing. The second housing can effectively protect the controller located in the inner cavity and play a role of dustproof, sunproof and anti-shower. When it is necessary to repair the controller, the second housing may be removed and the controller may be taken out from the inner cavity, thereby increasing a convenience of a maintenance process.

In an embodiment of the disclosure, the second housing is provided with the storage cavity. The storage cavity is an opening cavity that is concave towards the inner cavity and opens upwards. The storage cavity can accommodate small items such as mobile phones, wallets, keys, etc., which are always carried by the operator.

In an embodiment of the disclosure, the supporting bracket is arranged on the tail of the frame, and the storage platform is rotatably mounted on the supporting bracket. The connecting component is arranged between the supporting bracket and the storage platform, the first end of the connecting component is mounted on the supporting bracket, and the second end of the connecting component is mounted on the storage platform. The supporting bracket is provided with the pin hole, and the first mounting hole is correspondingly arranged on the storage platform. The pin bolt passes through the pin hole and the first mounting hole, so that the storage platform is rotatably connected with the supporting bracket. The storage platform is located above the storage cavity, and the two form two layers of storage space, where the storage platform is used to place large items and the storage cavity is used to place small items. During maintenance, the storage platform is lifted up and the second housing is removed, and the controller may be maintained.

In an embodiment of the disclosure, the first mounting frame is mounted in the casing, and the controller is mounted on the first mounting frame. The first mounting frame is detachably mounted at an inner side of the first housing and is located in the inner cavity, and the controller is detachably mounted on the first mounting frame. The controller is mounted on the first mounting frame, which can increase a firmness of a control and prevent the controller from loosening due to bumps or vibrations during mowing. The controller adopts a detachable mounting to facilitate a removal of the controller during later maintenance, so that a maintenance personnel may maintain the controller outside a machine body, thus increasing an operating space and reducing a difficulty of the maintenance. In addition, a removable mounting enables it to be easy to replace the controller, which increases a duration life of other parts of the mower.

In an embodiment of the disclosure, the first mounting frame is provided with a bracket. The bracket is detachably mounted on the first mounting frame. The bracket is used to mount the second housing so that the second housing is clamped onto the first housing. A detachable mounting method of the bracket facilitates a transportation before the machine body is assembled, and can reduce processing costs, while also facilitating a replacement and reducing maintenance costs.

In an embodiment of the disclosure, the first mounting frame further includes the supporting plate. The supporting plate is mounted on the frame and is located inside the casing, the battery and the controller are respectively located on two sides of the supporting plate, and the second housing is located above the supporting plate. A function of the supporting plate is to support the second housing on one hand, and to protect the controller located in the inner cavity on the other hand.

In an embodiment of the disclosure, the tail of the casing is provided with a tail light. The tail light is a strip light that are laid at the tail of the casing and located at an edge of the second housing. The tail light can be lit according to a control command of the controller to show a working condition of the mower.

In an embodiment of the disclosure, the mower includes the machine body, a cutting system, a walking system, an operating system and a display system. The cutting system is mounted on the machine body and includes at least one cutter and cutter driving device for mowing. The walking system is mounted on the machine body and includes the walking wheel and a walking wheel driving device that are used for enable the mower to move. The operating system is mounted on the machine body and includes the operating device for controlling the mower, and the operating device is provided with a speed regulation key. The display system is arranged on the machine body and includes identification information for displaying a walking speed and a cutting speed, and the identification information includes: a speed regulation identification. The walking speed or the cutting speed can be set by the speed regulation key or the speed regulating identification.

In an embodiment of the disclosure, the mower further includes a recording system, an energy supply system and a monitoring system. The recording system includes a memory that is used for recording fault information of the mower and corresponding fault handling measures, warning information and stage mowing information. The energy supply system includes at least one battery pack. The monitoring system is used for monitoring a state about the cutting system, the walking system, the operating system, the recording system and the energy supply system.

In an embodiment of the disclosure, the display system is further used to display an external tool state. The external tool state includes whether the external tool is turned on or off. The mower further includes a port to connect the external tool, and the monitoring system is further used to control whether to start the external tool when it is detected.

In an embodiment of the disclosure, the operating system further includes the operating handle for operating and controlling the walking system of mowing. The operating handle is rotatably mounted on the machine body, and a rotation angle of the operating handle is positively correlated with the walking speed. The speed regulation key is located at an end part of the controller. The speed and the rotation angle of the mower can be operated and controlled by the operating handle.

In an embodiment of the disclosure, the operating system includes two operating handles, each operating handle is respectively provided with the speed regulation key, and the speed regulation key is mounted at an end part of the corresponding operating handle.

In an embodiment of the disclosure, the operating system further includes a communication system. The monitoring system is electrically connected with the communication system and the display system respectively.

The display system includes the display screen. The display screen is arranged on the machine body. The display screen is used to display identification information of the walking speed and a working speed, and the identification information includes the speed regulation identification, and the walking speed or the working speed of the machine body can be set through the speed regulation identification.

In an embodiment of the disclosure, the display screen includes a state display area and a working display area, the state display area is used for displaying state information, the working display area is used for displaying working information, and the working information includes the identification information.

In an embodiment of the disclosure, the state information includes at least one of an operator in-position state, a closing state and releasing state of an electromagnetic brake, time in a current time zone, a cellular signal state, a remote control state, a lighting device state, an alarm light state, and a project name. The project name may be a name of an item in working information. For example, the project name may be light, setting, stage working information, and so on.

In an embodiment of the disclosure, the working information includes a fault reminding, the fault reminding includes the fault information and the corresponding fault handling measures, and the fault information includes a fault code and corresponding fault details.

In an embodiment of the disclosure, the working information further includes the stage working information, which includes: a working area, a working duration, and an average speed.

In an embodiment of the disclosure, the working information further includes pause reminding information, and the pause reminding information includes a pause duration.

In an embodiment of the disclosure, the mower includes the machine body, the walking wheel, the cutting deck assembly, the cutting motor, the controller and a light group. The machine body includes the frame. The walking wheel is rotatably mounted on the frame. The cutting deck assembly is arranged on the frame. The cutting deck assembly is provided the cutting blade. The cutting motor is arranged on the frame and is connected with the cutting blade. The controller is arranged inside the machine body and is electrically connected with the cutting motor. The light group is arranged on the machine body, electrically connected with the controller, and lit according to a preset lighting method under a control of the controller. The light group has at least one lighting method, and the lighting method of the light group corresponds to a state of the mower. For example, the state of the mower corresponding to the different lighting method of the light group is different, and in a certain embodiment, the lighting method of the light group corresponds to the state of the mower one-to-one.

In an embodiment of the disclosure, the mower further includes a functional assembly and an operating assembly. An energy supply assembly includes the battery pack to supply energy to the mower. The operating assembly includes an operating panel and the operating keys arranged on the operating panel to realize an operating and controlling of the mower. The mower further includes the walking motor. The walking motor drives the walking wheels to roll to allow the mower to move as controlled.

In an embodiment of the disclosure, the light group includes at least one of a headlight, a side light, a dome light or a tail light.

In an embodiment of the disclosure, the headlight, the side light or the dome light is a white light. The headlight, the side light or the dome light includes a light cover and a light bead arranged inside the light cover, and the light cover of the headlight, the side light or the dome light emits a white light with the light beads. For example, the light bead is white, and the light cover is transparent.

In an embodiment of the disclosure, the tail light is a red light, the tail light includes a tail light cover and a tail light bead arranged inside the tail light cover, and the tail light cover and the lamp bead of the tail light cooperate with each other to emit a red light externally. For example, the tail light cover is red, and the tail light bead is white or red.

In an embodiment of the disclosure, the mower is a riding mower, and the machine body further includes the casing arranged on the frame. The riding mower is provided with the anti-roll frame and the driving seat, and the headlight is arranged at the casing under the driving seat. The side lights are arranged on the casing and are respectively located at the two sides of the driving seat. The dome light is arranged on a top of the anti-roll frame, and the tail light is arranged at the tail of the casing.

In an embodiment of the disclosure, the mower is the standing mower, the headlight is arranged on a front side of the machine body, the side light is arranged on left and right directions of the front side of the machine body, the dome light is arranged on a top of the machine body, and the tail light is arranged on left and right directions of the tail of the casing.

In an embodiment of the disclosure, the state of the mower includes a charging state, a charging completion state, a low power state, a light on state, or a light off state.

In an embodiment of the disclosure, the state of the mower further includes a plurality of fault states. The fault state includes a fault element and a number of faults. For example, a right driving controller has two faults, a left cutting blade controller has two faults, etc.

In an embodiment of the disclosure, the cutting deck assembly includes the cutting deck, the motor controller and the plurality of cutting motors. The motor controller and the cutting motor are both mounted on the cutting deck, and the plurality of the cutting motors each is electrically connected with the motor controller, and controlled by the motor controller to centrally control the rotation of each cutting motor.

In an embodiment of the disclosure, the cutting deck is provided with a controller accommodating cavity for mounting the motor controller, a bottom of the controller accommodating cavity is an opening hole structure, and at least part of a lower surface of the motor controller is exposed in the opening hole structure.

In an embodiment of the disclosure, the controller accommodating cavity is provided with a controller protective cover, and a connection between the controller protective cover and the controller accommodating cavity is provided with an air inlet.

In an embodiment of the disclosure, a bottom of the motor controller is provided with a plurality of heat sinks, and the plurality of heat sinks is arranged at intervals along the lower surface of the motor controller.

In an embodiment of the disclosure, the cutting deck is provided with the controller accommodating cavity for mounting the motor controller, the motor controller is mounted in the controller accommodating cavity, and an upper surface of the motor controller is not higher than an upper surface of the cutting deck.

In an embodiment of the disclosure, the cutting deck is provided with a motor mounting hole penetrating the cutting deck, and the cutting motor passing through the motor mounting hole is fixed on the cutting deck through a flange part at an end part of the cutting motor.

In an embodiment of the disclosure, the cutting motor includes a motor end cover, a motor housing, a motor rotor and a motor stator, the motor end cover is fastened with the motor housing to form a motor cavity, and the motor rotor and the motor stator are mounted in the motor cavity.

In an embodiment of the disclosure, the motor housing includes a connecting flange, the first housing and the second housing that are connected sequentially, an outer diameter of the connecting flange is greater than a diameter of the motor mounting hole, and an outer diameter of the first housing and the second housing is less than or equal to the diameter of the motor mounting hole.

In an embodiment of the disclosure, the motor end cover is provided with a first bearing mounting base, and the first bearing mounting base is matched with a first bearing of the motor rotor. A second bearing mounting base is arranged in the second housing, and the second bearing mounting base is matched with the second bearing of the motor rotor.

In an embodiment of the disclosure, a connection between the first housing and the second housing protrudes inward along a radial direction to form a stator supporting step, and the motor stator is arranged on the stator supporting step.

In an embodiment of the disclosure, the connecting flange includes a plurality of first connecting parts and a plurality of second connecting parts, and the first connecting part protrudes from the second connecting part along the radial direction. A plurality of first connecting parts and the plurality of second connecting parts are arranged at intervals and are connected sequentially along a circumferential direction of the first housing to form the connecting flange. The first connecting part is used for being connected with the motor end cover and the cutting deck.

In an embodiment of the disclosure, the motor end cover includes an end cover body and an end cover flange. The end cover flange is matched with the connecting flange, a position of the end cover flange corresponding to the second connecting part is concave downward and forms a step with the second connecting part, and a position of the cutting deck corresponding to the step is provided with a ventilation hole.

In an embodiment of the disclosure, a height of the steps is from 10 mm to 12 mm.

In an embodiment of the disclosure, an outer surface of the motor housing is provided with a plurality of reinforcing ribs.

In an embodiment of the disclosure, the mower includes a mowing device, a grass collection device, the grass conveying device, the clogging detection device, and the first sensor. The grass conveying device conveys the lawn in the mowing device to the grass collection device. The clogging detection device includes the first movable component. When the grass conveying device works normally, the first movable component is in the first state. When the grass conveying device is clogged, the first movable component is in the second state. The first sensor is configured to detect a state of the first movable component.

In an embodiment of the disclosure, the grass collection device is provided with a lawn inlet that is communicated with the grass conveying device, and the first movable component is arranged on the grass collection device and is close to a position of the lawn inlet.

In an embodiment of the disclosure, the first movable component is caused to switch between the first state and the second state by an action of air flow in the grass conveying device.

In an embodiment of the disclosure, the clogging detection device further includes a fixing plate. The first sensor is arranged on the fixing plate, the first movable component is rotatably connected with the grass collection device, and the first movable component rotates relative to the grass collection device to switch between the first state and the second state.

In an embodiment of the disclosure, the fixing plate includes a first limiting part to limit a rotation range of the first movable component.

In an embodiment of the disclosure, the fixing plate includes a first arm and a second arm. A first end of the first arm is fixed on the grass collection device, and a second end of the first arm extends to form the second arm. The first sensor is fixedly mounted on the second arm, and the first limiting part is located at a free end of the second arm.

In an embodiment of the disclosure, when the first movable component is transformed from the first state to the second state, and when the first movable component is maintained in the second state for more than a preset time, the clogging detection device generates a clogging signal.

In an embodiment of the disclosure, the preset time is 3 seconds.

In an embodiment of the disclosure, the first sensor is a switch. The first movable component triggers the switch when the first movable component is in the first state. The first movable component is disconnected from the switch under an action of a gravity of the first movable component when the grass conveying device is clogged.

In an embodiment of the disclosure, the grass collection device is provided with the lawn inlet that is communicated with the grass conveying device, and the first movable component is arranged on the grass collection device and is close to the position of the lawn inlet. When the first movable piece is in the first state, the first movable component is flush with a tangent direction of a top end of the lawn inlet.

In an embodiment of the disclosure, the first movable component is arranged in the grass conveying device, and the first movable component is located at one end of the grass conveying device close to the grass collection device.

In an embodiment of the disclosure, the grass conveying device includes a fan machine and a lawn conveying tube. A first end of the lawn conveying tube is connected with the mowing device, and a second end of the lawn conveying tube is communicated with a grass collection device box, so that the fan machine can suck the lawn cut by the mowing device into the lawn conveying tube.

In an embodiment of the disclosure, the mower further includes an overfill detection device, and the overfill detection device is arranged in the grass collection device to detect a load state of the grass collection device.

In an embodiment of the disclosure, the mower further includes a control device. When the grass conveying device is clogged, the clogging detection device generates the clogging signal and sends it to the control device, and the control device controls the mower to drive to a fault repairing area from a current working position for repairing.

The disclosure further provides the mower. The mower includes the mowing device, the grass conveying device and the clogging detection device. The grass conveying device is configured to convey the lawn cut by the mowing device. The clogging detection device is configured to detect a flow parameter in the grass conveying device. When the airflow parameter is less than a preset value, the clogging detection device generates the clogging signal.

In an embodiment of the disclosure, the clogging detection device detects an air speed at an outlet of the grass conveying device.

In an embodiment of the disclosure, a preset time of the air speed is 156 M/s.

In an embodiment of the disclosure, when the air speed is more than the preset time, the clogging detection device sends the clogging signal.

The disclosure further provides the mower. The mower includes the mowing device, the grass collection device, the grass conveying device and the overfill detection device. The grass conveying device is configured to convey the lawn in the mowing device to the grass collection device. The overfill detection device detects a lawn amount state in the grass collection device. When a lawn amount reaches a threshold, the overfill detection device detects an overfill.

In an embodiment of the disclosure, the overfill detection device is mounted in the grass collection device and is close to a top position of the grass collection device.

In an embodiment of the disclosure, the overfill detection device includes at least one detection unit. When the detection unit all detects that the lawn amount in a grass collection box reaches the threshold, the overfill detection device generates an overfill signal.

In an embodiment of the disclosure, the overfill detection device includes a first detection unit, a second detection unit and a third detection unit, and the three detection units are mounted at intervals.

In an embodiment of the disclosure, the detection unit includes a second sensor and a second movable component. The second movable component has the first state and the second state. The second movable component switches between the first state and the second state under an action of the lawn in the grass collection device. When the lawn amount in the grass collection box reaches the threshold, the second movable component is in the second state.

In an embodiment of the disclosure, the detection unit further includes a mounting bracket, the second sensor is fixed on the mounting bracket, and the second movable component is rotatably connected with the mounting bracket.

In an embodiment of the disclosure, the mounting bracket is provided with a second limiting part to limit a rotation range of the second movable component.

In an embodiment of the disclosure, the second sensor is a switch. When the second movable component is in the second state, the second movable component triggers the switch. When the second movable component is in the first state, the second movable component is disconnected.

In an embodiment of the disclosure, the mower further includes a lawn unloading device, and the lawn unloading device includes an electric pushing rod. The grass collection device includes the grass collection box, and the grass collection box includes a box door. A first end of the electric pushing rod is mounted on the grass collection box, and a second end of the electric pushing rod is connected with the box door of the grass collection box to drive the box door to open or close.

In an embodiment of the disclosure, when the overfill detection device generates the overfill signal, the electric pushing rod drives the box door to open.

In an embodiment of the disclosure, the mower further includes the clogging detection device, the lawn inlet is arranged at a connection of the grass collection device and the grass conveying device, and the clogging detection device is arranged on the grass collection device and is close to the lawn inlet.

In an embodiment of the disclosure, the mower further includes a control device. When the grass conveying device is clogged, the clogging detection device generates the clogging signal and sends it to the control device, and the control device controls the mower to drive to a fault repairing area from a current working position for repairing.

The disclosure further provides the mower. The mower includes the mowing device, the grass collection device, the grass conveying device and the clogging detection device. The grass conveying device is configured to convey the lawn in the mowing device to the grass collection device. The clogging detection device is arranged on the grass collection device, close to a position of the grass collection device connected with the grass conveying device, and used for detecting whether the grass conveying device is clogged.

The overfill detection device is mounted in the grass collection device to detect the load state of the grass collection device.

In an embodiment of the disclosure, the mower further includes a control device. When the grass conveying device is clogged, the clogging detection device generates the clogging signal and sends it to the control device, and the control device controls the mower to drive to a fault repairing area from a current working position for repairing.

When the grass collection device is full, the overfill detection device generates an overfill signal and sends it to the control device, and the control device controls the mower to move from the current working position to the lawn discharging area to unload the lawn.

In an embodiment of the disclosure, the mower includes the driving motor. The driving motor includes a motor casing and a driving motor winding. The driving motor winding is arranged in the motor casing, and the motor casing is provided with at least one reinforcing connecting body. The motor casing and the reinforcing connecting body are made of different materials respectively, and a material strength of the reinforcing connecting body is greater than a material strength of the motor casing. The reinforcing connecting body is provided with a threaded hole for a threaded connection with a reducer.

In an embodiment of the disclosure, the reinforcing connecting body is detachably fixed on the motor casing.

In an embodiment of the disclosure, the reinforcing connecting body is embedded and cast inside the motor casing.

In an embodiment of the disclosure, the motor casing is provided with one reinforcing connecting body, and the reinforcing connecting body is provided with at least two threaded holes for the threaded connection with the reducer connecting component.

In an embodiment of the disclosure, the motor casing is provided with at least two reinforcing connecting bodies, and each reinforcing connecting body is provided with the threaded holes for the threaded connection with the reducer connecting component.

In an embodiment of the disclosure, a first circumferential stopping structure is arranged between the reinforcing connecting body and the motor casing.

In an embodiment of the disclosure, the first circumferential stopping structure includes a plurality of first protruding parts and a plurality of first concave parts corresponding to the plurality of first protruding parts. The plurality of the first protruding parts are arranged on one of the reinforcing connecting body and/or the motor casing, and the plurality of first concave parts is correspondingly arranged on the other one of the reinforcing connecting body and/or the motor casing.

In an embodiment of the disclosure, the mower includes a walking driving mechanism. The walking driving mechanism includes the driving motor, the reducer and a sealing structure. The reducer is coaxially connected with the driving motor, and the sealing structure is arranged at a connecting position of the driving motor and the reducer, and a sealing fit is formed between the driving motor and the reducer.

In an embodiment of the disclosure, the sealing structure includes a first sealing component, and the first sealing component is coaxially sleeved on the driving motor and/or the reducer.

In an embodiment of the disclosure, the first sealing component is a first sealing ring, and the first sealing ring is provided with a first elastic structure. The first elastic structure is arranged on one surface of the sealing ring facing the reducer along the circumferential direction, and the first elastic structure is interference abutted on an end face of the reducer, and forms a sealing with the end face through a friction matching.

In an embodiment of the disclosure, the sealing structure further includes a second sealing component, the second sealing component is coaxially arranged on the reducer, and a radial plane of the second sealing component at a connection position is arranged opposite to the first sealing component.

In an embodiment of the disclosure, the first sealing component is a second sealing ring, and the second sealing ring is provided with a second elastic structure along an outer edge of the circumferential direction. The second sealing component is provided with a lip edge along the circumferential direction, the lip edge is located at the circumferential outer side of the second sealing ring, and the second elastic structure is interference abutted on an inner wall of the lip edge along the circumferential direction, and is matched with the lip edge to form the sealing through the friction matching.

In an embodiment of the disclosure, the first sealing component is provided with a first deck surface, and the second sealing component is provided with a second deck surface. The first deck surface and the second deck surface are arranged relative to each other at a radial plane, and a gap is left between the first deck surface and the second deck surface.

In an embodiment of the disclosure, a length of the gap is from 1 mm to 3 mm.

In an embodiment of the disclosure, the second sealing component is provided with a first flange along an outer edge of a circumferential direction of the first deck surface, and the outer edge of the circumferential direction of the first sealing component is relatively matched with the first flange to form the sealing.

In an embodiment of the disclosure, the first sealing component is provided with a second flange along an inner edge of the circumferential direction of the second deck surface. The second flange extends toward one side of the reducer, and the first deck surface is provided with a sealing groove matched with the second flange. The second flange is embedded in the sealing groove, and the second flange is matched with the sealing groove to form the seal.

Beneficial effects of some embodiments of the disclosure are that:

the conventional mower frame has an integrated structure, the wheelbase of the front wheel and rear wheel is fixed, and the cutting deck assembly mounted at the bottom of the frame cannot be replaced with a suitable specification according to a working environment because of the limited wheelbase; the frame of the disclosure is a separating type frame, the front frame and the rear frame are detachable and fixedly mounted, the cutting deck assembly of different specifications corresponds to the front frame of different specifications, the front wheel assembly is mounted on the front frame, when the cutting deck assembly needs to be replaced to meet the use requirements, the front frame and the rear frame of appropriate specifications are first selected to be fixed, so that the cutting deck assembly is guaranteed to have a suitable mounting size, and then the cutting deck assembly that needs to be replaced is mounted on the frame, so that the suitable cutting deck assembly may be replaced in different working environments, which meets the use requirements of a variety of environments. The suitable cutting deck assembly of the disclosure and the front frame may also be in a relative connecting state at all times, on one hand, it reduces time of finding components, on the other hand, it saves an assembly process and improves replacement efficiency.

### BRIEF DESCRIPTION OF THE DRAWINGS

In order to explain technical solutions of embodiments of the disclosure more clearly, the following will briefly introduce drawings used in a description of the embodiments or the conventional art. Obviously, the drawings in the following description are only some embodiments of the disclosure. For those of ordinary skill in the art, other drawings may be obtained based on these drawings without creative work.

FIG. 1 is a schematic structural view of a riding mower according to an embodiment of the disclosure.

FIG. 2 is a left view of the riding mower according to an embodiment of the disclosure.

FIG. 3 is a structural view of the riding mower according to an embodiment of the disclosure.

FIG. 4 is a schematic view of the riding mower according to an embodiment of the disclosure.

FIG. 5 is a first bottom view of a mower according to an embodiment of the disclosure.

FIG. 6 is a schematic view of a parking releasing mechanism according to an embodiment of the disclosure.

FIG. 7 is a schematic view of a manual releasing mechanism according to an embodiment of the disclosure.

FIG. 8 is a schematic structural view of a braking plate according to an embodiment of the disclosure.

FIG. 9 is a first schematic view of the mower according to an embodiment of the disclosure.

FIG. 10 is a front view of the mower according to an embodiment of the disclosure.

FIG. 11 is a right view of the mower according to an embodiment of the disclosure.

FIG. 12 is a schematic structural view of a frame according to an embodiment of the disclosure.

FIG. 13 is a schematic structural view of a front frame according to an embodiment of the disclosure.

FIG. 14 is a schematic structural view of a rear frame according to an embodiment of the disclosure.

FIG. 15 is a schematic mounting view of a motor controller according to an embodiment of the disclosure.

FIG. 16 is a schematic structural view of a frame according to another embodiment of the disclosure.

FIG. 17 is a schematic structural view of a front frame according to another embodiment of the disclosure.

FIG. 18 is a second schematic view of the mower according to an embodiment of the disclosure.

FIG. 19 is a right view of the mower according to an embodiment of the disclosure.

FIG. 20 is a first schematic view of a cutting deck assembly according to an embodiment of the disclosure.

FIG. 21 is a first schematic structural view of the cutting deck assembly according to an embodiment of the disclosure.

FIG. 22 is a right view of the cutting deck assembly according to an embodiment of the disclosure.

FIG. 23 is a left view of the cutting deck assembly according to an embodiment of the disclosure.

FIG. 24 is a top view of the cutting deck assembly according to an embodiment of the disclosure.

FIG. 25 is a partial schematic structural view of the cutting deck assembly according to an embodiment of the disclosure.

FIG. 26 is a partial schematic view of the cutting deck assembly according to an embodiment of the disclosure.

FIG. 27 is a partial perspective structural view of the cutting deck assembly according to an embodiment of the disclosure.

FIG. 28 is a schematic view of a height adjustment device according to an embodiment of the disclosure.

FIG. 29 is a structural view of the height adjustment device according to an embodiment of the disclosure.

FIG. 30 is an enlarged view of an area E in FIG. 21 of the disclosure.

FIG. 31 is an enlarged view of an area F in FIG. 21 of the disclosure.

FIG. 32 is an enlarged view of an area G in FIG. 28 of the disclosure.

FIG. 33 is a schematic structural view of a self-locking mechanism according to an embodiment of the disclosure.

FIG. 34 is a schematic view of a self-locking component according to an embodiment of the disclosure.

FIG. 35 is a third schematic view of the mower according to an embodiment of the disclosure.

FIG. 36 is a second bottom view of a mower according to an embodiment of the disclosure.

FIG. 37 is a second schematic view of a cutting deck assembly according to an embodiment of the disclosure.

FIG. 38 is a bottom view of the cutting deck assembly according to an embodiment of the disclosure.

FIG. 39 is a second schematic structural view of the cutting deck assembly according to an embodiment of the disclosure.

FIG. 40 is a schematic structural view of a lawn crushing mode of the cutting deck assembly according to an embodiment of the disclosure.

FIG. 41 is a bottom view of a lawn discharging mode of the cutting deck assembly according to an embodiment of the disclosure.

FIG. 42 is a schematic structural view of the lawn discharging mode of the cutting deck assembly according to an embodiment of the disclosure.

FIG. 43 is a schematic view of a cutting deck assembly with the height adjustment device according to an embodiment of the disclosure.

FIG. 44 is a left view of the cutting deck assembly with the height adjustment device according to an embodiment of the disclosure.

FIG. 45 is a right view of the cutting deck assembly with the height adjustment device according to an embodiment of the disclosure.

FIG. 46 is a schematic structural view of the cutting deck assembly with the height adjustment device according to an embodiment of the disclosure.

FIG. 47 is a schematic structural view of the cutting deck according to an embodiment of the disclosure.

FIG. 48 is a side view of the mower when an anti-roll frame is in a first position according to an embodiment of the disclosure.

FIG. 49 is a right view of FIG. 48.

FIG. 50 is a top view of FIG. 48.

FIG. 51 is a side view of the mower when an anti-roll frame is in a second position according to an embodiment of the disclosure.

FIG. 52 is an enlarged view of an area I in FIG. 51.

FIG. 53 is a perspective axis side view of the mower according to an embodiment of the disclosure.

FIG. 54 is an enlarged view of an area II in FIG. 53.

FIG. 55 is an enlarged view of an area III in FIG. 53.

FIG. 56 is a schematic structural view of a storage platform of the riding mower according to an embodiment of the disclosure.

FIG. 57 is a partial enlarged view of an area 7A in FIG. 56 of the disclosure.

FIG. 58 is a partial enlarged view of an area 7B in FIG. 56 of the disclosure.

FIG. 59 is a partial enlarged view of an area 7C in FIG. 57 of the disclosure.

FIG. 60 is a schematic structural view of a storage cavity and a mounting plate of the riding mower according to an embodiment of the disclosure.

FIG. 61 is a schematic structural view of the riding mower removing the storage platform and the storage cavity according to an embodiment of the disclosure.

FIG. 62 is a schematic structural view of the riding mower after removing a casing according to an embodiment of the disclosure.

FIG. 63 is a partial enlarged view of an area 7D in FIG. 62 of the disclosure.

FIG. 64 is a schematic structural view of a cup groove and a dust-proof cover of the riding mower according to an embodiment of the disclosure.

FIG. 65 is a schematic structural view of a storage platform lifted up according to an embodiment of the disclosure.

FIG. 66 is a schematic structural view of a mounting position of a controller according to an embodiment of the disclosure.

FIG. 67 is a schematic structural view of the cup groove and the dust-proof cover according to an embodiment of the disclosure.

FIG. 68 is a schematic structural view of a second housing and the storage cavity of the disclosure.

FIG. 69 is a schematic structural view of an overall structure of the mower according to an embodiment of the disclosure.

FIG. 70 is a schematic structural view of an inside of an inner cavity according to an embodiment of the disclosure.

FIG. 71 is a partial enlarged view of an area 8C in FIG. 70 of the disclosure.

FIG. 72 is a partial enlarged view of an area 8A in FIG. 66 of the disclosure.

FIG. 73 is a partial enlarged view of an area 8B in FIG. 68 of the disclosure.

FIG. 74 is a schematic view of a position relationship of a supporting plate, a battery and a controller.

FIG. 75 is a partial enlarged view of an area 8D in FIG. 74 of the disclosure.

FIG. 76 is a structural block view of the mower according to an embodiment of the disclosure.

FIG. 77 is a schematic structural view of the mower according to an embodiment of the disclosure.

FIG. 78 is a partial enlarged view of an area 9A in FIG. 77 of the disclosure.

FIG. 79 is a schematic display view of a display screen according to an embodiment of the disclosure.

FIG. 80 is a schematic display view of an external tool state according to an embodiment of the disclosure.

FIG. 81 is a display view of a state of a lighting device and a state of an alarm light according to an embodiment of the disclosure.

FIG. 82 is a schematic display view of a device parameter according to an embodiment of the disclosure.

FIG. 83 is a schematic display view of a device use time according to an embodiment of the disclosure.

FIG. 84 is a schematic display view of a screen brightness according to an embodiment of the disclosure.

FIG. 85 is a schematic display view of a unit conversion according to an embodiment of the disclosure.

FIG. 86 is a schematic display view of a detailed fault code and an advice of a fault handling measure according to an embodiment of the disclosure.

FIG. 87 is a schematic display view of stage working information according to an embodiment of the disclosure.

FIG. 88 is a schematic display view of a fault reminding according to an embodiment of the disclosure.

FIG. 89 is a schematic structural view of the riding mower according to an embodiment of the disclosure.

FIG. 90 is a rear view of the riding mower according to an embodiment of the disclosure.

FIG. 91 is a perspective schematic structural view of the riding mower according to an embodiment of the disclosure.

FIG. 92 is a partial enlarged view of an area 10A in FIG. 91 of the disclosure.

FIG. 93 is a schematic structural view of the cutting deck assembly according to an embodiment of the disclosure.

FIG. 94 is a partial schematic structural view of the cutting deck assembly according to an embodiment of the disclosure.

FIG. 95 is a schematic structural view of a cutting motor of the cutting deck assembly according to an embodiment of the disclosure.

FIG. 96 is a schematic structural view of the cutting deck assembly from another angle according to an embodiment of the disclosure.

FIG. 97 is a schematic matching view of a controller protective cover and the cutting deck according to an embodiment of the disclosure.

FIG. 98 is a schematic structural view of the motor controller of the cutting deck assembly according to an embodiment of the disclosure.

FIG. 99 is a schematic cross-sectional structural view of the cutting motor of the cutting deck assembly according to an embodiment of the disclosure.

FIG. 100 is a schematic structural view of a motor end cover of the cutting deck assembly according to an embodiment of the disclosure.

FIG. 101 is a schematic structural view of a motor housing of the cutting deck assembly according to an embodiment of the disclosure.

FIG. 102 is a schematic structural view of the motor housing of the cutting deck assembly from another angle according to an embodiment of the disclosure.

FIG. 103 is a schematic structural view of a motor rotor of the cutting deck assembly according to an embodiment of the disclosure.

FIG. 104 is a schematic structural view of a motor stator of the cutting deck assembly according to an embodiment of the disclosure.

FIG. 105 is a schematic structural view of an area 11II in FIG. 94.

FIG. 106 is a schematic structural view of an area 11I in FIG. 94.

FIG. 107 is a schematic view of the mower (mower) and a RTK base station of the disclosure.

FIG. 108 is a schematic block view of the mower, a terminal control device and the RTK base station of the disclosure.

FIG. 109 is a schematic block view of a working principle of the mower of the disclosure.

FIG. 110 is a schematic view of a lawn map calibration for the mower of the disclosure.

FIG. 111 is a flowchart of generating a calibration map of a mowing area by the mower of the disclosure.

FIG. 112 is a flowchart of a mowing operation of the mower selecting the generated calibration map of the disclosure.

FIG. 113 is another schematic block view of the mower, a terminal control device and the RTK base station according to an embodiment of the disclosure.

FIG. 114 is a schematic perspective view of the mower of the disclosure.

FIG. 115 is a schematic perspective view of the mower from another angle of the disclosure.

FIG. 116 is a front view of a grass collection box of the mower removing a box door of the disclosure.

FIG. 117 is a partial enlarged schematic view of the grass collection box of the mower of the disclosure, schematically illustrating a working position of a clogging detection device.

FIG. 118 is a partial schematic view of the grass collection box of the mower from another angle of the disclosure, in which a composition of the clogging detection device is shown schematically in a form of a perspective exploded view.

FIG. 119 is a partial enlarged schematic view of the grass collection box of the mower from another angle of the disclosure, schematically illustrating a working position of a lawn collection overfill detection device.

FIG. 120 is a schematic perspective exploded view of a lawn collection overfill detection device in FIG. 119.

FIG. 121 is a schematic perspective view of a grass collection box of the mower of the disclosure, schematically illustrating a connection relationship of an auto lawn unloading device and a grass collection box.

FIG. 122 is a side view of the mower of the disclosure, schematically illustrating a closing of the box door of the grass collection box.

FIG. 123 is a side view of the mower of the disclosure, schematically illustrating an opening of the box door of the grass collection box.

FIG. 124 is a schematic view of a working situation of the mower of the disclosure.

FIG. 125 is a schematic view of a working principle of an auto lawn collection system of the mower of the disclosure.

FIG. 126 is a perspective view of a driving motor according to an embodiment of the disclosure.

FIG. 127 is a connection exploded view of a motor casing and a reducer fixing base of the driving motor according to an embodiment of the disclosure.

FIG. 128 is a perspective view of a motor casing of the driving motor according to an embodiment of the disclosure.

FIG. 129 is a perspective view of a reinforcing connecting body of the driving motor according to an embodiment of the disclosure.

FIG. 130 is a perspective cross-sectional view of the motor casing of the driving motor according to another embodiment of the disclosure.

FIG. 131 is a perspective view of a reinforcing connecting body of the driving motor according to another embodiment of the disclosure.

FIG. 132 is a perspective view of a motor casing of the driving motor according to another embodiment of the disclosure.

FIG. 133 is a cross-sectional view of the motor casing in FIG. 7.

FIG. 134 is a perspective view of the reinforcing connecting body embedded in the motor casing in FIG. 7.

FIG. 135 is an exploded view of the motor casing of the driving motor according to another embodiment of the disclosure.

FIG. 136 is a left view of the motor casing with a pressing ring in FIG. 135.

FIG. 137 is a cross-sectional view of a direction of 16C-16C in FIG. 136.

FIG. 138 is a perspective view of the reinforcing connecting body in FIG. 135.

FIG. 139 is a connecting exploded view of a driving device and a walking wheel of the disclosure.

FIG. 140 is an exploded view of the driving device according to an embodiment of the disclosure.

FIG. 141 is a cross-sectional view of the driving device according to an embodiment of the disclosure.

FIG. 142 is a cross-sectional view of a direction of 16B-16B in FIG. 141.

FIG. 143 is a cross-sectional view of a direction of 16A-16A in FIG. 141.

FIG. 144 is a perspective view of the mower according to an embodiment of the disclosure.

FIG. 145 is a schematic structural view of a walking driving mechanism according to an embodiment of the disclosure.

FIG. 146 is a schematic structural exploded view of the walking driving mechanism according to an embodiment of the disclosure.

FIG. 147 is a schematic structural view of a first sealing ring according to an embodiment of the disclosure.

FIG. 148 is a schematic cross-sectional structural view of the walking driving mechanism at a connection of a motor and the reducer according to a first embodiment of the disclosure.

FIG. 149 is a schematic structural exploded view of the walking driving mechanism according to another embodiment of the disclosure.

FIG. 150 is a schematic matching view of an oil sealing and a second sealing ring according to another embodiment of the disclosure.

FIG. 151 is a schematic cross-sectional structural view of the second sealing ring according to an embodiment of the disclosure.

FIG. 152 is a schematic cross-sectional structural view of the walking driving mechanism at a connection of a motor and the reducer according to a second embodiment of the disclosure.

FIG. 153 is a schematic structural exploded view of the walking driving mechanism according to another embodiment of the disclosure.

FIG. 154 is a schematic cross-sectional structural view of the walking driving mechanism at a connection of a motor and the reducer according to a third embodiment of the disclosure.

FIG. 155 is a schematic structural exploded view of the walking driving mechanism according to another embodiment of the disclosure.

FIG. 156 is a schematic cross-sectional structural view of the walking driving mechanism at a connection of a motor and the reducer according to a fourth embodiment of the disclosure.

### PART NUMBER DESCRIPTION

1—mower; 10—machine body; 100—frame; 101—casing; 1010—first housing; 1011—inner cavity; 1012—concave area; 1013—tail cover; 1020—second housing; 110—front frame; 111—first cross beam; 112—first connecting part; 113—assembling tube; 114—first clamping board; 115—second clamping board; 116—first through hole; 117—penetrating groove; 118—wheel protective board; 119—accessory connecting part; 120—rear frame; 121—square tube; 122—connecting bolt; 123—first placing area; 1231—first mounting hole; 1232—battery protective board; 124—second rotation connecting hole; 125—first rotation connecting hole; 130—anti-collision device; 140—inserting groove; 1400—light group; 1410—headlight; 1420—side light; 1430—dome light; 1440—tail light; 150—supporting bracket; 151—supporting rod; 152—pin hole; 153—connecting hole; 154—connecting component; 1600—monitoring system; 1601—external tool state; 1602—battery power; 1603—operator in-position state; 1604—closing state and releasing state of electromagnetic brake; 1605—time in current time zone; 1606—unit conversion; 1607—cellular signal state; 1608—remote control state; 1609—lighting device state; 1610—alarm light state; 1611—device energy consumption state; 1612—device use time; 1613—fault reminding; 1614—detailed fault code; 1615—advice of fault handling measure; 1616—stage working information; 1620—identification information; 1621—speed gear of the walking system; 1622—speed gear of the cutting system; 1623—walking speed regulation identification; 1624—cutting speed regulation identification; 1630—device parameter; 1631—screen brightness; 1700—display system; 1711—state display area; 1712—working display area; 1713—interface switching key; 1714—communication system; 1811—radio unit; 1812—GNSS receiving antenna; 1813—wireless antenna; 240—controller; 1814—positioning device; 1815—autonomous controller; 1816—4G-GPS module; 1817—remote control signal receiving unit; 1818—communication device; 1819—standing frame; 1820—RTK base station; terminal control device (APP (iPad) 3; 1840—server; 185—lawn to be calibrated (area to be calibrated); 1850—boundary of mowing area (plot to be calibrated); 1855—non-mowing area (obstacle); 1856—non-mowing area (obstacle);

200—walking mechanism; 201—walking wheel; 2010—cutting system; 2020—walking system; 200—walking mechanism; 201—walking wheel; 2030—operating system; 12031—cutting switch; 0233—main switch; 1330—operating rod; 231—operating handle; 2040—recording system; 210—front wheel assembly; 2100—steering wheel; 2101—first front wheel; 2102—second front wheel; 220—rear wheel assembly; 2200—driving wheel; 221—braking plate; 2211—first notch; 222—manual releasing part; 2221—releasing protrusion; 230—operating device; 2301—operating deck; 231—operating handle; 2311—walking speed regulation key; 232—display screen; 233—main control switch; 240—controller; 241—first mounting frame; 242—bracket; 243—supporting plate;

300—cutting deck assembly; 310—cutting deck; 311—motor mounting hole; 3111—first hole; 3112—second hole; 312—ventilation hole; 313—pedal pad; 314—connecting base; 320—cutting part; 321—cutting motor; 3211—motor end cover; 32111—first bearing mounting base; 32112—end cover body; 32113—end cover flange; 321131—first flange part; 321132—second flange part; 32114—step; 32115—wiring outlet; 3212—motor housing; 32121—second bearing mounting base; 32122—connecting flange; 321221—first connecting part; 321222—second connecting part; 321223—circumferential protrusion; 321224—arc-shaped protrusion; 32123—first housing; 32124—second housing; 321241—reinforcing rib; 3213—motor rotor; 32131—first bearing; 32132—second bearing; 3214—motor stator; 32141—stator supporting step; 3215—connecting wiring; 322—cutting blade; 3221—first cutting blade; 3222—second cutting blade; 3223—lawn pushing part; 323—motor controller; 324—controller accommodating cavity; 3240—controller protective cover; 3241—cover board; 3242—connecting plate; 3243—air inlet; 325; heat sink; 330—cutting baffle; 331—edge blocking board; 332—middle blocking board; 333—lawn discharging blocking board; 334—accommodating cavity; 340—lawn discharging port; 341—lawn discharging cover; 342—mounting plate; 343—torsion spring; 350—height adjustment device; 3501—front height adjustment component; 351—first connecting rod; 352—second connecting rod; 353—third connecting rod; 354—pedal rod; 3541—pedal mounting hole; 355—fourth connecting rod; 356—fifth connecting rod; 357—first connecting plate; 360—locking device; 361—blocking plate; 362—limiting board; 3621—limiting hole; 3622—clamping hole; 363—limiting rod; 364—blocking step; 370—self-locking mechanism; 371—self-locking rod; 372—self-locking component; 373—self-locking groove; 374—holding part; 375—protrusion; 376—bent part; 380—roller; 390—shock absorbing device; 400—anti-roll frame; 401—first side arm; 402—connecting body; 403—second side arm; 404—protective body; 405—lighting assembly; 406—tail light; 410—anti-loss pulling structure; 411—second mounting frame; 412—pulling wire; 413—anti-loosening locking body; 414—shock absorbing block; 415—bolt assembly; 4151—gasket; 416—locking pin; 4111—first locking hole; 4112—second locking hole; 420—storage groove; 500—driving seat; 501—seat belt; 502—seat belt buckle; 503—armrest; 510—pedal area; 520—placing frame; 521—cup groove; 522—dust-proof cover; 6105—lawn collection system control device; 6106—auto driving control system; 300—cutting deck assembly; 620—fan machine; 6210—fan machine controller; 625—lawn conveying tube; 630—grass collection box; 631—first side wall; 632—lawn inlet; 633—front wall; 634—second side wall; 6340—framework; 635—swing arm; 636—box door; 6360—framework; 637—top wall; 638—bottom wall; 640—clogging detection device; 641—bolt; 642—screw; 643—washer; 644—nut; 645—first movable component; 646—first sensor/first switch; 647—fixing plate; 6470—first arm; 6471—second arm; 6472—limiting part; 648—mounting post; 650—overfill detection device; 6501—first detection unit; 6502—second detection unit; 6503—third detection unit; 651—nut; 652—flat washer; 653—opening pin; 654—bolt; 655—second movable component; 656—second sensor/second switch; 6560—triggering piece; 6562—triggering head; 657—screw; 658—mounting bracket; 6580—mounting bracket part; 6581—first part; 6582—second part; 6583—third part; 6584—mounting part; 659—long axis pin; 660—auto lawn unloading device; 661—bolt; 662—nut; 663—electric pushing rod; 664—bolt; 665—nut; 6A—current working position; 6B—current working position; 6P—detection and repairing point; 6M—lawn discharging point; 700—driving device; 7110—driving motor; 7111—motor casing; 71111—first concave part; 71112—stopping disc mounting hole; 71113—connecting sleeve mounting through hole; 71114—block; 7112—reinforcing connecting body; 71121—threaded hole; 71122—first protruding part; 711221—axial protrusion; 711222—annular protrusion; 71123—connecting sleeve; 71124—shaft hole; 71125—positioning boss; 71126—blocking edge; 7113—first torque output end; 71131—first sun gear; 7114—elastic blocking ring; 7115—compressing plate; 7116—compressing bolt; 7120—reducer; 7121—first gear system; 71211—fixing base; 71212—second planetary gear; 7122—second torque output end; 71221—first inner tooth ring; 71222—second inner tooth ring; 7123—second gear system; 71231—first planetary gear bracket; 71232—first planetary gear; 71233—second sun gear; 7130—connecting bolt; 710—charging port cover; 8110—first groove; 8120—second protrusion; 8200—reducer; 8210—outer tooth ring; 8211—outer tooth ring end surface; 8300—first sealing component; 8310—first sealing ring; 8311—first elastic structure; 8312—first protrusion; 8313—second groove; 8320—second sealing ring; 8321—third groove; 8322—second elastic structure; 8330—end surface pressing plate; 8331—first deck surface; 8332—second flange; 8400—second sealing component; 8410—oil sealing; 8411—tightening steel ring; 8412—lip edge; 8420—rotating frame; 8421—second deck surface; 8422—first flange; 8423—sealing groove; 8500—clamping hood; 800—battery; 810—control assembly; 820—cavity body; 900—storage device; 910—storage platform; 911—boss; 912—flange; 913—friction protrusion; 914—first mounting hole; 915—second mounting hole; 916—connecting plate; 920—storage cavity; 921—cushion block.

### DETAILED DESCRIPTION

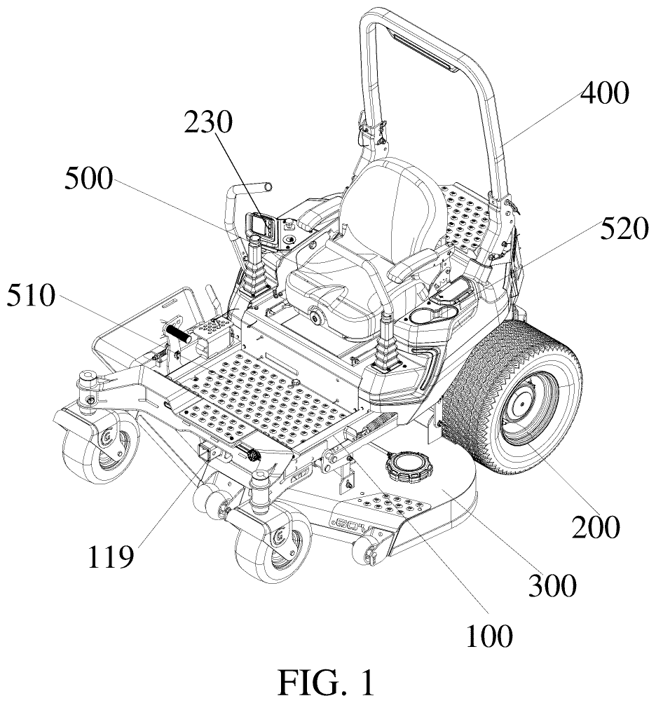

Please refer to FIG. 1 through FIG. 156. The following describes the implementation of the disclosure through specific embodiments, and those skilled in the art can easily understand other advantages and effects of the disclosure from the content disclosed in this specification. The disclosure may also be implemented or applied through other different specific embodiments. Various details in this specification may also be modified or changed based on different viewpoints and applications without departing from the disclosure. It should be noted that, the following embodiments and the features in the embodiments can be combined with each other without conflict. It should further be understood that the terms used in the examples of the disclosure are used to describe specific embodiments, instead of limiting the protection scope of the disclosure. The test methods that do not indicate specific conditions in the following examples are usually in accordance with conventional conditions, or conditions recommended by each manufacturer.

When an embodiment gives a range of values, it should be understood that, unless otherwise specified in the disclosure, two endpoints of each range of values and any one of the values between the two endpoints may be selected. Unless otherwise defined, all technical and scientific terms used in the disclosure and the prior art mastered by a person skilled in the art and a description of the disclosure may also be realized by using any method, equipment and material similar to or equivalent to the prior art described in the embodiments of the disclosure.

It should be noted that terms “upper”, “lower”, “left”, “right”, “middle” and “one” quoted in this specification are only for a convenience of description, and are not used to limit a scope of the disclosure.

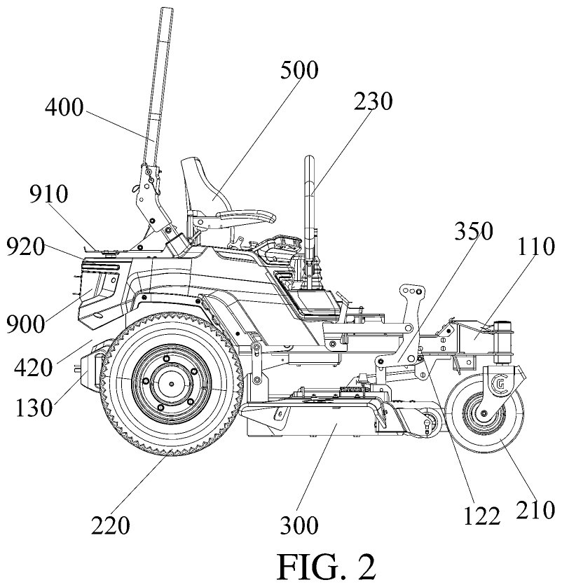

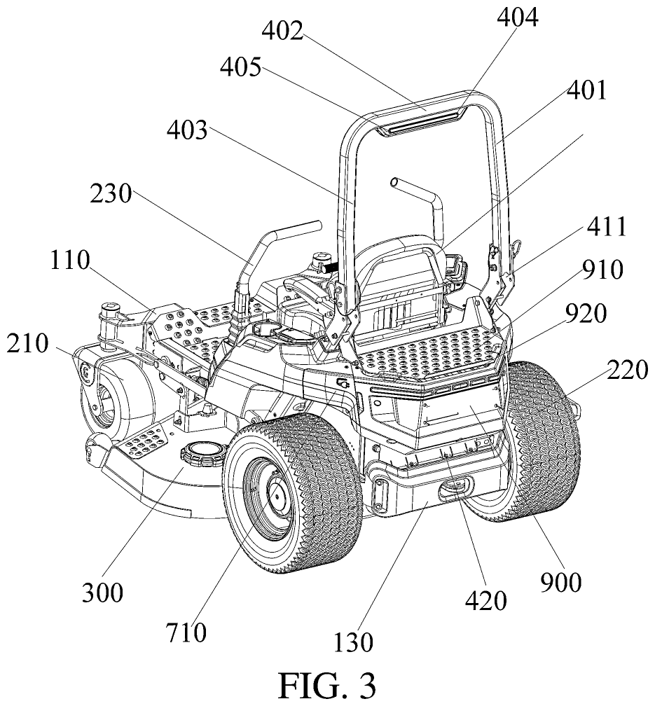

Please refer to FIG. 1 through FIG. 4. The disclosure provides a mower. The mower includes a frame 100, a walking mechanism 200 and a cutting deck assembly 300.

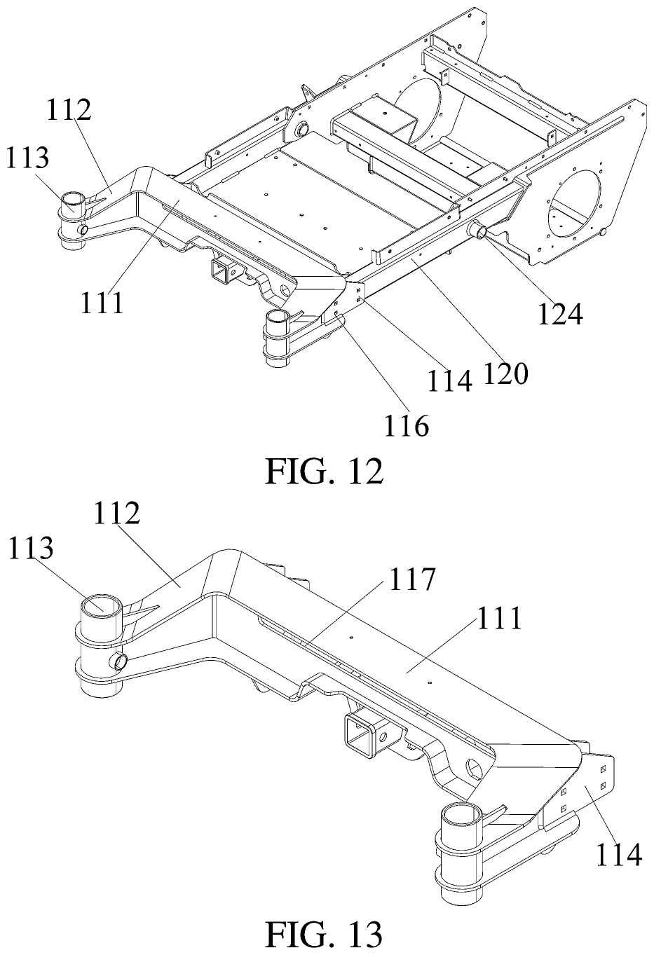

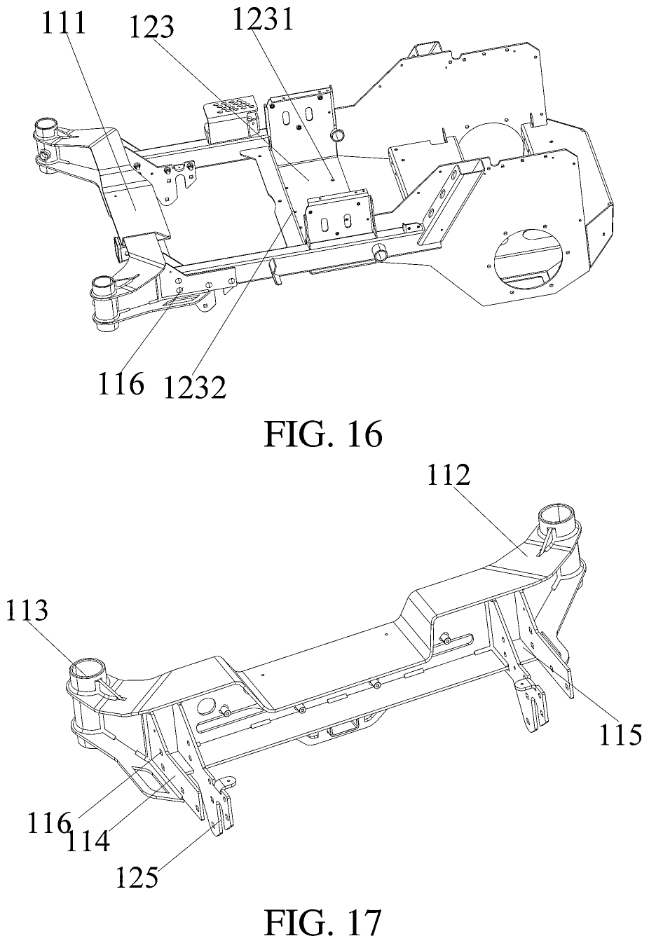

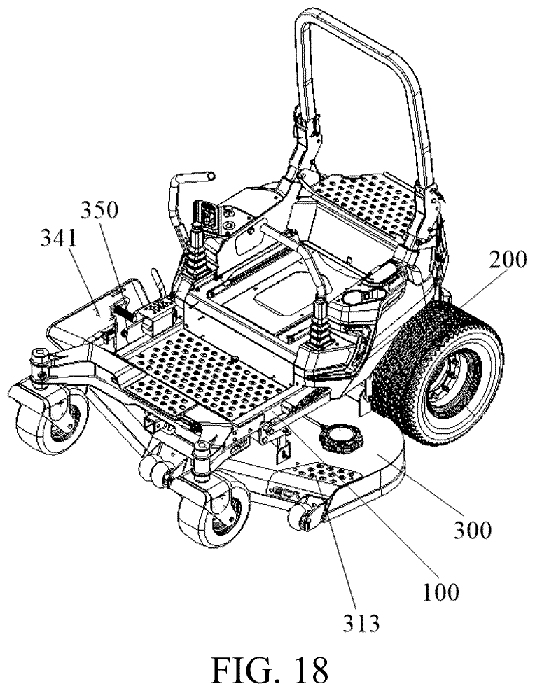

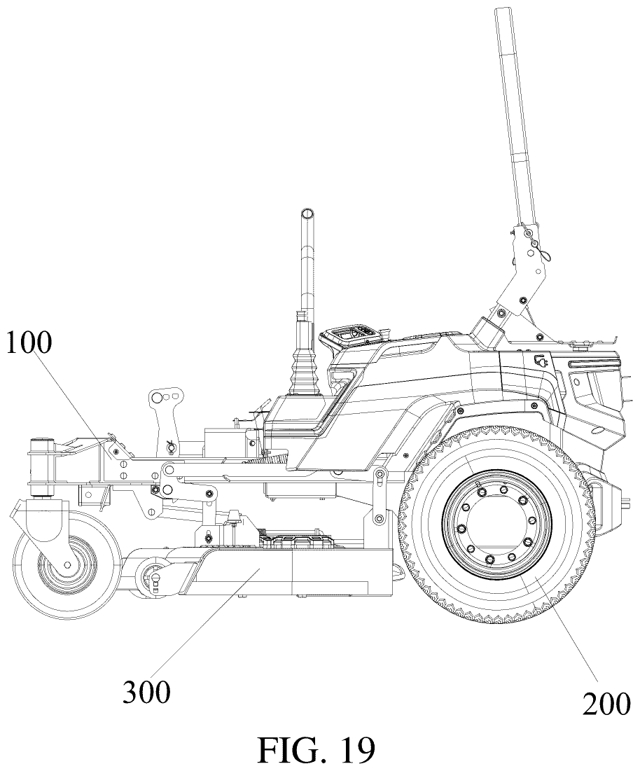

Please refer to FIG. 12 and FIG. 16. FIG. 12 and FIG. 16 show structures of two exemplary frames 100. The frame 100 includes a front frame 110 and a rear frame 120. The front frame 110 is detachably connected with the rear frame 120, the front frame 110 is provided with a front wheel assembly 210, and the rear frame 120 is provided with a rear wheel assembly 220. In some embodiments, the front frame 110 and the rear frame 120 are mounted and fixed through a connecting bolt 122. The front wheel assembly 210 is separately assembled on the front frame 110, and the battery, the control assembly, etc. are assembled on the rear frame 120. When the cutting deck 310 of different specifications needs to be replaced, such as 48 inches, 52 inches, 60 inches, etc., the mower changes a wheelbase of the mower by replacing an adapted front frame 110, so that the cutting deck 310 may be assembled.

In an embodiment, after the cutting deck 310 is assembled on the mower, the cutting deck 310 is located between the front wheel and the rear wheel. A closest distance between the cutting deck 310 and the front wheel is from 10 mm to 60 mm, and a closest distance between the cutting deck 310 and the rear wheel is from 10 mm to 60 mm. The cutting deck 310 keeps a suitable distance from both of the front wheel and the rear wheel. On one hand, it is convenient for the cutting deck 310 to adjust a height, on the other hand, in a harsh working environment such as bumps, the cutting deck 310 will produce a slight front and rear shaking. Keeping a certain distance from the front wheel and the rear wheel avoids a collision between the cutting deck 310 and the front wheel, and between the cutting deck 310 and the rear wheel, and reduces a risk of a damage to the mower.

Please refer to FIG. 13. FIG. 13 is a structure of the front frame 110 according to an embodiment. In an embodiment, the front frame 110 of the mower is U-shaped and includes a first cross beam 111. Two ends of the first cross beam 111 are provided with a first connecting part 112 extending forward, and the two first connecting parts 112 are respectively provided with a front wheel assembly 210. In some embodiments, the front wheel uses a universal wheel as a steering wheel. In an embodiment, a front end of the first connecting part 112 is provided with an assembling tube 113. The assembling tube 113 is provided with a first bearing, and an inside of the first bearing is interference fit a first rotating shaft. A lower end of the first rotating shaft extends out from the assembling tube 113 and is connected with a front wheel fork, and the front wheel fork is rotatably connected with the front wheel. When steering, the front wheels rotate around a first rotating shaft to change a direction. In an embodiment, a front end of the front wheel fork is further provided with a protective inclined plate, and a front edge of the protective inclined plate exceeds a front edge of the front wheel. When encountering an obstacle, the protective inclined plate touches an obstacle earlier than the front wheel, which avoids a bumping and damage to the front wheel.

In an embodiment, the first cross beam 111 of the front frame 110 is provided with a headlight. In some embodiments, the first cross beam 111 is provided with a penetrating groove 117, the headlight is assembled on a back of the first cross beam 111, the headlight is partially clamped in the penetrating groove 117, and light from the headlight illuminates or transmits a signal. In an embodiment, a front side of the first cross beam 111 is provided with a concavity, and the penetrating groove 117 is arranged in the concavity. The headlight is arranged in the penetrating groove 117 of the concavity, and when encountering the obstacle or a collision, the first cross beam 111 may protect the headlight and avoid a direct collision and a damage to the headlight.

Please refer to FIG. 17. FIG. 17 is a structure of the front frame 110 in an embodiment. In an embodiment, a rear end of the front frame 110 is provided with two first clamping boards 114 on both sides, and front ends of the rear frame 120 are two square tubes 121. The square tube 121 is inserted between the two first clamping boards 114, corresponding positions of the square tube 121 and the first clamping board 114 are provided with a first through hole 116, and the first clamping board 114 and the square tube 121 are fastened through the connecting bolt 122 passing through the first through holes 116. In some embodiments, no less than four bolts are used on each side for mounting, so that the front frame 110 is fixed with the rear frame 120. In an embodiment, the first clamping board 114 is vertically arranged, a bottom surface of the two first clamping boards 114 on the same side is provided with a transverse second clamping board 115, and the first clamping boards 114 and the second clamping board 115 form a U-shape. A U-shaped groove is convenient for the square tube 121 of the rear frame 120 to be inserted and fixed, and the second clamping board 115 at the bottom supports for the square tube 121. Affected by a gravity of each part of the mower, a force between the front frame 110 and the rear frame 120 is mainly concentrated at a connection, which is shown in a relative rotation tendency of the front frame 110 and the rear frame 120. A rotation direction is respectively around the front wheel and the rear wheel from the connection downward. Through the second clamping board 115, a supporting area of the connection between the front frame 110 and the rear frame 120 is increased, a shear force that the connecting bolt 122 receives is reduced, a connection firmness is increased, and a duration life of the connecting bolt 122 is prolonged.

When the cutting deck 310 of different specifications needs to be replaced, the front frame 110 needs to be replaced in advance. If parts of the mower that do not need to be replaced are mounted on the front frame 110, a workload of disassembly and assembly is inevitably increased. In an embodiment of the disclosure, most parts of the mower are mower on the rear frame 120, such as a battery, a control system, a driving seat 500 or a standing area, etc.

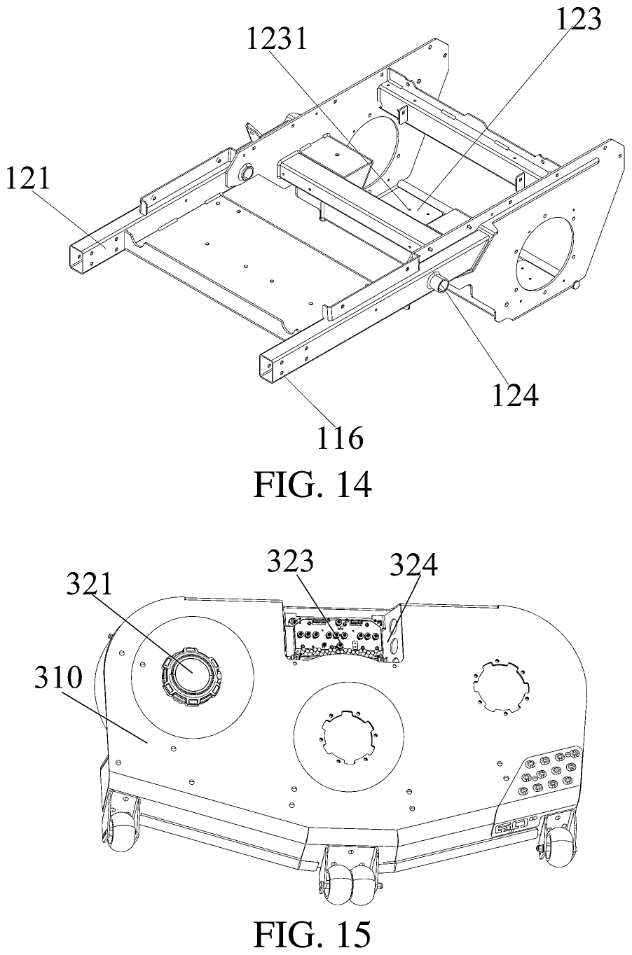

Please refer to FIG. 14. FIG. 14 is a structure of the rear frame 120 according to an embodiment. The rear frame 120 is provided with a first placing area 123, the first placing area 123 is arranged below the driving seat 500, extends forward to a rear end of a pedal area 510, extends backward to a tail end of the frame 100, and fixes the battery in the first placing area 123. The battery provides electrical energy for the mower, and the mowers with different specifications and different requirements need to mount suitable batteries as needed. In some embodiment, a bottom plate of the first placing area 123 is provided with a plurality of first mounting holes 1231, and batteries of different specifications are matched with the first mounting holes 1231 at different positions, so that a mounting and fixation of the batteries of different specifications are realized, and different uses are satisfied. It should be noted that, positions of the first placing areas 123 of the mowers of different forms are different, such as a standing mower, the first placing area 123 is arranged at a position of the rear frame 120 close to the front frame 110. A battery weight is larger, and it is placed in a front position, so that a force brought by a staff standing at a rear end of the mower may be balanced, a stability of the mower is improved, which avoids the mower from overturning when the staff stands back. Such as a riding mower, the staff is sitting on a top surface of the mower. In order to reduce a center of gravity of the mower, the first placing area 123 may be arranged below the driving seat 500, and a center of gravity of the mower may be reduced, which improves a moving stability of the mower and a climbing performance of the mower. An arrangement position of the first placing area 123 may be selected according to an actual situation, and the disclosure does not limit this, which meets placement needs of the battery. It should be noted that, one first placing area 123 may only place one battery, or may place a plurality of batteries. The plurality of batteries may be connected in parallel or in series. The batteries may supply energy at the same time, or a second battery may be used after a power of a first battery is exhausted, and which is not limited in this disclosure, and may be selected according to actual needs. In an embodiment, after the battery 800 is mounted in the first placing area 123, the distance from a top surface of the battery 800 to a ground is less than 610 mm. A distance between a center of gravity of the battery pack and a lower edge of the front wheel assembly 210, or a lower edge of the rear wheel is less than 480 mm. Furthermore, the distance between the center of gravity of the battery pack and the lower edge of the front wheel assembly 210, or the lower edge of the rear wheel is from 360 mm to 460 mm. A distance between the center of gravity of the battery 800 and a rotation center of the rear wheel is less than 400 mm, and a distance between the center of gravity of the battery 800 and a rotation center of the front wheel assembly 210 is 2 to 4 times of the distance between the center of gravity of the battery 800 and the rotation center of the rear wheel. In this embodiment, a mounting height of the battery 800 is lower, and the center of gravity of the battery 800 is lower, which reduces a center of gravity of the mower, enables the whole mower to be more stable and reliable when driving, and at the same time, reduces a riding height of the staff, and also reduces a height of the whole mower to a certain extent. In an embodiment, a maximum height of the mower is less than 2000 mm, further, the height of the mower is from 1700 mm to 1900 mm, for example, 1841 mm. A width of the mower is from 1700 mm to 2100 mm, for example, 1867 mm. A length of the mower is from 1600 mm to 2200 mm, for example, the length is 1874 mm. In an embodiment, a distance between the center of gravity of the mower and an axis of the rear wheel is from 244 mm to 444 mm, and the distance may be any value between 244 mm and 444 mm, such as 244 mm, 300 mm, 344 mm, 444 mm, etc. In some embodiments, the distance between the center of gravity of the mower and the axis of the rear wheel is from 259 mm to 429 mm, and may be any value between 259 mm and 429 mm, such as 259 mm, 344 mm, 385 mm, 400 mm, 729 mm, etc. In an embodiment, the center of gravity of the mower is 65% to 81% between the front wheel axis and the rear wheel axis, which may be any value between 65% and 81%, such as 65%, 71%, 73.5%, 81%, etc. The center of gravity of the mower is close to the rear wheel. In some embodiments, the center of gravity of the mower is 67% to 80% between the front wheel axis and the rear wheel axis, and may be any value between 67% and 80%, such as 67%, 69%, 73.5%, 80%, etc. The center of gravity of the mower is close to the rear wheel.

Please refer to FIG. 16. In an embodiment, a front end and a bottom surface of the first placing area 123 are both provided with a battery protective board 1232, and the battery protective board 1232 is arranged on the frame 100. On one hand, the battery protective board 1232 may limit the battery, which ensures that the battery will not be displaced in a process of use. On the other hand, the battery may be protected, conventional batteries generally select lithium batteries or the lead-acid batteries, the lithium batteries are preferred in a field of mowers. The lithium batteries have a certain risk of spontaneous combustion under a condition of short circuit, the battery is protected by the battery protective board 1232, and the battery is prevented from being damaged and short-circuited. It should be noted that, a specific mounting mode of the battery protective board 1232 may be welded, bolted, riveted, etc., and selected according to the actual needs, which is not limited by the disclosure.

In an embodiment, the cutting deck assembly 300 is mounted at a bottom of the frame 100, and a lawn of suitable height is obtained through mowing the lawn by the cutting deck assembly 300. In an embodiment, the cutting deck assembly 300 includes a cutting deck 310, a cutting part 320, a height adjustment device 350 and a locking device 360. The height adjustment device 350 is used for adjusting a distance between the cutting deck assembly 300 and the ground as a whole, and the locking device 360 is used for locking the distance between the whole of the cutting deck assembly 300 and the ground. In an embodiment, the cutting part 320 includes a cutting blade 322 and a cutting motor 321. One cutting motor 321 may drive one cutting blade 322 to rotate, and it may also drive a plurality of cutting blades to rotate through a transmission mechanism.

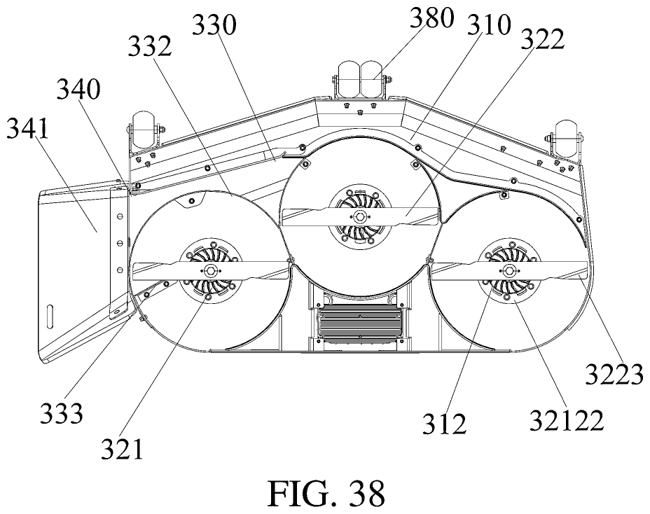

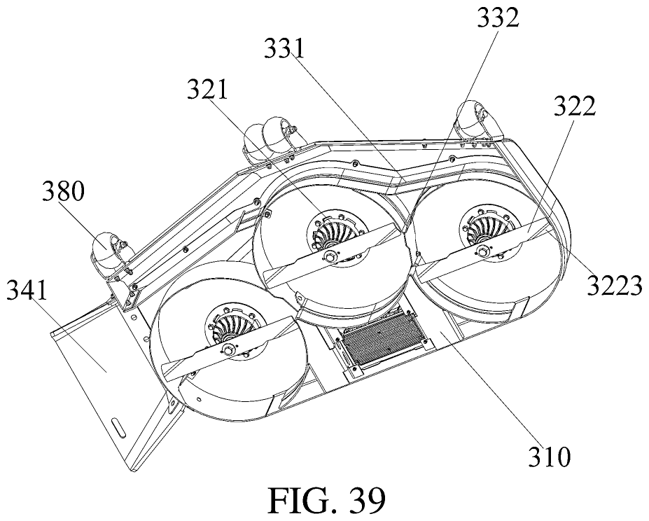

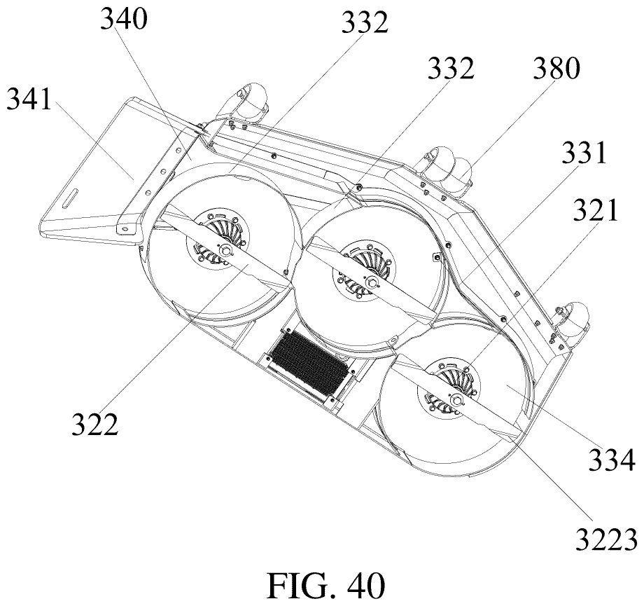

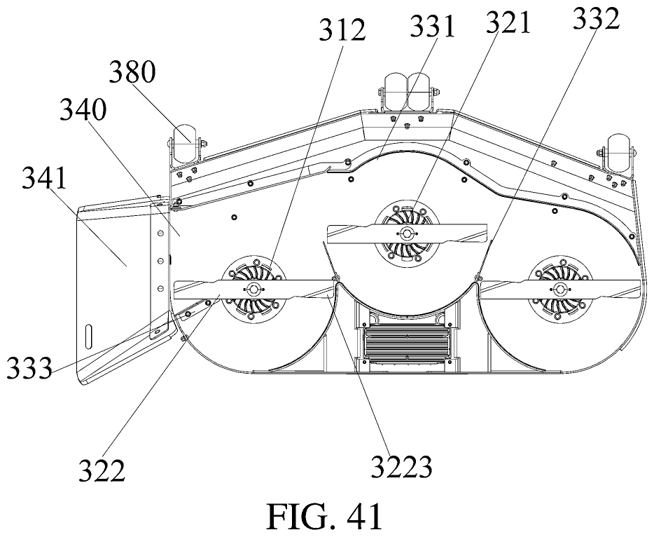

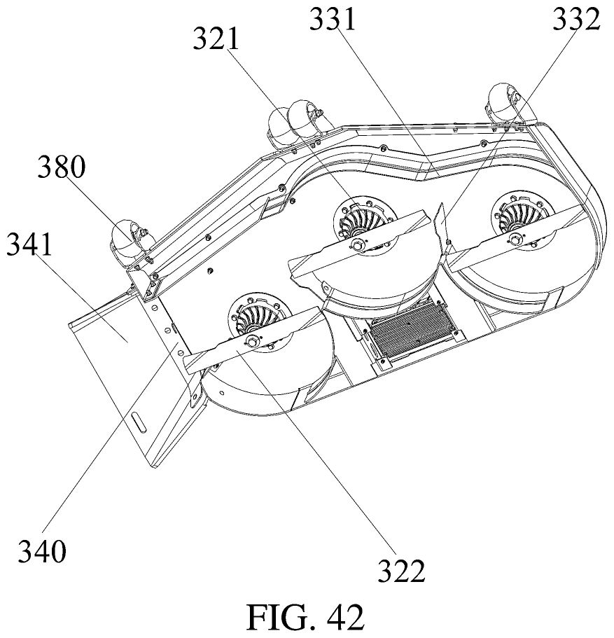

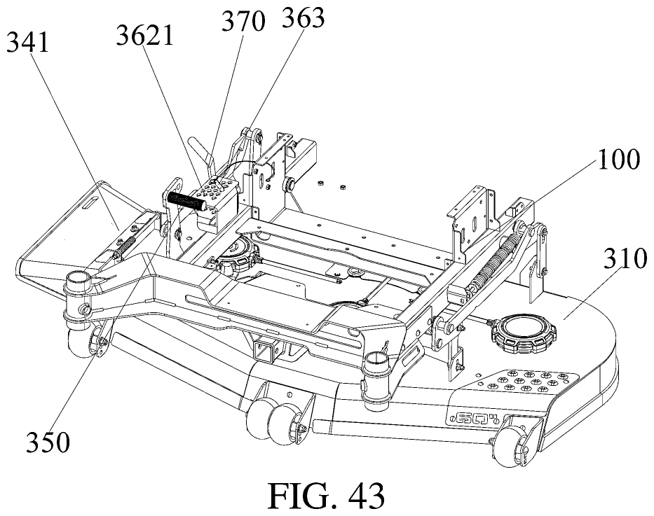

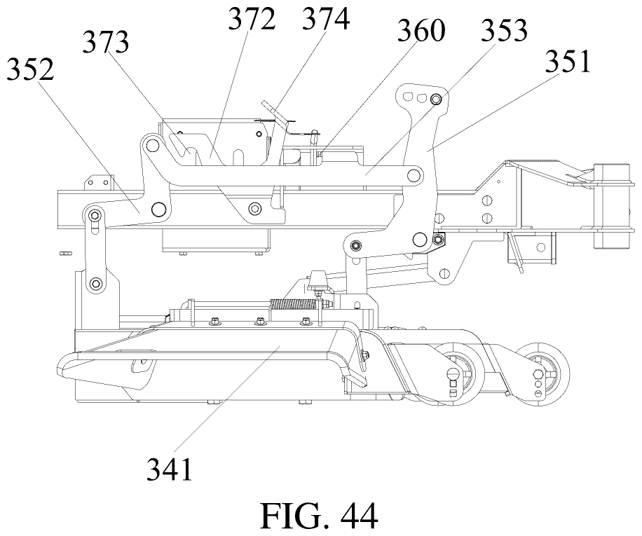

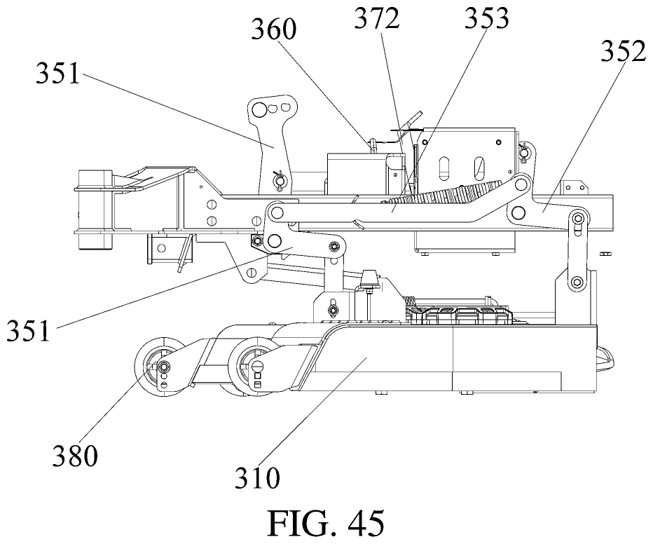

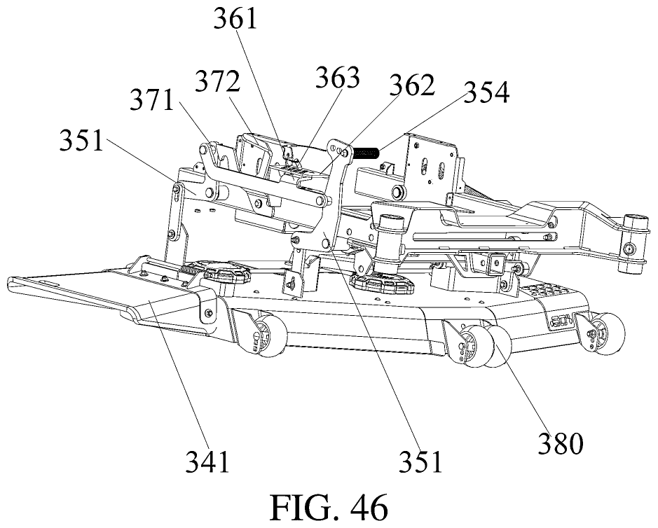

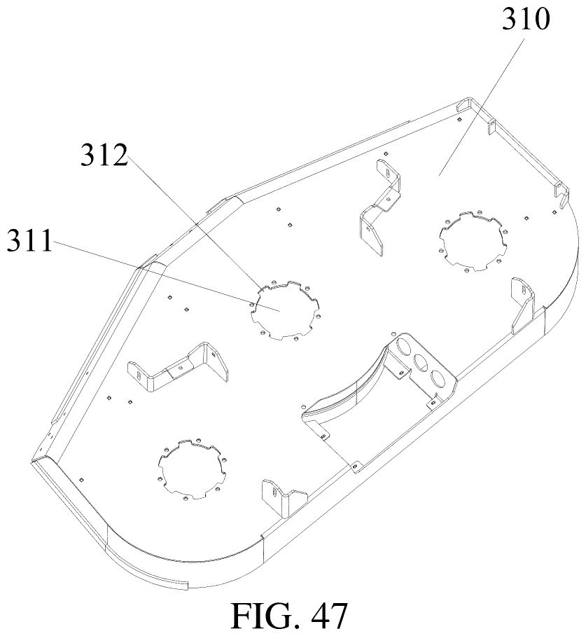

Please refer to FIG. 38. In an embodiment, the cutting part 320 is arranged on the cutting deck 310, and includes the cutting motor 321 and the cutting blade 322 driven by the cutting motor 321. The cutting blade 322 mows the lawn, the height of the cutting blade 322 to the ground is a height required by the lawn. In an embodiment, the cutting motor 321 drives the cutting blade 322, and in another embodiment, the cutting motor 321 simultaneously drives the plurality of cutting blades 322 through the transmission mechanism, which is not limited by the disclosure. A bottom of the cutting deck 310 is provided with a cutting baffle 330, and the cutting deck 330 prevents the cut lawn from splashing. A side surface or a rear surface of the cutting baffle 330 is provided with a lawn discharging port 340, and the lawn discharging port 340 is provided with a lawn discharging cover 341 that is rotatably connected with the cutting deck 310. It should be noted that, in other embodiments, the cutting motor 321 may be directly mounted on the frame 100 or other suitable positions.

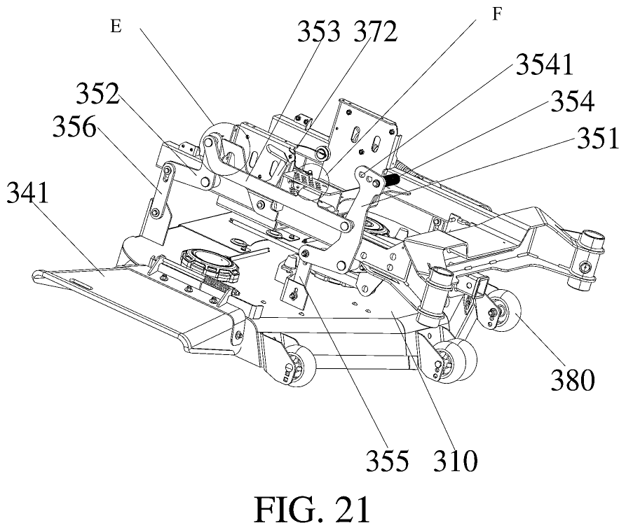

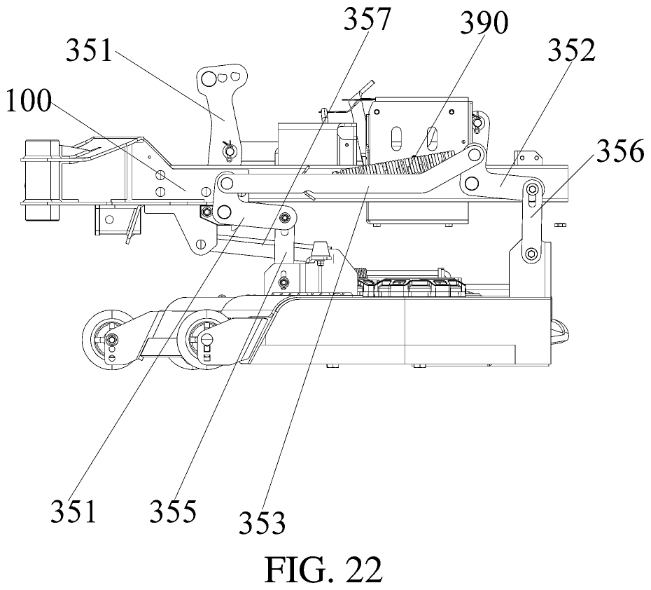

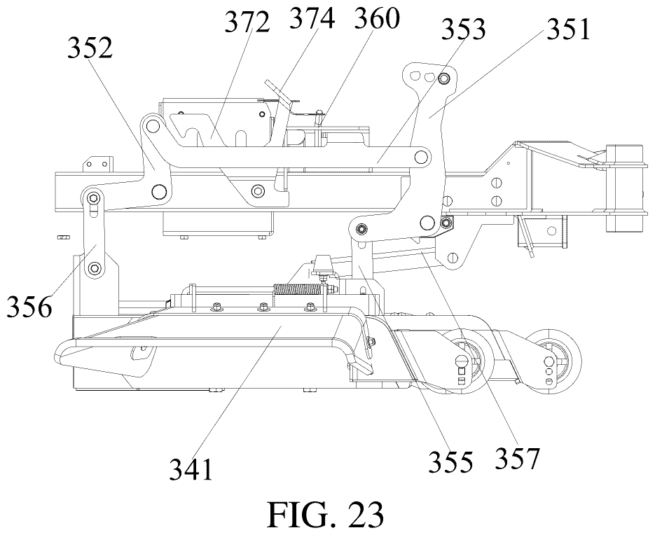

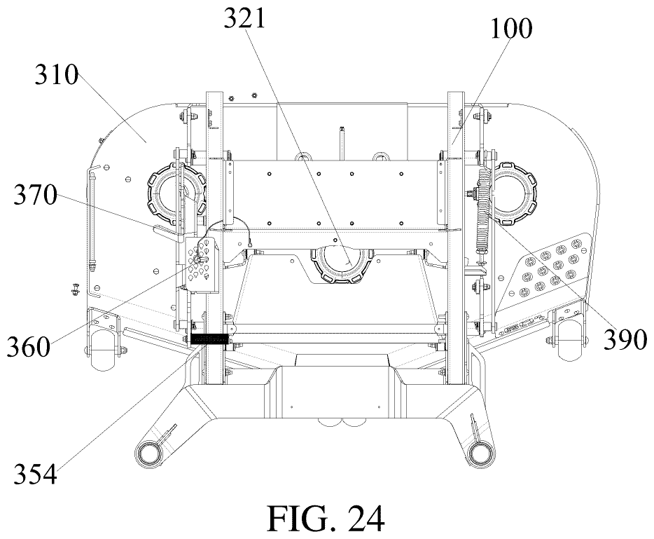

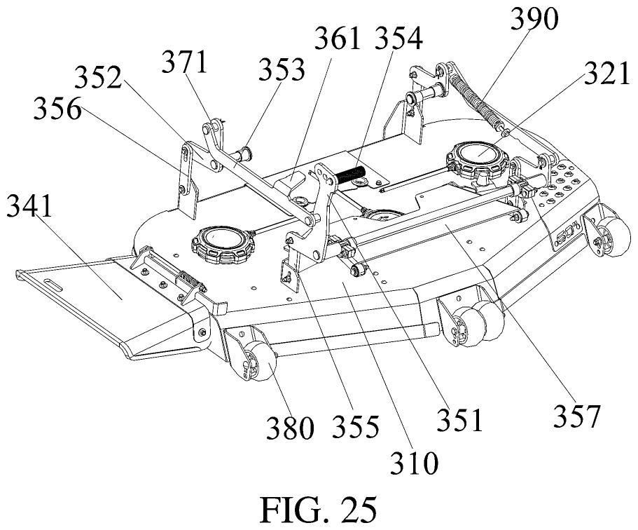

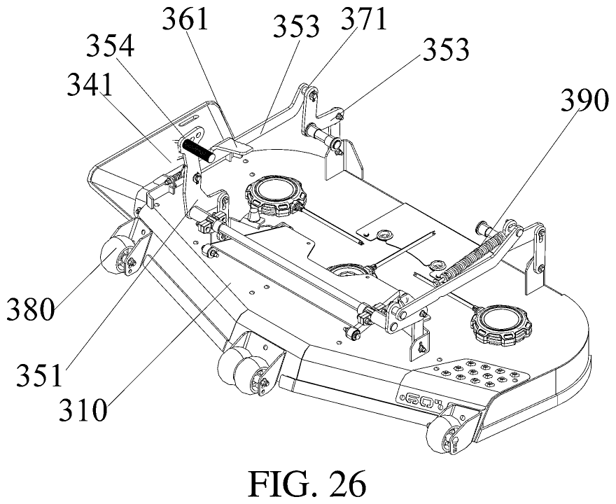

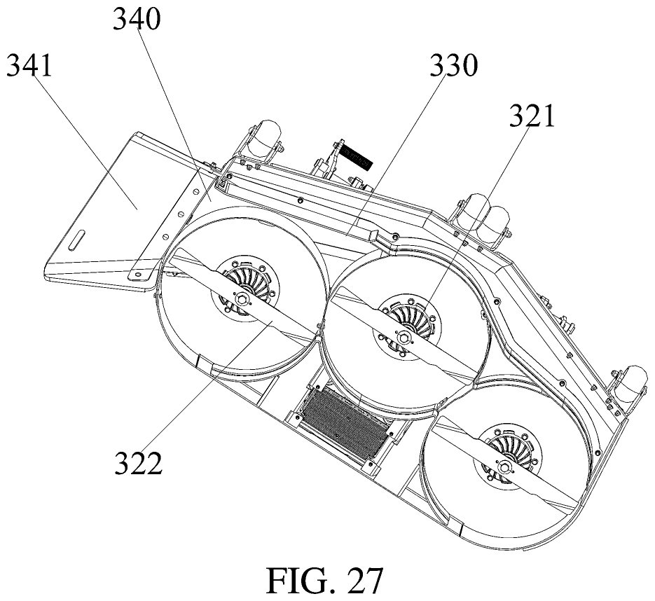

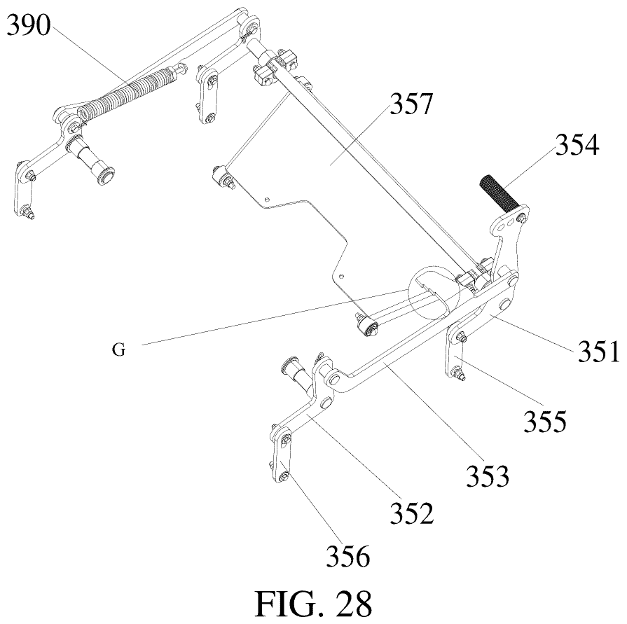

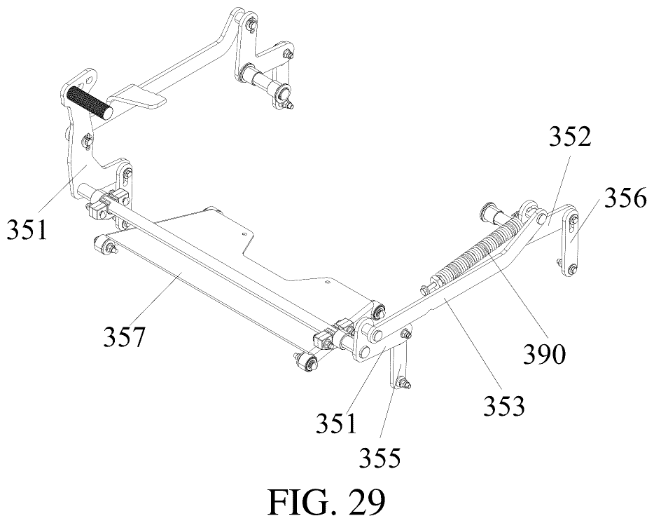

Please refer to FIG. 21 through FIG. 23. The height adjustment device 350 is used for adjusting a height of the cutting blade 322 from the ground, so as to obtain a suitable height to meet needs of different lawn. When the height adjustment device 350 adjusts the height, a distance to the ground of the cutting deck assembly 300 is adjusted as a whole. On one hand, it may meet mowing needs of different lawns, on the other hand, when encountering uneven road surface or obstacles, the cutting deck assembly 300 maintains a higher distance to the ground, which may avoid obstacles, and has a better terrain passing ability. The height adjustment device 350 includes a first connecting rod 351, a second connecting rod 352 rotatably connected with the frame 100. There are two first connecting rods and two second connecting rods, and they are arranged two sides of the frame 100 respectively. The first connecting rod 351 and the second connecting rod 352 are respectively rotatably connected with the cutting deck 310. The first connecting rod 351 is connected with the second connecting rod 352 through a third connecting rod 353. The third connecting rod 353 is rotatably connected with both of the first connecting rod 351 and the second connecting rod 352. The third connecting rod 353 and the cutting deck 310 are arranged on two sides of the first connecting rod 351, and the third connecting rod 353 and the cutting deck 310 are arranged on two sides of the second connecting rod 352. The cutting deck 310 may be driven to rise or fall through rotating the first connecting rod 351 or the second connecting rod 352, so that a height of the cutting deck assembly 300 is adjusted. In some embodiment, the two first connecting rods 351 are relatively fixed with each other, or the two second connecting rods 352 are relatively fixed with each other, so that two sides of the height adjustment device 350 may be adjusted synchronously, which keeps the cutting deck assembly 300 being stable. In an embodiment, the two first connecting rods 351 are connected through a fixing rod, and the fixing rod is in a fixed connection with the two first connecting rods 351, so that a relative fixation between the two first connecting rods 351 is realized. In an embodiment, the fixing rod is used as a rotating shaft of the first connecting rod 351 and the frame 100, which not only realizes the fixation between the two first connecting rods 351, but also avoids a displacement of the fixing rod when the first connecting rod 351 rotates, and saves an assembly and use space.

In an embodiment, the first connecting rod 351 is rotatably connected with the frame 100 through the rotating shaft, and an axis of the rotating shaft of the first connecting rod 351 and the frame 100 is a first axis. The second connecting rod 352 is rotatably connected with the frame 100 through the rotating shaft, and an axis of the rotating shaft of the second connecting rod 352 and the frame 100 is a second axis. A connecting line of the first axis and the second axis is a first line segment, and the first line segment is perpendicular to the first axis and the second axis respectively. The connecting rod 351 is rotatably connected with the third connecting rod 353 through the rotating shaft, and an axis of the rotating shaft of the first connecting rod 351 and the third connecting rod 353 is a third axis. The second connecting rod 352 is rotatably connected with the third connecting rod 353 through the rotating shaft, and an axis of the rotating shaft of the second connecting rod 352 and the third connecting rod 353 is a fourth axis. A connecting line of the third axis and the fourth axis is a second line segment, and the second line segment is perpendicular to the third axis and the fourth axis respectively. The first connecting rod 351 is rotatably connected with the cutting deck 310 through the rotating shaft, and an axis of the rotating shaft of the first connecting rod 351 and the cutting deck 310 is a fifth axis. The second connecting rod 352 is rotatably connected with the cutting deck 310 through the rotating shaft, and an axis of the rotating shaft of the second connecting rod 352 and the cutting deck 310 is a sixth axis. A connecting line of the fifth axis and the sixth axis is a third line segment, and the third line segment is perpendicular to the fifth axis and the sixth axis respectively. The first line segment, the second line segment, and the third line segment are parallel and equal in length, so that in a lifting process, the cutting deck 310 is always at a level, and the cutting blade 322 is horizontal, so as to obtain a good mowing effect.

Please refer to FIG. 21. In an embodiment, the first connecting rod 351 is provided with a pedal rod 354, and the pedal rod 354 is arranged at one end of the first connecting rod 351 away from the cutting deck 310. The user may lift the cutting deck assembly 300 by a foot pedaling, and by lifting the feet, the cutting deck assembly 300 falls due to gravity. Compared to using hands, it is faster and easier to operate with feet. Especially for the riding mower, a height of the cutting deck assembly 300 may be adjusted by the user sitting on the mower, which is very convenient. It should be noted that, the pedal rod 354 may be a rod-shaped, plate-shaped, block-shaped and other structures suitable for pedaling, and a specific structure is not limited.

In some embodiment, a surface of the foot pedal rod 354 is provided with an anti-slip structure, such as the surface is provided with anti-skid lines, sleeved with of an anti-slip pad, etc., and a suitable anti-slip structure is selected according to an actual situation, which is not repeated in this disclosure.

Please refer to FIG. 21. A height and leg length of different users are different, and in order to facilitate an operation of different personnel, in an embodiment of the disclosure, one end of the first connecting rod 351 away from a deck frame is provided with a plurality of pedal mounting holes 3541, and the pedal rod 354 may be fixed on different pedal mounting holes 3541, so that an adjustment of a position of the pedal rod 354 is realized, and different use requirements of different personnel are satisfied. The pedal rod 354 is detachably connected with the first connecting rod 351, an external thread may be arranged for an end part of the pedal rod 354, the pedal mounting hole 3541 is a threaded hole, and the pedal rod 354 is directly threaded with the foot pedal mounting hole 3541. In an embodiment, a threaded hole is arranged at the end part of the pedal rod 354, and the pedal rod 354 may be fixed through a bolt passing through the pedal mounting hole 3541 and the pedal rod 354. In an embodiment, the end part of the pedal rod 354 may be provided with an external threaded step, and a step of the pedal rod 354 penetrates through the pedal mounting hole 3541 and is fixed through a nut. Appropriate connection means are selected according to actual needs, which are not limited by this disclosure.

In an embodiment, in order to facilitate a lifting operation of the cutting deck assembly 300, the first connecting rod 351 and the rotating shaft of the frame 100 are close to the cutting deck 310, which means that a distance from the pedal rod 354 to the rotating shaft is greater than a distance from the cutting deck 310 to the rotating shaft. According to a principle of lever, when the height of the cutting deck assembly 300 is adjusted by the user, only a small force needs to be applied to the pedal rod 354 to realize a height adjustment of the cutting deck assembly 300, and an operation of the user is more convenient and more force-saving.

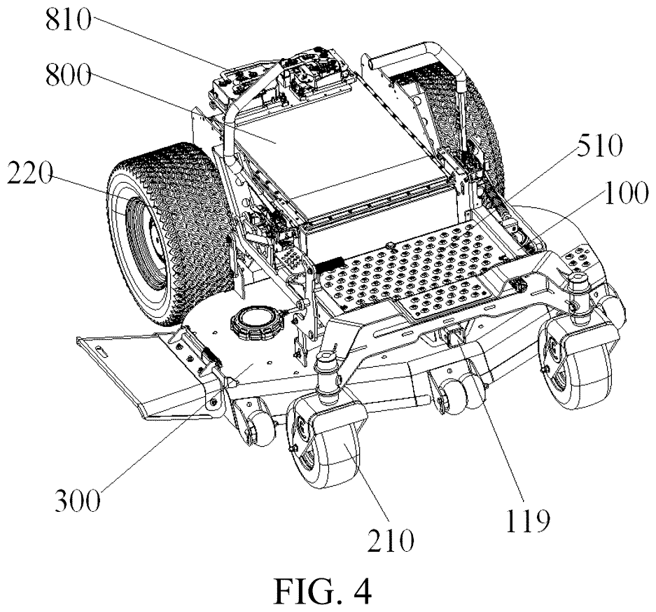

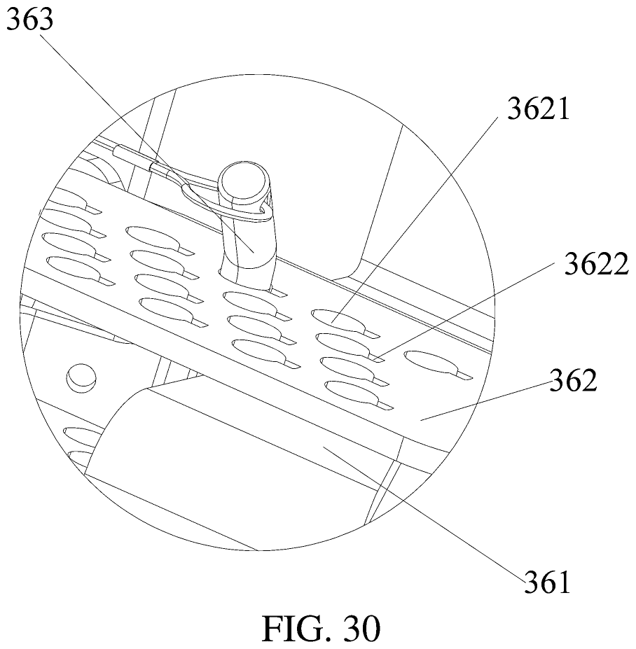

Please refer to FIG. 30. FIG. 30 is an enlarged view of an area E in FIG. 4 of the disclosure and shows a locking device in an embodiment. After adjusting a distance to the ground of the cutting blade 322, the locking device 360 is required to lock the cutting deck assembly 300 to ensure that an appropriate cutting height is always maintained. The locking device 360 includes a blocking plate 361 and a limiting board 362. The blocking plate 361 is arranged on the height adjustment device 350, such as on the first connecting rod 351, the second connecting rod 352, the third connecting rod 353 and other positions. In an embodiment, the blocking plate 361 is fixed on the third connecting rod 353. The third connecting rod 353 is arranged on both sides of the frame 100, and in order to facilitate use, the blocking plate 361 is arranged on the third connecting rod 353 on a same side as the pedal rod 354, and extends out to the frame 100. The limiting board 362 is fixed on the frame 100, a plurality of limiting holes 3621 are arranged on the limiting board 362, and a limiting rod 363 is matched and arranged in the limiting hole 3621.

In an embodiment, in order to facilitate a height adjustment, when stepping on the pedal rod 354 forward, the cutting deck assembly 300 is lifted, which means that when the blocking plate 361 moves forward, the cutting deck assembly 300 is lifted, and when the cutting deck assembly 300 is lowered, the blocking plate 361 moves backward. In order to lock the height of the cutting deck assembly 300, the limiting rod 363 is arranged at a rear of the blocking plate 361. Under an effect of gravity of the cutting deck assembly 300, the blocking plate 361 has a tendency to move backward, and through a matching of the limiting rod 363 and the limiting board 362, the blocking plate 361 is limited from moving backwards, thereby limiting a downward movement of the cutting deck assembly 300, so that the height of the cutting deck assembly 300 is locked.

The limiting rod 363 is plugged and connected with the limiting hole 3621. When the limiting rod 363 is pulled out and placed aside, it is easy to be lost. In an embodiment of the disclosure, the limiting rod 363 is flexibly connected with the frame 100 or other components of the mower through a rope to avoid a loss of the limiting rod 363 after pulling it out.

Under a condition that a working condition is severe and bumpy, there is a risk that the limiting rod 363 falls out of the limiting hole 3621, and there is also a situation that the staff pulls out the limiting rod 363 by mistake, causing the cutting deck assembly 300 to fall suddenly. In an embodiment, an edge of the limiting hole 3621 is provided with a protruding clamping hole 3622, a side wall of the limiting rod 363 is provided with a clamping block, and the clamping block is matched with the clamping hole 3622. When a position of the clamping block corresponds to a position of the clamping hole 3622, the limiting rod 363 may be pulled out or inserted into the limiting hole 3621. In order to avoid the limiting rod 363 falling off from the limiting hole 3621, after the limiting rod 363 is inserted into the limiting hole 3621, the limiting rod 363 is rotated, so that the position of the clamping block does not correspond to the position of the clamping hole 3622, then the limiting rod 363 cannot be pulled out directly, a risk that the limiting rod 363 falls off from the limiting hole 3621 may be effectively reduced, and a risk of the user pulling out the limiting lever 363 by mistake may also be reduced.

In order to effectively lock the blocking plate 361, please refer to FIG. 30. In an embodiment, the limiting board 362 is provided with upper and lower layers, the limiting holes 3621 on the two layers of limiting board 362 is at a same position, and the limiting rod 363 successively penetrates through the limiting hole 3621 of the two layers of limiting board 362. The blocking plate 361 is arranged between two layers of limiting boards 362, so that two ends of the limiting rod 363 are supported by the limiting board 362, and a problem that the limiting rod 363 is inclined because of an uneven stress at upper and lower ends is avoided when the blocking plate 361 extrudes the limiting rod 363.

Please refer to FIG. 32. In an embodiment, one side of the blocking plate 361 in contact with the limiting rod 363 is provided with a plurality of blocking steps 364, and the limiting holes 3621 are dislocated and arranged. Under a condition that a total height of the cutting deck assembly 300 remains unchanged, a number of lockings of the cutting deck assembly 300 is increased, and the height of the cutting deck assembly 300 is adjusted more accurately.

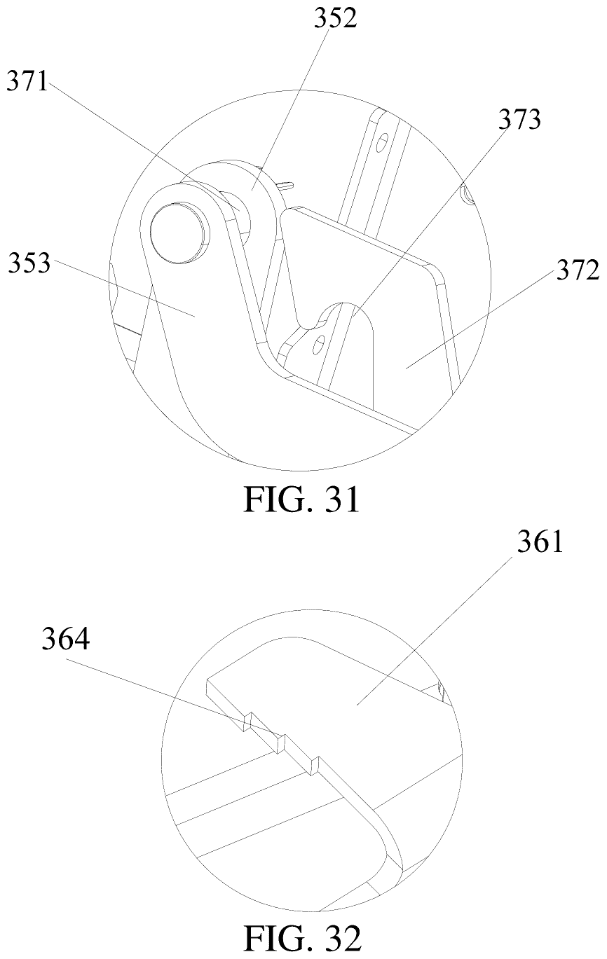

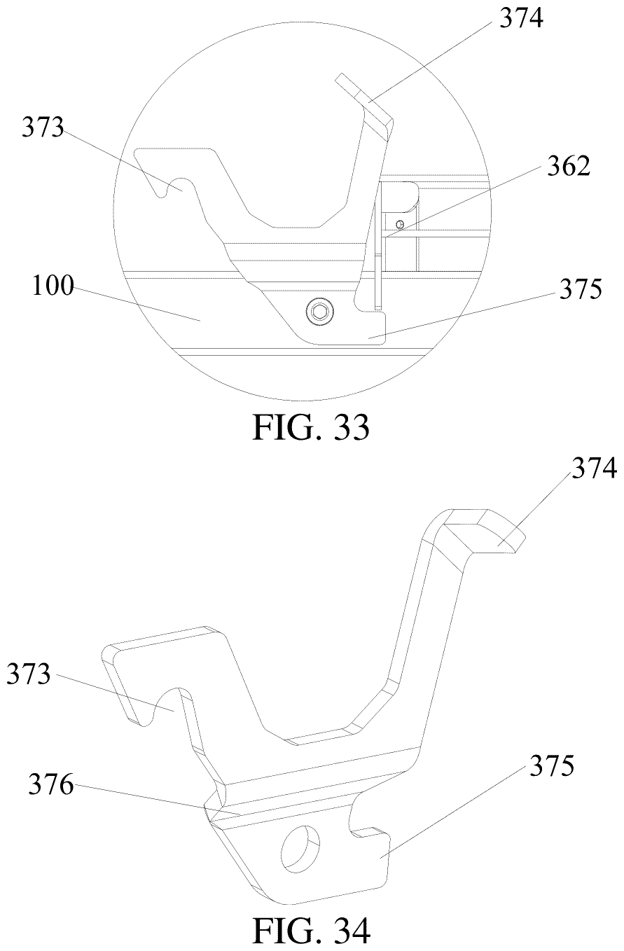

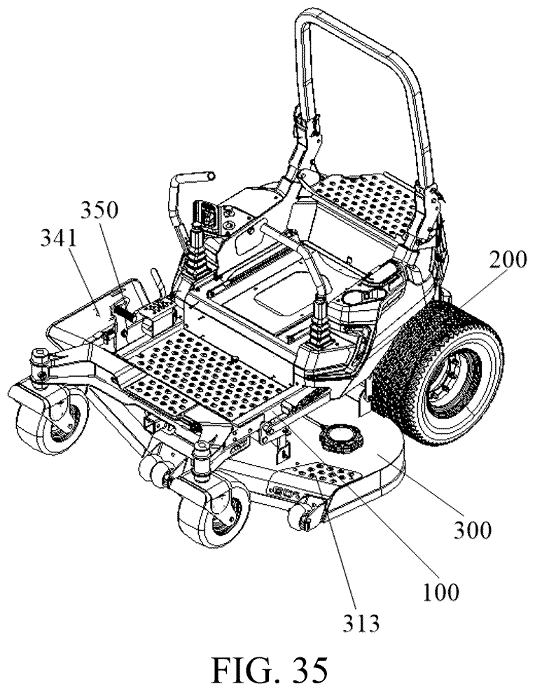

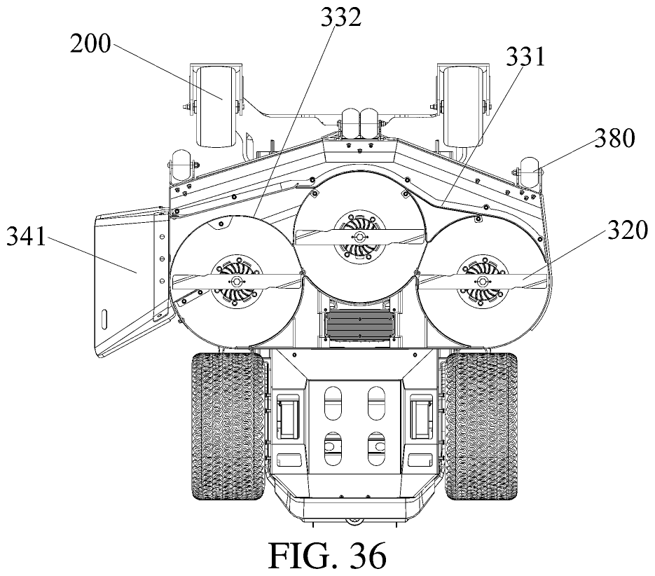

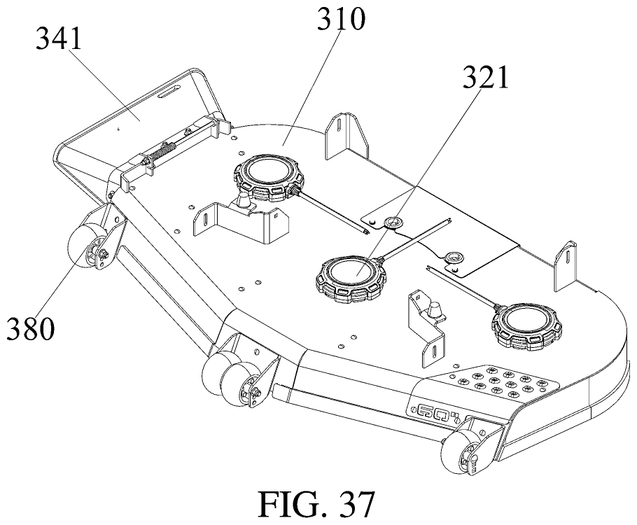

Please refer to FIG. 31. FIG. 31 is an enlarged view of an area F in FIG. 21 of the disclosure and shows a self-locking mechanism 370 in an embodiment. The cutting deck assembly 300 includes the self-locking mechanism 370. The self-locking mechanism 370 includes a self-locking rod 371 and a self-locking component 372. In an embodiment, the self-locking component 372 is rotatably connected with the frame 100. The self-locking component 372 is provided with a self-locking groove 373, and after the self-locking component 371 slides into the self-locking groove 373, the self-locking rod 371 and the self-locking groove 373 are matched with each other to limit a downward movement of the cutting deck 300. In a process of adjusting the height of the cutting deck assembly 300, the user needs to always keep a lifting state of the cutting deck assembly 300. For the user is not familiar with adjusting the height, it will be a waste of physical strength to always maintain the lifting state of the cutting deck assembly 300. Through a matching of the self-locking rod 371 and the self-locking groove 373, the cutting deck assembly 300 may be limited to a higher height, and in the process of height adjustment of the cutting deck assembly 300, and the waste of physical energy of the user in maintaining the lifting state of the cutting deck assembly 300 is reduced. When the mower moves in a non-working state, the cutting deck assembly 300 also needs to be lifted to a high position to avoid a collision damage of the cutting blade 322, and the self-locking mechanism 370 may keep the cutting deck assembly 300 in the high position.

In an embodiment, one side of the self-locking component 372 close to the self-locking rod 371 is an inclined plane, and the inclined plane is inclined toward the self-locking rod 371 from bottom to top. The self-locking groove 373 is arranged on the inclined plane, and in a natural state, the self-locking groove 373 opens downward. An arrangement of the inclined plane may ensure that the self-locking rod 371 moves forward and downward in the lifting process of the cutting deck assembly 300, and will not be limited by the self-locking component 372 to move, and the self-locking rod 371 may also enter the self-locking groove 373 more smoothly. The self-locking component 372 rotates around the frame 100 through the rotating shaft, and in a process of moving the self-locking rod 371 forward and downward, the self-locking component 372 rotates around the rotating shaft until the self-locking rod 371 slides into the self-locking groove 373. The cutting deck assembly 300 is released at this moment, and the self-locking groove 373 limits the self-locking rod 371 to move backwards, so that the cutting deck assembly 300 is kept in the high position.

In an embodiment. In the natural state, the self-locking component 372 has a tendency to rotate in a direction towards the self-locking rod 371 under an action of its own gravity, and the self-locking component 372 is prevented from rotating in the direction towards the self-locking rod 371 by arranging a limiting device on the frame 100. The limiting device may be a structure that prevents a locking plate from rotating in the direction towards the self-locking rod 371 such as a limiting rod and a limiting block. In an embodiment, the limiting board 362 extends out to an outside of the frame 100, and a bottom of the self-locking component 372 is provided with a protrusion 375 away from the self-locking rod 371. The protrusion 375 is located below the limiting board 362, a bottom of the limiting board 362 is contacted through the protrusion 375, and the self-locking component 372 is limited from rotating in the direction towards the self-locking rod 371. In an embodiment, in order to facilitate a mounting and ensure a firmness of a mounting of the self-locking component 372, the bottom of the limiting board 362 is provided with a downward extending plate, so that the protrusion 375 is not higher than the rotating shafts of the self-locking component 372 and the frame 100, and the self-locking component 372 is mounted in a middle part of the frame 100. Please refer to FIG. 17. In an embodiment, in order to avoid the self-locking rod 371 from entering the self-locking groove 373, a rotation of the self-locking component 372 is limited. The self-locking part 372 is provided with a bent part 376, the bent part 376 enables an upper part of the self-locking component 372 to be away from the frame 100, and the self-locking component 372 is not limited when it rotates away from the self-locking rod 371. In order to facilitate a release of the self-locking rod 371 from the self-locking groove 373, the self-locking part 372 is provided with a holding part 374, the holding part 374 is convenient for holding the self-locking component 372, and the self-locking component 372 may be rotated by the holding part 374 to realize the release of the self-locking rod 371. In some embodiments, the self-locking component 372 is V-shaped, and the holding part 374 and the self-locking groove 373 are arranged on both sides of the V-shape.

The self-locking rod 371 may be arranged on components such as the second connecting rod 352 and the third connecting rod 353. In an embodiment, the self-locking rod 371 is arranged at the rotating shaft of the second connecting rod 352 and the third connecting rod 353. In some embodiments, and the rotating shaft of the second connecting rod 352 and the third connecting rod 353 is used as the self-locking rod 371 to realize two uses of one component. The cutting deck 310 is subjected to a downward gravity, has a tendency to move downward, and drives the rotating shaft of the second connecting rod 352 and the third connecting rod 353 to move. The self-locking rod 371 is inserted into the self-locking groove 373, and moves to enable the self-locking component 372 to rotate. Since the self-locking component 372 and the protrusion 375 are matched with the limiting device, the rotation of the self-locking component 372 is limited, so that the self-locking rod 371 cannot produce a movement, a self-locking of the cutting deck 310 is realized, and the cutting deck 310 is limited from moving downward.

The cutting deck assembly 300 further includes a shock absorbing device 390. In an embodiment, the shock absorbing device 390 is a shock absorbing spring. A first end of the shock absorbing spring is fixed with the frame 100, and a second end of the shock absorbing spring is connected with the height adjustment device 350 on a side not connecting with the locking device 360. In some embodiments, the second end of the shock absorbing spring is hung on the rotating shaft of the third connecting rod 353 and the second connecting rod 352, and a force of the shock absorbing device 390 acting on the height adjustment device 350 is opposite to a force of the cutting deck assembly 300 acting on the height adjustment device 350. When encountering a shaking of the cutting deck assembly 300 in a bumpy area, the cutting deck assembly 300 may be buffered through the shock absorbing device 390, and a shaking amplitude of the cutting deck assembly 300 is reduced. In another embodiment, the shock absorbing device 390 may be a plurality of shock absorbing springs, or may be one or more other elastic shock absorbing parts, the shock absorbing device 390 is connected between the frame 100 and the cutting deck assembly 300, and a specific connection position is not limited.

In an embodiment, a first end of the first connecting rod 351 away from the third connecting rod 353 is rotatably connected with a fourth connecting rod 355. One end of the second connecting rod 352 away from the third connecting rod 353 is rotatably connected with a fifth connecting rod 356. The fourth connecting rod 355 and the fifth connecting rod 356 are rotatably connected with the cutting deck 310, and the first connecting rod 351 and the second connecting rod 352 are not directly rotatably connected with the cutting deck 310. A top of the cutting deck 310 is rotatably connected with the first connecting plate 357, and a second end of the first connecting plate 357 is rotatably connected with the bottom of the frame 100. Through arranging the first connecting plate 357, a connection stability of the cutting deck assembly 300 may be increased, and the shaking is reduced.

In an embodiment, a front end of the cutting deck 310 is provided with a plurality of rollers 380, and the rollers 380 are in contact with the ground. The cutting deck assembly 300 is in contact with the ground through the roller 380, and the cutting deck assembly 300 may be avoided from shaking during a movement compared with the cutting deck assembly 300 being suspended. The height of the cutting deck assembly 300 may be adjusted. In some embodiments, a position of the roller 380 on the cutting deck 310 may also be adjusted, so as to meet requirements of different cutting heights, and the roller 380 is always in contact with the ground.

Please refer to FIG. 38. In an embodiment, the cutting deck 310 is provided with the cutting blade 322, the cutting motor 321 and the cutting baffle 330. The cutting blade 322 is arranged on a driving shaft of the cutting motor 321, and the cutting motor 321 drives the cutting blade 322 to rotate to carry out a mowing and repairing. In an embodiment, a rotating front end of the cutting blade 322 is a cutting edge, and a rear side of a rotation is provided with a lawn pushing part 3223. In some embodiments, a rotating rear edge of the cutting blade 322 is bent downward to form the lawn pushing part 3223, thereby forming the front end of the cutting blade 322 to mow and the lawn pushing part 3223 at the rear side to take the lawn away after mowing, which realizes a directional discharging of the lawn after mowing, such as a side discharging, a rear discharging or collection into a grass collection box, etc. so as to avoid the mowed lawn falling directly on an original spot and avoid a problem of separate cleaning.

Please refer to FIG. 38. The cutting baffle 330 is detachably fixed at a bottom part of the cutting deck 310, the cutting baffle encloses a cutter accommodating cavity, and the cutting blade 322 is arranged in the cutter accommodating cavity. In an embodiment, the cutting baffle 330 may be detachably connected with the cutting deck 310 through bolts, including but not limited to a mounting plate with holes arranged on the cutting baffle 330, such as the cutting baffle 330 connected with a top plate of the cutting deck 310. The cutting baffle 330 is provided with the mounting plate perpendicular to a main body of the cutting baffle 330, and the mounting plate is parallel to the top plate of the cutting deck 310, which facilitates that the cutting baffle 330 is detachably connected with the cutting deck 310 through the bolts. For the cutting deck assemblies 300 of different specifications, the needed cutting baffles 330 are also different. For a larger cutting deck assembly 300, a larger blocking board 330 is required, and if the cutting baffle 330 is a whole, it is neither convenient for transportation nor maintenance and replacement. In an embodiment, the cutting baffle 330 includes a plurality of single-section cutting baffles 330, and the cutting baffles 330 of different single sections are connected with each other by bolts or directly fixed on the cutting deck 310. Compared with the whole integrated cutting baffle 330, a processing difficulty and a transportation difficulty of the single-section cutting baffle 330 are greatly reduced. An overall replacement is also not required when replacing, and it is only necessary to replace the cutting baffle 330 of the single section, so that transportation and maintenance are convenient.

In an embodiment, a bottom edge of the cutting baffle 330 at a front end in a forward direction of the cutting deck assembly 300 is higher than a bottom edge of the cutting baffle 330 at a rear end, which means that a height to the ground of the cutting baffle 330 at the front end is greater than a height to the ground of the cutting baffle 330 at the rear end. The cutting baffle 330 at the front end is located at a front side of the cutting baffle 330 at the rear end, the cutting baffle 330 at the front end is the cutting baffle 330 close to a side of the front wheel of the mower, and the cutting baffle 330 at the rear end is the cutting baffle close to a side of the rear wheel of the mower. When carrying out the mowing, the mower moves forward according to a predetermined track, the cutting baffle 330 at the front end first passes through the lawn to be mowed, then the cutting blade 332 cuts the lawn to be mowed, and the cutting baffle 330 at the rear end moves through this area. The bottom edge of the cutting baffle 330 at the front end is higher than the bottom edge of the cutting baffle 330 at the rear end, so that the lawn is convenient to enter the mowing area, and the lawn after mowing is avoided from being thrown back from a rear side of the cutting baffle 330. In some embodiments, a cutting height of the cutting blade 322 is flush with the cutting baffle 330 at the front end or slightly lower than the cutting baffle 330 at the front end, and a height after mowing is effectively guaranteed to be the same as an expected mowing height.

In an embodiment, the cutting baffle 330 includes an edge blocking board 331 and a middle blocking board 332. The edge blocking board 331 is a peripheral cutting baffle 330, and the edge blocking board 331 is connected into an accommodating cavity that is provided with the lawn discharging port 340. The accommodating cavity enclosed by the edge blocking board 331 is larger, spaces between the plurality of cutting blades 322 are not closed, and a lawn discharge passage is formed. The lawn after mowing passes through the lawn discharge passage by one side away from the lawn discharging port 340, and is finally discharged by the lawn discharging port 340. In some embodiments, the lawn discharging port 340 is arranged on a side of a forward direction of the cutting deck 310, and the discharged lawn may be avoided from splashing on a staff through a mode of side discharging, which may affect the staff. The middle blocking board 332 is detachably arranged in the accommodating cavity enclosed by the edge blocking board 331, the accommodating cavity enclosed by the edge blocking board 331 is separated into a plurality of smaller accommodating cavities 334, and the cutting blades 332 are arranged in the accommodating cavities 334.

In an embodiment, there are three cutting blades 322. The three cutting blades 322 are arranged in a triangular pattern. The middle blocking board 332 and the edge blocking board 331 are matched with each other to enclose three accommodating cavities 334, and the cutting blade 322 is arranged in the accommodating cavity. In some embodiments, the middle blocking board 332 may be disassembled according to the needs to meet the use requirements of a lawn crushing mode and a lawn discharging mode of the mower. When the mower crushes the lawn, a working area of the three cutting blades 322 is separated to each other, and the mowed lawn is continuously crushed and broken in the accommodating cavity 334 until it falls to the ground. In an embodiment, the middle blocking board 332 at a connection of the accommodating cavity 334 is provided with a notch. In some embodiments, a notch height is set at a half height of the middle blocking board 332. In the lawn discharging mode, part of the middle blocking board 332 is removed, the accommodating cavity 334 communicates with each other, and the mowed lawn moves from one side away from the lawn discharging port 340 to the lawn discharging port 340 until it is discharged by the lawn discharging port 340. In order to facilitate the discharging of the mowed lawn, in an embodiment, a lawn discharging blocking board 333 is arranged in the accommodating cavity 334 closest to the lawn discharging port 340, and the lawn discharging blocking board 333 prevents the mowed lawn from re-entering the accommodating cavity 334 closest to the lawn discharging port 340.

In an embodiment, a lawn discharging cover 341 is arranged at the lawn discharging port 340, the lawn discharging cover 341 is detachably connected with the cutting deck 310, and the lawn discharging cover 341 enables the lawn discharged by the lawn discharging port 340 moves along a set track to avoid the lawn splashing. An opening of the lawn discharging cover 341 becomes larger from an inside of the cutting deck 300 to an outside of the cutting deck 300, which is convenient for a discharging of broken lawn and avoids an accumulation of the broken lawn. In some embodiments, the lawn discharging blocking board 333 is obliquely arranged, a first end of the lawn discharging blocking board 333 is close to the lawn discharging port 340, and a second end of the lawn discharging blocking board 333 is arranged along an extending line of a side edge of the lawn discharging cover 341, which means that a length direction of the lawn discharging blocking board 333 overlaps with the side edge of the lawn discharging cover 341, so that the lawn is convenient for being discharged. The lawn discharging cover 341 is rotatably connected with the cutting deck 310, and in the natural state, the lawn discharging cover 341 is in a working position through an elastic component.

In an embodiment, the front end of the cutting deck assembly 300 is provided with the roller 380. In some embodiments, the roller 380 is arranged at three places, which are respectively arranged at two ends and a middle part of the front end of the cutting deck 310. In a process of traveling, the roller 380 is in contact with the ground, and the cutting deck assembly 300 moves forward more stably in a working process, reduces the shaking, and ensures that the mowing height is consistent.

In an embodiment, a top surface of the cutting deck 310 is provided with a pedal pad 313, and the pedal pad 313 is arranged at a side of the cutting deck 310 away from the lawn discharging cover 341. When sitting on the mower, the staff may first step on the pedal pad 313 and then sit on the mower, so as to facilitate the staff to sit on the mower. In some embodiments, the pedal pad 313 is arranged on an outside of the frame 100, which means at least part of the pedal pad 313 is not blocked by the frame 100 in a vertical direction projection, so that the staff is convenient to step on. In an embodiment, a surface of the pedal pad 313 is provided with an anti-slip device, and the anti-slip device avoids a situation that the staff slips and falls when stepping on it. The anti-slip device may be an anti-skid layer covered with such as rubber on the surface, and may also anti-skid lines provided on a surface of the pedal pad, and a specific embodiment is selected according to an actual situation, which is not limited in the disclosure.

In an embodiment, the cutting deck assembly 300 includes the cutting deck 310, a motor controller 323 and a plurality of cutting motors 321. The motor controller 323 and the cutting motor 321 are all arranged on the cutting deck 310, each cutting motor 321 is electrically connected with the motor controller 323, and a rotation of each cutting motor 321 is centrally controlled by the motor controller 130. A structure of the cutting deck assembly 300 of the disclosure may save a mounting space of the whole machine, improve heat dissipation efficiency of the motor and the motor controller, and reduce a cost of a whole vehicle.

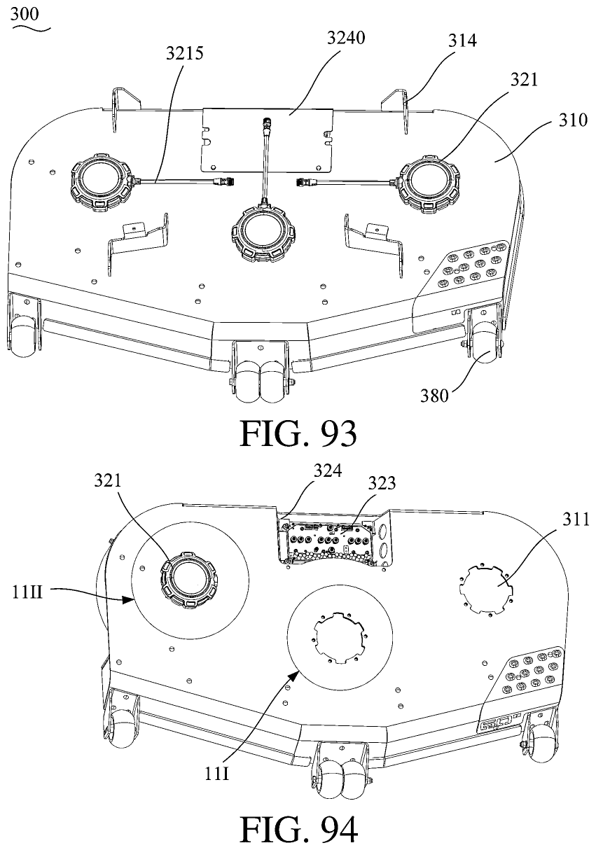

Please refer to FIG. 93 through FIG. 95. In an embodiment, the cutting deck 310 is provided with a controller accommodating cavity 324 for mounting the motor controller 323, and a structural form of the controller accommodating cavity 324 is not limited. It may be an independent structure or integrally formed with the cutting deck 310. For example, a middle part of one side of the cutting deck 310 is concave downward to form the controller accommodating cavity 324, and the motor controller 323 is fixed in the controller accommodating cavity 324 through fasteners, such as screws. The motor controller 323 is arranged in the controller accommodating cavity 324, and an upper surface of the motor controller 323 is not higher than an upper surface of the cutting deck 310, so that the cutting deck 310 may be easy to be mounted. Of course, in other embodiments, the upper surface of the motor controller 323 may also extend beyond the upper surface of the cutting deck 310, but a lower surface of the motor controller 323 is lower than the upper surface of the cutting deck (which means that the motor controller 323 is at least partially located in the cutting deck). In some embodiments, a bottom of the controller accommodating cavity 324 is an opening hole structure, and a bottom of the motor controller 323 is at least partially arranged at an opening hole, so that a heat dissipation of the controller is convenient. In addition, the bottom of the controller accommodating cavity 324 is a completely opening structure, which means that the bottom of the motor controller 323 is completely open, so that the motor controller 323 gets a better heat dissipation.

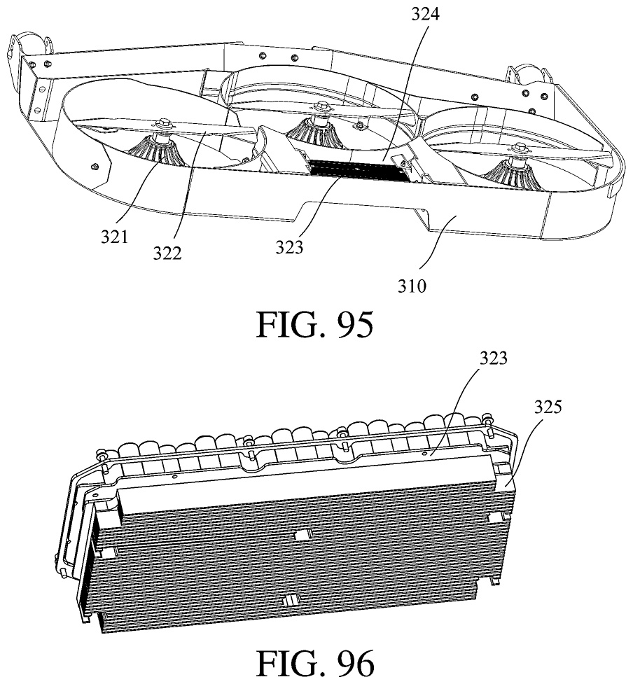

Please refer to FIG. 93, FIG. 95 and FIG. 96. In an embodiment, the bottom of the motor controller 323 is provided with a plurality of heat sinks 325. The plurality of heat sinks 325 is arranged at intervals along the lower surface of the motor controller 323, the heat sink 325 extends downward along a direction perpendicular to the lower surface of the motor controller 323, and a height of the heat sink 325 extending downwards does not exceed a lower edge of the cutting deck 310, which means that the heat sink 325 is completely accommodated in the controller accommodating cavity 324. Air at the bottom of the cutting deck 310 flows through the heat sink 325, and heat generated by the motor controller 323 is taken away, which is conducive to an effective heat dissipation of the controller.

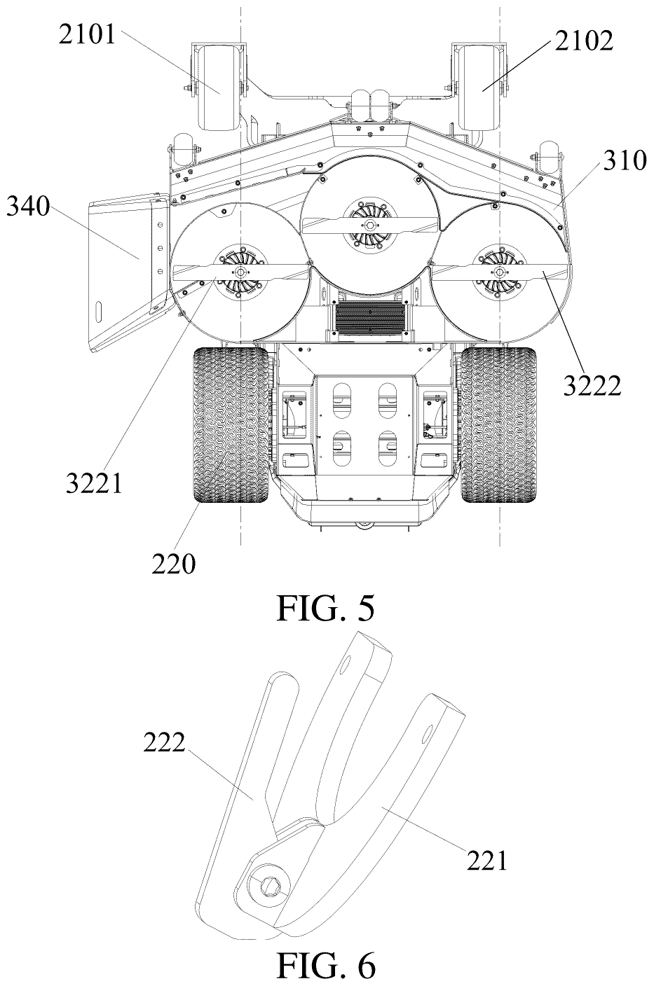

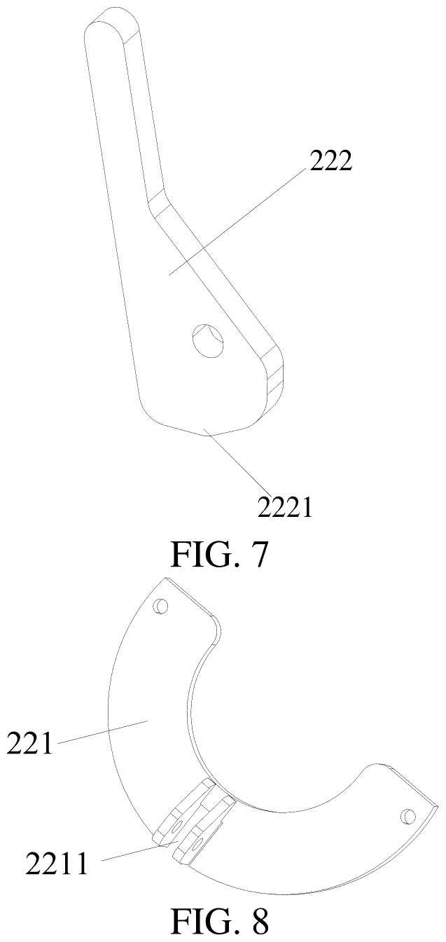

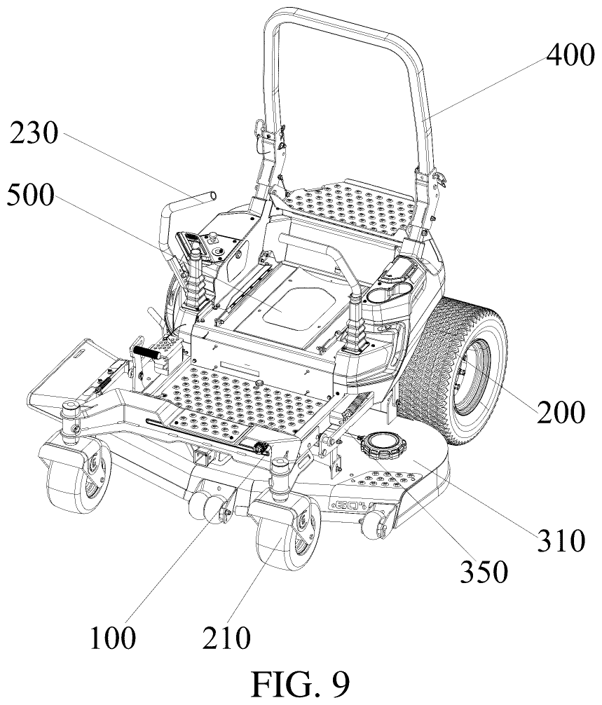

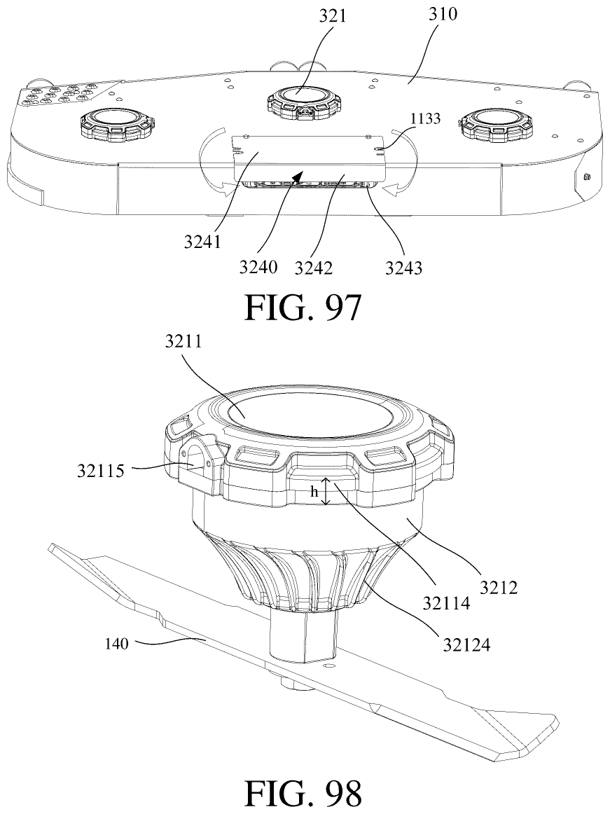

Please refer to FIG. 93, FIG. 94 and FIG. 97. In some embodiments, a controller protective cover 3240 is arranged above the motor controller 323, and an air inlet 3243 is arranged at a connection of the controller protective cover 3240 and the controller accommodating cavity 324. In this embodiment, one side wall of the controller accommodating cavity 324 is lower than the upper surface of the cutting deck 310. The controller protective cover 3240 includes a cover board 3241 and a connecting plate 3242 fixedly connected with the cover board 3241, the cover board 3241 is matched with an upper opening of the controller accommodating cavity 324, and the cover board 3241 covers above the controller accommodating cavity 324 and is fixed on the cutting deck 310 through the fasteners. The connecting plate 3242 is matched with the side wall of the controller accommodating cavity 324 lower than the upper surface of the cutting deck 310, and the connecting plate 3242 extends downward along a direction perpendicular to the cover board 3241. A gap is left between the connecting plate 3242 and the side wall of the controller accommodating cavity 324, and this gap forms the air inlet 3243. Cold air above the cutting deck 310 enters the controller accommodating cavity 324 from the air inlet 1131 (an arrow direction in FIG. 5 is a flow direction of the cold air), and flows to a bottom of the controller accommodating cavity 324 along the gap between the controller accommodating cavity 324 and the controller 120, and heat generated by the controller 120 flows out from the bottom of the controller accommodating cavity 324 with the cold air. Of course, the air inlet 3243 may also be arranged at a connection of the cover board 3241 and cutting deck 310. In other embodiments, the controller protective cover 3240 may also be a cover body structure, and a side wall of a cover body is provided with the air inlet that is matched with the controller accommodating cavity 324. There is no limitation on a shape of the controller protective cover 3240, as long as it can cover the upper opening of the controller accommodation cavity 324. The controller protective cover 3240 may be fixed on the cutting deck 310 through the fasteners, and may also be hinged with the cutting deck 310. After the motor controller 323 is mounted in the controller accommodating cavity 324, the motor controller 323 is enclosed in the controller accommodating cavity 324 through the controller protective cover 3240, and the motor controller 323 is protected from an external damage.

Please refer to FIG. 93 and FIG. 94. In an embodiment, the cutting deck 310 is provided with a motor mounting hole 311 longitudinally penetrating the cutting deck 310, and the cutting motor 321 passing through the motor mounting hole 311 is fixed on the cutting deck 310 through a flange part at an end part of the cutting motor. The cutting deck assembly 300 may include one or more cutting motors 321, and a mounting mode of each cutting motor 321 is the same. For example, the cutting deck assembly 300 includes three cutting motors 321, and three motor mounting holes 311 are correspondingly arranged on the cutting deck 310. In some embodiments, the three motor mounting holes 311 are triangularly distributed on the cutting deck 310, which means that one motor mounting hole 311 is arranged in the middle part of one side of the cutting deck 310 that deviates from the controller accommodating cavity 324, and the other two motor mounting holes 311 are respectively arranged on the two sides of the controller accommodating cavity 324. This mounting mode enables a force of the cutting deck 310 to be more uniform.

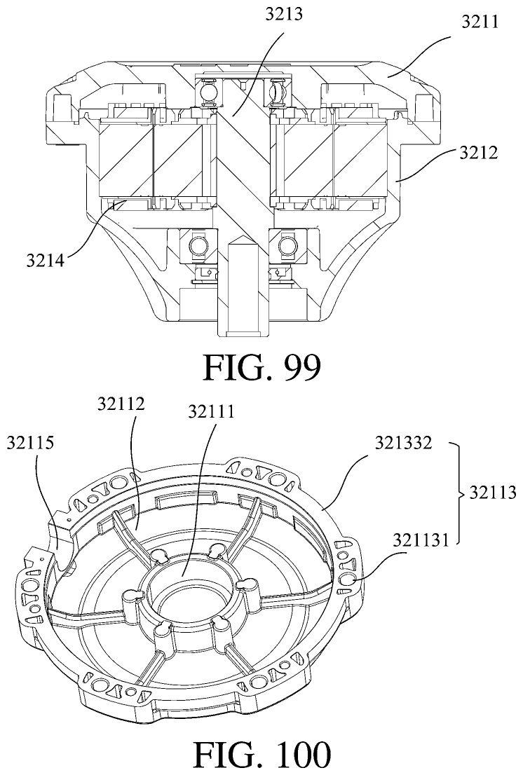

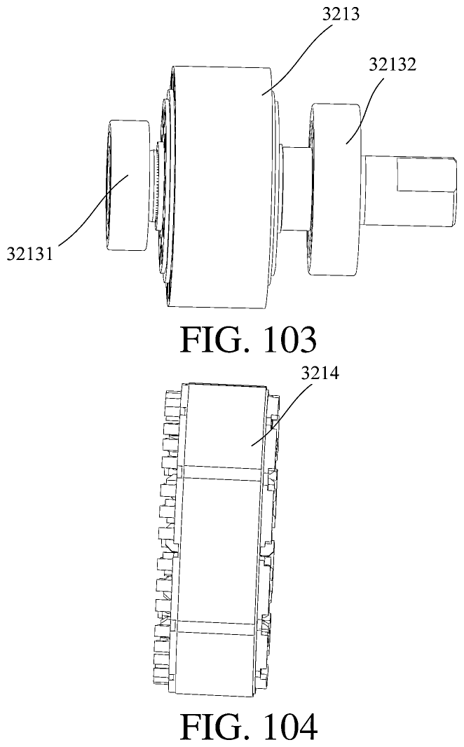

Please refer to FIG. 98 through FIG. 104. In an embodiment, the cutting motor 321 includes a motor end cover 131, a motor housing 3212, a motor rotor 3213 and a motor stator 3214. The motor end cover 131 is buckled with the motor housing 3212 to form a motor cavity, and the motor rotor 3213 and the motor stator 3214 are mounted in the motor cavity. Two ends of the motor rotor 3213 are respectively provided with a first bearing 32131 and a second bearing 32132, and the motor rotor 3213 is rotatably mounted on the motor end cover 131 and the motor housing 3212 through the first bearing 32131 and the second bearing 32132 respectively. In some embodiments, a middle part of motor end cover 131 is provided with a first bearing mounting base 32111, and a shape and size of the first bearing mounting base 32111 are matched with the first bearing 32131. A middle of a bottom of the motor housing 3212 is provided with a second bearing mounting base 32121, and a shape and size of the second bearing mounting base 32121 are matched with the second bearing 32132. The motor stator 3214 is sleeved and mounted in a periphery of the motor rotor 3213, and when the motor stator 3214 receives current, the motor rotor 3213 will rotate along a magnetic field direction of the motor stator 3214 according to a principle of electromagnetism. In some embodiments, a position of an inner wall of the motor housing 3212 corresponding to the motor stator 3214 radially protrudes inward to form a stator supporting step 32141, and the motor stator 3214 is fixed in the motor cavity through the stator supporting step 32141.

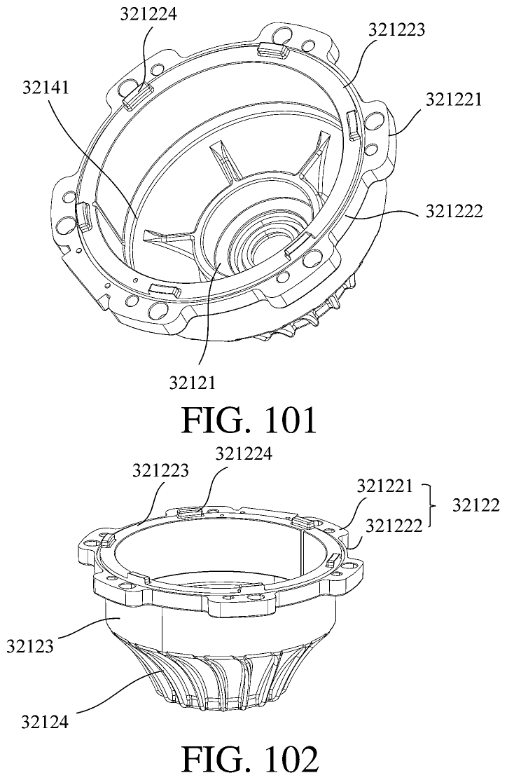

Please refer to FIG. 94, FIG. 101 and FIG. 102. In an embodiment, the motor housing 3212 includes a connecting flange 32122, a first housing 32123 and a second housing 1324 that are communicated sequentially. The first housing 32123 is a cylindrical empty cavity structure. A first end of the first housing 32123 is connected with the connecting flange 32122, and a second end of the first housing 32123 is connected with the second housing 1324. An outer diameter of the connecting flange 32122 is greater than a diameter of the motor mounting hole 311, and an outer diameter of the first housing 32123 is less than or equal to the diameter of the motor mounting hole 311. The connecting flange 32122 extends outward along a radial direction of the first housing 32123 and protrudes beyond the first housing 32123. The second housing 1324 is a conical empty cavity structure. The first housing 32123 is used for mounting the motor rotor 3213 and the motor stator 3214, and the second housing 1324 is used for mounting the second bearing 32132 of the motor rotor 3213. A connection of the first housing 32123 and the second housing 1324 is provided with the stator supporting step 32141, and the second housing 1324 is provided with the second bearing mounting base 32121 matched with the second bearing 32132. In some embodiments, a surface of the second housing 1324 is provided with a plurality of reinforcing ribs 321241, which may thin the motor housing while ensuring a strength of a motor assembly, thereby greatly reducing a weight of the motor, and an arrangement of the reinforcing ribs 321241 may further increase a heat dissipation area and improve heat dissipation efficiency.

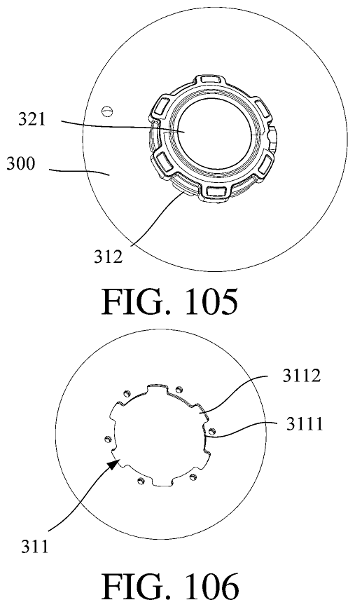

Please refer to FIG. 94, FIG. 101, FIG. 102, FIG. 105 and FIG. 106. The connecting flange 32122 of the motor housing 3212 includes a plurality of first connecting parts 321221 and a plurality of second connecting parts 321222. In an embodiment, the first connecting part 321221 is used for connecting with the motor end cover 131 and the cutting deck 310, and the second connecting part 321222 is used for connecting the first connecting part 321221. The plurality of first connecting parts 321221 and the plurality of second connecting parts 321222 are arranged at intervals and enclose in a circle along a circumferential direction of the first housing 32123 to form the connecting flange 32122. The first connecting part 321221 protrudes outwards from the second connecting part 321222 along a radial direction of the first housing 32123. When the cutting motor 321 is mounted in the motor mounting hole 311 of the cutting deck 310, it is fixed on the cutting deck 310 through the first connecting part 321221. At this moment, a position of the motor mounting hole 311 corresponding to the second connecting part 321222 is left with a ventilation hole 312, so that an air circulation of upper and lower surfaces of the cutting deck 310 is convenient. In some embodiments, the motor mounting hole 311 includes a first hole 3111 and a second hole 3112, a diameter of the first hole 3111 matches the outer diameter of the first housing 32123, and a diameter of the second hole 3112 is greater than the diameter of the first hole 3111. The first hole 3111 corresponds to the first connecting part 321221 of the connecting flange 32122, and the second hole 3112 corresponds to the second connecting part 321222 of the connecting flange 32122. The motor housing 3212 fixes the first connecting part 321221 to the cutting deck 310 outside the first hole 3111 through the fasteners such as bolts. Since the diameter of the second connecting part 321222 is smaller than the diameter of the first connecting part, the diameter of the second hole 3112 is larger than the diameter of first hole 3111. Therefore, after the motor is mounted, a larger ventilation hole 312 (a gap between the second connection part 321222 and the second hole 3112) is left at a position of the second connection part 321222 corresponding to the cutting deck 310. A hole shape of the ventilation hole 312 corresponds to a hole shape of the second hole 3112, and is an arc-shaped long hole, which may realize the air circulation on the upper and lower surfaces of the cutting deck 310.

Please refer to FIG. 98, FIG. 100, FIG. 101, FIG. 102 and FIG. 105. The motor end cover 131 is matched with the motor housing 3212. In an embodiment, the motor end cover 131 includes an end cover body 32112 and an end cover flange 32113 located at a periphery of the end cover body 32112. In order to facilitate a matching of the motor end cover 131 and the motor housing 3212, a circumferential protrusion 321223 is arranged on one side of the connecting flange 32122 towards the motor end cover 131, and an outer diameter of the circumferential protrusion 321223 matches an inner diameter of the end cover body 32112. In some embodiments, a plurality of arc-shaped protrusions 321224 is further arranged at intervals above the circumferential protrusion 321223, and the arc-shaped protrusion 321224 is used for guiding the end cap body 32112 to be nested on an outer side of the circumferential protrusion 321223. A shape of the end cover flange 32113 matches the connecting flange 32122, which means that the end cover flange 32113 includes a first flange part 321131 and a second flange part 321132. The first flange part 321131 is matched with the first connecting part 321221, and the second flange part 321132 is matched with the second connecting part 321222. The second flange part 321132 is concave downward with respect to the first flange part 321131, so as to reduce a weight of the motor end cover 131. When the motor end cover 131 is connected with the motor housing 3212, the first flange part 321131 and the first connecting part 321221 are fixed on the cutting deck 310 through the fasteners such as bolts, and the second flange part 321132 is fitted with the second connecting part 321222 to form a step 32114. A height h of the step 32114 may be from 10 mm to 12 mm, for example, it may be 10 mm, 11 mm, 11.5 mm, 12 mm and so on. The motor housing 3212 and the motor end cover 131 adopt a stepped design, which may reduce an overall weight of the motor assembly and is convenient for disassembly, maintenance and mounting. In addition, after the cutting motor 321 and the cutting deck 310 are mounted, an arc-shaped strip hole left at a position of the cutting deck 310 corresponding to the step 32114 is convenient for the air circulation when the cutting deck 310 is in a lowest position.

Please refer to FIG. 93, FIG. 94, FIG. 98 and FIG. 100. The cutting motor 321 is electrically connected with the motor controller 323 by a connecting wiring 3215, which means that a wiring outlet 32115 is left on one side of the motor end cover 131. A first end of the connecting wiring 3215 is electrically connected with the cutting motor 321 through the wiring outlet 32115, and a second end of the connecting wiring 3215 is electrically connected with the motor controller 323. An energy storage device supplies power to the motor controller 323, and the motor controller 323 distributes and controls a current according to a signal of a rotating speed and a direction of the rotating speed required by the cutting motor 321. In some embodiments, the connecting wiring 3215 adopts a protective connector, and after a wiring connection is completed, the controller protective cover 3240 is mounted above the motor controller 323, so that a protection level reaches IP65, and a water ingress is avoided at a terminal connection, which may result in the motor being unable to operate.

The cutting deck assembly of the disclosure integrates the mowing motor and the motor controller on the cutting deck of the mower, which utilizes one motor controller to control an operation of the plurality of mowing motors simultaneously, saves a layout space of the whole mower, reduces a cost of the whole mower and its own weight, facilitates the heat dissipation of the motor controller, and enable it to be able to maintain a long-term efficient operation. In addition, a stator coil of the motor is mounted in a sinking way, so that a main component of the motor is located below the cutting deck. On one hand, a volume of the motor is reduced, a center of gravity of the motor is reduced, and the motor runs more smoothly. On the other hand, the heating components of the motor are concentrated below the cutting deck, the heat generated during a running of the motor is concentrated below the cutting deck, and the cutting blade may be used as a heat dissipation fan to accelerate the heat dissipation.

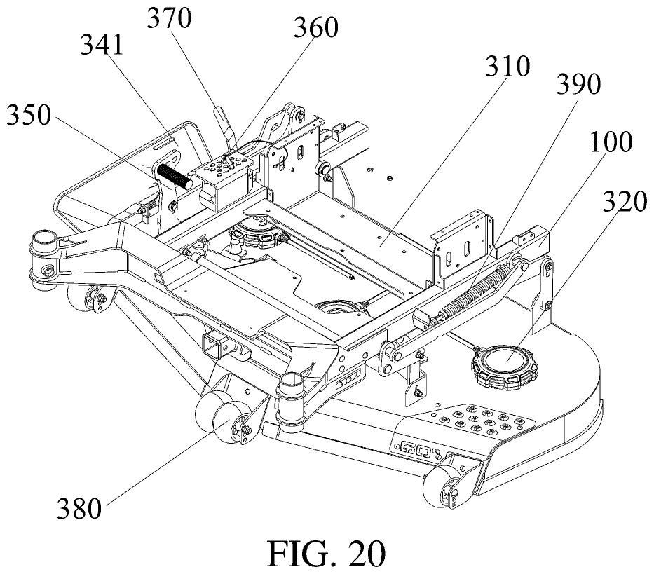

Please refer to FIG. 5. In an embodiment, along a longitudinal projection of the mower 1, a rotation axis of the cutting blade 322, that a projection of the front wheel falls into a projection of a rotation area of the cutting blade 322, is located on a side of the front wheel away from the lawn discharging port 311. This means that in a longitudinal direction of the mower 1, a rotation area of the cutting blade 322 is divided into two by the rotating shaft of the cutting blade 322, and the front wheel is located in the rotation area of the cutting blade 322 close to the lawn discharging port 340. In an embodiment, the front wheel includes a first front wheel 2101 and a second front wheel 2102. The cutting blade 322 includes a first cutting blade 3221 and a second cutting blade 3222. When in a forward or backward state, along a longitudinal projection of the mower 1, a projection of the first front wheel 2101 overlaps at least partially with the rotation area of the first cutting blade 3221, and a projection of the second front wheel 2102 overlaps at least partially with the rotation area of the second cutting blade 3222. With a longitudinal line that passes through an axis of the rotation shaft of the first cutting blade 3221 as a boundary, a cutting and rotation area of the first cutting blade 3221 is divided into two areas close to the lawn discharging port 340 and away from the lawn discharging port 340. The projection of the first front wheel 2101 will fall into the area close to the lawn discharging port 340, which means that the axis of the rotation shaft of the first cutting blade 3221 is located on a side of the first front wheel 2101 away from the lawn discharging port 340. With a longitudinal line that passes through an axis of the rotating shaft of the second cutting blade 3222 as a boundary, a cutting and rotation area of the second cutting blade 3222 is divided into two areas close to the lawn discharging port 340 and away from the lawn discharging port 340. The projection of the second front wheel 2102 will fall into the area close to the lawn discharging port 340, which means that an axis of the rotating shaft of the second cutting blade 3222 is located on a side of the second front wheel 2102 away from the lawn discharging port 340. In other words, a plane parallel to a forward direction of the mower 1 and passing through the axis of the rotation shaft of the first cutting blade 3221 is defined as a first plane, and the projection of the first front wheel 2101 is located on a side of the first plane close to the lawn discharging port 340. In an embodiment, the projection of the first front wheel 2101 is completely located on one side of the first plane close to the lawn discharging port 340. A plane parallel to a forward direction of the mower 1 and passing through the axis of the rotation shaft of the second cutting blade 3222 is defined as a second plane, the projection of the second front wheel 2102 is located on one side of the second plane close to the lawn discharging port 340. In this embodiment, the projection of the second front wheel 2102 is completely located on the side of the second plane close to the lawn discharging port 340. For example, please refer to FIG. 20. From a bottom of the mower 1, a left side of the cutting deck 310 is provided with the lawn discharging port 340, and the projection of the first front wheel 2101 falls into the area close to the lawn discharging port 340 (a left side of the axis of the rotation shaft of the first cutting blade 3221), which means that the first front wheel 2101 is located at a left side of the first plane. The projection of the second front wheel 2102 falls in the area close to the lawn discharging port 340 (a left side of the axis of the rotation shaft of the second cutting blade 3222), which means that the second front wheel 2102 is located on a left side of the second plane. When mowing, the lawn crushed by the front wheels was sucked up, and then cut off and discharged by the cutting blade 322. The front wheel on this side may enable the lawn to be cut off directly on one side close to the lawn discharging port 340, and the lawn may be directly discharged after cutting. In addition, a direction of air flow enables the air flow close to the lawn discharging port 340 to be relatively larger, and the lawn that is crushed by the front wheel is easier to be sucked up, which is convenient for cutting. An arrangement of the front wheels and the cutting blade 322 improves a lawn discharging effect. In an embodiment, the cutting blade 322 includes and may also include a third cutting blade, and the third cutting blade may be arranged between the first cutting blade 3221 and the second cutting blade 3222. In another embodiment, the mower 1 may also be provided with a third front wheel, a fourth cutting blade, etc., and the disclosure does not limit this.

In an embodiment, the cutting deck is arranged at the bottom of the frame, the cutting deck 310 is arranged between the front wheel and the rear wheel. When the front wheel keeps moving forward and does not turn, a minimum distance between the cutting deck 310 and the front wheel is from 10 mm to 60 mm. When the rear wheel keeps moving forward and does not turn, the minimum distance between the cutting deck 310 and the rear wheel is from 10 mm to 60 mm. The cutting deck 310 keeps a certain distance from the front wheel and/or the rear wheel. On one hand, it is convenient that the front wheel or the rear wheel does not collide with the cutting deck 310 when steering, on the other hand, when the height of the cutting deck 310 is adjusted, the cutting deck 310 is avoided from interfering with the front wheel or the rear wheel, and a safe use is guaranteed.

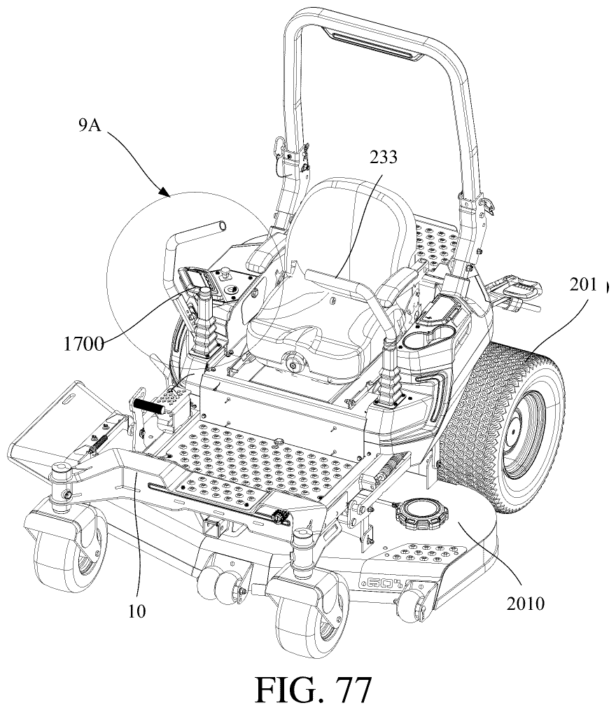

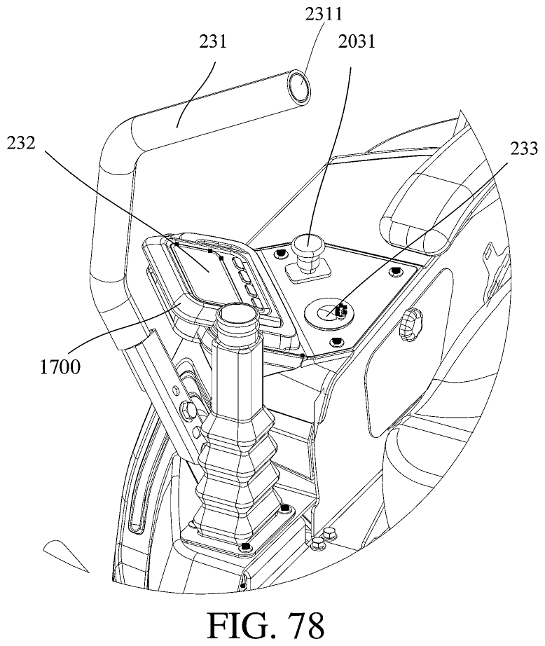

Please refer to FIG. 77 through FIG. 78. An operating device 230 includes two operating handles 231, and the two operating handles 231 respectively control a rotating speed of the driving motor at a same side, in order to control a speed of the front wheel and/or the rear wheel. The two operating handles 231 are respectively provided with a cutting blade speed regulation key and a walking speed regulation key 2311. In some embodiments, the cutting blade speed regulation key and the walking speed regulation key 2311 are respectively mounted at end parts of the two operating handles to facilitate the user to adjust. In an embodiment, the end parts of the two operating handles 231 are hollow structures, the cutting blade speed regulation key and the walking speed regulation key 2311 are provided with buckles, and the cutting blade speed regulation key, the walking speed regulation key 2311 are respectively clamped in the end parts of the two operating handles 231 through the buckles. If the cutting blade speed regulation key or the walking speed regulation key 2311 is damaged, it may be directly disassembled for maintenance and replacement. In another embodiment, the cutting blade speed regulation key, the walking speed regulation key 2311 are mounted on an operating handle 231 by means of an interference matching or gluing. In an embodiment, the walking speed regulation key 2311 regulates a maximum walking speed. For example, the walking regulation key 2311 includes a first gear, a second gear, and a third gear, corresponding to different maximum walking speeds respectively, and a current speed is determined by the maximum walking speed and a rotation angle of the operating handle 231 together. In an embodiment, the walking speed regulation key 2311 is a self-reset button for a convenience of the user. In another embodiment, the walking speed regulation key 2311 may be a shift switch, a knob switch, etc. In an embodiment, the cutting blade speed regulation key 2311 may be a self-reset button, a shift switch, a knob switch, etc. In an embodiment, the cutting blade speed regulation key and the walking speed regulation key 2311 draw power from the battery 800 of the mower, and the battery 800 may be connected with the cutting blade speed regulation key and the walking speed regulation key 2311 respectively through a connecting wire, a connecting terminal, etc. The connecting wire and the connecting terminal, etc. are arranged inside the operating handle 231. Of course, in another embodiment, the cutting blade speed regulation key and the walking speed regulation key 2311 may be separate modules, which means that the cutting blade speed regulation key and the walking speed regulation key 2311 are provided with a power supply device themselves, and do not need to draw power from the battery 800.

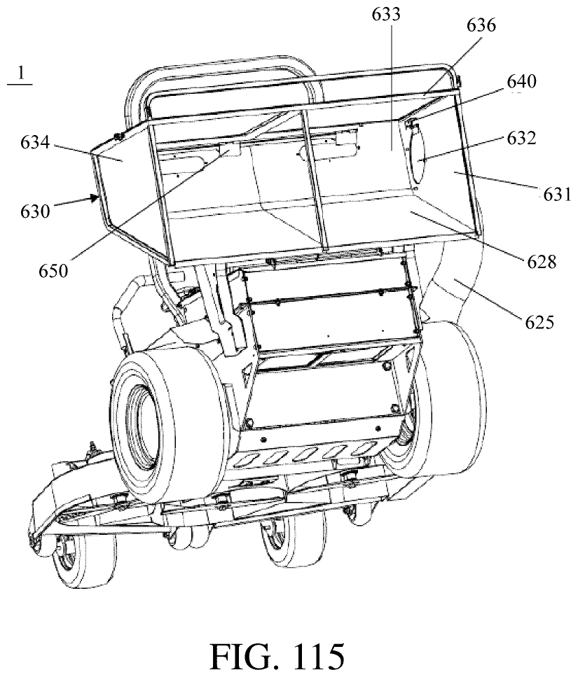

Please refer to FIG. 114 through FIG. 125. In an embodiment of the mower, the mower 1 includes a grass collection system. The grass collection system includes a grass conveying device, a grass collection device, a clogging detection device 640, an overfill detection device 650 and a lawn unloading device 660.

Although the mower shown in the drawings accompanying this disclosure is the riding mower 1, it may also be a mower of any other type or structural design. Further, in addition to individual components/devices/systems specifically described in this specification, any suitable design scheme may be adopted for other components of the mower 1 in the disclosure, which is not specifically described herein.

In this embodiment, the grass conveying device includes a fan machine 620, a fan machine controller 6210 and a lawn conveying tube 625. The fan machine controller 6210 is fixedly mounted on the fan machine 620, and the fan machine 620 is communicated with the cutting deck 310 and the lawn conveying tube 625 respectively, so that the fan machine 620 can suck the crushed lawn cut by the cutting deck 310 into the lawn conveying tube 625 when working, and continues to blow the lawn into the grass collection device.

The grass collection device of the disclosure adopts a grass collection box 630. The grass collection box 630 includes a first side wall 631 and a second side wall 634 arranged oppositely, a front wall 633 located between the first side wall 631 and the second side wall 634, a box door 636 located between the first side wall 631 and the second side wall 634 and arranged opposite to the front wall, and a top wall 637 and a bottom wall 628 respectively arranged between the front wall 633, the box door 636, the first side wall 631 and the second side wall 634, which may refer to FIG. 114 through FIG. 115 and FIG. 121 simultaneously.

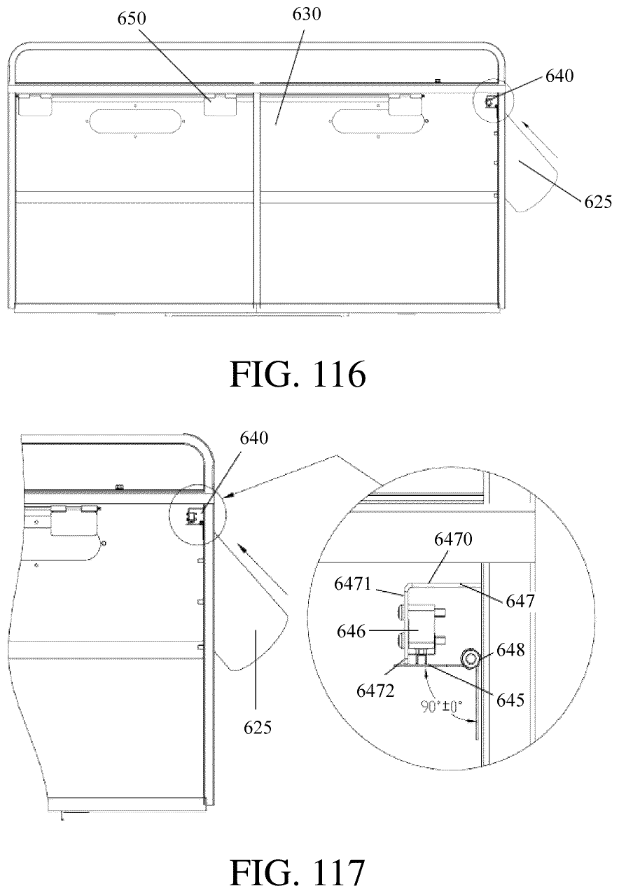

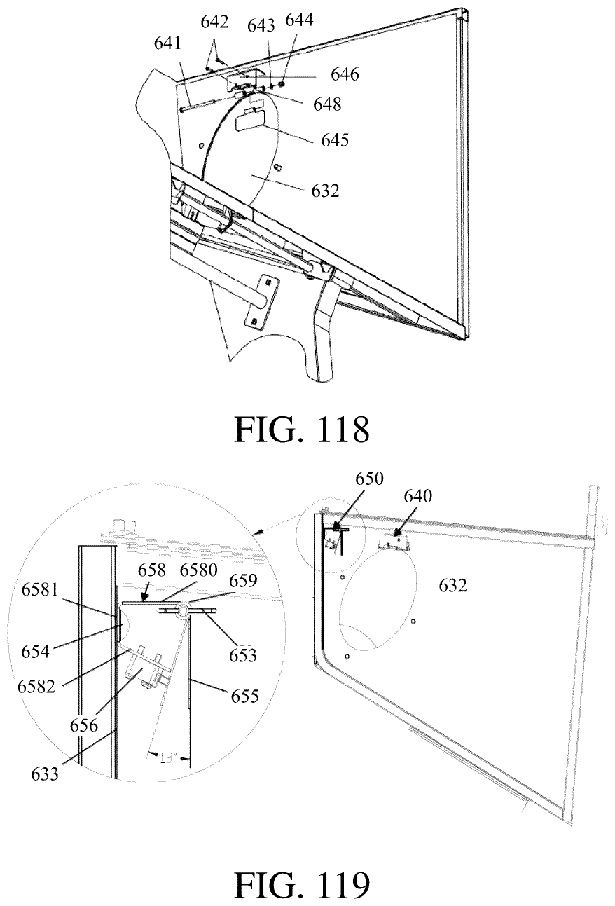

Please refer to FIG. 116 and FIG. 118. In this embodiment, the grass collection device is provided with the lawn inlet 632 that is communicated with the grass conveying device, and the clogging detection device 640 is arranged on the grass collection device close to the lawn inlet 32. In an embodiment, the clogging detection device 640 is arranged on a side wall of the grass collection box 630, and the first side wall 631 of the grass collection box 630 is provided with the lawn inlet 632. The clogging detection device 640 is mounted on the first side wall 631 close to the lawn inlet 632, and the overfill detection device 650 is arranged on the front wall 633 of the grass collection box 630 close to the top wall 637. Of course, the clogging detection device 640 is not limited to being mounted on the first side wall 631, the clogging detection device 640 may also be mounted in the lawn conveying tube 625 of the grass conveying device, and the blockage detection device 640 may be arranged at one end of the lawn conveying tube 625 close to the grass collection device.

Please further refer to FIG. 117 through FIG. 118. The clogging detection device 640 includes a first sensor 646 and a first movable component 645. When the lawn conveying tube 625 of the grass conveying device is in normal operation, the first movable component 645 is in a first state. When the lawn conveying tube 625 of the grass conveying device is clogged, the first movable component 645 is in a second state. The first movable component 645 is caused to switch between the first state and the second state by an action of air flow in the lawn conveying tube 625. When the first movable component 645 is in the first state under the action of air flow, the clogging detection device 640 does not send out a clogging signal. When the lawn conveying tube 625 is clogged, the air flow in the lawn conveying tube 625 decreases or even disappears, the first movable component 645 will be in the second state, and the clogging detection device 640 sends out the clogging detection signal just time.

In this embodiment, when the first movable component 645 is transformed from the first state to the second state, and when the first movable component 645 is maintained in the second state for more than a preset time, the clogging detection device 640 generates the clogging signal. In some embodiments, the preset time is 3 seconds to 5 seconds, and the preset time may be selected as 3 seconds. Since there may be an accumulated lawn in the lawn conveying tube 625, the air flow in the lawn conveying tube 625 may be caused to change, thereby affecting a state of the first movable component 645. However, after a certain time, the accumulated lawn finally enters the grass collection box 630, and the air flow in the lawn conveying tube 625 may return to normal. In this case, the grass conveying device is not clogged. Therefore, the embodiment is set with a preset time to avoid the clogging detection device from producing an error signal.

The clogging detection device 640 further includes a fixing plate 647. The first sensor 646 is arranged on the fixing plate 647, the first movable component 645 is rotatably connected with the grass collection device, and the first movable component 645 rotates relative to the grass collection device to switch between the first state and the second state. In an embodiment, the fixing plate 647 includes a first arm 6470 and a second arm 6471 that extend integrally. A first end of the first arm 6470 is fixed on the first side wall 631 of the grass collection box 630, a second end of the first arm 6470 extends vertically from the first arm 6470 to form the second arm 6471, and the second arm 6471 is fixedly provided with the first sensor 646. A free end of the second arm 6471 includes a limiting part 6472 and is used for limiting the rotation of the first movable component 645 to prevent the first sensor 646 from being damaged by the first movable component 645. The limiting part 6472 may be two protruding pieces extending outward from the free end of the second arm 6471, or other suitable designs. The first arm 471 of the fixing plate 647 may be welded to the first side wall 631 of the grass collection box 630 or fixed to the first side wall 631 by any other suitable connecting method. The fixing plate 647 of this embodiment is “L” shaped, and of course, in other embodiments, the fixing plate 647 may further be other shapes and structures.

The first movable component 645 is fixed at a top end of the lawn inlet 632 of the grass collection box 630 through a screw rod 641 passing through two mounting posts 648 and matched with a washer 643 and a nut 644, and the first movable component 645 may rotate freely around the screw rod 641 like a hinge. In an embodiment, the mounting columns 648 are both hollow for the screw rod 641 to pass through, and a distance between the two mounting columns 648 is just enough to house a mounting part corresponding to the first movable component 645 in between. The two mounting posts 648 may be welded to the first side wall 631 of the grass collection box 630 or connected to the first side wall 631 by any other suitable method.

When the grass conveying device (such as the lawn conveying tube 625) works normally, the grass conveying device is not clogged, the air flow in the lawn conveying tube 625 blows the first movable component 645 to rotate. The first movable component 645 rotates to the second state under an action of the air flow in the lawn conveying tube 625, and maintains in the second state. The first movable component 645 is flush with a top tangent direction of the lawn inlet 632 of the grass collection box 630 at this moment. When the first sensor 646 detects that the first movable component 645 is in the second state, the first sensor 646 does not send out the clogging signal. When the grass conveying device (e.g., the lawn conveying tube 625) is clogged, the air flow in the lawn conveying tube 625 decreases, or even disappears completely. At this time, the air flow is insufficient to blow the first movable component 645 to reach and maintain the second state, and this case is defined as the first movable component 645 is in the first state (other states other than the second state are defined as the first state in the disclosure). When the first sensor 646 detects that the first movable component 645 is in the first state, the first sensor 646 sends out the clogging signal.

In some embodiments of the disclosure, the first sensor 646 is a switch. The first sensor 646 detects the state of the first movable component 645 through a form of the first movable component 645 triggering the switch. When the first movable component 645 triggers the switch, the first sensor 646 detects that the first movable component 645 is in the first state, and when the first movable component 645 is disconnected from the switch, the first sensor 646 detects that the first movable component 645 is in the second state. Of course, in other embodiments, the first sensor 646 may also be another type of sensor, such as a displacement sensor, and the displacement sensor detects a displacement magnitude of the first movable component 645, thereby detecting the state of the first movable component 645. The first movable component 645 may realize a state switching through a mode of rotation, and may also realize the state switching by means such as translation. In order to clearly illustrate a scheme of the disclosure, the embodiment takes the first sensor 646 as a switch as an example to elaborate.

When the grass conveying device is working normally, the first movable component 645 is closed with the first switch (first sensor) 646 under an action of the air flow from the lawn conveying tube 625, and this air flow enters the grass collection box 630 through the lawn inlet 632. When the grass conveying device (e.g., in the lawn conveying tube 625) is clogged, the air flow entering the grass collection box 630 may decrease until it disappears completely, and this may enable the first movable component 645 and the first switch 646 to be disconnected. At this moment, the clogging detection device 640 sends out a fault signal. Further, in this embodiment, when a time of disconnection between the first movable component 645 and the first switch 646 exceeds a certain time interval (for example, 3s), the clogging detection device 640 sends out the fault signal.

The clogging detection device 640 further includes the fixing plate 647, and the fixing plate 647 includes the first arm 6470 and the second arm 6471 that extend integrally. The first end of the first arm 6470 is fixed on the first side wall 631 of the grass collection box 630, the second end of the first arm 6470 extends vertically from the first arm 6470 to form the second arm 6471, and the second arm 6471 is fixedly provided with the switch 646. The free end of the second arm 6471 includes the limiting part 6472 and is used for limiting the rotation of the first movable component 645 to prevent the switch 646 from being damaged by a first movable component 645. The limiting part 6472 may be two protruding pieces extending outward from the free end of the second arm 6471, or other suitable designs. The first arm 471 of the fixing plate 647 may be welded to the first side wall 631 of the grass collection box 630 or fixed to the first side wall 631 by any other suitable connecting method. The fixing plate 647 of this embodiment is “L” shaped, and of course, in other embodiments, the fixing plate 647 may further be other shapes and structures.

In addition, the clogging detection device 640 of the disclosure is configured to detect an air flow parameter in the grass conveying device. When the air flow parameter is less than the preset value, the clogging detection device 640 generates the clogging signal. In an embodiment, the clogging detection device 640 detects an air speed at an outlet of the grass conveying device (such as the lawn conveying tube 625), and a preset value of the air speed may be 156 M/s. The preset value of the air speed may also be other appropriate values according to an actual situation. When the air speed is less than the preset value for more than the preset time (for example, 3 seconds), the clogging detection device 640 sends the clogging signal.

In an embodiment of the disclosure, when the air speed of the air flow entering the grass collection box 630 from the lawn inlet 632 reaches the preset value, and the first movable component 645 of the clogging detection device 640 will be pushed by air to touch the first switch 646 and enable it to close, which means that the first switch 646 is triggered thereby. The preset value of the air speed may be set to 156 M/s, which means that the first switch 646 is triggered when the air speed is greater than this preset air speed.

When the air speed at the lawn inlet 632 is 15 m/s, an air volume is 15*15/1600 KN/m², a pressure is multiplied by this value, and an area may be calculated as 1.5e2 mm2 or 2.5e2 mm2.

An air pressure is a pressure of the air on a plane perpendicular to a direction of the air flow. According to an air-pressure relationship derived from Bernoulli's equation, a dynamic pressure of the air is:

$$wp = 0.5 \cdot ro \cdot {v}^{2} \qquad ( 1 )$$

In an embodiment, wp is the air pressure [kN/m²], ro is an air density [kg/m³], and v is the air speed [m/s].

Since a relationship between air density (ro) and a gravity (r) is r=ro·g, there is ro=r/g.

Use this relation in (1) to get:

$$wp = 0.5 \cdot r \cdot {v}^{2} / g \qquad ( 2 )$$

This is a standard air pressure formula.

For example, in a standard state (a pressure is 1013 hPa, and a temperature is 15° C.), an air gravity r=0.01225 [kN/m³], and a gravitational acceleration at latitude 45° g=9.8[m/s²], we get: wp=v²/1600 (3).

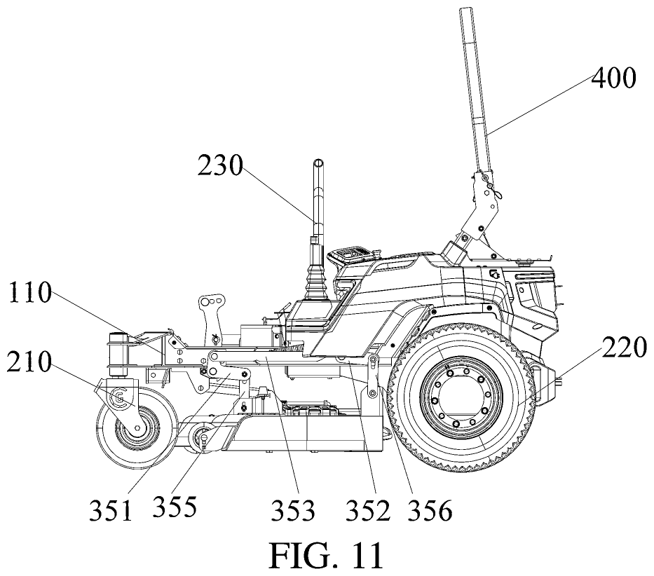

In an embodiment of the disclosure, when there is no air flow at the lawn inlet 632, the first movable component 645 is vertically downward under the effect of gravity. The first movable component 645 does not touch the switch 646, and the first switch 646 is in a disconnected state at this moment. When the lawn inlet 632 has a certain air flow, the first movable component 645 rotates freely around the screw rod 641 clockwise under an effect of air flow (as shown in FIG. 117 and FIG. 118). After rotating at a certain angle (for example, 90°), the first movable component 645 touches the first switch 646, is limited by the fixing plate of the first switch 646, and no longer continues to rotate, which prevents the first switch 646 from being crushed by an external force. The switch is in the closed state at this moment, which indicates that there is normal air flow passing through a tube at this time, and the tube is smooth. Once a clogging situation occurs in the lawn conveying tube 625, the air flow flowing out from the lawn inlet 632 will decrease. When the air flow decreases to a certain extent, then the first movable component 645 may rotate counterclockwise and rotate downward under the effect of gravity, so that the first switch 646 is disconnected. When a disconnection time exceeds the preset value (for example, 3 seconds), a blockage signal may be sent, the cutting deck 310 stops mowing, the fan machine 620 stops rotating, the mower 1 shows a clogging fault indication, and the mower stops mowing. The mower 1 automatically drives from the current working position 6A (represents a position where the grass conveying device is detected to be clogged) to a parking detection and repairing point 6P for maintenance (FIG. 11). For example, when the fan machine 620 is started, the air speed may reach 406 M/s and a pressure value may reach 1.69 kg. When a situation of lawn clogging occurs, the air speed may be rapidly reduced to 0, and no air pressure is applied to the first movable component 645 of the clogging detection device 640. Due to the effect of gravity, the first movable component 645 rotates downward 90 degrees to a vertical state. If no external force applies pressure to the first switch 646, the first switch 646 is turned off.

The preset time may be set to 3 seconds, and a disconnection for 3 seconds is a delay of 3 seconds. Due to an actual mowing, there will be the lawn accumulation that are easy to cause the clogging of the lawn conveying tube 625, sometimes it may be at a critical point of clogging, and sometimes lawn accumulation may be discharged into the grass collection box without eventually causing clogging. Therefore, in order to exclude this situation, a preset time range of a disconnection of the first switch 646 may be set to 3 seconds to 5 seconds (or may be preset to other appropriate time lengths according to the actual situation), so that the first switch 646 is disconnected for a long time, and if the lawn collection still cannot enter the grass collection box 630 normally, it may be determined that the clogging situation occurs.

The first switch 646 may be a pressure switch, a micro switch, a travel switch, or any switch or device that may be applied to the clogging detection device 640 of the disclosure. In this embodiment, the first switch 646 is the pressure switch.

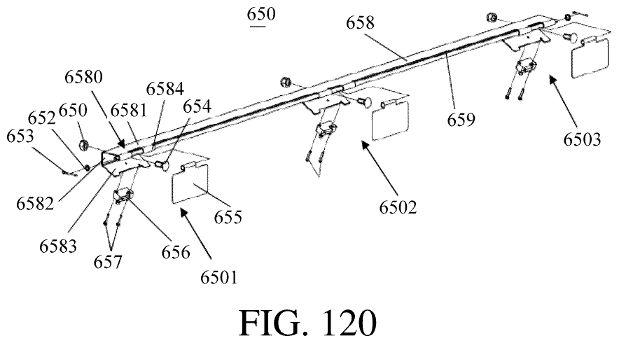

Please refer to FIG. 119 through FIG. 120. The overfill detection device 650 detects a lawn amount state in the grass collection device, and when the lawn amount reaches a threshold, the overfill detection device detects an overfill. In this embodiment, a lawn threshold is the lawn amount when the grass collection box 630 is full. The overfill detection device 650 is mounted in the grass collection device (i.e. in the grass collection box 630) and is close to a top position of the grass collection device.

The overfill detection device 650 includes at least one detection unit, a plurality of detection units are arranged at different positions in the grass collection box 630. When all the detection unit detects that the lawn amount in the grass collection box 630 reaches the threshold, which means that the lawn amount at a plurality of positions in the grass collection box 630 has reached the threshold (lawn full), the overfill detection device 650 generates an overfill signal at this moment, which means that when the plurality of detection units all detect the lawn full in the grass collection box 630, the overfill detection device 650 generates the overfill signal.

In this embodiment, the overfill detection device 650 includes a first detection unit 6501, a second detection unit 6502 and a third detection unit 6503. The three detection units are connected to a longitudinally extended mounting bracket 658, and the mounting bracket 658 is fixedly mounted at the front wall 633 of the grass collection box 630 close to the top wall 637. In an embodiment, positions of the first detection unit 6501, the second detection unit 6502 and the third detection unit 6503 are basically arranged on a left side (close to the second side wall 634), a middle and a right side (close to the first side wall) of the front wall 633 of the grass collection box 630.

Each detection unit 50 includes a second sensor 656 and a second movable component 655. The second movable component 655 has the first state and the second state. When the lawn amount in the grass collection box 630 reaches the threshold (lawn full), the lawn in the grass collection box 630 pushes the second movable component 655 to move to the second state, and at this moment, the second sensor 656 detects that the second movable component 655 is in the second state. When a plurality of the second movable components 655 are in the second state, the overfill detection device 650 sends the overfill signal.

In some embodiments of the disclosure, the second sensor 656 is a switch. The second sensor 656 detects a state of the second movable component 655 through a form of the second movable component 656 triggering the switch. When the second sensor 656 triggers the switch, the second sensor 656 detects that the second movable component 656 is in the first state, and when the second movable component 655 is disconnected from the switch, the second sensor 656 detects that the second movable component 655 is in the second state. Of course, in other embodiments, the second sensor 656 may also be another type of sensor, such as a displacement sensor, and the displacement sensor detects a displacement magnitude of the second movable component 655, thereby detecting the state of the second movable component 655. The second movable component 655 may realize a state switching through a mode of rotation, and may also realize the state switching by means such as translation. In order to clearly illustrate a scheme of the disclosure, the embodiment takes the second sensor 656 as a second switch an example to elaborate.

Each detection unit 6501-6503 includes a mounting bracket part 6580, the second switch 656 and the second movable component 655. Each mounting bracket part 6580 includes a first part 6581, a second part 6582 and a third part 6583 extending integrally, and the second part 6582 extends between the first part 6581 and the third part 6583. The switch 656 is fixed on the third part 6583, the second movable component 655 is mounted to a mounting part 6584 at one end of the first part 6581 through a long axis pin 659, and the second movable component 655 may rotate freely around the long axis pin 659.

The second switch 656 may be a pressure switch, a micro switch, a travel switch, or any switch or device that may be applied to the clogging detection device 640 of the disclosure. In this embodiment, the second switch 656 is the pressure switch.

It is noted that in some embodiments of the disclosure, the overfill detection device 650 may include one, two, three or more detection units as required. These detection units may be connected with a common mounting bracket 658 or individually mounted at a suitable position of the grass collection box 630, such as at a corresponding position near the top wall 637 of the grass collection box 630.

The second switch 656 may be a pressure switch, a micro switch, a travel switch, or any switch or device that may be applied to the overfill detection device 650 of the disclosure. In this embodiment, the second switch 656 is the pressure switch. The mounting bracket part 6580 of the three detection units 6501-6503 may be separate parts of the three detection units 6501 to 6503 respectively, or the mounting bracket part 6580 of the three detection units 6501 to 6503 may be integrated together to form the longitudinally extended mounting bracket 658. The first, second, and third parts 6581 to 6583 included in each mounting bracket part 6580 extend continuously in a shape of “[”.

The first, second and third detection units 6501 to 6503 may share one long axis pin 659 to mount their second movable components 655 on the first part 6581 of their respective mounting bracket parts 6580, or they may each include one pin to rotatably mount their second movable components 655 onto the first part 6581 of their respective mounting bracket parts 6580.

The overfill detection device 650 may further include a pair of opening pins 653 and washers 52, which are respectively arranged on two ends of the long axis pin 659 to prevent the long axis pin 659 from moving left and right along a longitudinal direction of the mounting bracket 658.

In this embodiment, the first detection unit 6501, the second detection unit 6502 and the third detection unit 6503 adopt a mode of series connection, which means that a plurality of second switches 656 are connected in series in a line. When the plurality of second switches 656 are all triggered, the grass collection box 630 is considered to be in an overfill state.

With a collection of crushed lawn in the grass collection box 630 gradually increases, the crushed lawn may touch the second switch 656 (series connection) in the overfill detection device 650 of the grass collection device under an action of its own gravity. Under normal circumstances, after the air flow from the lawn conveying tube 625 blows the crushed lawn from the lawn inlet 631 on the first side wall 631 of the grass collection box 630 into the grass collection box 630, the crushed lawn will first begin to accumulate at a position of the grass collection box 630 near the second side wall 634, and then slowly accumulate towards a position of the first side wall 631. Therefore, under normal circumstances, the crushed lawn will first touch, squeeze the second movable component 655 of the first detection unit 6501 of the overfill detection device 650, so that it is closed with the corresponding switch6 56.

In other words, when the grass collection box 630 is gradually filled with crushed lawn, the second movable component 655 of the first detection unit 6501 on a left side rotates freely at a certain angle around the long axis pin 659 (such as 18 degrees, or an angle of other degrees), first touches the corresponding second switch 656 and closes, then touches the third part 6583 of the mounting bracket part 6580, is limited and cannot continue to rotate. Then, the second switch 656 of a middle second detection unit 6502 is closed sequentially, and the second switch 656 of a right third detection unit 6503 is finally closed. When the second switch 656 of left, middle and right three positions all closed, the overfill detection device 650 may send out the overfill signal of the grass collection box. The mower 1 may receive a feedback signal, the cutting deck 310 stops mowing, the fan machine 620 stops working, and the mower will travel to a lawn discharging point 6M from the current working position 6B (representing detecting a position that grass collection box 630 is full) at this moment, and an unloading is carried out.

The first sensor 646 and the second sensor 656 in this embodiment may adopt a same structure or different structures, and the first movable component 656 and the second movable component 655 may adopt a same structure or adopt different structures, which is not limited herein.

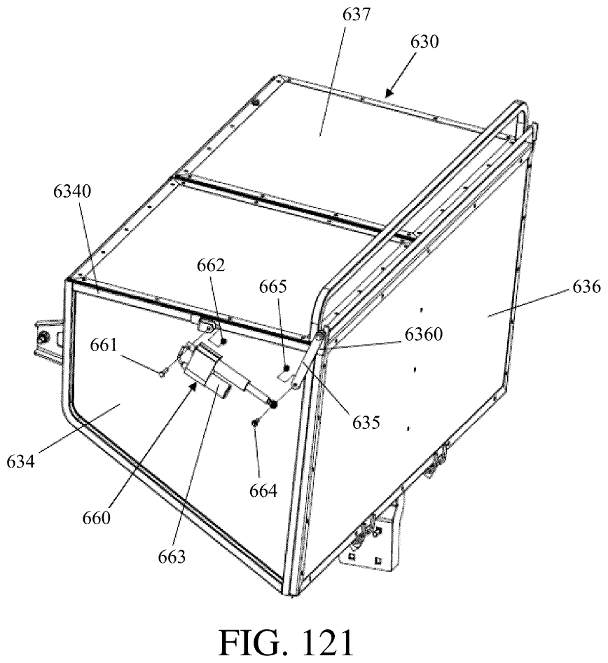

Please refer to FIG. 121 through FIG. 123. The lawn unloading device 660 includes an electric pushing rod 663, a first end of the electric pushing rod 663 is mounted on a top of a frame 6340 of the second side wall 634 of the grass collection box 630, and a second end of the electric pushing rod 663 is connected to a first end of a swing arm 635 of the grass collection box 630. A second end of the swing arm 635 is connected with a top of a frame 6360 of the box door 636 of the grass collection box 630, and the electric pushing rod 663 can push or pull the swing arm 635 to drive the box door 636 to open or close.

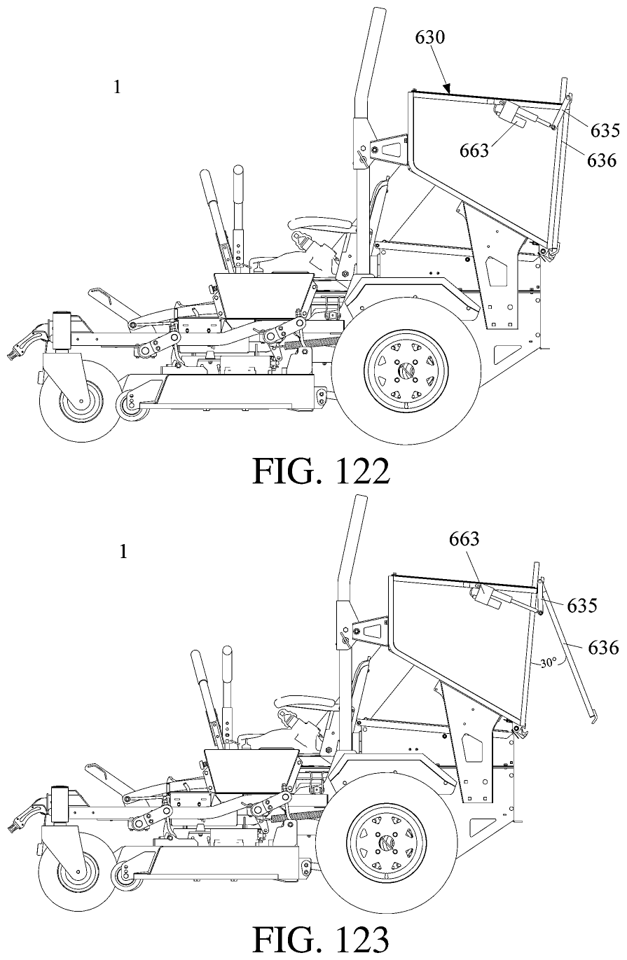

In FIG. 122 and FIG. 123, the grass collection box 630 and the lawn unloading device 660 are highlighted with a thicker line, while the mower 1 and its other components are shown with a thinner (lighter) line. FIG. 123 is a schematic view that the box door 636 rotates about 30 degrees and may be rotated from an open position to a closed position, and vice versa. A number of degrees that the box door 636 needs to rotate between the open and closed positions may be set according to the actual situation.

In one embodiment of the disclosure, the bottom wall 638 is not parallel to the top wall 637, but is inclined downward relative to the top wall 637 at a certain angle (it may be any suitable angle), so that the crushed lawn entering the grass collection box 630 may be easily poured out from the grass collection box 630 under the action of gravity when the box door 636 is opened, which is conducive to completing an unloading process quickly and thoroughly.

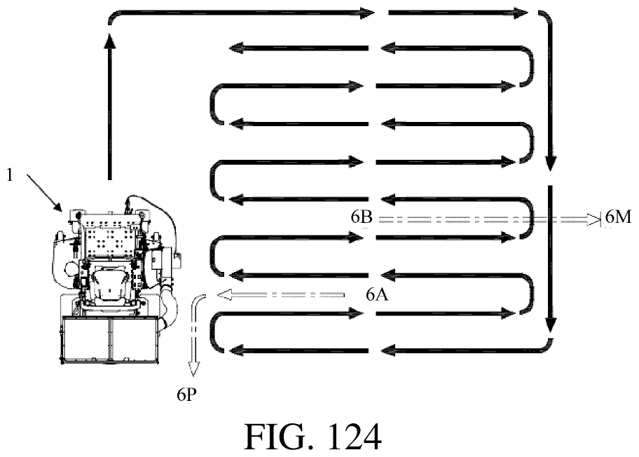

A rear end of the electric pushing rod 663 is mounted on the frame 6340 of the second side wall 634 of the grass collection box 630 through a bolt 661 and a nut 662, and the other end of the electric pushing rod 663 is fixed on the swing arm 635 of the box door 636 of the grass collection box through a bolt 664 and a nut 665. Under normal conditions, the box door 636 of the grass collection box is firmly closed by an action of the electric pushing rod 663. When the grass collection box 630 is full of lawn and the mower 1 automatically walks to the lawn discharging point 6M (FIG. 124), the electric pushing rod 663 on the grass collection box 630 will receive a working signal and push the grass collection box 630 to open. After the box door 636 is opened, the crushed lawn will automatically slide down under the action of gravity. After a set unloading time interval, the electric pushing rod 64 will automatically retract, and the box door 636 of the grass collection box 630 box is closed, and an automatic unloading process is completed. The mower 1 automatically walks to the position 6B where a last mowing stop on the cutting deck 310 and continues to mow the lawn.

Each element and component of the clogging detection device 640, overfill detection device 650 and lawn unloading device 660 of the disclosure may be made of any material that can help realize its intended function. For example, the first movable component 645 and/or the second movable component 655 may be made of spring steel with a wear-resistance and high-strength, while a material of other components may be made of ordinary Q235 steel.

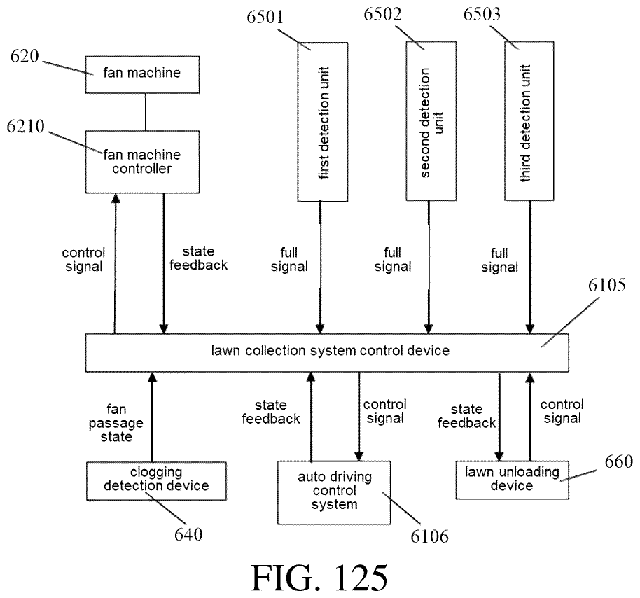

Please refer to FIG. 124 and FIG. 125. The mower 1 of the disclosure includes a lawn collection system control device 6105, which may receive the overfill signal from the overfill detection device 650 and the clogging signal of the clogging detection device 640, and controls the mowing device, the lawn conveying system, the grass collection device and the lawn unloading device 660 according to the received signal to cooperate with each other.

The mower 1 further includes an auto driving control system 6106. The lawn collection system control device 6105 sends a fault condition of the grass conveying device and a load condition of the grass collection device to the auto driving control system 6106 respectively.

The lawn collection system control device 6105 may be mounted under a seat of the mower 1, the fan machine controller 6210 of lawn collection is mounted on the fan machine 620 for controlling a working condition of the fan machine 620, and the auto driving control system 6106 may be mounted under a flat plate behind the seat. The lawn collection system control device 6105 and the auto driving control system 6106 may also be arranged at other suitable positions of the mower 1.

The clogging detection device 640, the overfill detection device 650 and the auto lawn unloading device 660 are respectively electrically connected with the lawn collection system control device 6105. A specific wiring method may be used in any suitable way, which is not detailed in this specification. The lawn collection system control device 6105 may be a central controller of the mower 1 itself at the same time, and control the clogging detection device 640, the overfill detection device 650 and the auto lawn unloading device 660 respectively. The lawn collection system control device 6105 may also have a function of controlling the other components of the mower 1 at the same time.

When the grass conveying device (e.g., the lawn conveying tube 625) is clogged, the air flow entering the grass collection box 630 from the lawn inlet 632 of the grass collection box 630 will be reduced to enable the first movable component 645 of the clogging detection device 640 to be disconnected from the first switch 646 under the action of gravity. The clogging detection device 640 sends the fault signal to the lawn collection system control device 6105, and the lawn collection system control device 6105 notifies the auto driving control system 6106.

The auto driving control system 6106 controls and operates the mower 1 to walk from the current working position 6A (recorded as a breakpoint position 6A) to a fault repairing area 6P for corresponding repairs. When the fault is eliminated after repairing, the lawn collection system control device 6105 notifies the auto driving control system 6106 according to a received signal (for example, it may be a signal that a maintenance personnel input to the lawn collection system control device 6105, or a corresponding signal sent to the lawn collection system control device 6105 in other possible ways), and the auto driving control system 6106 will control the mower 1 to drive back to the breakpoint position 6A from the fault repairing area 6P and continue to mow. It may also be that the maintenance personnel directly send a signal to the auto driving control system 6106 to notify and control the mower 1 to return to the breakpoint position 6A.

When the crushed lawn entering the grass collection box 630 are gradually filled up and the second movable component 655 and the second switch 656 of the first detection unit, the second detection unit and the third detection unit 6501-6503 of the overfill detection device 650 are all closed under an action of a generated pressure, the overfill detection device 650 will send the overfill signal to the lawn collection system control device 6105. The lawn collection system control device 6105 will notify the auto driving control system 6106, and the auto driving control system 6106 will control and operate the mower 1 to drive from the current working position 6B (recorded as the breakpoint position 6B) to the lawn discharging area 6M. Then the lawn collection system control device 6105 is notified, and the lawn collection system control device 6105 controls the electric pushing rod 663 of the lawn unloading device 660 to push the swing arm 635 of the box door 636 of the grass collection box 630 to open the box door 636 of the grass collection box 636 to unload the lawn. After a predetermined time interval, the electric pushing rod 663 will drive the swing arm 635 to close the box door 636 and complete an unloading of the lawn. When the unloading of the lawn is finished, the lawn collection system control device 6105 notifies the auto driving control system 6106 according to the received signal (for example, it may be a signal sent by the electric pushing rod 663, or a signal that a specific personnel input to the lawn collection system control device 6105, or a corresponding signal sent in other possible ways), and the auto driving control system 6106 will control the mower 1 to drive back to the breakpoint position 6B from the lawn unloading area 6M and continue to mow. It may also be that the specific personnel directly send a signal to the auto driving control system 6106 to notify and control the mower 1 to return to the breakpoint position 6B.

In a process of unloading the lawn, once the electric pushing rod 663 starts to work, the crushed lawn begins to leak outward. When the box door 636 is in a maximum opened state, a dumping of the crushed lawn has basically been completed. The predetermined time interval is set according to a speed of the electric pushing rod 663, for example, it may be set to 15 seconds, then a tolerance of 5 seconds is reserved, and the predetermined time interval may be recommended to be 15 seconds to 20 seconds.

In summary, the mower and its lawn collection system in the disclosure realize following functions in a mode of auto driving of the mower (lawn mower): three major functions: auto detection of clogging, auto detection of overfill of the lawn collection and auto unloading of the lawn, which may cooperate with the mower in an unmanned state, and may also be applied to the mower controlled by a driver. Therefore, the disclosure effectively overcomes various shortcomings in the prior art and has a high degree of industrial utilization value.

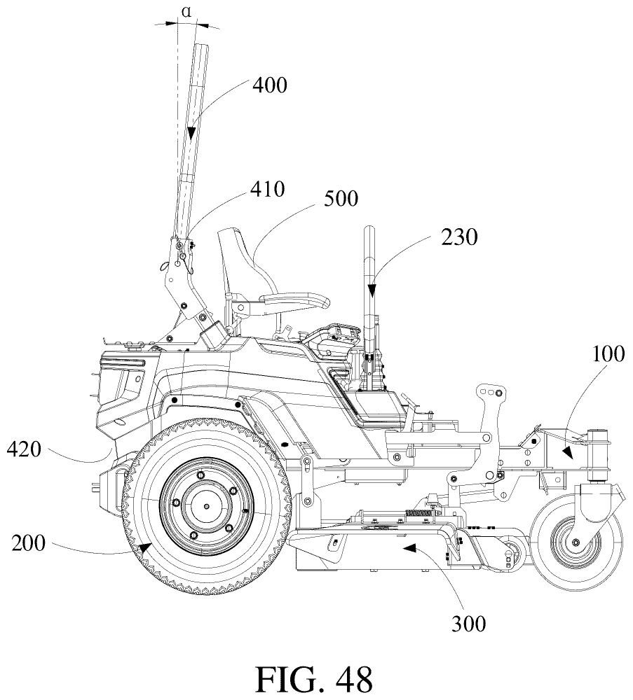

Please refer to FIG. 48. In an embodiment, the mower 1 further includes an anti-roll frame 400. The frame 100 is provided with a driving seat 500. Other structural forms of the frame 100 are not limited, which may refer to frame structures of the conventional mowers 1. The walking mechanism 200 is mounted on the frame 100 and is used for driving the frame 100 to walk. The walking mechanism 200 may include a driving part, a steering part, a power supply part and other components. The power supply part provides energy for the driving part, and the driving part provides power for a rotation of the walking wheel, and the walking mechanism 200 carries out a corresponding walking action in a control of an operating device 230. The cutting deck assembly 300 is mounted on the bottom of the frame 100 to carry out the corresponding mowing. The anti-rolling frame 400 is rotatably mounted on the frame 100 on a side of the driving seat 500 and is provided with a first position and a second position. In an embodiment, the anti-rollover frame 400 is fixed on a side of the driving seat 500 (which means any position next to the driving seat 500 that may prevent the driver's head from an injury when rolling), and is higher than a top of the driver's head in an operating state, so as to protect the driver when the frame 100 rolls. When the anti-rollover frame 400 is in the second position, the anti-rollover frame 400 folds relative to the frame 100 to reduce a storage volume of the mower 1. It should be noted that, a part not described in detail by the above-mentioned mower 1 and a relative connection relationship may refer to all conventional suitable structures of the mower 1, and will not be repeated in detail.

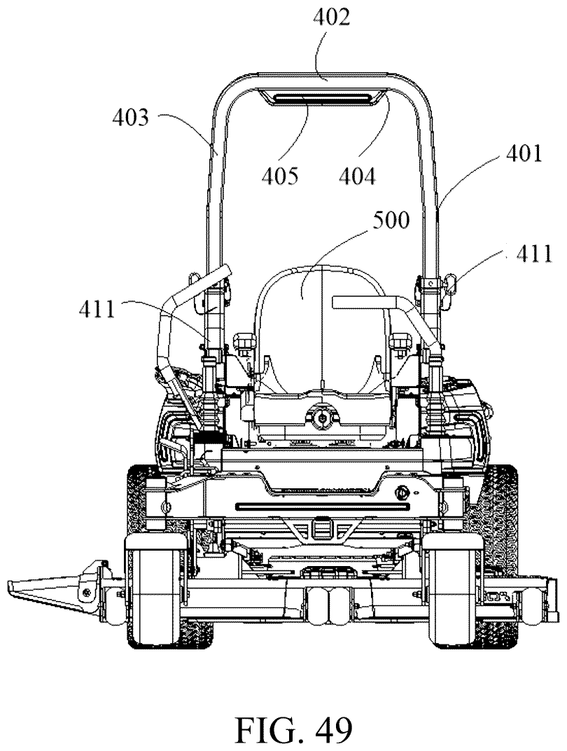

In this disclosure, a structure of the anti-roll frame 400 may be unlimited. Please refer to FIG. 49. In an embodiment of the disclosure, the anti-roll frame 400 includes a first side arm 401, a second side arm 403 and a connecting body 402. A first end of the first side arm 401 is rotatably mounted on the frame 100 on a first side of a rear side of the driving seat 500, a second end of the second side arm 403 is rotatably mounted on the frame 100 on a second side of the rear side of the driving seat 500, and the first side arm 401 and the second side arm 403 rotates coaxially. A first end of the connecting body 402 is connected with a second end of the first side arm 401, and a second end of the connecting body 402 is connected with a second end of the second side arm 403, thereby forming an approximate U-shaped structure. In an embodiment, the connecting body 402 is located at a top of the head of the driver sitting on the driver seat 500 or close to an upper position, so that when the frame 100 rolls and contacts with the ground, it prevents the head of the driver from touching the ground, which may cause the driver being injured.

As long as a storage space can be reduced relative to the frame 100, a specific position of the second position of the anti-roll frame 400 and a structure between the anti-roll frame 400 relative to the frame 100 may not be limited. The anti-roll frame 400 and the frame 100 may be locked after folding or not, in order to have a better appearance and customer experience. In some embodiments, please refer to FIG. 48. In an embodiment of the mower 1 of the disclosure, a storage groove 420 is arranged on the frame 100. The anti-roll frame 400 is clamped into the storage groove 420 when it is in the second position, and a position of the storage groove 420 in the disclosure may be selected according to a shape, a structure, a position and a storage position of the anti-roll frame 400. In an embodiment of the mower 1 of the disclosure, the second position of the anti-roll frame 400 is arranged at a tail of the frame 100, and the storage groove 420 is arranged at the tail of the frame 100. When the anti-roll frame 400 rotates from the first position to the second position, it may be clamped into the storage groove 420, so that the anti-roll frame 400 does not protrude to a surface of the frame 100, which optimizes an appearance. At the same time, a folding stability of the anti-roll frame 400 may also be increased through being clamped into the storage groove 420.

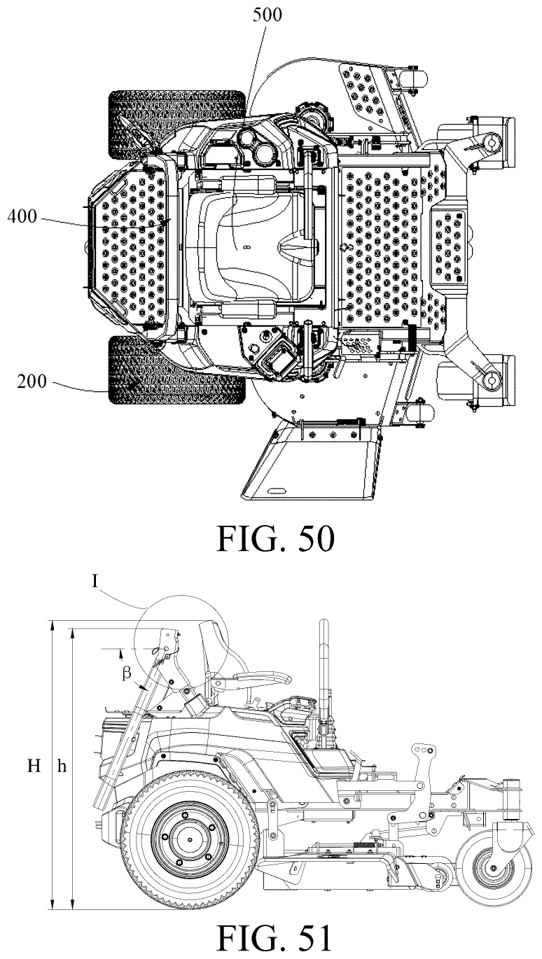

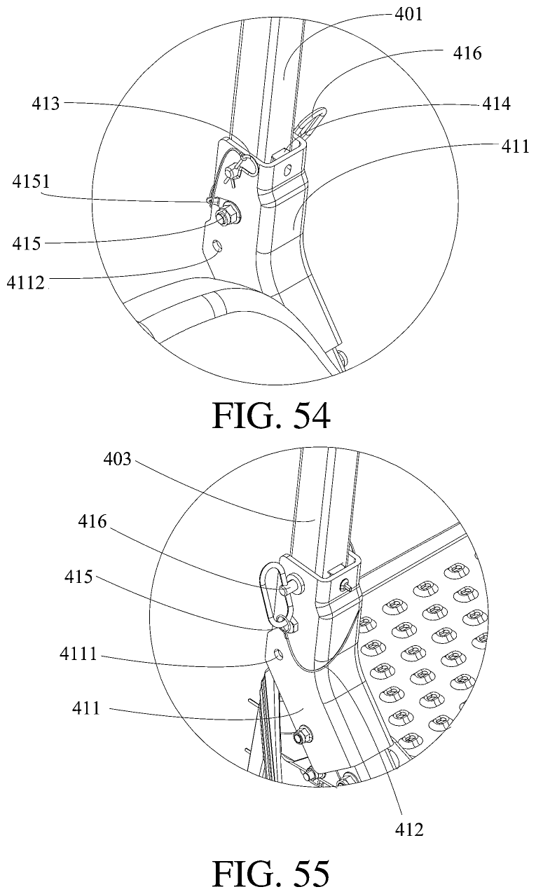

Please refer to FIG. 49 through FIG. 52, and FIG. 54 through FIG. 55. In an embodiment of the mower 1 of the disclosure, second mounting frames 411 are symmetrically mounted on both sides of the frame 100, and the first side arms 401 and the second side arms 403 on both sides of the anti-roll frame 400 are respectively rotatably connected with the second mounting frames 411 on both sides of the frame 100. A mode of a rotational connection is not limited. It may be realized only by a bolt assembly 415, or by a bearing assembly, etc. In an embodiment of the disclosure, the first side arm 401, the second side arm 403, the connecting body 402 is formed by bending a same square tube. The second mounting frame 411 is provided with a mounting cavity matched with the square tube. The square tubes of the first side arm 401 and the second side arm 403 are rotatably mounted on the second mounting frame 411 on both sides through the bolt assembly 415 and may be coaxially rotated. The first side arm 401 and the second side arm 403 are provided with a shock absorbing block 414 on one side that is in contact with the mounting cavity in the rotation direction, and the shock absorbing block 414 may reduce an impact force on the second mounting frame 411 when the anti-roll frame 400 adjusts a position. The mounting cavity is provided with an avoidance opening within a rotation range of the anti-roll second mounting frame 411, so as to fully ensure that the anti-roll frame 400 rotates between at least the first position and the second position. In order to obtain a more compact storage volume, a height h of the second mounting frame 411 is lower than a height H of the driving seat 500 (see FIG. 51).

In an embodiment of the mower 1 of the disclosure, the anti-roll frame 400 is locked at the first position and/or the second position through a locking structure. The locking structure may be all conventional suitable locking structure types, such as a spring-pin locking assembly and the like. Considering a reliability of the anti-roll frame 400 as a protective structure, please refer to FIG. 54. In an embodiment of the disclosure, the locking structure includes a locking pin 416 and an anti-loosening locking body 413 arranged on the locking pin 416. The second mounting frames 411 on both sides are provided with a first locking hole 3111 and a second locking hole 4112. The first locking hole 3111 and the second locking hole 4112 are distributed on a same circumference centered on an axis of the bolt assembly 415, and the first side arm 401 and the second side arm 403 are provided with a through hole corresponding to the first locking hole 3111 or the second locking hole 4112. The locking pin 416 penetrates from the first locking hole 4111 (or the second locking hole 4112) on a first side of the through hole, and penetrates out from the first locking hole 4111 (or the second locking hole 4112) on a second side of the through hole. The anti-loosening locking body 413 is arranged on the locking pin 416 to prevent the locking pin 416 from falling out from the first locking hole 4111 (or the second locking hole 4112) and the through hole. The anti-roll frame 400 realizes a locking on the first position and the second position through the same locking pin 416 and the same anti-loosening locking body 413 arranged on the locking pin 416. It should be noted that, in the disclosure, it may also be locked by the locking pin 416 and the anti-loosening locking body 413 only when in the first position, and may also be locked by the locking pin 416 and the anti-loosening locking body 413 only when in the second position. It may also be locked by different locking pins 416 and anti-loosening locking bodies 413 respectively when in the first position and the second position.

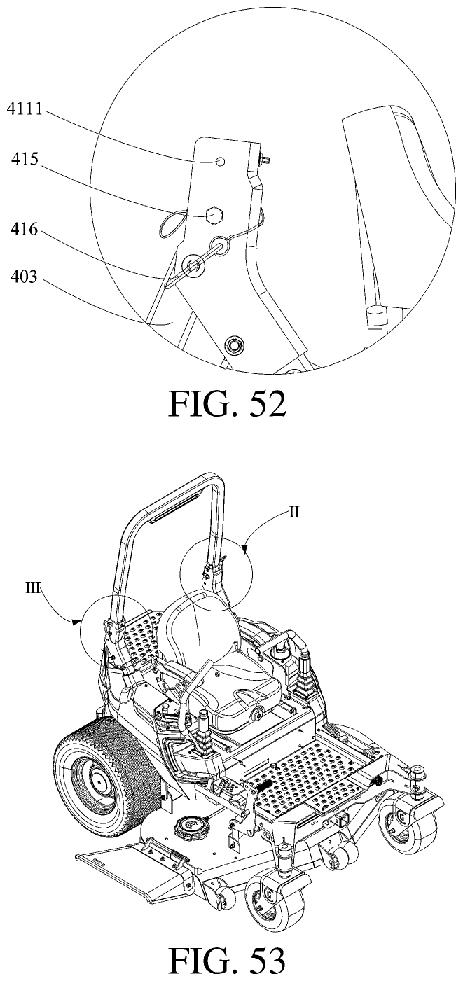

Please refer to FIG. 48, FIG. 52, FIG. 54 through FIG. 55. In order to prevent a loss of the locking pin 416 and/or the anti-loosening locking body 413, an anti-loss pulling structure 410 may be arranged in the disclosure. It should be noted that, the anti-loss pulling structure 410 may be arranged only between the locking pin 416 and the frame 100, or the anti-loss pulling structure 410 may be arranged only between the anti-loosening locking body 413 and the frame 100. In an embodiment of the mower 1 of the disclosure, the anti-loss pulling structures 410 are both arranged between the frame 100 and the locking pin 416, and between the frame 100 and the anti-loosening locking body 413. A form of the anti-loss pulling structure 410 may be all the conventional suitable forms, and the locking pin 416 and/or the anti-loosening locking body 413 may be effectively prevented from being lost by the anti-loss pulling structure 410.

Please refer to FIG. 52, FIG. 54 through FIG. 55. In an embodiment of the mower 1 of the disclosure, the anti-loss pulling structure 410 includes a pulling wire 412 and a pulling wire through hole (not labeled). The pulling wire through hole is arranged on the frame 100. The pulling wire 412 is threaded in the pulling wire through hole, and two ends of the pulling wire 412 are respectively connected with the locking pin 416 and the anti-loosening locking body 413. The locking pin 416 and the anti-loosening locking body 413 blocks on two sides of the pulling wire through hole respectively. Through this kind of structure, a pulling of the locking pin 416 and the anti-loosening locking body 413 may be realized through a same pulling wire 412, and a mounting structure is optimized. However, it should be noted that, if the same locking pin 416 and the anti-loosening locking body 413 are locked in the first position and the second position, it needs to ensure that the pulling wire 412 has sufficient length to meet a mounting in the first locking hole 3111 and the second locking hole 4112.

Please refer to FIG. 52, FIG. 54 through FIG. 55. In an embodiment of the mower 1 of the disclosure, the first side arms 401 and the second side arms 403 on both sides of the anti-roll frame 400 are respectively rotatably connected with the second mounting frames 411 on both sides of the frame 100 through the bolt assembly 415. The pulling wire through hole is arranged on a gasket 4151 in the bolt assembly 415. This structure may simplify a structure and reduce a number of components. It should be noted that in the disclosure, the locking structure may be arranged only between the first side arm 401 and the second mounting frame 411 or between the second side arm 403 and the second mounting frame 411. However, considering a balance of a force and a reliability of a locking, in this embodiment, the locking pins 416 and the anti-loosening locking bodies 413 are both arranged between the first side arm 401 and the second mounting frame 411 on the first side of the frame 100, and between the second side arm 403 and the second mounting frame 411 on the second side of the frame 100. The locking pins 416 and the anti-loosening locking bodies 413 on both sides are provided with the anti-loss pulling structures 410.

Please refer to FIG. 52, FIG. 54 through FIG. 55. In the disclosure, as long as a top height of the anti-roll frame 400 in the first position is higher than a height of the head of the driver when sitting on the driving seat 500, a protection of the driver when the frame 100 rolls may be realized. In some embodiments, in an embodiment of the mower 1 of the disclosure, the anti-roll frame 400 is inclined to a head of the frame 100 (which means a front side of a walking direction when the mower 1 goes straight) from bottom to top, and an angle α between it and a vertical plane is 5 degrees to 10 degrees. This angle may not only enable the anti-roll frame 400 to be closer to the head of the driver, but also is conducive to form a protective triangle area together with the frame 100 when the mower 1 rolls, which can better protect safeties of the driver through the protective triangle area. When the anti-roll frame 400 is in the second position, an angle R between the anti-roll frame and a horizontal plane is 50 degrees to 70 degrees, and this angle range may disperse part of a gravity of the anti-roll frame, and a force of the anti-roll frame on the frame may be reduced.

Please refer to FIG. 49. In an embodiment of the mower 1 of the disclosure, the anti-roll frame 400 is further provided with a lighting assembly 405, and a shock absorbing body and/or a protective body 404 is arranged at a position where the anti-roll frame 400 is in contact with the storage groove 420. The lighting assembly 405 is arranged below the connecting body 402, such as on a shock absorbing body and/or a protective body 404 on a side of the connecting body 402 towards the driver. The shock absorbing body and the protective body 404 may be a same component that has both a protective function and a shock absorption function, or may be different components. The protective body 404 is used for preventing the head of the driver from colliding with the anti-roll frame 400 during a rolling process, and the shock absorbing body is used for avoiding noise and vibration caused by a gap when being clamped into the storage groove 420, which may improve a driving experience. In this embodiment, the protective body 404 is an elastic rubber, and also has a shock absorbing function. It is located at a side of a U-shaped anti-roll frame 400 towards the head of the driver in the first position, clamped in the groove when in the second position, and is in contact with the frame 100, so as to reduce a damage and vibration of the anti-roll frame 400 when contacting the frame 100. The lighting assembly is arranged on the anti-roll frame 400, which may have a higher lighting angle and obtain a better lighting effect.

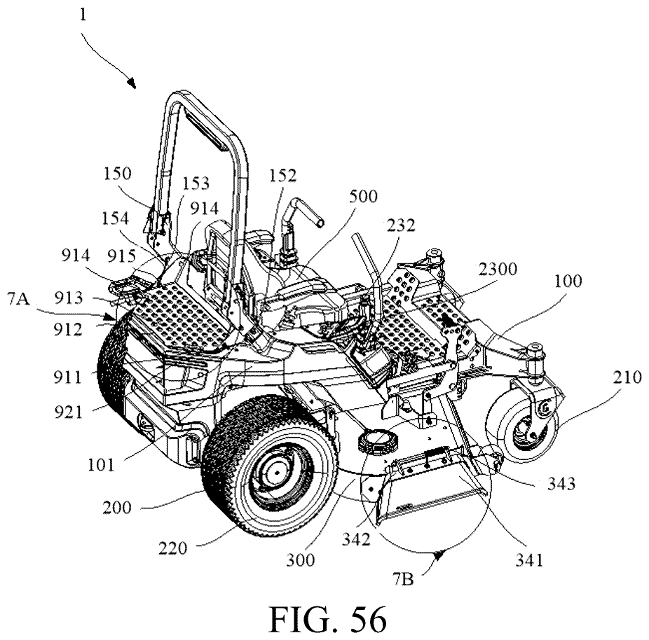

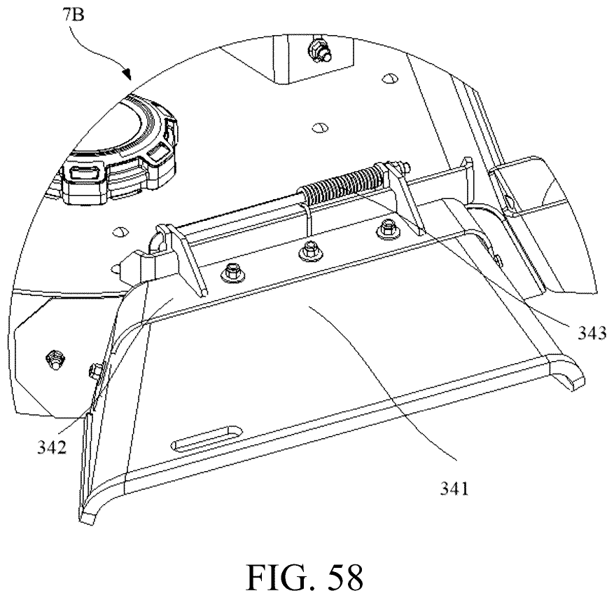

Please refer to FIG. 56 through FIG. 58. In an embodiment, the mower 1 further includes a storage platform 910. The storage platform 910 is arranged on the frame 100.

By arranging the storage platform 910 on the mower 1, a load capacity of the mower 1 in a running process is increased, and the staff is convenient for randomly configuring auxiliary tools or other articles, so that the staff has reduced labor effort in the mowing process, and increased a convenience of the mower 1 when using.

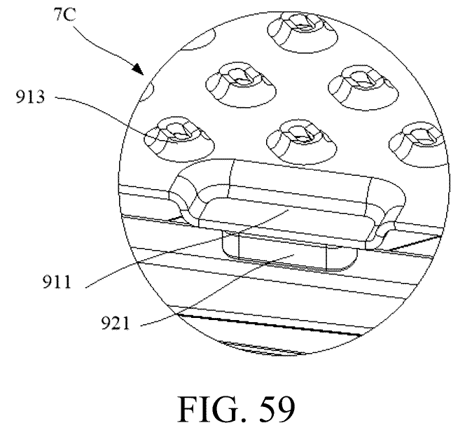

Please refer to FIG. 56 through FIG. 61. In an embodiment of the disclosure, the mower 1 is a riding mower, the frame 100 is provided with the driving seat 500, the storage platform 910 is mounted at the tail of the frame 100, and the tail of the frame 100 is provided with a storage cavity 920. An opening of the storage cavity 920 is facing upward, and the storage platform 910 is located at the opening of the storage cavity 920. The storage platform 910 and the storage cavity 920 form an upper and lower two-layer storage structure 910. In an embodiment, the storage platform is used to place items with larger volume or shape, such as ropes, buckets, and large tools etc.; the storage cavity 920 is used to accommodate some small items, such as mobile phones, power banks, pads, and small tools etc. In an embodiment, the large tools may be electric logging saws, etc., and the small tools may be hand-held percussion drills, etc. At the same time, the storage platform 910 further acts as a cover for the storage cavity 920, so that the storage platform 910 can protect objects in the storage cavity 920.

Please refer to FIG. 56 through FIG. 60. In an embodiment of the disclosure, the tail of the frame is provided with a casing 101. The casing located below the storage platform 910 is concave inward to form the storage cavity 920, and a cushion block 921 is arranged on an opening edge of the storage cavity 920. A function of the cushion block 921 is to separate the casing 101 and the storage platform 910. The mower 1 will cause a vibration of the storage platform 910 in a process of mowing 910, and the cushion block 921 can effectively prevent the storage platform 910 from causing wear to an edge of the storage cavity 920 by arranging the cushion block 921 between the storage platform 910 and the storage cavity 920.

Please refer to FIG. 1 through FIG. 5. In an embodiment of the disclosure, a boss 911 is arranged at a position corresponding to the cushion block 921 of the storage platform 910, and the boss 911 protrudes towards the cushion block 921. The boss 911 and the cushion block 921 can effectively increase a height of the storage cavity 920, thereby increasing an accommodating space of the storage cavity 920.

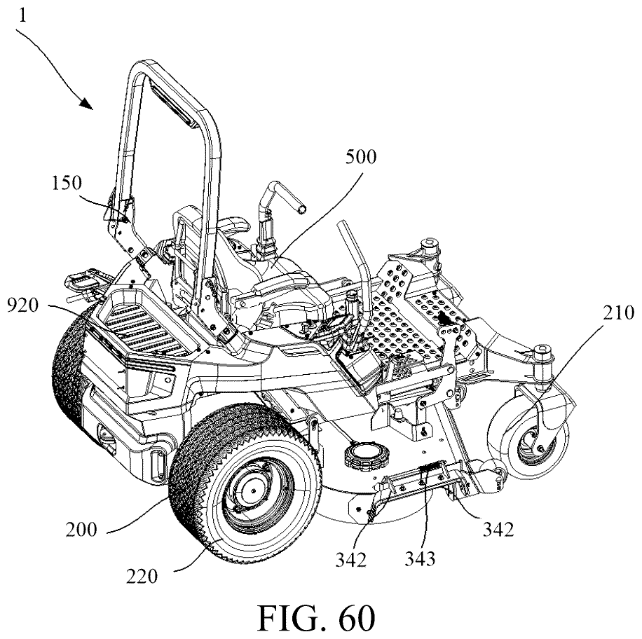

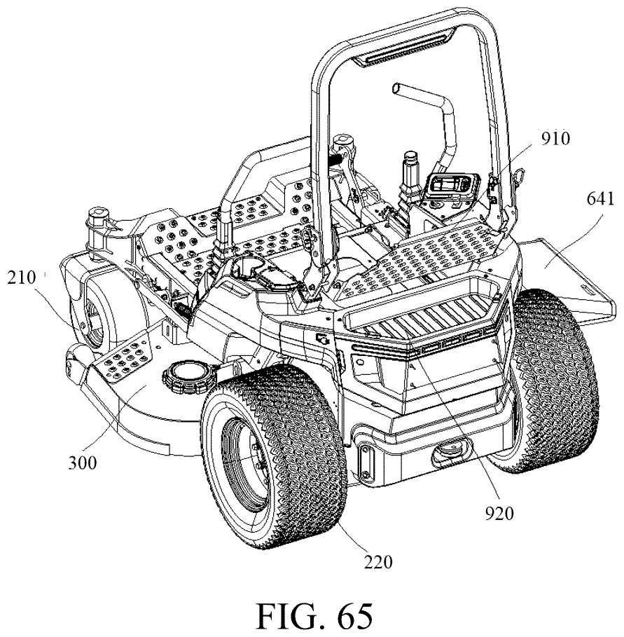

Please refer to FIG. 56, FIG. 60 through FIG. 65. In an embodiment of the disclosure, the storage platform 910 is rotatably mounted at the tail of the frame 100 and is located behind the driving seat 500. A rotatable mounting allows the storage platform 910 to be lifted from a top of the storage cavity 920, enable it to be easier to pick up and place items in the storage cavity 920.

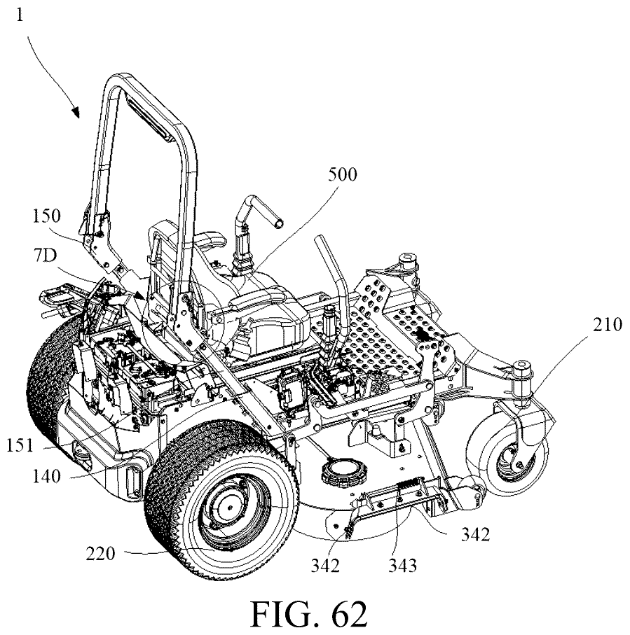

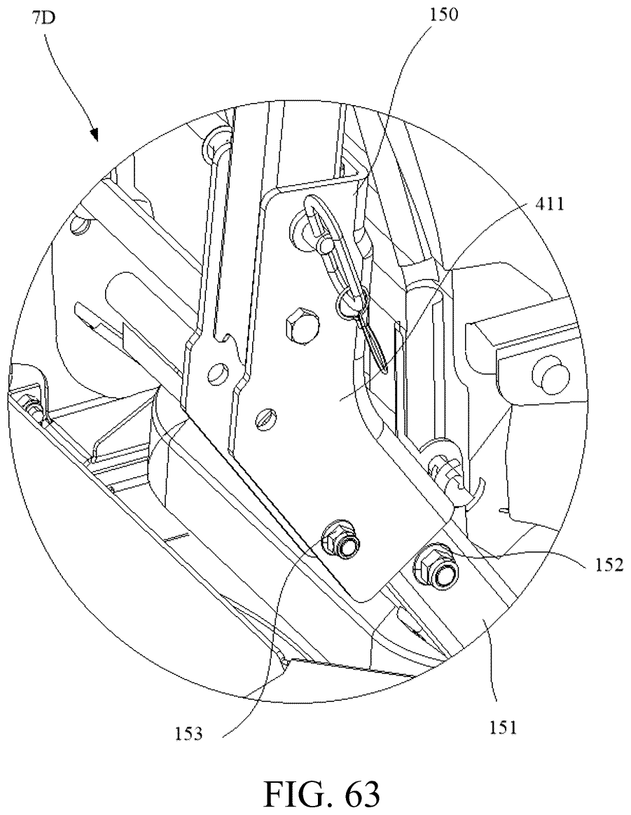

Please refer to FIG. 56, FIG. 62 and FIG. 63. In an embodiment of the disclosure, a supporting bracket 150 is arranged on the tail of the frame 100, and the storage platform 910 is rotatably mounted on the supporting bracket 150. A connecting component 154 is arranged between the supporting bracket 150 and the storage platform 910, the first end of the connecting component 154 is mounted on the supporting bracket 150, and the second end of the connecting component 154 is mounted on the storage platform 910. The supporting bracket 150 is provided with a pin hole 152, and the first mounting hole 914 is correspondingly arranged on the storage platform 910. A pin bolt passes through the pin hole 152 and the first mounting hole 914, so that the storage platform 910 is rotatably connected with the supporting bracket 150.

Please refer to FIG. 56 through FIG. 63. In an embodiment of the disclosure, the supporting bracket 150 includes a supporting rod 151 and the second mounting frame 411. The frame 100 is provided with an inserting groove 140, the supporting rod 151 is inserted into the inserting groove 140, and the second mounting frame 411 is arranged at an end part of the supporting rod 151. The supporting rod 151 is connected with the second mounting frame 411 by a bolt. A first end of the second mounting frame 411 is connected with the supporting rod 151, and a second end of the second mounting frame 411 is connected with an anti-roll frame. The pin hole 152 is arranged on the supporting rod 151.

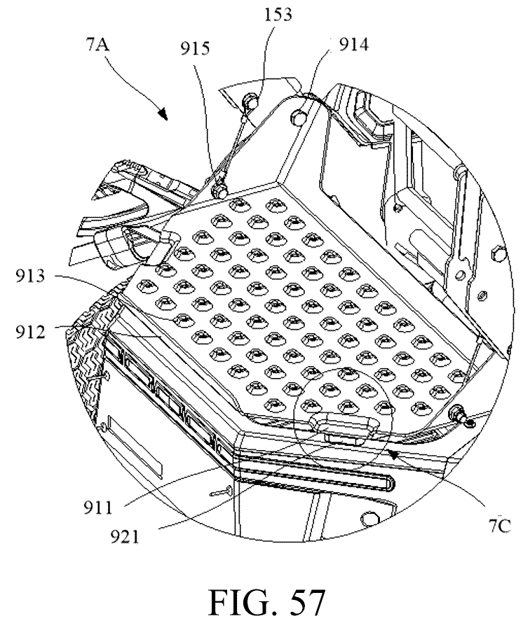

Please refer to FIG. 56, FIG. 57 and FIG. 63. In an embodiment of the disclosure, the supporting bracket 150 is further provided with a connecting hole 153, and the connecting hole 153 is arranged on the second mounting frame 411. A second mounting hole 915 is arranged on the storage platform 910. A first end of the connecting component 154 is mounted on the connecting hole 153, and a second end of the connecting component 154 is mounted on the second mounting hole 915. A main function of the connecting component 154 is to enhance a load-bearing capacity of the storage platform 910, and in addition, the connecting component 154 also has a limiting function.

Please refer to FIG. 56, FIG. 57 and FIG. 63. In an embodiment of the disclosure, the connecting component 154 is a rope, and the rope may be directly mounted in the connecting hole 153 and the second mounting hole 915. But in order to avoid a wear and tear to the rope caused by the connecting hole 153 or the second mounting hole 915, the pin bolt or the bolt is mounted in the connecting hole 153 and the second mounting hole 915 respectively, and an end of the rope is provided with a ring buckle, and the ring buckle is mounted on the pin bolt or the bolt, so that the wear to the rope can be effectively reduced.

Please refer to FIG. 56. In an embodiment of the disclosure, the storage platform 910 is provided with a flange 912, the flange 912 is located on a rear edge of the storage platform 910. The flange 912 can prevent objects from slipping and is easy to be held to lift the storage platform 910. At the same time, the flange 912 can effectively increase a strength of the storage platform 910 and the load-bearing capacity of the storage platform 910.

Please refer to FIG. 56. In an embodiment of the disclosure, a plurality of friction protrusions 913 is arranged on the storage platform 910. A middle part of each friction protrusion 913 is provided with a through hole, and the through hole is mainly set up for two purposes: firstly, it can effectively reduce a weight of a storage board, and secondly, the through hole can play a role of ventilation in order to maintain a dryness of the storage cavity 920.

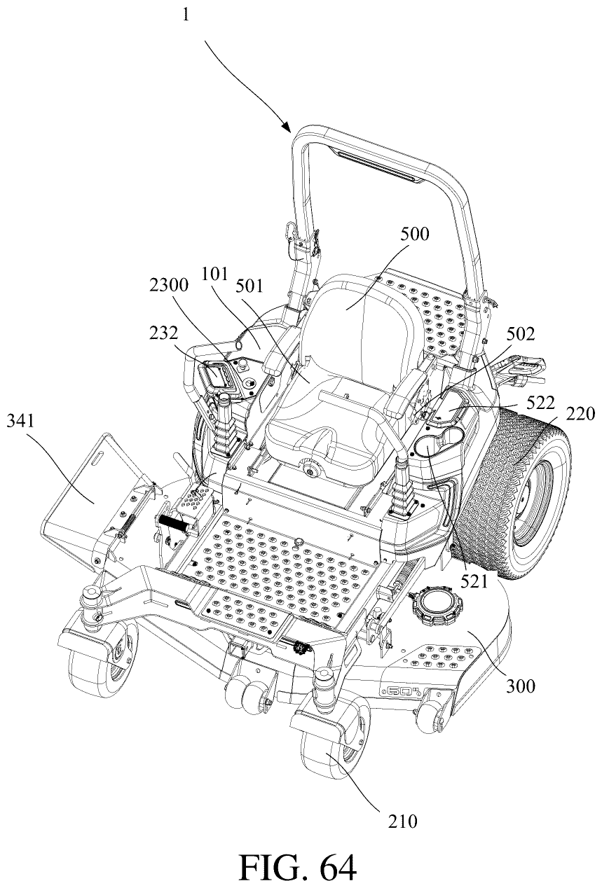

Please refer to FIG. 56 and FIG. 64. In an embodiment of the disclosure, the mower 1 further includes the casing 101 mounted on the frame 100, the casing 101 is provided with a cup groove 521, which is located next to the driving seat 500. The casing 101 is further provided with a storage space, the storage space is located at the side of the driving seat. A port is arranged in the storage space, a dust-proof cover 522 is covered above the port, and the dust-proof cover 522 may be rotatably mounted on the casing 101. The dust-proof cover 522 can effectively protect the port. The port may be the USB port, the type-c port and the micro port and so on. There is also a wireless charging base in the storage space for wireless charging of hand-held terminals (such as mobile phones).

Please refer to FIG. 64. In an embodiment of the disclosure, the casing 101 is provided with the operating device 230, the operating device 230 is provided with an operating key, and the operating key is used to realize an operation of the mower 1, such as a speed or a light of the mower 1, etc. The operating device 230 is further provided with a display screen 232. The display screen 232 is tilted and arranged.

Please refer to FIG. 56, FIG. 57 and FIG. 60. In an embodiment of the disclosure, the casing 101 is further provided with a tail light (not labeled), and the tail light is oriented towards a rear of the mower 1 and is located at a position below the storage platform 910 to play a role of indication, warning and the like.

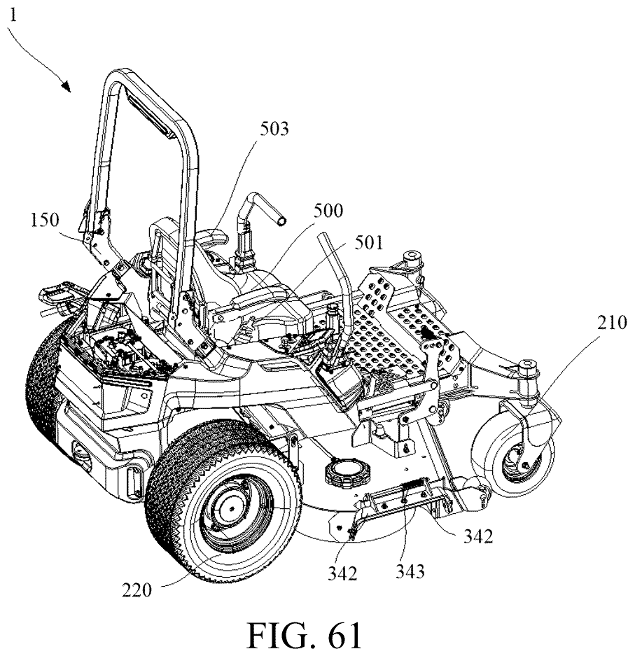

Please refer to FIG. 61 and FIG. 64. In an embodiment of the disclosure, the driving seat is provided with a seat belt 501 and a seat belt buckle 502, and the seat belt 501 and the seat belt buckle 502 are respectively located on the two sides of the driving seat 500. The seat belt 501 can ensure the safety of the staff. The two sides of the driving seat 500 are provided with an armrest 503, and the armrests 503 are provided with the cushion to increase comfort.

Please refer to FIG. 56. In an embodiment of the disclosure, a walking wheel 201 includes the front wheel assembly 210 and the rear wheel assembly 220, the front wheel assembly 210 is the universal wheel, and the rear wheel assembly 220 is driven by a driving motor 7110. Radius of the front wheel assembly 210 is less than radius of the rear wheel assembly 220. The large radius of the rear wheel assembly 220 ensures that the mower 1 has enough horsepower.

Please refer to FIG. 56 and FIG. 61. In an embodiment of the disclosure, the lawn outlet of the cutting deck assembly 300 is provided with the lawn discharging cover 341, and two sides of the lawn discharging cover 341 are provided with the flange that bends downward. A function of the lawn discharging cover 341 is to drain lawn clippings at the lawn outlet, and the flange on both sides of the lawn discharging cover 341 can effectively prevent the lawn clippings from flying during the discharging process.

Please refer to FIG. 56. In an embodiment of the disclosure, the lawn discharging cover 341 is rotatably mounted on the frame 100, and a torsion spring 343 is arranged between the frame 100 and the lawn discharging cover 341. The lawn clippings carry moisture and may easily stick to the inside of the lawn discharging cover 341, so when it is necessary to clean the inside of the lawn discharging cover 341, the lawn discharging cover 341 needs to be turned over and cleaned. After cleaning, the lawn discharging cover 341 is reset under an action of the torsion spring 343.

Please refer to FIG. 56 and FIG. 61. In an embodiment of the disclosure, the lawn discharging cover 341 is mounted on the frame 100 by two mounting plates 342. A plurality of bolts are arranged between the two mounting plates 342, the lawn discharging cover 341 is mounted between the two mounting plates 342 through the plurality of bolts, and the two mounting plates 342 are rotatably mounted on the frame 100.

In an embodiment of the disclosure, three flanges are arranged on the storage platform 910. The three flanges enclose the storage platform 910 into a frame body with one side opening, which enables it to be easy to store things and increase the strength of the storage platform 910. The storage platform 910 is provided with the friction protrusion, the friction protrusion protrudes upward, and a through hole is arranged in the friction protrusion. The through holes can reduce the weight of the entire storage platform 910 and facilitate heat dissipation for electrical equipment (e.g., motors, control panels, batteries, etc.) below the storage platform 910.

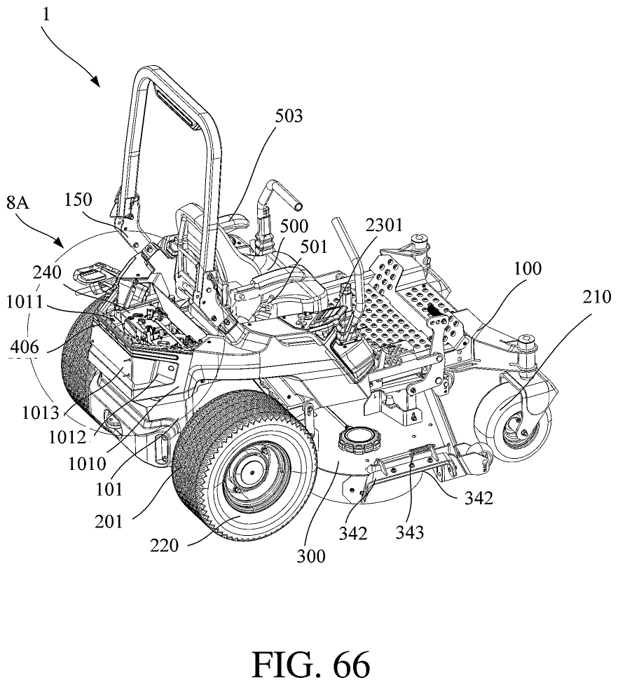

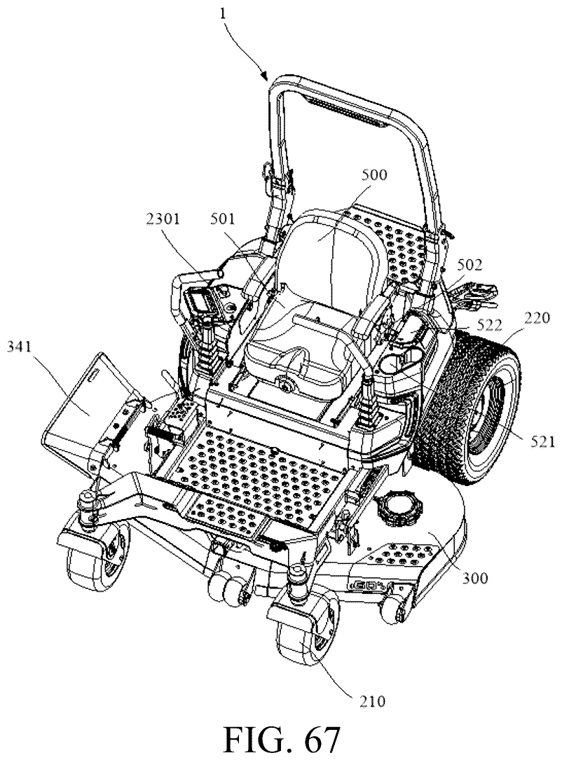

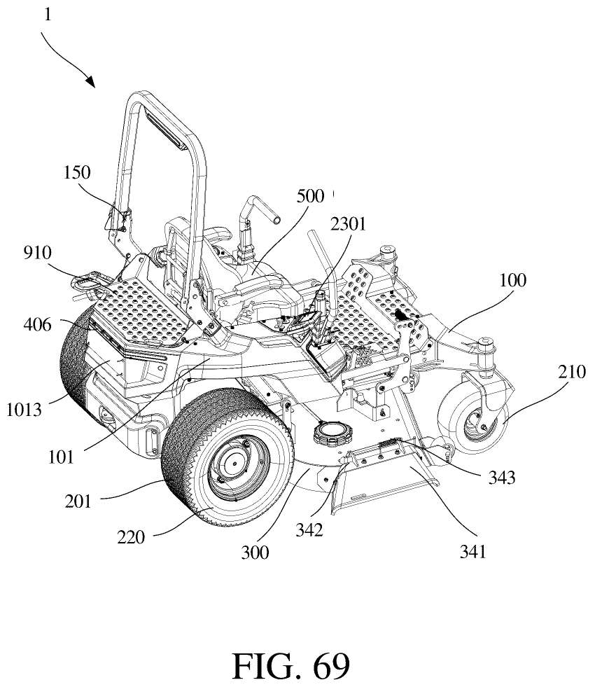

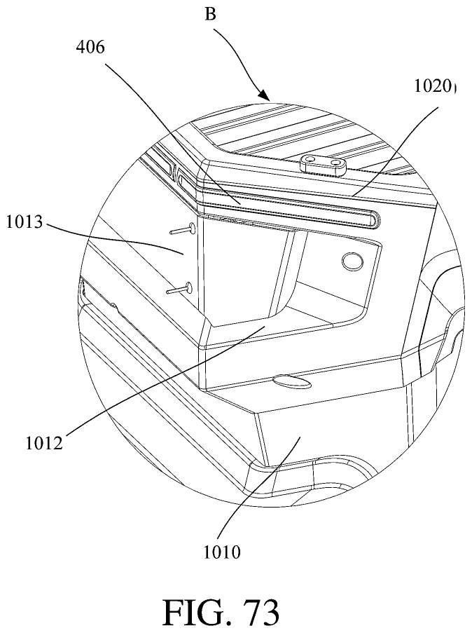

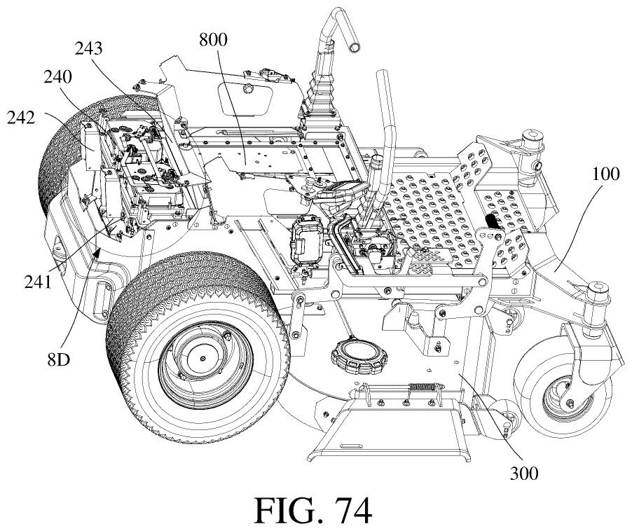

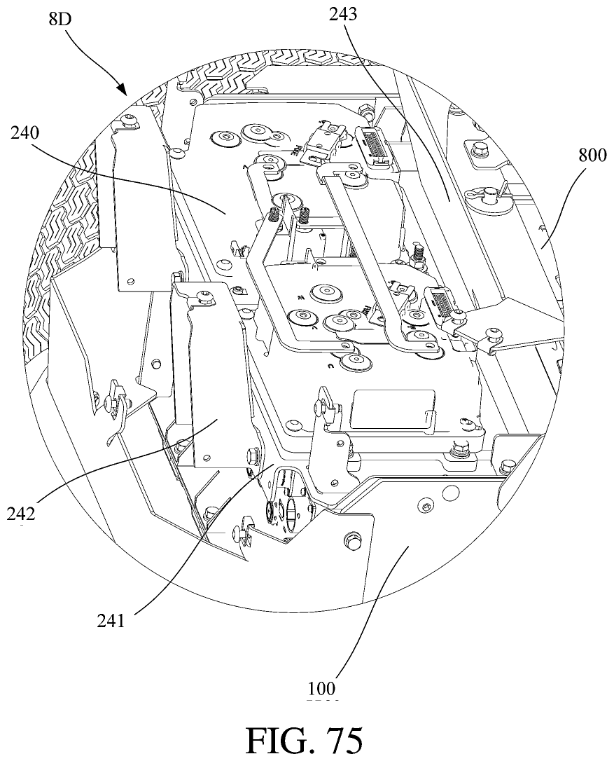

Please refer to FIG. 66 through FIG. 75. In an embodiment, the mower 1 further includes the casing 101. The casing 101 is mounted on the frame 100. The battery 800 is mounted on the frame 100 and located inside the casing 101, and in this embodiment, the battery 800 is located below the driving seat 500. The controller 240 is electrically connected with the battery 800 and the electrical equipment of the mower 1 respectively, and the controller 240 is mounted inside the casing 101 and located at a tail of the casing 101. In other embodiments of the disclosure, the battery 800 may located in front of the frame 100, at a rear of the frame 100, or below a part of the battery 800 located at the driving seat 500. This means that a mounting position of the battery 800 may be adjusted according to a structure of the frame, an arrangement of a whole machine, a shape and a mounting position of the driving seat.

The battery 800 is mounted on the frame 100 and located inside the casing 101 and located below the driving seat 500 to save a space. The controller 240 is electrically connected with the battery 800 and the electrical equipment of the mower 1 respectively to realize an electrical control of the mower 1. The controller 240 is mounted inside the casing 101 and located at the tail of the casing 101, so that the controller 240 may be conveniently mounted and disassembled to realize a maintenance of the controller 240.

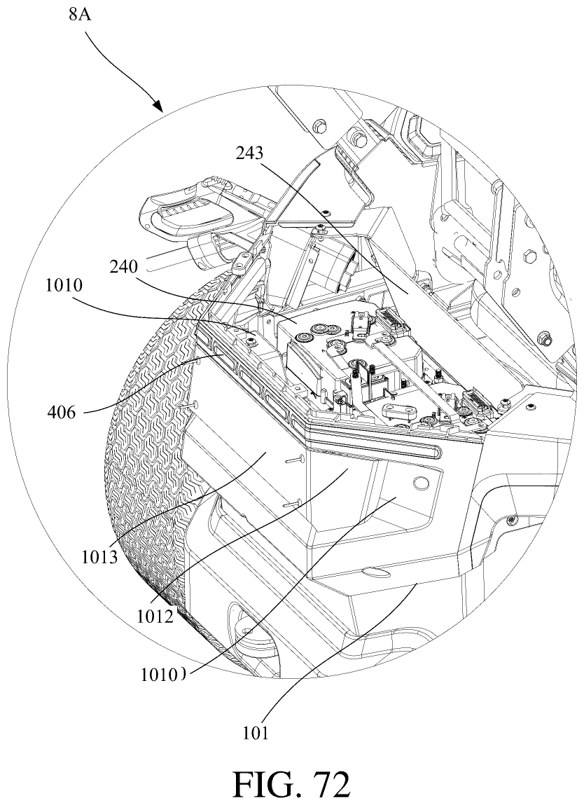

Please refer to FIG. 66 and FIG. 72. In an embodiment of the disclosure, the casing 101 includes a first housing 1010, the first housing 1010 encloses an inner cavity 1011 with the tail of the frame 100, the controller 240 is located in the inner cavity 1011, and the inner cavity 1011 is opened upwards to take and place the controller 240. The inner cavity 1011 is located under a rear and lower part of the driving seat 500, and the controller 240 can be mounted and disassembled through an upward opening of the inner cavity 1011, thus facilitating a maintenance. At the same time, since the controller 240 is located in the inner cavity 1011 enclosed by the tail of the first housing 1010, the controller 240 may be inspected and repaired by removing the first housing 1010.

Please refer to FIG. 66. In an embodiment of the disclosure, the tail of the casing 101 is concave inward and defines a concave area 1012. The casing 101 further includes a tail cover 1013, and the tail cover 1013 is detachably mounted in the concave area 1012. The concave area 1012 can form a mounting space to mount the tail cover 1013, so that an outer surface of the tail cover 1013 fits to upper and lower edges of the concave area 1012 to maintain aesthetics. At the same time, the tail cover 1013 can also play a protective role in the first housing 1010. In addition, product identification information, such as product identifications or product labels, may also be set on the tail cover 1013.

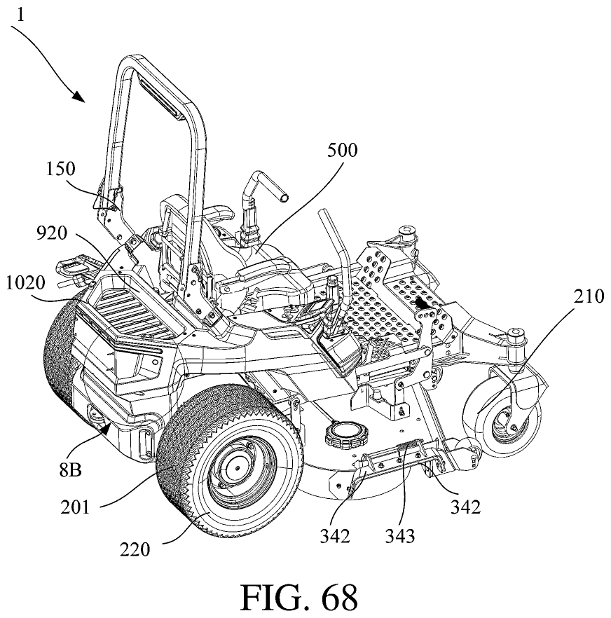

Please refer to FIG. 66 and FIG. 68. In an embodiment of the disclosure, the casing 1010 includes a second housing 1020, and the second housing 1020 is arranged on the first housing 1010 and cover the opening. The second housing 1020 can be removed from the first housing 1010. The second housing 1020 can effectively protect the controller 240 located in the inner cavity 1011 and play a role of dustproof, sunproof and anti-shower. When it is necessary to repair the controller 240, the second housing 1020 may be removed and the controller 240 may be taken out from the inner cavity 1011, thereby increasing a convenience of a maintenance process.

Please refer to FIG. 66 and FIG. 68. In an embodiment of the disclosure, the storage cavity 920 is arranged on the second housing 1020. The storage cavity 920 is an opening cavity that is concave towards the inner cavity 1011 and opens upwards. The storage cavity 920 can accommodate small items such as mobile phones, wallets, keys, spare batteries, small power tools, etc., which are always carried by the operator.

A first mounting frame 241 is mounted in the casing 101, and the controller 240 is mounted on the first mounting frame 241. The first mounting frame 241 is detachably mounted at an inner side of the first housing 1010 and is located in the inner cavity 1010, and the controller 240 is detachably mounted on the first mounting frame 241. The controller 240 is mounted on the first mounting frame 241, which can increase a firmness of a control and prevents the controller 240 from loosening due to bumps or vibrations during mowing. And a mounting position of the controller 240 can be controlled through the first mounting frame 241. In a specific embodiment, the suitable first mounting frame 241 may be arranged according to the mounting position required by the controller 240. At the same time, the first mounting frame can raise a height of the controller 240, which is more convenient for maintenance. The controller 240 adopts a detachable mounting to facilitate a removal of the controller 240 during later maintenance, so that a maintenance personnel may maintain the controller outside a machine body, thus increasing an operating space and reducing a difficulty of the maintenance. In addition, a removable mounting enables it to be easy to replace the controller 240, which increases a duration life of other parts of the mower 1.

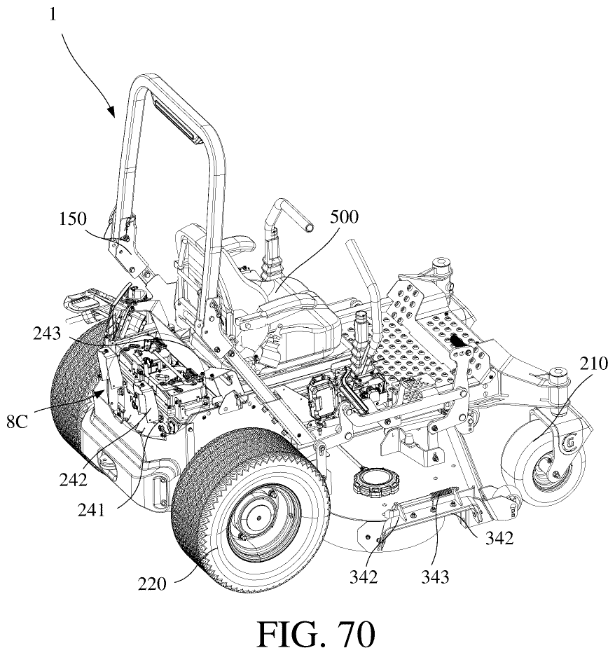

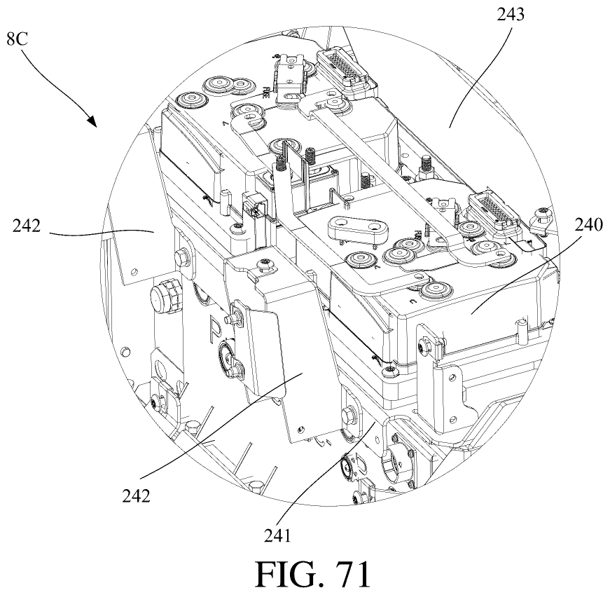

Please refer to FIG. 68, FIG. 70 and FIG. 71. In an embodiment of the disclosure, a bracket 242 is arranged on the first mounting frame 241. The bracket 242 is detachably mounted on the first mounting frame 241. The bracket 242 is used to mount the second housing 1020 so that the second housing 1020 is clamped onto the first housing 1010. A detachable mounting method of the bracket 242 facilitates a transportation before the machine body is assembled, and can reduce processing costs, while also facilitating a replacement and reducing maintenance costs.

Please refer to FIG. 68, FIG. 70 and FIG. 71. In an embodiment of the disclosure, the first mounting frame 241 further includes a supporting plate 243. The supporting plate 243 is mounted on the frame 100 and is located inside the casing 101, the battery 800 and the controller 240 are respectively located on two sides of the supporting plate 243, and the second housing 1020 is located above the supporting plate 243. An upper edge of the supporting plate 243 is provided with the flange, a screw hole is arranged on the flange, and the second housing 1020 is mounted on the supporting plate 243 through the screw hole and the bolt. A function of the supporting plate 243 is to support the second housing 1020 on one hand, to protect the controller 240 located in the inner cavity 1011 on the other hand, and to separate the battery 800 from the controller 240 at the same time. A separation of the battery 800 from the controller 240 can effectively reduce heat generated in a local position during a working process of the mower, avoid heat accumulation, and reduce potential safety hazards.

The first housing 1010 encloses the inner cavity 1011 at the tail of the frame 100, and the controller 240 is arranged in the inner cavity 1011. The inner cavity 1011 is sealed through the second housing 1020, so that the controller 240 plays a protective role. At the same time, the second housing 1020 detachably arranged on the first housing 1010, so that a convenience of maintenance is increased. And the first mounting frame 241 is arranged in the inner cavity 1011 and the controller 240 is detachably mounted on the first mounting frame 241 to increase a convenience of the maintenance and maintenance cost of the controller 240.

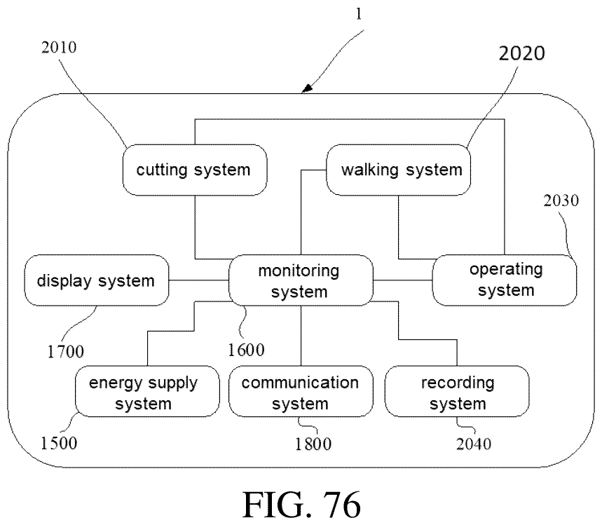

Please refer to FIG. 76 through FIG. 78. In an embodiment, the mower 1 further includes a machine body 10 and a cutting system 2010, a walking system 2020, an operating system 2030, a recording system 2040, an energy supply system 1500, a monitoring system 1600 and a display system 1700 mounted on the machine body 10. In an embodiment, the cutting system 2010 includes at least one cutting deck assembly 300 for mowing. The walking system 2020 includes the walking wheel 201 and a driving device 700 of the walking wheel 201. The operating system 2030 includes an operation device for controlling the mower 1, and the operation device is provided with a speed regulation key. A regulation of the speed regulation key according to a setting method can set a walking speed or a cutting speed of a cutting machine, such as setting a gear of the walking speed or the cutting speed. In an embodiment of the disclosure, the recording system 2040 includes a memory that is used for recording fault information of the mower 1 and corresponding fault handling measures, warning information and stage mowing information. The energy supply system 1500 includes at least one battery pack. The monitoring system 1600 is used for monitoring a state about the cutting system 2010, the walking system 2020, the operating system 2030, the recording system 2040 and the energy supply system 1500. The display system 1700 includes the display screen 232 for displaying monitoring results and parameter settings of the monitoring system 1600. The display screen 232 is tilted on the machine body, and a tilt angle range is from 30 degrees to 60 degrees, for example, 45 degrees.

The monitoring results include state information as well as working information. The monitoring results may all be displayed by the display screen 232. The monitoring results may be displayed through text, icons, etc. The working information includes identification information of the walking speed and the cutting speed, and the identification information includes a speed identification and a speed regulation identification. The speed identification includes a walking speed identification and a cutting speed identification, and the speed regulation identification includes a walking speed regulation identification and a cutting speed regulation identification. The display screen 232 can display the identification information of the walking speed and the cutting speed, and a regulation of the speed regulation identification can set the gear of the walking speed or the cutting speed.

In an embodiment of the disclosure, the state information includes at least one of an operator in-position state 1603, a closing state and releasing state of an electromagnetic brake 1604, time in a current time zone 1605, a cellular signal state 1607, a remote control state 1608, a lighting device state 1609, an alarm light state 1610, and a project name. The project name may be a name of an item in working information. For example, the project name may be light, setting, stage working information, and so on.

In the embodiment of the disclosure, the working information includes states of battery power 1602, a charging remaining time, an estimated time of a full charging, an external tool state 1601, a device energy consumption state 1611, a device use time 1612, a fault reminding 1613 and other states. The device use time 1612 includes a total use time of the device, a use time of the cutting system 2010, and a use time of a knife blade. The working information may all be displayed by the display screen 232.

In an embodiment, the fault reminding 1613 includes the fault information 1614 and the corresponding fault handling measures 1615, and the fault information includes a fault code and corresponding fault details. The working information further includes the stage working information, which includes: a working area, a working duration, and an average speed. The working information further includes pause reminding information, and the pause reminding information includes a pause duration.

In an embodiment of the disclosure, the mower 1 further includes a lighting device and an alarm light, the lighting device and the alarm light are arranged on the machine body of the mower 1. The lighting device is used to provide lighting or light display, and alarm lights are used to alarm. The monitoring system 1600 is used to monitor a working state of the lighting device.

Please refer to FIG. 76 and FIG. 77. In an embodiment of the disclosure, the mower 1 further includes a communication system 1800. The monitoring system 1600 further monitors the communication system 1800. The device is located by a GPS positioning of the communication system 1800. Device information is collected and sent to a cloud through a cellular network, and a remote user may check a device state through a mobile phone or a computer.

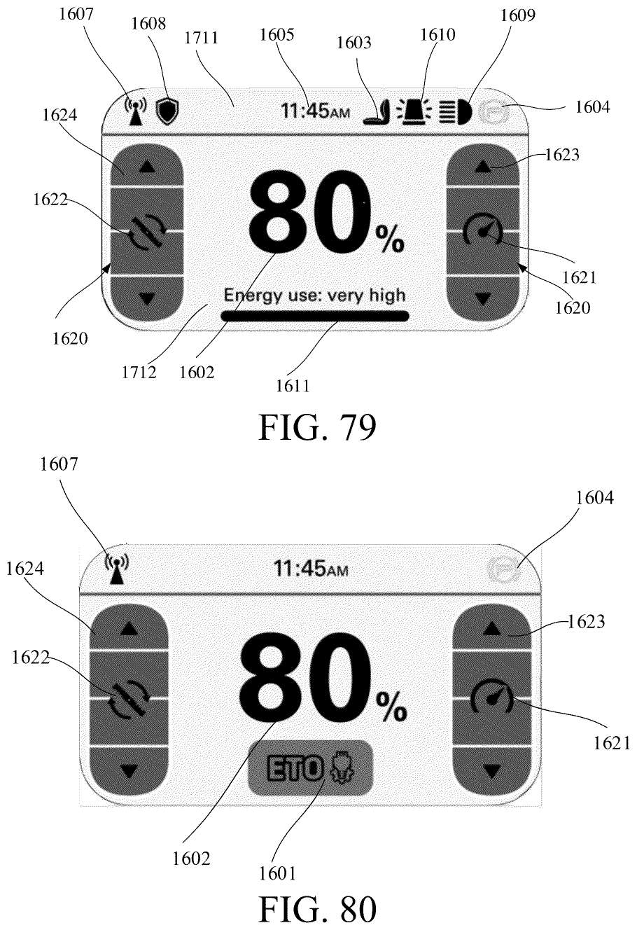

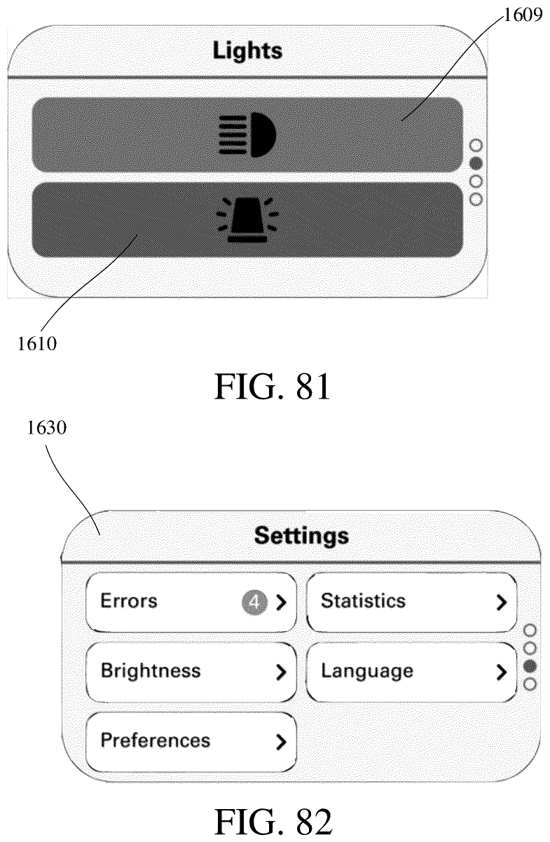

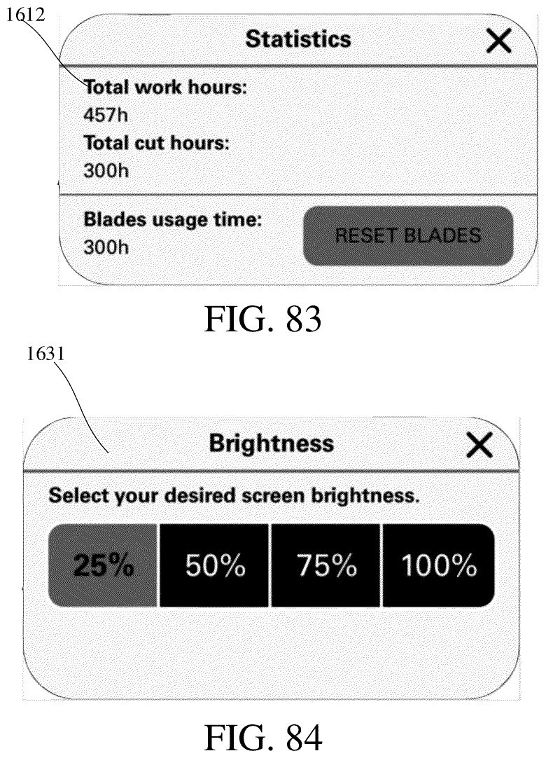

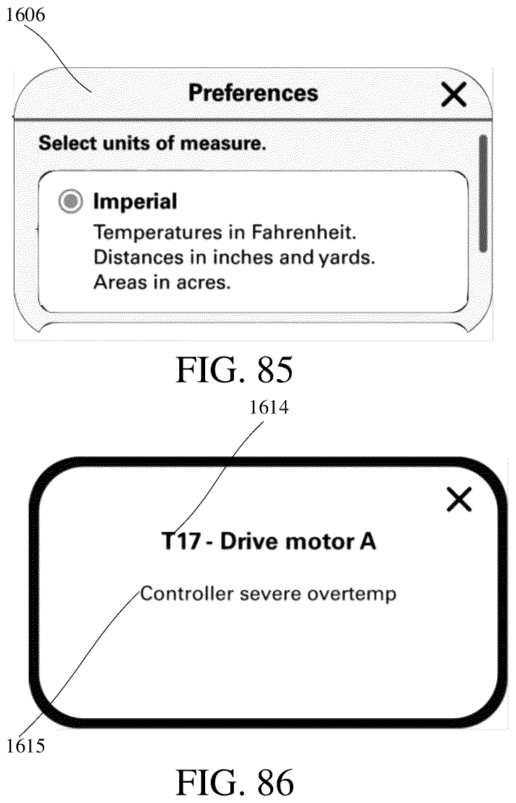

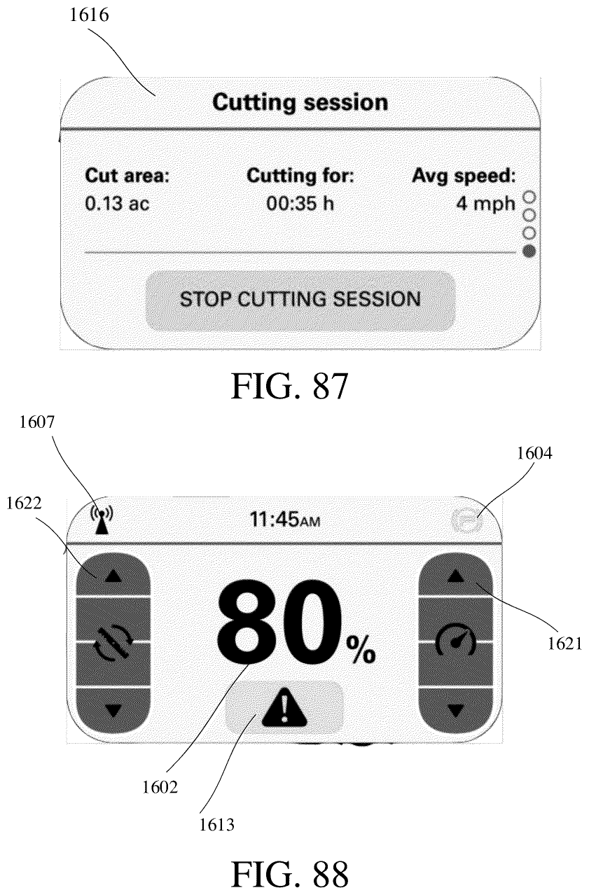

Please refer to FIG. 78 and FIG. 79. In an embodiment of the disclosure, the working information includes the external tool state 1601. The external tool state 1601 includes whether there is an external tool and whether the external tool is turned on or off. The mower 1 further includes a port to connect the external tool, and the monitoring system 1600 is further used to control whether to start the external tool when it is detected.

In an embodiment of the disclosure, the operating system 2030 further includes the operating handle 231 for operating and controlling the walking system 2020. The operating handle 231 is rotatably mounted on the machine body, and a rotation angle of the operating handle is positively correlated with the walking speed. The rotation angle refers to an angle between an initial position of the operating handle 231 and a current position. When the operating handle 231 is at the initial position, the walking speed of the mower is zero. When a position of the operating handle 231 is in an extreme position (the rotation angle is largest at this time), the walking speed of the mower is a maximum value corresponding to a gear of a current walking speed. A number of the operating handle 231 is two, the two operating handles 231 control driving wheels at corresponding sides of the walking system respectively, and a walking direction of the mower is adjusted by a rotation angle difference of the two operating handles 231. The walking speed and the rotation angle of the walking system 2020 can be operated and controlled by the operating handle 231.

Each operating handle 231 is respectively provided with the speed regulation key, one of operating handle 231 is provided with the walking speed regulation key, and a cutting speed regulation key is arranged on the other operating handle 231. The speed regulation key is located at an end of the operating handle 231, and a moving direction of the speed regulation key is along a direction of a holding part of the operating handle 231. When the operator holds an operating rod tightly, a thumb is naturally located at the end of the operating handle 231, the operator only needs to move and press with the thumb to a palm direction at this moment, and then a regulation of the speed is completed, which is ergonomic.

In an embodiment, the speed regulation key is divided into three gears, a high gear, a medium gear and a low gear, which can regulate a maximum value of walking speed or cutting speed. When the speed is regulated by using the speed regulation key, a regulation result is displayed synchronously on the display system. At the same time, the speed regulation identification on the display can also regulate a rotation speed of the blade and walking speed of the mower.

Please refer to FIG. 77 and FIG. 79. In an embodiment of the disclosure, the operating system further includes a plurality of operating buttons. Through the operating buttons, it can be realized a turning on and off of the lighting device, a turning on and off of the alarm light, a start and stop of the external tool, a reset of a knife blade use time, a selection of language, a conversion of a unit, a brightness regulation of the display screen 232, and a statistics of a staged mowing area, a mowing time and an average speed. A side of the display screen 232 is further provided with a cutting switch 2031. When the operator is in position, a starting of the cutting switch may start the cutting system to mow. It should be noted that, when the operator is not in position, even if the cutting switch is started, the cutting system cannot be started. The cutting system can only be started after the operator is in position and starts the cutting switch, and this starting mode avoids the cutting system being started by mistake, which increases a safety of the mower.

In an embodiment of the disclosure, the speed regulation key may be a separating type structure. The speed regulation key includes the cutting speed regulation key and the walking speed regulation key. In an embodiment, the cutting speed regulation key includes the speed regulation key of a cutting acceleration key and a cutting deceleration key. The walking speed regulation key includes a walking acceleration key and a walking deceleration key. When pressing the speed regulation key, a corresponding speed regulation identification on the display screen 232 will be lit. For example, when the walking acceleration key is used to accelerate the walking system 2020 of the cutting machine, an acceleration identification corresponding to the walking speed identification is illuminated. In addition, the speed regulation key may also be an integrated structure, and the above functions may be realized through a touch screen or a swing mode.

Please refer to FIG. 76 through FIG. 79. The display system 1700 includes the display screen 232. The display screen 232 is arranged on the machine body. The display screen is used to display identification information 1620 of the walking speed and a working speed, and the identification information includes a speed identification and the speed regulation identification. The walking speed or the working speed of the machine body can be set through the speed regulation identification.

In an embodiment of the disclosure, the display screen 232 includes a state display area 1711 and a working display area 1712, the state display area 1711 is used for displaying state information, the working display area 1712 is used for displaying working information, and the working information includes the identification information. In an embodiment, the state display area is located in an upper area of the display screen in a form of a horizontal bar, and a rest area of the display screen is the working display area.

In an embodiment of the disclosure, the state information includes at least one of the operator in-position state 1603, the closing state and releasing state of the electromagnetic brake 1604, the time in the current time zone 1605, the cellular signal state 1607, the remote control state 1608, the lighting device state 1609, the alarm light state 1610, and the project name. The project name may be the name of the item in working information. For example, the project name may be light, setting, stage working information, and so on.

Please refer to FIG. 76, FIG. 78 and FIG. 82. In an embodiment of the disclosure, the display screen 232 may be the touch screen, and a device parameter 1630 can be set through the display screen 232. The device parameter 1630 includes language, screen brightness 1631, unit conversion 1606 and statistical parameter etc. The statistical parameter includes a cumulative use time of a blade strip, a cumulative use time of the device, and a cumulative use time of the cutting system 2010. The display screen 232 is further provided with a blade strip reset key. The blade strip reset key is used to reset the use time of the blade strip. When replacing the blade strip, the accumulated usage time of the previous blade strip may be reset to zero through the blade strip reset key. The screen brightness 1631 increases in steps of 25%.

Please refer to FIG. 88. In an embodiment of the disclosure, the display screen 232 can display power information, and different states will be displayed below the power information. For example, when a fault occurs, the fault reminding is displayed, and a fault detail interface may be viewed through directly clicking the fault reminding. The side of the display screen 232 is further provided with an interface switching key 1713 and a main switch 233, and a switching of a display interface can be realized through the interface switching key. The interface switching key 1713 may be a touch key. The main switch 233 is provided with a safety key. A lower part of the safety key is a magnet, and a sensor is arranged at a key base to sense the magnet. If the safety key is not inserted, the main switch cannot be activated.

Please refer to FIG. 76 and FIG. 80. In an embodiment of the disclosure, the external tool state 1601 includes whether there is the external tool and whether the external tool is turned on or off. The mower 1 further includes the port to connect the external tool, and the monitoring system 1600 is further used to control whether to start the external tool when it is detected.

In an embodiment of the disclosure, the working information further includes stage working information 1616, which includes the working area, the working duration, and the average speed. The monitoring results further include the pause reminding information, and the pause reminding information includes the pause duration.

The display system 1700 can display states of the battery power 1602, the operator in-position state 1603, the closing state and the releasing state of the electromagnetic brake 1604, the time in current time zone 1605, the cellular signal state 1607 (2/3/4G and so on), the remote control state 1608, the charging remaining time, the estimated time of the full charging, the lighting device state 1609, the alarm light state 1610, the external tool state 1601, a speed gear of the walking system 1621, a speed gear of the cutting system 1622, the device energy consumption state 1611, the device use time 1612, the fault reminding 1613, a detail fault code 1614, an advice of fault handling measure 1615 and other states. The device use time 1612 includes the total use time of the device, the use time of the cutting system 2010, and the use time of the knife blade. Therefore, the disclosure realizes a centralized management of functions of a garden tool, and improves a visualization degree of the functions.

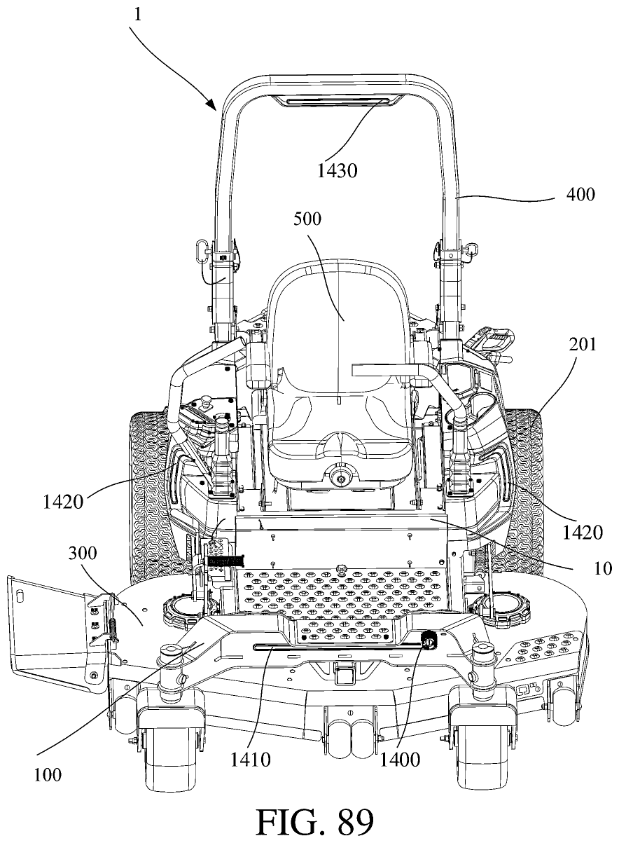

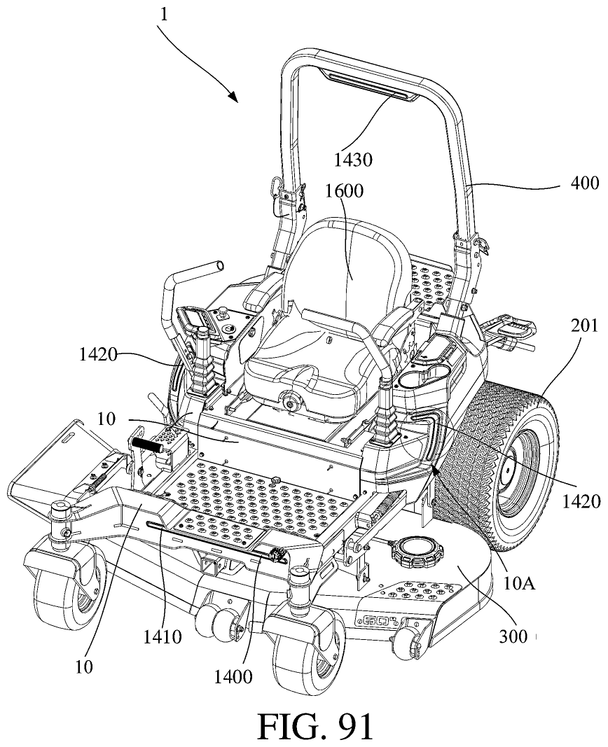

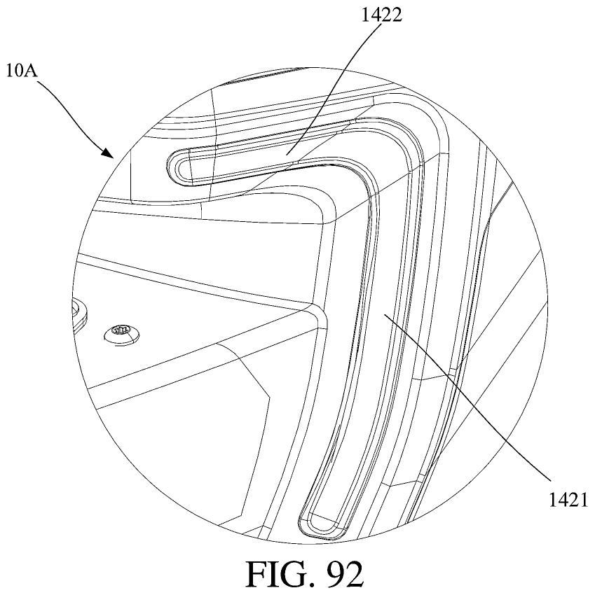

Please refer to FIG. 89 through FIG. 92. In an embodiment, the mower 1 further includes a light group 1400. The light group 1400 is arranged on the machine body 10 and is electrically connected with the controller. And it will be lit up according to a preset lighting method under a control of the controller. The light group 1400 is provided with at least one lighting method, and the lighting method of the light group 1400 corresponds to the state of the mower. For example, the state of the mower corresponding to the different lighting method of the light group 1400 is different, and in a certain embodiment, the lighting method of the light group 1400 corresponds to the state of the mower 1 one-to-one. The light group 1400 includes at least one of a headlight 1410, a side light 1420, a dome light 1430 or a tail light 1440.

Please refer to FIG. 89. In an embodiment of the disclosure, the headlight 1410, the side light 1420 or the dome light 1430 is a white light. The headlight 1410, the side light 1420 or the dome light 1430 includes a light cover and a light bead arranged inside the light cover, and the light cover of the headlight 1410, the side light 1420 or the dome light 1430 emits a white light with the light beads. For example, the light bead is white, and the light cover is transparent.

Please refer to FIG. 89. In an embodiment of the disclosure, the headlight 1410, the side light 1420 or the dome light 1430 is further provided with a green light bead, and the green light bead can emit a green light. Therefore, the headlight 1410, the side light 1420 or the dome light 1430 may emit the green light according to a control command of the controller.

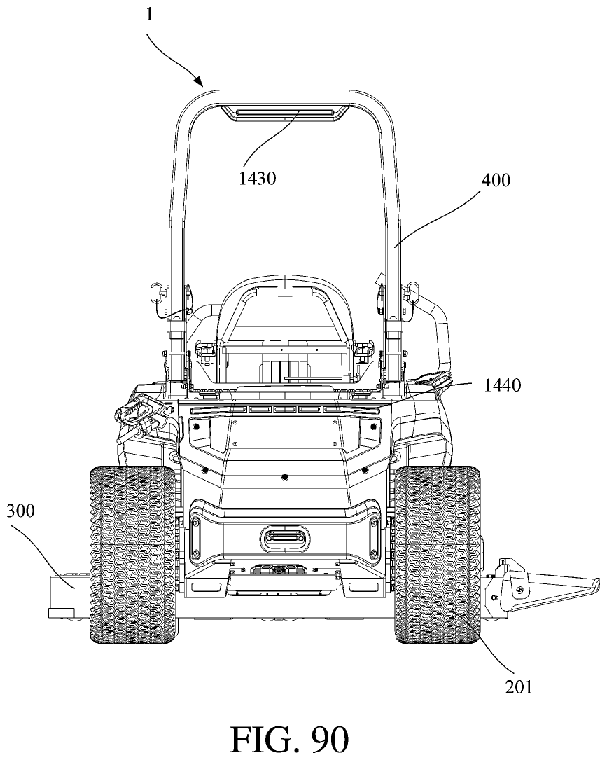

Please refer to FIG. 90. In an embodiment of the disclosure, the tail light 1440 is a red light, the tail light 1440 includes a tail light cover and a tail light bead arranged inside the tail light cover, and the tail light cover and the lamp bead of the tail light cooperate with each other to emit a red light externally. For example, the tail light cover is red, and the tail light bead is white or red.

Please refer to FIG. 89. In an embodiment of the disclosure, the mower 1 is the riding mower. The machine body 10 further includes the casing arranged on the frame 100. The riding mower is provided with the anti-roll frame 400 and the driving seat 500. The headlight 1410 is a long strip-shaped light bar, and the light bar is arranged at the casing below the driving seat 500 and is located on a side wall facing forward. The side light 1420 is arranged on the casing, located at the two sides of the driving seat 500 respectively and faces forward. The two side lights are symmetrical, each side light 1420 includes a first light bar 1421 and a second light bar 1422, and the first light bar 1421 and the second light bar 1422 intersect with each other and are smoothly transitioned. An intersection of the first light bar and the second light bar is conducive to setting a lighting method of the side light, such as a lighting sequence, a quantity or a flashing mode of the first light bar 1421 and the second light bar 1422. The dome light 1430 is arranged at a top of the anti-roll frame 400 and is located at a lower surface of the top. The tail light 1440 is arranged at the tail of the casing. The tail light is strip-shaped, laid from a tail end of a side of the casing, and extends to a tail end of the other side of the casing through a rear end of the tail of the casing. Therefore, a light of the tail light may be seen at a rear left, right and directly behind the casing.

In an embodiment of the disclosure, the state of the mower 1 include a charging state, a charging completion state, a low power state, a light on state, or a light off state.

In an embodiment of the disclosure, the state of the mower 1 further includes a plurality of fault states. The fault state includes a fault device and a number of faults. For example, a right driving controller has two faults, a left blade controller has two faults, etc.

In an embodiment of the disclosure, the mower 1 further includes the light group 1400. The light group 1400 will be lit up according to the preset lighting method under a control of the controller. The lighting method of the light group 1400 corresponds to the state of the mower 1 one-to-one. The light group 1400 is arranged on the machine body 10, so a lighting of the light group 1400 may be viewed from a long distance. And the lighting mode of the light group 1400 corresponds to the state of the mower 1 one-to-one, so a current state of the mower 1 may be known by viewing a light form of the light group 1400 from the long distance.

In an embodiment, the walking mechanism 200 includes the front wheel assembly 210, the rear wheel assembly 220, a driving device 700, the operating device 230 and so on. In an embodiment, the front wheel assembly 210 is the universal wheel for a convenience of the steering. The driving device 700 is connected with the rear wheel assembly 220. The operating device 230 controls the driving assembly to drive the rear wheel to rotate, thereby realizing the movement of the mower. When need to steer, a speed of two rear wheels is regulated by the operating device 230, and there is a certain speed difference between the two rear wheels, thereby driving the mower to steer. A driving mechanism is connected with the rear wheel assembly 220, which improves a moving performance of the mower and meets needs of multi-working conditions. It should be noted that, mounting positions of the operating rod of the operating device 230 are different according to different models of mowers. For the riding mower, the operating rod is mounted at the front end of the driving seat 500, so as to facilitate an operation of personnel. A specific mounting mode, position, etc. are selected according to needs, which is no limited in the disclosure.

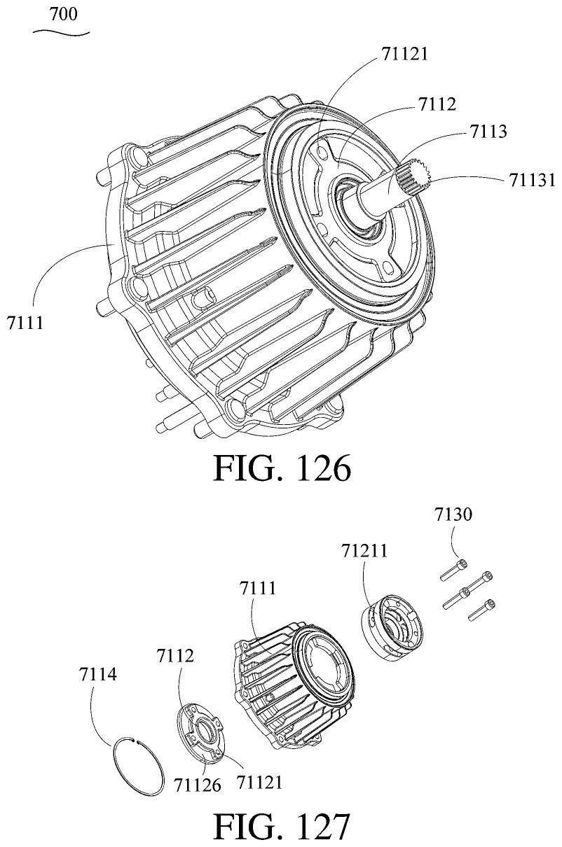

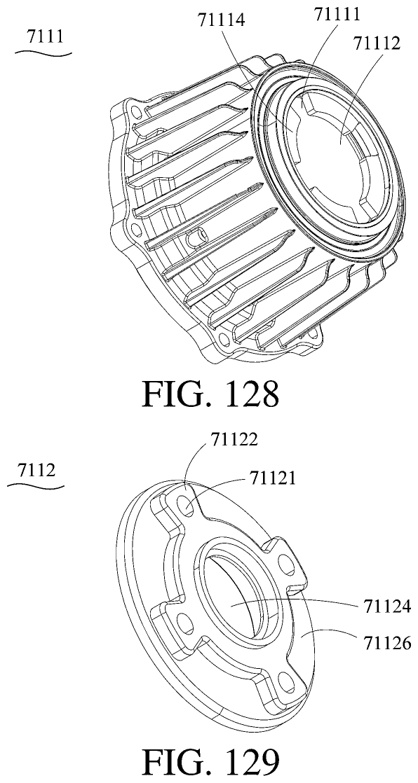

Please refer to FIG. 126 through FIG. 129. In an embodiment of the mower, the driving device 700 includes a driving motor 7110. The driving motor 7110 includes a motor casing 7111 and a driving motor winding mounted in the motor casing 7111. The driving motor winding includes a stator winding (not labeled) and a rotor winding (not labeled). A structure and a mounting mode of the stator winding and the rotor winding may be found in all conventional stator windings or rotor winding types. In this embodiment, the stator winding is fixedly mounted in the motor casing 7111, and the rotor winding is rotatably mounted in the motor casing 7111, and can be matched with the stator winding to convert electrical energy into rotating mechanical energy of the rotor winding. One end of the rotor winding is provided with a first torque output end 7113. At least one reinforcing connecting body 7112 is arranged on the motor casing 7111. The motor casing 7111 and the reinforcing connecting body 7112 are made of different materials respectively, and a material strength of the reinforcing connecting body 7112 is greater than that of the motor casing 7111. The reinforcing connecting body 7112 is provided with a threaded hole 71121 for a threaded connection with the reducer 120. When the driving motor 7110 needs to be connected with the reducer 120, a small end of a connecting bolt 7130 may pass through a bolt through hole on the fixing base 71211 of the reducer 120 after a mounting of the driving motor 7110 assembly is completed, and then be threaded with the threaded hole 71121 on the reinforcing connecting body 7112, so that the fixing base 71211 is connected and fixed with the motor casing 7111. Since the bolt in the disclosure may be threaded with the connecting body from an outside of the motor casing 7111, it may be connected with the fixing base 71211 of the reducer 120 after the mounting of the entire driving motor 7110 is completed, so that an assembly process of the driving motor 7110 and an assembly process of the reducer 120 may be completed independently. Moreover, there is no threaded connection between the connecting bolt 7130 and the fixing base 71211 of the reducer 120 in the disclosure, so a material of the fixing base 71211 of the reducer 120 may be flexibly selected according to the design needs without a material of relatively high connection strength. For example, it may be a plastic material such as PA6 and POM with a weak connection strength.

A mounting mode of the reinforcing connecting body 7112 on the motor casing 7111 in the disclosure may not be limited, including but not limited to modes such as embedded casting, detachable fixing, bonding, welding, etc. There is also no limit to a number of reinforcing connecting bodies 7112, which may be one, two, or more, and following examples of various forms and quantities of reinforcing connecting bodies 7112 are illustrated.

Please refer to FIG. 126 through FIG. 129. In an embodiment of the driving motor 7110, only one reinforcing connecting body 7112 is arranged on the motor casing 7111. The reinforcing connecting body 7112 is a stopping disk, and the motor casing 7111 is provided with a stopping disk mounting hole 71112 matched with an outer diameter of the stopping disk. A blocking edge 71126 is arranged on the stopping disk, and a shaft hole 71124 for a core shaft of the first torque output end 7113 to pass through is arranged in a middle of the stopping plate. The stopping disc is clamped in the stopping disc mounting hole 71112. A first side of the blocking edge 71126 is in contact with a block 71114 in the motor casing 7111 and is positioned, and a second side of the blocking edge 71126 is detachably fixed along an axial direction through an elastic blocking ring 114 that is clamped on the motor casing 7111. The reinforcing connecting body 7112 is provided with at least two threaded holes 71121 for a threaded connection with a connecting component of the reducer 120. A number of threaded holes 71121 is determined according to a number of the connecting bolts 7130 between the reducer 120 and the motor casing 7111. For example, when there are two connecting bolts 7130, the number of threaded holes 71121 are two correspondingly. In this embodiment, there are four connecting bolts 7130. An outer contour of the fixing base 71211 is approximately cylindrical. The fixing base 71211 is provided with four bolt through holes matched with the connecting bolts 7130. Four threaded holes 71121 are arranged on the stopping disc, positions of the four threaded holes 71121 correspond to positions of the four bolt through holes, and small ends of the four connecting bolts 7130 are threaded with the four threaded holes 71121 by passing through the four bolt through holes respectively. As long as a stable connection between the fixing base 71211 and the motor casing 7111 can be realized, the position and an arrangement of connecting through holes are not limited. In this embodiment, the four bolt through holes are evenly distributed along a same circumference, so that a stress of the four connecting bolts 7130 will be more uniform.

Please refer to FIG. 126 through FIG. 129. In an embodiment of the disclosure, a first circumferential stopping structure (not labeled) is arranged between the stopping disc and the motor casing 7111. Although a circumferential stop of the stopping disc relative to the motor casing 7111 may also be realized through a matching of an outer contour of the stopping disc and a contour of the stopping disc mounting hole 71112, such as setting a non-rotary profile that cannot rotate relatively, in some embodiments, the first circumferential stop structure includes a plurality of first protruding parts 71122 and a plurality of first concave parts 71111 corresponding to the plurality of first protruding parts 71122. The plurality of first protruding parts 71122 are arranged on one of the reinforcing connecting body 7112 and/or the motor casing 7111, and the plurality of first concave parts 71111 are correspondingly arranged on the other one of the reinforcing connecting body 7112 and/or the motor casing 7111. In this embodiment, the first protruding part 71122 is arranged on the stopping disk, and the first concave part 71111 is arranged on the motor casing 7111. A shape and a position of the first protruding part 71122 on the stopping disc correspond to a shape and a position of the first concave part 71111 on the motor casing 7111. The first protruding part 71122 is clamped into the first concave part 71111 to stop it in the circumferential direction, and a shearing force may be evenly distributed to the motor casing 7111 by arranging the first protruding part 71122 and the first concave part 71111 with a larger contact area, which may avoid a damage to a weaker motor casing 7111. In another embodiment of the driving motor of the disclosure, the first concave part 71111 may also be arranged on the stopping disk, and the first protruding part 71122 is arranged on the motor casing 7111. The shape and the position of the first concave part 71111 on the stopping disc correspond to the shape and the position of the first protruding part 71122 on the motor casing 7111, and the first protruding part 71122 is clamped into the first concave part 71111. In a third embodiment of the driving motor of the disclosure, the plurality of the first concave parts 71111 may also be arranged on the stopping disk and the motor casing 7111 respectively, and the plurality of first protruding parts 71122 is correspondingly arranged on the motor casing 7111 and the stopping disc 7111 respectively. The first concave parts 71111 and the first protruding part 71122 on the stopping disc respectively correspond to and are clamped with the first protruding parts 71122 and a second concave part on the motor casing 7111.

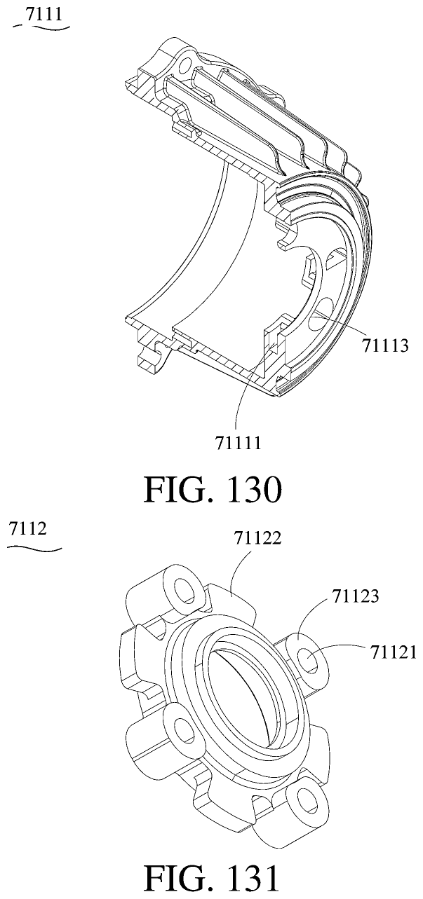

Please refer to FIG. 130 through FIG. 131. In another embodiment of the driving motor 7110 of the disclosure, there are also only one reinforcing connecting body 7112 arranged on the motor casing 7111. The reinforcing connecting body 7112 is embedded and cast in the motor casing 7111. A periphery of the reinforcing connecting body 7112 is fixedly connected with four connecting sleeves 71123, the four connecting sleeves 71123 are respectively provided with the threaded holes 71121, and the threaded holes 71121 on the four connecting sleeves 71123 are used for threaded connections with the corresponding connecting bolts 7130. It should be noted that, the number of threaded holes 71121 is equal to the number of the connecting bolts 7130 between the reducer 120 and the motor casing 7111, but should be at least two according to connection needs. The fixing base 71211 is provided with four bolt through holes matched with the connecting bolts 7130. The small ends of the four connecting bolts 7130 are threaded with the four threaded holes 71121 by passing through the four bolt through holes respectively.

Please refer to FIG. 130 through FIG. 131. Although the circumferential stop between the reinforcing connecting body 7112 and the motor casing 7111 may also be realized through an embedded casting, the first circumferential stopping structure is also arranged between the reinforcing connecting body 7112 and the motor casing 7111 considering a stability of an embedded fixation. As long as a circumferential relative stopping can be realized, a specific structure of the first circumferential stopping structure is not limited. For example, the reinforcing connecting body 7112 is set into a non-rotating outer contour, so that a corresponding matching concave part and filling protrusions are formed on the subsequently motor casing 7111 when embedded casting, and the more stable and reliable circumferential stopping and fixed connection of the reinforcing connecting body 7112 relative to the motor casing 7111 are realized. In some embodiments, the first circumferential stopping structure includes the plurality of first protruding parts 71122 and the plurality of first concave parts 71111 corresponding to the plurality of first protruding parts 71122. The first protruding parts 71122 are arranged on one of the reinforcing connecting body 7112 and/or the motor casing 7111, and the plurality of first concave parts 71122 is correspondingly arranged on the other one of the reinforcing connecting body 7112 and/or the motor casing 7111. In this embodiment, the first protruding part 71122 is arranged on the reinforcing connecting body 7112, and the first concave part 71111 is arranged on the motor casing 7111. The shape and the position of the first protruding part 71122 on the reinforcing connecting body 7112 correspond to the shape and the position of the first concave part 71111 on the motor casing 7111. When casting, a formed reinforcing connecting body 7112 is put into a mold of the motor casing 7111, and when the motor casing 7111 is cast, metal melt of the motor casing 7111 fills other cavities around the reinforcing connecting body 7112, so as to form the concave parts matched with the first protruding parts 71122 and the connecting sleeves 71123.

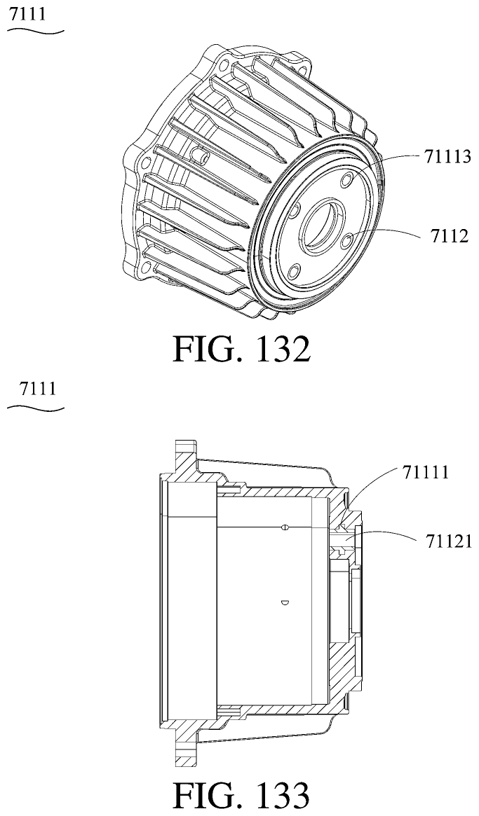

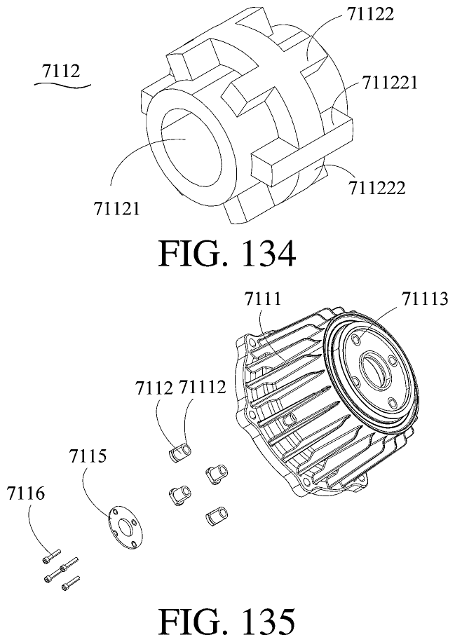

Please refer to FIG. 132 through FIG. 134. In an embodiment of the driving motor 7110 of the disclosure, the motor casing 7111 is provided with at least two reinforcing connecting bodies 7112, each reinforcing connecting body 7112 is an independent connecting sleeve, and each reinforcing connecting body 7112 is provided with the threaded holes 71121 for the threaded connection with the connecting components of the reducer 120. All the reinforcing connecting bodies 7112 are embedded and cast at corresponding positions in the motor casing 7111 and are used for the threaded connection with the connecting bolt 7130 of the reducer 120. It should be noted that, the number of reinforcing connecting bodies 7112 is equal to the number of the connecting bolts 7130 between the reducer 120 and the motor casing 7111, and should be at least two according to connection needs. Considering a stability of a connection, in this embodiment, the motor casing 7111 includes four independent reinforcing connecting bodies 7112. The fixing base 71211 is provided with four bolt through holes matched with the connecting bolts 7130. The small ends of the four connecting bolts 7130 are threaded with the threaded holes 71121 of the reinforcing connecting bodies 7112 by passing through the four bolt through holes respectively.

Please refer to FIG. 132 through FIG. 134. Although the circumferential stop between the reinforcing connecting body 7112 and the motor casing 7111 may also be realized through an embedded casting, the first circumferential stopping structure is arranged between the reinforcing connecting body 7112 and the motor casing 7111 considering a stability of an embedded fixation. As long as the circumferential relative stopping can be realized, the specific structure of the first circumferential stopping structure is not limited. For example, the reinforcing connecting body 7112 is set into the non-rotating outer contour, so that the corresponding matching concave part and filling protrusions are formed on the subsequently motor casing 7111 when embedded casting, and the more stable and reliable circumferential stopping and fixed connection of the reinforcing connecting body 7112 relative to the motor casing 7111 are realized. In some embodiments, the first circumferential stopping structure includes the plurality of first protruding parts 71122 and the plurality of first concave parts 71111 corresponding to the plurality of first protruding parts 71122. The first protruding parts 71122 are arranged on one of the reinforcing connecting body 7112 and/or the motor casing 7111, and the plurality of first concave parts 71111 is correspondingly arranged on the other one of the reinforcing connecting body 7112 and/or the motor casing 7111. In this embodiment, the first protruding part 71122 is arranged on the reinforcing connecting body 7112. The first protruding part 71122 includes an annular protrusion 711222 and a plurality of axial protrusions 711221, the plurality of the axial protrusions 711221 is parallel to each other and extends along an axial direction of the reinforcing connecting body 7112. The plurality of axial protrusions 711221 is uniformly distributed on a circumference of the reinforcing connecting body 7112. The annular protrusions 711222 is arranged in a middle part of the reinforcing connecting body 7112, surrounds an outer circle of the reinforcing connecting body 7112 and connects each axial protrusions. When casting, the formed reinforcing connecting body 7112 is put into the mold of the motor casing 7111. When the motor casing 7111 is cast, the metal melt of the motor casing 7111 fills cavities around the axial protrusion and the annular protrusion 711222, so as to form the concave parts that matches the axial protrusion and the annular protrusion 711222. Of course, those skilled in the art may understand that if a volume and a strength of the reinforcing connecting body 7112 are not considered, a concave part may also be arranged on the reinforcing connecting body 7112 so that the metal melt of the motor casing 7111 fills the concave part, thereby forming a protruding part of the motor casing. Alternatively, concave parts and protruding parts are respectively arranged on the reinforcing connecting body 7112, so that the metal melt of the motor casing 7111 fills the cavities around the concave parts and the protruding parts, so as to form the protruding parts of the motor casing and the concave parts of the motor casing correspondingly.

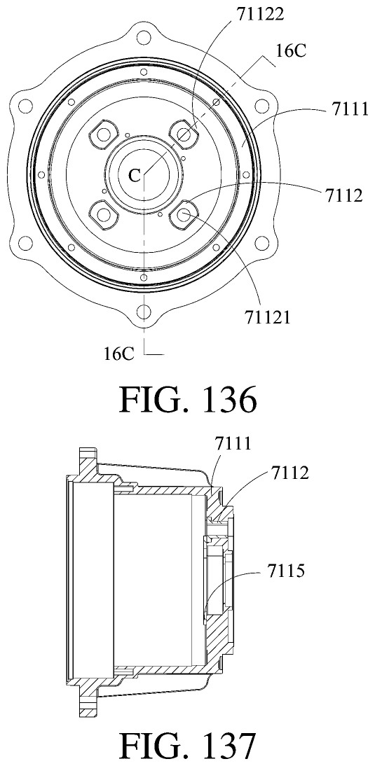

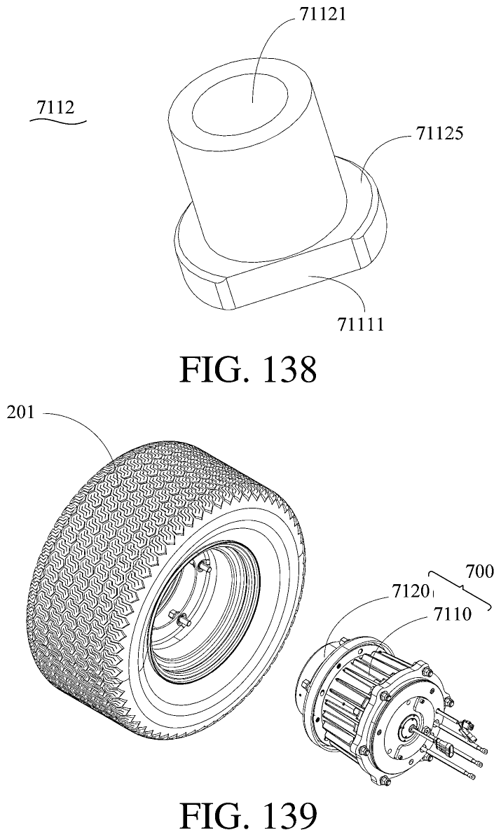

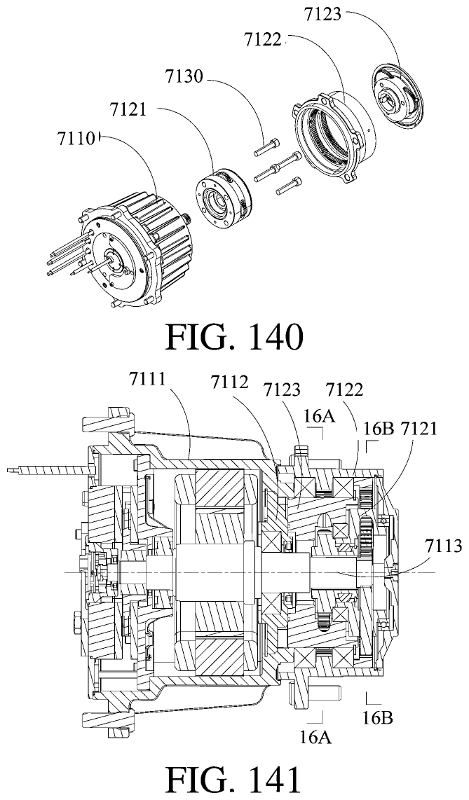

Please refer to FIG. 135 through FIG. 138. In another embodiment of the driving motor 7110 of the disclosure, the motor casing 7111 is provided with at least two reinforcing connecting bodies 71122, both of the reinforcing connecting bodies 7112 are the independent connecting sleeves, and each reinforcing connecting body 7112 is provided with the threaded holes 71121 for the threaded connection with connecting components of the reducer 120. One end of the reinforcing connecting body 7112 deviating from the reducer 120 is provided with a positioning boss 71125, and a connecting sleeve mounting through hole 71113 is arranged on the motor casing 7111. The reinforcing connecting body 7112 is mounted in the connecting sleeve mounting through hole 7113 from an inner cavity of the motor casing 7111, and one side of the positioning boss 71125 towards the reducer 120 is abutted against an inner wall of the motor casing 7111 to be positioned along the axial direction. A compressing plate 115 is arranged on one side of the positioning boss 71125 of all the reinforcing connecting body 7112 that deviates from the reducer 120, and the compressing plate 115 is connected with the motor casing 7111 through a compressing bolt 116, so that all the reinforcing connecting bodies 7112 are detachably press-mounted at corresponding positions in the motor casing 7111 and are respectively used for the threaded connection with different connecting bolts 7130. It should be noted that, the number of reinforcing connecting bodies 7112 is equal to the number of the connecting bolts 7130 between the reducer 120 and the motor casing 7111, and should be at least two according to connection needs. Considering the stability of the connection, in this embodiment, the motor casing 7111 includes four independent reinforcing connecting bodies 7112. The fixing base 71211 is provided with four bolt through holes matched with the connecting bolts 7130. The small ends of the four connecting bolts 7130 are threaded with the threaded holes 71121 of the reinforcing connecting bodies 7112 by passing through the four bolt through holes respectively.

Please refer to FIG. 135 through FIG. 138. In order to prevent the reinforcing connecting body 7112 from rotating, causing the connecting bolt 7130 to loosen, in an embodiment of the disclosure, the first circumferential stopping structure is arranged between the reinforcing connecting body 7112 and the motor casing 7111. The first circumferential stopping structure includes the plurality of first protruding parts 71122 and the plurality of first concave parts 71111 corresponding to the plurality of first protruding parts 71122. The first protruding parts 71122 are arranged on one of the reinforcing connecting body 7112 and/or the motor casing 7111, and the plurality of first concave parts 71111 is correspondingly arranged on the other one of the reinforcing connecting body 7112 and/or the motor casing 7111. In this embodiment, the first concave part 71111 is arranged on one side edge of the positioning boss 71125, and the first protruding part 71122 is arranged on the motor casing 7111. The connecting sleeve mounting through hole 71113 is provided with the first protruding part 71122 that matches a shape of the first concave part 71111. The first protruding part 71122 is matched with the first concave part 71111 to stop movement in the circumferential direction. In another embodiment of the driving motor 7110 of the disclosure, the first protruding part 71122 may also be arranged on the reinforcing connecting body 7112, and the first protruding part 71111 may be arranged on the motor casing 7111. In a fourth embodiment of the driving motor 7110 of the disclosure, the plurality of the first concave parts 71111 may also be arranged on the reinforcing connecting body 7112 and the motor casing 7111 respectively, and the plurality of first protruding parts 71122 is correspondingly arranged on the motor casing 7111 and the reinforcing connecting body 7112 respectively. The first concave part 71111 and the first protruding part 71122 on the reinforcing connecting body 7112 correspond to and are clamped with the first protruding part 71122 and the second concave part on the motor casing 7111, respectively.

In an embodiment, the driving device 700 further includes the reducer 120. In an embodiment of the driving device 700 of the disclosure, the driving motor 7110 includes the motor casing 7111 and the first torque output end 7113. The reducer 120 includes the fixing base 71211, a torque input end and a second torque output end 7122. In an embodiment, the motor casing 7111 is fixedly provided with at least one reinforcing connecting body 7112 for connection. The motor casing 7111 and the reinforcing connecting body 7112 are made of different materials respectively, and the material strength of the reinforcing connecting body 7112 is greater than that of the motor casing 7111. The reinforcing connecting body 7112 is provided with the threaded hole 71121. The fixing base 71211 of the reducer 120 is in a threaded connection with the threaded hole 71121 on a same or different reinforcing connecting bodies 7112 through a plurality of connecting components. The first torque output end 7113 drives the torque input end (which means at least one first planetary gear 71232 in a first gear system 7121) to rotate. The torque input end drives the second torque output end 7122 to rotate, and the second torque output end 7122 is connected with the walking wheel 201, and drives the walking wheel 201 to rotate.

In an embodiment of the driving device 700 of the disclosure, a second circumferential stopping structure is arranged between the fixing base 71211 and the reinforcing connecting body 7112 to prevent the fixing base 71211 and the reinforcing connecting body 71121 from rotating. The second circumferential stopping structure includes a plurality of second protrusions (not shown) and a plurality of second grooves (not shown) matched with the plurality of second protrusions. The plurality of the second protrusions is arranged on one of the reinforcing connecting body 7112 and/or the fixing base 71211, and the plurality of second grooves is correspondingly arranged on the other one of the reinforcing connecting body 7112 and/or the fixing base 71211. In this embodiment of the driving device 700 of the disclosure, a second protruding part is arranged on the reinforcing connecting body 7112, and the second concave part is arranged on the fixing base 71211. A shape and a position of the second protruding part on the reinforcing connecting body 7112 correspond to a shape and a position of the second concave part on the fixing base 71211. The second protruding part is clamped into the second concave part to stop it in the circumferential direction, and a shearing force may be evenly distributed to the fixing base 71211 and the reinforcing connecting body 7112 by arranging the second protruding part and the second concave part with a larger contact area. In another embodiment of the driving motor 700 of the disclosure, the second concave part may also be arranged on the reinforcing connecting body 7112, and the second protruding part is arranged on the fixing base 71211. The shape and the position of the second concave part on the reinforcing connecting body 7112 correspond to the shape and the position of the second protruding part on the fixing base 71211, and the second protruding part is clamped into the second concave part. In a fifth embodiment of the driving motor 700 of the disclosure, the plurality of the second concave parts may also be arranged on the reinforcing connecting body 7112 and the fixing base 71211 respectively, and the plurality of second protruding parts is correspondingly arranged on the fixing base 71211 and the reinforcing connecting body 7112 respectively. The second concave parts and the second protruding parts on the reinforcing connecting body 7112 respectively correspond to and are clamped with the second protruding part and the second concave part on the fixing base 71211, respectively.

Please refer to FIG. 126 and FIG. 127. In another embodiment of the disclosure, the second protrusion and the first protrusion are a same protrusion. The fixing base 71211 is provided with the second concave part matched with the first protrusion, and the first protrusion extends into the second concave part by passing through the first concave part on the motor casing 7111. A bolt through hole is arranged in the second concave part, and a small end of the connecting bolt 7130 penetrates through the through hole and is threaded with the threaded hole 71121 on the first protruding part 71122 extending into the second concave part. In this arrangement mode, when a torsional reaction force on the reducer 120 acts on the fixing base 71211, the second concave part on the fixing base 71211 corresponds to and is matched with the first protruding part 71122 to realize a transmission of force, which may reduce a damage to the connecting bolt 7130. At the same time, a protruding part and a concave part with a larger cross-sectional area than the connecting bolt 7130 may be selected for transmission of a shear force between the fixing base 71211 and the first protruding part 71122, and between the first protruding part 71122 and the first concave part, thereby reducing a damage to the motor casing 7111 and the fixing base 71211 and improving a durability of the product.

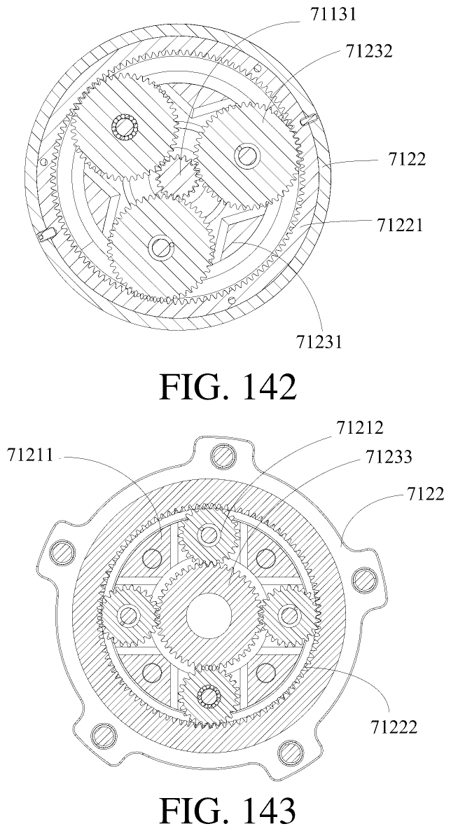

Please refer to FIG. 141 through FIG. 144. In the disclosure, as long as a set reduction ratio can be reached, and the driving motor 7110 can be fixed to realize an output of an external rotor, a type of the reducer 120 is not limited. In an embodiment of the driving device 700 in the disclosure, the reducer 120 is a planetary gear reducer 120. The reducer 120 includes the first gear system 7121, a second gear system 7123 and a rotating bracket (second torque output end 7122). The first gear system 7121 includes a first sun gear 71131, a plurality of first planetary gears 71232, a first planetary gear bracket 71231 and a first inner tooth ring 71221. The second gear system 7123 includes a second sun gear 71233, a plurality of second planetary gear 71212, a second planetary gear bracket (which means the fixing base 71211) and a second inner tooth ring 71222. The core shaft of the first torque output end 7113 is arranged at a center of the walking wheel 201 along the axial direction of the walking wheel 201, the core shaft is provided with the first sun gear 71131, and the first sun gear 71131 is coaxially fixed with the core shaft. The first planetary gear bracket 71231 is rotatably connected with the first torque output end 7113, and the first planetary gear bracket 71231 is provided with the first planetary gear 71232 and the second sun gear 71233. There is a plurality of first planetary gears 71232, and the first planetary gears 71232 are rotatably connected with the first planetary gear bracket 71231. The first planetary gear 71232 is meshed with the first sun gear 71131, and the second sun gear 71233 is coaxially connected with the first planetary gear bracket 71231. The second planetary gear bracket (which means the fixing base 71211) is fixed with the reinforcing connecting body 7112 on the motor casing 7111 through the connecting bolt 7130, a plurality of second planetary gears 71212 is rotatably arranged on the bracket of the second planetary gear 71212, and the second planetary gear 71212 is meshed with the second sun gear 71233. The rotating bracket (the second torque output end 7122) is fixedly connected with a hub of the walking wheel 201, and the first inner tooth ring 71221 and the second inner tooth ring 71222 are coaxially arranged inside the rotating bracket at intervals. The first inner tooth ring 71221 and the second inner tooth ring 71222 may be connected with the rotating bracket by interference fit or fixing pins, bolts and so on, so that the rotating bracket is driven to rotate, the first inner tooth ring 71221 is meshed with the first planetary gear 71232, and the second inner tooth ring 71222 is meshed with the second planetary gear 71212. The disclosure is provided with two groups of planetary gear mechanisms. The inner tooth rings of the two groups of planetary gear mechanisms (which means the first inner tooth ring 71221 and the second inner tooth ring 71222) are all fixed with the rotating bracket, so that they can be driven from two ends of the rotating bracket, and a power distribution is more uniform. In addition, a differential matching between the two groups of planetary gears realizes a two-stage deceleration from the driving motor 7110 to the walking wheel 201, a transmission ratio is larger, and a torque is increased more significantly.

In an embodiment of the disclosure, the driving device 700 is provided with a sealing structure at a connection of the driving motor and the reducer to realize a sealing along a circumferential surface and/or a radial surface of the connection thereof, so as to solve the technical problem that the walking drive mechanism of the prior art is prone to foreign body impurities to enter and cause the reducer to fail because there is a gap between the motor and the reducer in a harsh environment.

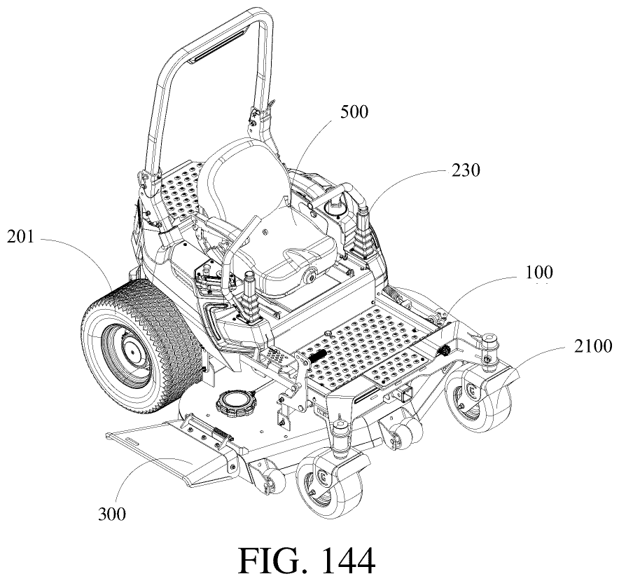

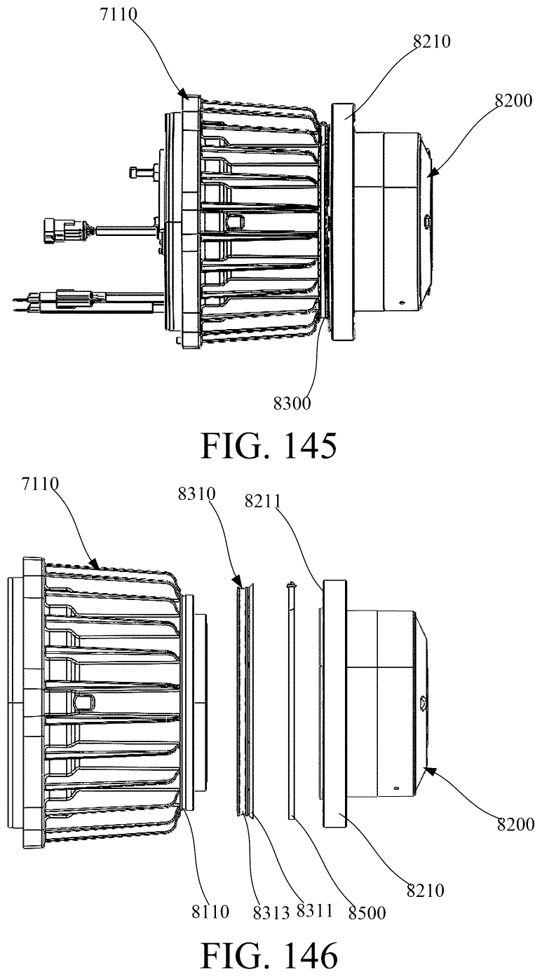

Please refer to FIG. 145 through FIG. 156. The driving device 700 includes the driving motor 7110, the reducer 8200 and the sealing structure. In an embodiment, the reducer 8200 is coaxially connected with the driving motor 7110, the walking wheel 201 is coaxially connected with the reducer 8200, and the driving motor 7110 drives the walking wheel 201 to rotate through the reducer 8200. The sealing structure is arranged at a coaxial connection position of the reducer 8200 and the driving motor 7110, and a sealing fit is formed between the driving motor 7110 and the reducer 8200. In an embodiment, in order to increase a circumferential sealing area of the sealing structure, the sealing structure extends radially or circumferentially from an axial overlapping position of the driving motor 7110 and the reducer 8200, and the sealing fit is formed on a circumferential surface and/or a radial surface at the axial overlapping position, so as to realize that foreign matters are prevented from entering a rotating gap between the reducer 8200 and the driving motor 7110.

Please refer to FIG. 145. In an embodiment of the disclosure, the driving motor 7110 is coaxially arranged with the reducer 8200 and is fixed by the bolts. A first sealing component 8300 is coaxially sleeved on the driving motor 7110 and/or the reducer 8200, so that it is matched with the driving motor 7110 and/or the reducer 8200 at a connection between the driving motor 7110 and/or the reducer 8200 to form a sealing. For example, in an embodiment, the first sealing component 8300 is coaxially sleeved along the circumferential direction at the connection of the driving motor 7110 and the reducer 8200, and at the same time matched with the driving motor 7110 and the reducer 8200 at an inner ring and/or an outer ring of the first sealing component 8300 to form a seal between the driving motor 7110 and the reducer 8200. In another embodiment, the first sealing component 8300 is coaxial sleeved on one side of the reducer 8200 towards a housing of the driving motor 7110, and the first sealing component 8300 is fixedly arranged on the outer tooth ring 8210 of the reducer 8200, and is relatively matched with an end face of the housing of the driving motor 7110 on one side towards the driving motor 7110 to form the sealing. In a third embodiment, the first sealing component 8300 is coaxial sleeved is on one side of the housing of the driving motor 7110 towards the reducer 8200, and the first sealing component 8300 is fixedly arranged on a circumferential periphery of the housing of the driving motor 7110, and is arranged relative to an outer tooth ring end surface 8211 of the reducer 8200 on one side towards the reducer 8200. There is a gap between the first sealing component 8300 and the outer tooth ring end surface 8211, and one surface of the first sealing component 8300 towards the reducer 8200 is matched with the outer tooth ring end surface 8211 on a radial plane to form the sealing structure to realize a sealing protection function of an internal structure of the reducer 8200 and the driving motor 7110 without affecting a relative rotation of the reducer 8200 and the driving motor 7110.

In an embodiment, the reducer 8200 mentioned above is a planetary reducer 8200, and a characteristic of planetary reducer 8200 can generate a larger reduction transmission ratio with a smaller axial size, and its axial length may even be less than a width of the walking wheel 201, so the reducer 8200 can be completely hidden in the walking wheel 201, which then increases a utilization rate of a lateral space.

In an embodiment, a gap distance between the first sealing component 8300 and the outer tooth ring end surface 8211 is from 1 mm to 3 mm, and this gap distance may be 1 mm, 2 mm or 3 mm for example.

Please refer to FIG. 146 through FIG. 148. In an embodiment of the disclosure, the driving motor 7110 is coaxially arranged with the reducer 8200 and is fixed by the bolts. The first sealing component 8300 is coaxially sleeved on the housing of one side of the driving motor 7110 towards the reducer 8200, and the first sealing component 8300 is fixedly arranged on the circumferential periphery of the housing of the driving motor 7110. The first sealing component 8300 does not rotate axially on the housing of the driving motor 7110, and the first sealing component 8300 is arranged relative to the outer tooth ring end surface 8211 of the reducer 8200 on a plane facing one side of the reducer 8200.

Please refer to FIG. 146 through FIG. 148. In this embodiment, the first sealing component 8300 is a first sealing ring 8310. The first sealing ring 8310 is sleeved and fixed on a peripheral of the housing of the driving motor 7110, and the first sealing ring 8310 is provided with a first elastic structure 8311. The first elastic structure 8311 protrudes and is arranged on a surface of the first sealing component 8300 towards the reducer 8200, and the first elastic structure 8311 is extended in a closed loop along the circumferential direction on an end face of the first sealing component 8300. When the reducer 8200 is coaxially assembled to the driving motor 7110, a first end of the first sealing ring 8310 is fixed by a sleeve to achieve the sealing structure with the driving motor 7110, and the first elastic structure 8311 protruding at a second end of the first sealing ring 8310 is interference abutted on the outer tooth ring end surface 8211 of the reducer 8200 (the outer tooth ring end surface 8211 is a radial plane that is axially connected with the reducer 8200 relative to the driving motor 7110). An end of the first elastic structure 8311 abuts and fits on the outer tooth ring end surface 8211 along the radial direction, and prevent the external foreign matter from entering from an abutting position through a friction matching with the outer tooth ring end surface 8211 when the outer tooth ring 8210 rotates, so as to form the sealing structure that does not affect an axial rotation of the reducer 8200.

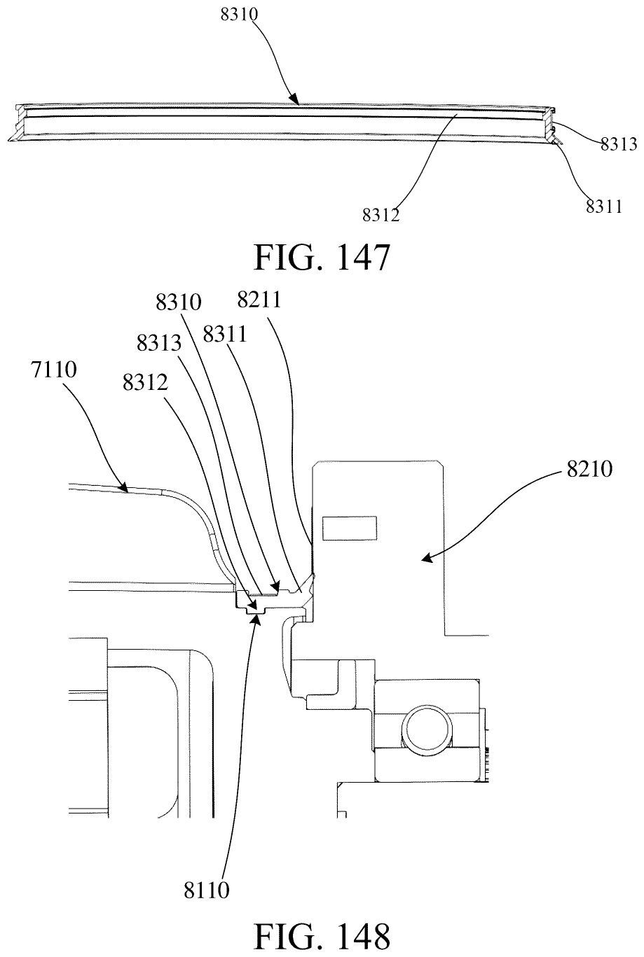

Please refer to FIG. 147 and FIG. 148. In an embodiment of the disclosure, the end of the first elastic structure 8311 is set to a double-lip structure. When the double-lip structure at the end of the first elastic structure 8311 is interference abutted on the outer tooth ring end surface 8211 of the reducer 8200, the double-lip structure may form two rings of sealing structures at different radial positions on the outer tooth ring end surface 8211, whereby the two rings of the sealing structure can form two block parts at a connection position of the driving motor 7110 and the reducer 8200, so as to enhance a sealing effect between the first sealing ring 8310 and the reducer 8200.

Please refer to FIG. 147 and FIG. 148. In an embodiment of the disclosure, an inner ring of the first sealing ring 8310 is provided with a first protrusion 8312. The first protrusion 8312 is arranged along a circumferential inner edge of the first sealing ring 8310, and a circumferential outer edge of a housing at a side of the driving motor 7110 facing towards the reducer 8200 is provided with a first groove 8110 matched with the first protrusion 8312. When the first sealing ring 8310 is sleeved on the housing of the driving motor 7110, the first protrusion 8312 on the inner ring of the first sealing ring 8310 is clamped and fixed in the first groove 8110 around an outer edge of the housing of the driving motor 7110. The housing of the driving motor 7110 clamps the first protrusion 8312 with elastic deformation characteristics in the first groove 8110, so that the first sealing ring 8310 is fixed on the housing of the driving motor 7110.

Please refer to FIG. 146. In an embodiment of the disclosure, an outer ring of the first sealing ring 8310 is further provided with a clamping hood 8500. The clamping hood 8500 is sleeved on the outer ring of the first sealing ring 8310, and the clamping hood 8500 limits the first sealing ring 8310 in the circumferential direction, so that the first sealing ring 8310 is sleeved on the housing of the driving motor 7110. In an embodiment, a circumferential surface of the outer ring of the first sealing ring 8310 is provided with a second groove 8313 concave inward. A shape of the second groove 8313 is matched with the clamping hood 8500, and a flange extending inward is arranged at two ends at a top of a groove body. The clamping hood 8500 is embedded in the second groove 8313 along the circumferential direction of the first sealing ring 8310, and is blocked by the top flange of the second groove 8313 and then fixed in the groove body.

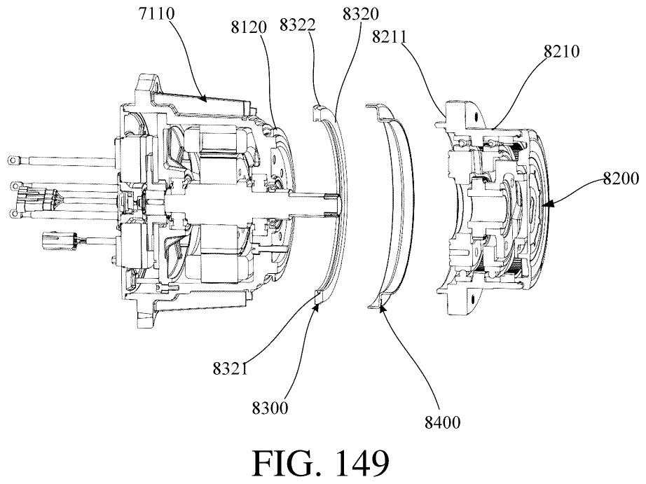

Please refer to FIG. 149 through FIG. 152. In some embodiments, the driving motor 7110 is coaxially arranged with the reducer 8200 and is fixed by the bolts. The sealing structure between the driving motor 7110 and the reducer 8200 is provided with the first sealing component 8300 and the second sealing component 8400 matched with each other. In an embodiment, the first sealing component 8300 is coaxially sleeved on the housing of one side of the driving motor 7110 towards the reducer 8200, and the first sealing component 8300 is fixedly arranged on the circumferential periphery of the housing of the driving motor 7110. The first sealing component 8300 does not rotate axially on the housing of the driving motor 7110. The second sealing component 8400 is coaxially arranged on one side of the reducer 8200 towards the driving motor 7110, and the first sealing component 8300 and the second sealing component 8400 are arranged relative to each other at a radial plane at the connection position between the driving motor 7110 and the reducer 8200, and matched with each other to form the sealing.

Please refer to FIG. 149 through FIG. 152. In this embodiment, the first sealing component 8300 is a second sealing ring 8320. The second sealing ring 8320 is sleeved and fixed on the peripheral of the housing of the driving motor 7110, and an outer ring of the second sealing ring 8320 is provided with a second elastic structure 8322 along the outer edge of the circumferential direction. The second elastic structure 8322 extends in a ring along the circumferential direction of the outer ring of the second sealing ring 8320. The second sealing component 8400 is an oil sealing 8410. The oil sealing 8410 is provided with a plane, and this plane extends along the radial direction. The oil sealing 8410 is coaxially connected with the outer tooth ring 8210 of the reducer 8200 on a first side of the radial plane, and the oil sealing 8410 is provided with a lip edge 8412 on a second side of the radial plane. The lip edge 8412 is arranged along a circumferential outer edge of the radial plane of the oil sealing 8410, and the lip edge 8412 extends to a side of the driving motor 7110 at an outer edge of the circumferential direction of the oil sealing 8410. When the reducer 8200 is coaxially assembled to the driving motor 7110, the second sealing ring 8320 is sleeved on the housing of one side of the driving motor 7110 towards the reducer 8200. One end of the oil sealing 8410 is coaxially connected with the outer tooth ring 8210 of the reducer 8200, the radial plane on the oil sealing 8410 is arranged opposite to one side of the second sealing ring 8320 towards the reducer 8200, and the lip edge 8412 arranged along the outer edge of the circumferential direction of the oil sealing 8410 is located on a circumferential outward side of the second sealing ring 8320. The second elastic structure 8322 protruding on the outer ring of the second sealing ring 8320 is interference abutted with an inner wall of the lip edge 8412 of the oil sealing 8410. An end of the second elastic structure 8322 abuts against the inner wall of the lip edge 8412 along a circumferential plane. And when the outer tooth ring 8210 rotates along the axial direction, the external foreign matter is prevented from entering from a conflicting position by a friction and matching with the inner wall of the lip edge 8412 of the oil sealing 8410 along the circumferential direction, so as to form the sealing structure that does not affect the axial rotation of the reducer 8200.

Please refer to FIG. 150 through FIG. 152. In this embodiment, the sealing structure utilizes the matching between the second sealing ring 8320 and the oil sealing 8410 in the radial plane and the circumferential plane, and effectively utilizes a sealing area of a matching between the first sealing component 8300 and the second sealing component 8400 increased by a small gap distance at the connection position of the driving motor 7110 and the reducer 8200, so that the sealing effect of the sealing structure is improved.

Please refer to FIG. 149 and FIG. 152. In an embodiment of the disclosure, one end of the oil sealing 8410 connected with the reducer 8200 is provided with a tightening steel ring 8411. The tightening steel ring 8411 is arranged along a circumferential inner edge of the radial plane of the oil sealing 8410, the tightening steel ring 8411 extends outward along the axial direction, and a size of the tightening steel ring 8411 matches the outer tooth ring 8210 of the reducer 8200. The tightening steel ring 8411 of the oil sealing 8410 is sleeved on the outer tooth ring 8210 of the reducer 8200, for example, sleeved on an outer side of the outer tooth ring 8210. The oil sealing 8410 is firmly connected with the reducer 8200 through an interference fit between the tightening steel ring 8411 and the outer tooth ring 8210.

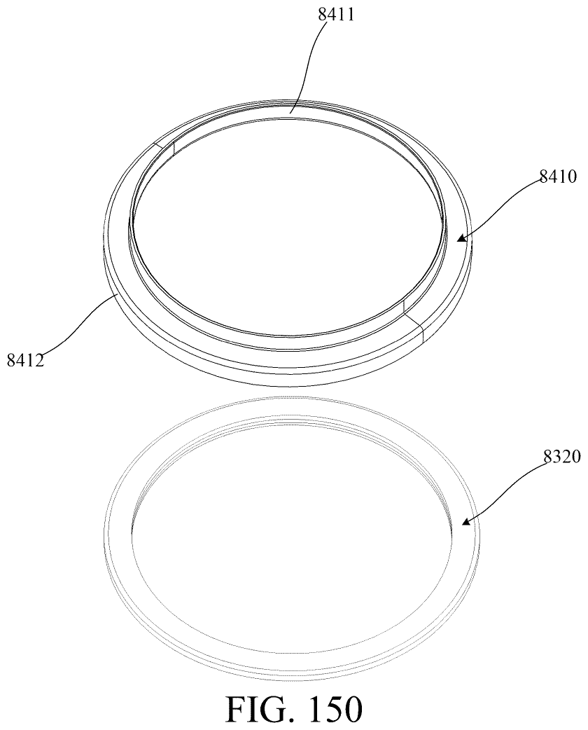

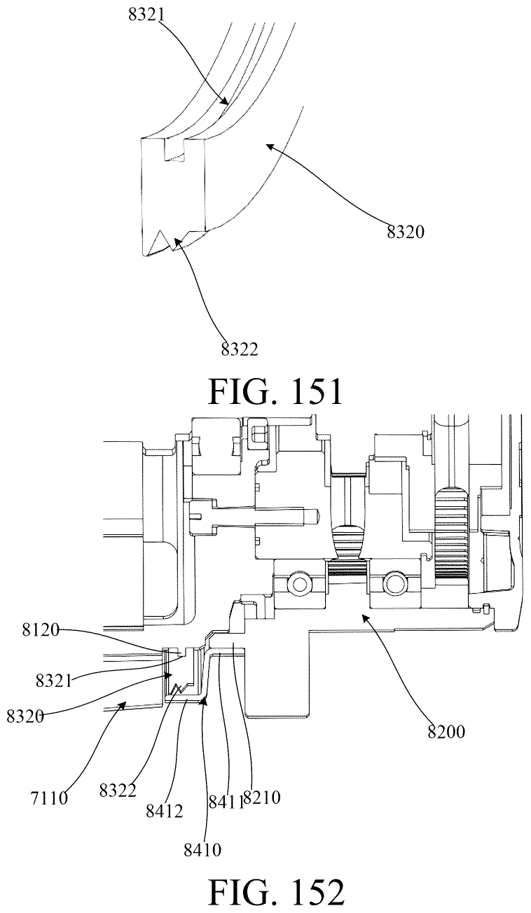

Please refer to FIG. 151 and FIG. 152. In an embodiment of the disclosure, the end of the second elastic structure 8322 is set to a double-lip structure. When the double-lip structure at the end of the second elastic structure 8322 is interference abutted on the inner wall of the lip edge 8412 of the oil sealing 8410, the double-lip structure may form two rings of sealing structures at different axial positions on the inner wall of the lip edge 8412. The two rings of the sealing structure can form two block parts at a circumferential surface of the second sealing ring 8320 opposite to the oil sealing 8410, so as to enhance a sealing effect between the second sealing ring 8320 and the oil sealing 8410.

Please refer to FIG. 151 and FIG. 152. In an embodiment of the disclosure, an inner ring of the second sealing ring 8320 is provided with a third groove 8321. The third groove 8321 is arranged along a circumferential inner edge of the second sealing ring 8320, and the circumferential outer edge of the housing at the side of the driving motor 7110 facing towards the reducer 8200 is provided with a second protrusion 8120 matched with the third groove 8321. When the second sealing ring 8320 is sleeved on the housing of the driving motor 7110, the second protrusion 8120 on the outer edge of the circumferential direction of the housing of the driving motor 7110 is clamped and fixed in the third groove 8321 on the inner ring of the second sealing ring 8320. The driving motor 7110 utilizes an interference fit between the second protrusion 8120 and the third groove 8321 to fix the second sealing ring 8320 on the housing of the driving motor 7110.

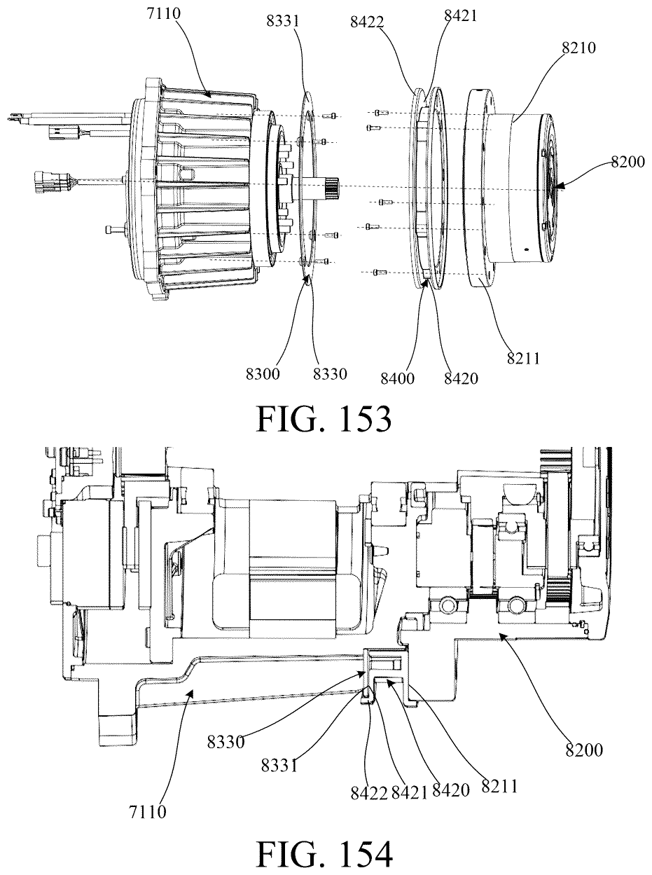

Please refer to FIG. 153 through FIG. 156. In some embodiments, the first sealing component 8300 is provided with a first deck surface 8331, and the second sealing component 8400 is provided with a second deck surface 8421. The first deck surface 8331 of the first sealing component 8300 and the second deck surface 8421 of the second sealing component 8400 are relatively arranged along the radial plane. A gap is maintained between the first deck surface 8331 and the second deck surface 8421, and the first sealing component 8300 and the second sealing component 8400 utilize the gap between the first deck surface 8331 and the second deck surface 8421 to prevent an entry of external foreign matters, so as to form the sealing structure that does not affect the axial rotation of the reducer 8200.

In an embodiment, a gap distance between the first deck surface 8331 and the second deck surface 8421 is from 1 mm to 3 mm, and this gap distance may be 1 mm, 2 mm or 3 mm for example.

Please refer to FIG. 153 and FIG. 154. In an embodiment of the disclosure, the first sealing component 8300 is an end surface pressing plate 8330. One surface of the end surface pressing plate 8330 towards the reducer 8200 is set to the first deck surface 8331. The end surface pressing plate 8330 is sleeved on one side of the housing of the driving motor 7110 towards the reducer 8200, and the end surface pressing plate 8330 is sleeved on a circumferential periphery of the housing of the driving motor 7110, and is fixedly connected with the housing of the driving motor 7110 by bolts. The second sealing component 8400 is a rotating frame 8420, and the rotating frame 8420 is fixedly connected with the outer tooth ring end surface 8211 of the reducer 8200 through the bolts. The second deck surface 8421 of the rotating frame 8420 and the first deck surface 8331 of the first sealing component 8300 are arranged relative to each other along the radial plane, and are matched with each other to form the sealing.

Please refer to FIG. 153 and FIG. 154. In an embodiment of the disclosure, the rotating frame 8420 is provided with a first flange 8422 on the second deck surface 8421, and the first flange 8422 on the second deck surface 8421 is arranged along the outer edge of the circumferential direction of the first deck surface 8331 and extends to one side of the driving motor 7110. When the driving motor 7110 and the reducer 8200 are axially connected, the first deck surface 8331 of the end surface pressing plate 8330 is arranged opposite to the second deck surface 8421 of the rotating frame 8420. The first flange 8422 arranged on the second deck surface 8421 surrounds a periphery of the end surface pressing plate 8330 along the circumferential direction, and the outer edge of circumferential direction of the end surface pressing plate 8330 is relatively matched with the first flange 8422 on the circumferential plane to form the sealing. In an embodiment, between the end surface pressing plate 8330 and the rotating frame 8420, in addition to utilizing the relative matching of the first deck surface 8331 and the second deck surface 8421 to form the sealing structure on the radial surface, the sealing structure on the circumferential surface is also formed through a relative matching of an outer edge of the end surface pressing plate 8330 and the first flange 8422 on the rotating frame 8420. The sealing structure of the circumferential surface can produce an outward centrifugal force at a gap between the end surface pressing plate 8330 and the first flanging plate 8422 to throw out the foreign matter entering the gap when the rotating frame 8420 rotates relative to the end surface pressing plate 8330 with the reducer 8200, so as to achieve an efficient sealing.

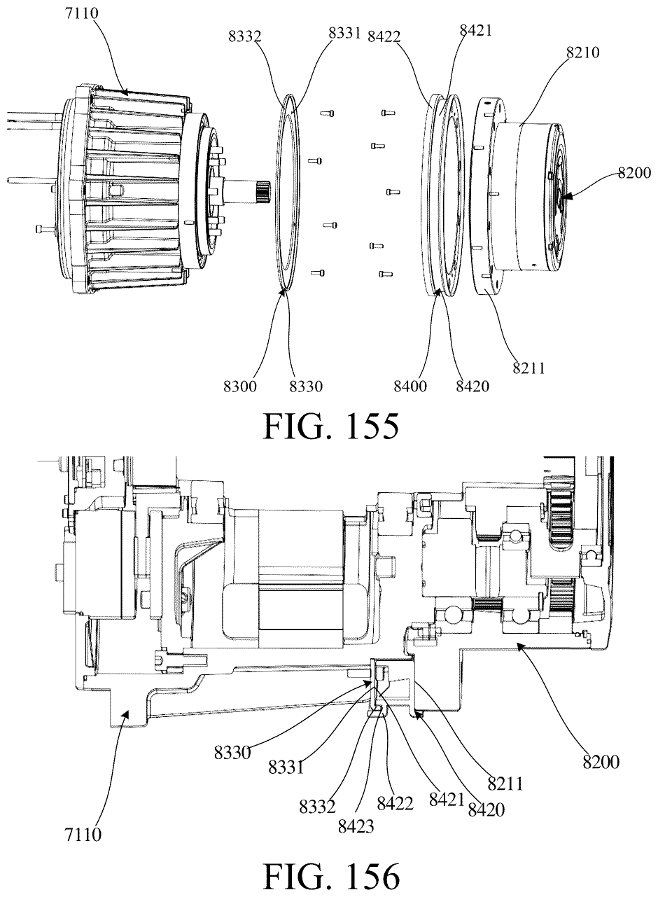

Further, please refer to FIG. 155 and FIG. 156. In an embodiment of the disclosure, the end surface pressing plate 8330 is provided with a second flange 8332 on the first deck surface 8331, and the second flange 8332 on the first deck surface 8331 is arranged along an inner edge of the circumferential direction of the second deck surface 8421 and extends to one side of the reducer 8200. The second deck surface 8421 of the rotating frame 8420 is provided with a sealing groove 8423 at a position corresponding to the second flange 8332. The sealing groove 8423 is arranged along the inner edge of the circumferential direction of the second deck surface 8421, and a shape of the sealing groove 8423 matches the second flange 8332. In an embodiment, an outer ring of the sealing groove 8423 is arranged at the first flange 8422 located at an outer edge of the second deck surface 8421, and an inner ring of the sealing groove 8423 is arranged at an inner edge of the second deck surface 8421.

Please refer to FIG. 156. When the driving motor 7110 and the reducer 8200 are axially connected, the first deck surface 8331 of the end surface pressing plate 8330 is arranged opposite to the second deck surface 8421 of the rotating frame 8420. The second flange 8332 arranged on the first deck surface 8331 is embedded in the sealing groove 8423 arranged on the second deck surface 8421, and in the sealing groove 8423, the second flange 8332 is respectively matched with inner walls of both sides of the sealing groove 8423 and a bottom of the groove to form the sealing. Under a premise of not affecting the relative rotation of the reducer 8200, the sealing structure increases a sealing length between the end surface pressing plate 8330 and the rotating frame 8420 on a plurality of radial and circumferential surfaces, which effectively improves the sealing effect of the sealing structure.

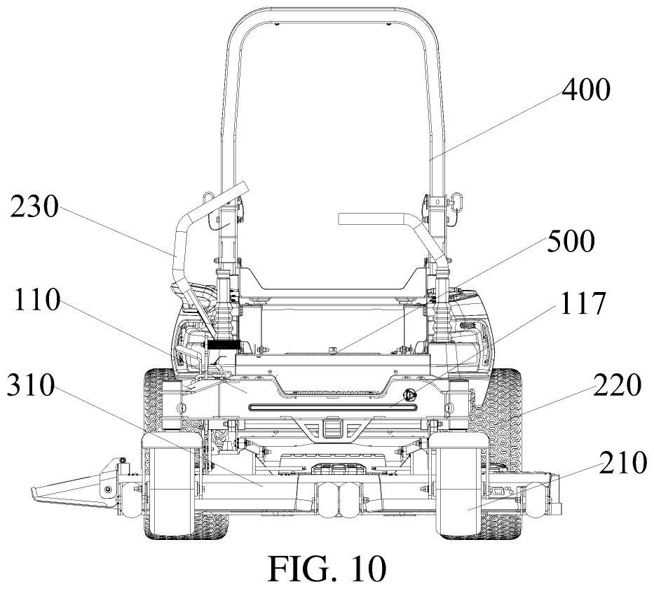

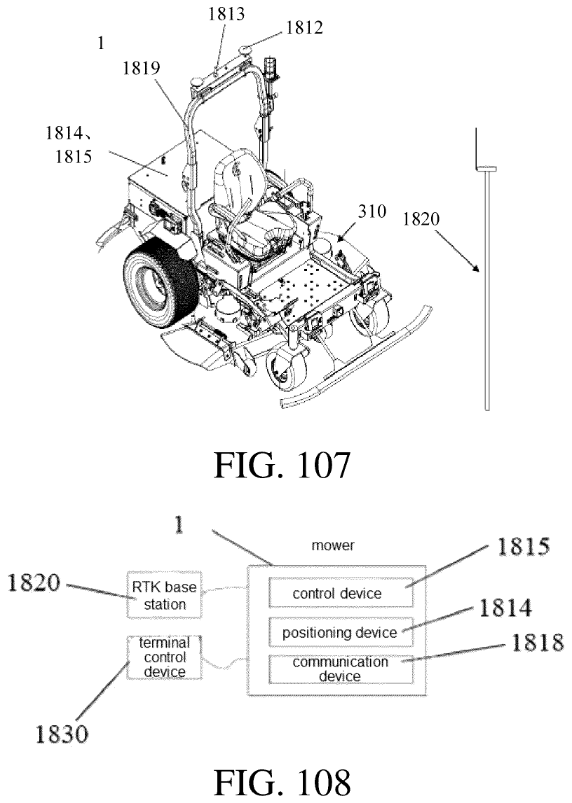

Please refer to FIG. 107 through FIG. 109. In other embodiments of the disclosure, the mower 1 further includes a standing frame 1819, and the standing frame 1819 is provided with two global navigation satellite systems (GNSS) receiving antenna 1812 and a wireless antenna 1813. The GNSS receiving antenna 1812 and the wireless antenna 1813 may also be arranged on other components or at other suitable positions of the mower 1. The mower 1 is further provided with the controller 240 and an autonomous controller 1815. The controller 240 and the autonomous controller 1815 may be arranged at any suitable position on the mower 1. An embodiment of FIG. 10 shows that the controller 240 and the autonomous controller 1815 are arranged in a box (not labeled) behind a driver's seat (not labeled) of the mower 1.

An RTK base station 1820 used in the disclosure is a portable RTK base station, which may be transported to different lawns with the mower 1, and then mounted on a fixed anchor point 20 (FIG. 110) next to the lawn to be used together with the mower 1 when the mower 1 is mapping the lawn or is mowing the lawn. The portable RTK base station 1820 wirelessly transmits differential data and a converged position (positioning) coordinates of the RTK base station itself to the mower 1, and the RTK base station 1820 may include a GNSS satellite receiver (not shown), a processing unit (not shown), a battery (not shown), a wireless signal transceiver (not shown) and other components. These components are what RTK base stations should normally include to achieve their functionality.

FIG. 108 is a schematic view of a functional module of the mower 1, a terminal control device 3 and the RTK base station of the disclosure. The mower 1 may be the mower 1 shown in FIG. 107. The RTK base station 1820 may be the portable RTK base station shown in FIG. 107, and the terminal control device 3 may be a hand-held terminal, such as an APP terminal of an iPad. The mower 1 includes the controller 240, a positioning device 14 and a communication device 1818.

In an embodiment, the controller 240 may control the mower 1 to perform operations or/and functions such as driving, map calibrating/calling/offset, and mowing operations, so as to realize an intelligent driving function of mower 1. The controller 240 may further include a map generation and management module, a trajectory planning module, and a mowing operation control module etc. The controller 240 may also be referred to as an intelligent driving controller or controller in this disclosure.

The positioning device 1814 may be the GNSS mobile station, other satellite positioning mobile, or other positioning device that may be matched with the RTK base station to realize a real-time positioning function. The positioning device 1814 further includes the GNSS receiving antenna 1812 arranged on the standing frame 1819 of the mower 1. The autonomous controller 1815 applies the differential data to correct the GNSS positioning coordinates (which means the positioning coordinates of the mower 1) and outputs them to the controller 240.

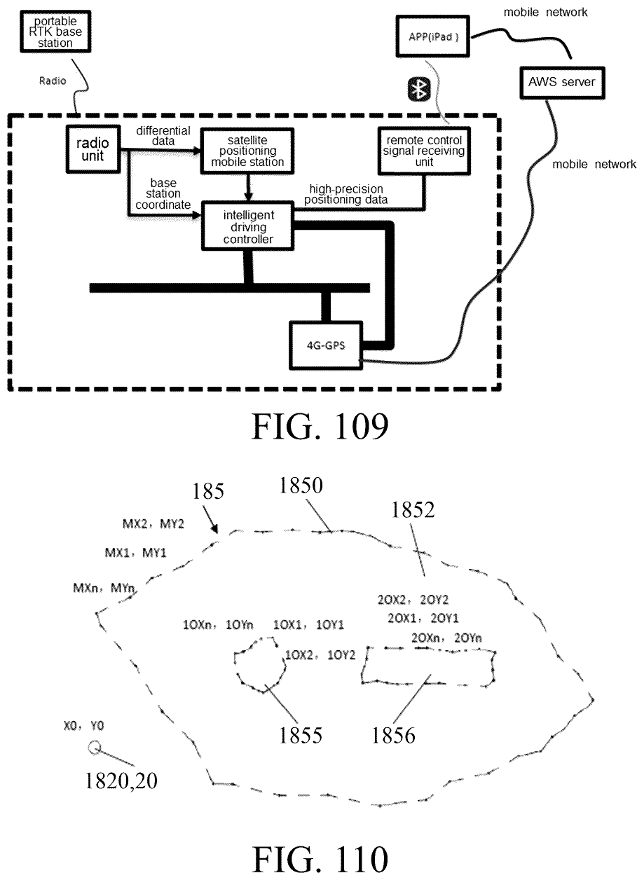

Please refer to FIG. 109. The communication device 1818 includes a radio unit 1811, which receives data/signals from the portable RTK base station 1820, including the differential data and base station coordinate data. The radio unit 1811 sends the differential data from the RTK base station 1820 to the positioning device (satellite positioning mobile station) 14, and transmits the base station coordinates from the RTK base station 1820 to the control device (intelligent driving controller) 15. The communication device 1818 may further include a remote control signal receiving unit 1817 used between the mower 1 and the hand-held terminal 1830 (e.g., an APP on the iPad), and the remote control signal receiving unit 1817 may be a Bluetooth device or other wireless communication device to receive a command signal from the hand-held terminal 1830. The communication device 1818 may further include a 4G-GPS module 1816. The mower 1 may communicate with a server (such as an AWS server) 4 through a network (such as a mobile network) through the 4G-GPS module 1816, and the server 1840 may communicate with the hand-held terminal 1830 through the network (such as the mobile network).

The hand-held terminal 1830 receives state information fed back by the mower 1, and then sends a corresponding command to the mower 1 to control it to execute the command sent. The state information fed back by the mower 1 includes a positioning state and alarm information. The positioning state of the mower 1 received by the hand-held terminal 1830 includes a high-precision positioning state and a non-high-precision positioning state. The high-precision positioning state refers to an RTK fixed solution, and the non-high-precision positioning state refers to an RTK floating-point solution. In an embodiment, the high-precision positioning state indicates that the mower 1 is in a centimeter-level positioning state. The alarm information refers to various fault states of mower 1, such as overcurrent of a blade current, overcurrent of a walking motor, a control temperature being too high, etc.

The commands sent by the hand-held terminal 1830 are: a command to continue a current state, a command to calibrate the map, a command to calibrate a non-mowing area (which means a non-working area), a command to increase the non-mowing area, a command that the map boundary demarcation is completed, a command that a calibration of the non-mowing area is completed, etc. The hand-held terminal 1830 is a medium of communication between the operator and the mower 1, and it may send commands to the mower 1 through a wireless communication way such as Bluetooth, Wi-Fi, Lora, etc.

In this disclosure, a GNSS positioning mobile station (which means the positioning device) 14 collects positioning coordinates of mower 1 in real time. When the mower performs a map calibration on the lawn to be mowed (which may be a working area) 185, the positioning device 1814 applies the differential data from the RTK base station 1820 to correct positioning coordinate data of the mower 1, and sends the corrected positioning coordinate data to controller 240. The controller 240 applies the corrected positioning coordinate data and base station coordinate data from the RTK base station 1820 to generate a calibration map of the lawn to be mowed, and sends the calibration map to a saving device for saving. When the mower 1 mows the lawn 185 to be mowed, the controller 240 compares RTK base station coordinates in the calibration map with the RTK base station coordinates of the current RTK base station 1820. If a deviation value obtained by the comparison is less than a preset value, then the calibration map is offset accordingly, and a new map is generated for a use of mowing operation. If the deviation value obtained by the comparison is greater than the preset value, an abnormal position of the RTK base station 1820 will be reported as an alarm. The preset value may be 1.5 m.

When the positioning state information received by the hand-held terminal 1830 is high-precision positioning state information, the hand-held terminal 1830 sends a corresponding execution command to the mower 1. The execution command may be one of commands such as the command to continue a current state, the command to calibrate the map, the command to calibrate the non-mowing area, the command to increase the non-mowing area, the command that the map boundary demarcation is completed, the command that the calibration of the non-mowing area is completed, etc.

When the positioning state information received by the hand-held terminal 1830 is non-high-precision positioning state information, the hand-held terminal 1830 sends a stop command to the mower.

When the hand-held terminal 1830 receives alarm information, the hand-held terminal 1830 displays the alarm information and notifies the operator, and the operator sends corresponding processing command to the mower 1 through the terminal control device.

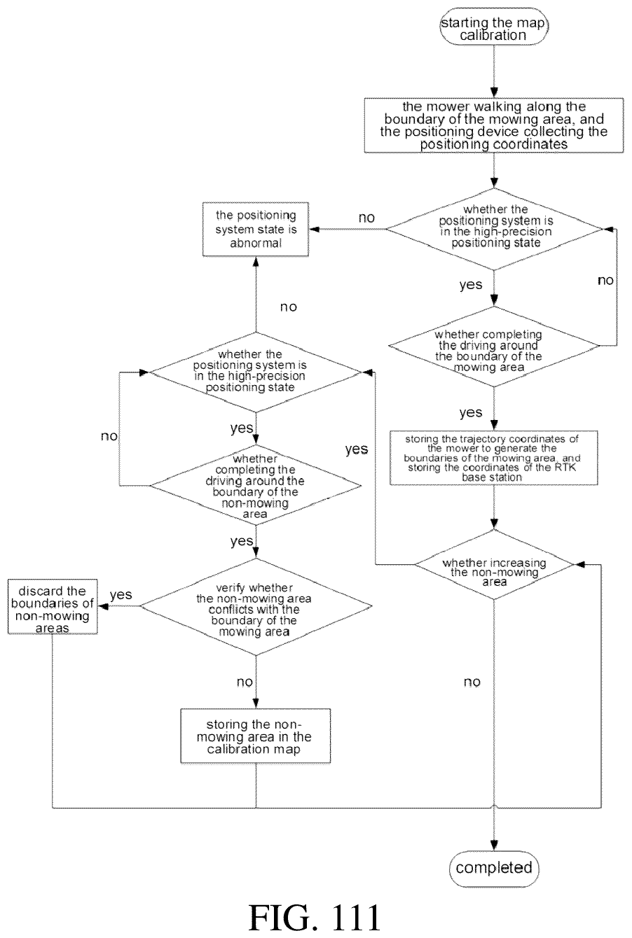

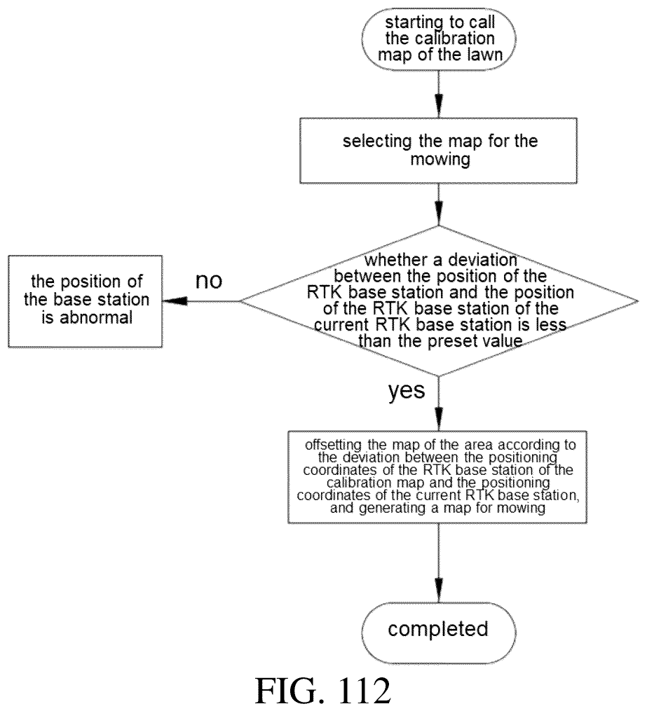

Please refer to FIG. 111 and FIG. 112. When the mower 1 is mapping to calibrate the map of a lawn 5, the mower 1 walks along a boundary 1850 of the mowing area (which means the working area) 1852 of the lawn to be calibrated, and the GNSS positioning mobile station (positioning device) 14 collects the positioning coordinates of the mower 1 in real time. The controller 240 monitors whether the mower 1 is in the high-precision positioning state in real time. If it is not in the high-precision positioning state, then a feedback that the positioning system is abnormal is sent to the hand-held terminal 1830. If it is in the high-precision positioning state all the time, then the positioning coordinates of the mower 1 is continuously recorded until the hand-held terminal 1830 sends a map boundary calibration completion command to the controller 240 of the mower 1. Since the positioning device 14 is mounted on the mower 1, it may be considered that the controller 240 is actually monitoring whether the positioning system is in the high-precision positioning state in real time. The controller 240 generates a calibration map of the mowing area 1852 according to the positioning coordinates of the mower 1 received from a start calibration command to an end calibration command, stores the calibration map to the saving device, and correspondingly stores the RTK base station coordinates sent by the RTK base station 1820 simultaneously.

After completing the map of the mowing area 1852, the hand-held terminal 1830 may further send the command to calibrate the non-mowing area to the mower 1, and the non-mowing area is an obstacle 1855, 1856 and the like. The mower 1 walks along a boundary of the non-mowing area (obstacle) 1855 or 1856, the Positioning device 1814 collects the positioning coordinates of the mower 1 in real time, and the controller 240 monitors whether the mower 1 (or positioning system) is in the high-precision positioning state in real time. If it is not in the high-precision positioning state, then a feedback that the positioning system is abnormal is sent to the hand-held terminal 1830. If it is in the high-precision positioning state all the time, then the positioning coordinates of the mower 1 is continuously recorded until the hand-held terminal 1830 sends a non-mowing area calibration completion command to the mower 1. The controller 240 generates a calibration map of the non-mowing area (obstacle, also the non-working area) 1855 or 1856 according to the positioning coordinates of the mower 1 received from the start calibration command and the end calibration command, compares it with the calibration map of the mowing area 1852 to verify whether boundaries of the non-mowing area 1855 and 1856 exceed the boundary 1850 of the mowing area 1852 (a plot to be calibrated) (or verify whether the boundaries of the non-mowing area 1855 and 1856 conflict with the boundary of the mowing area 1852 (the plot to be calibrated), and correspondingly store a boundary calibration map of the non-mowing areas 1855 and 1856 and the RTK base station coordinates sent by the RTK base station 1820.

The calibration map of the mowing area 1852 and the calibration map of the non-mowing area 1855 or 1856 may be stored on the controller 240, the hand-held terminal 1830, or the server 1840 that may communicate with the mower and the hand-held terminal 1830.

In this disclosure, when the calibration map of the mowing area 1852 is offset accordingly, the calibration map is first called by the saving device and sent to a map generation and management module of the controller 240. The map generation and management module calculates a difference between the RTK base station coordinates in the calibration map and the RTK base station coordinates of the current RTK base station 1820, and then adds coordinates of all points in the calibration map to the calculated difference, thereby generating a new map after the offset. The mower 1 may carry out the mowing operation according to this new map.

Further, the disclosure provides a map calibration and a calling method for the mower 1, which includes:

S1: calibrating the map and generating processes/operations, which may be referred to FIG. 111. When starting the map calibration, the mower 1 walks along the boundary 1850 of the mowing area 1852 to be calibrated, and the Positioning device 1814 collects (monitors and records) the positioning coordinates of the mower 1 in real time. The Positioning device 1814 applies the differential data from the RTK base station 1820 to correct the positioning coordinate data of the mower 1, and sends the corrected positioning coordinate data to the controller 240 of the mower 1. The controller 240 applies the corrected positioning coordinate data and base station coordinate data from the RTK base station 1820 to generate a calibration map of the mowing area 1852, and sends the calibration map to the corresponding saving device for storage.

The controller 240 monitors information whether the mower 1 is in the high-precision positioning state in real time. If it is not in the high-precision positioning state, then a feedback that the positioning system is abnormal is sent to the hand-held terminal 1830. If it is in the high-precision positioning state all the time, then the positioning coordinates of the mower 1 is continuously recorded until the hand-held terminal 1830 sends the map boundary calibration completion command. The controller 240 generates and stores the calibration map of the mowing area 1852 according to the positioning coordinates of the mower 1 received from the start calibration command and the end calibration command, and correspondingly stores the RTK base station coordinates sent by the RTK base station 1820 simultaneously.

After completing the calibration of the map mentioned above, the hand-held terminal 1830 may further send the command to calibrate the non-mowing area to the mower 1. The mower 1 walks along a boundary of the non-mowing area (for example the obstacle) 1855 or 1856, the map generation and management module of the mower 1 monitors whether the autonomous controller 1815/the mower 1 (or monitoring the positioning system) is in the high-precision positioning state in real time. If it is not in the high-precision positioning state, then a feedback that the positioning system is abnormal is sent to the hand-held terminal 1830. If it is in the high-precision positioning state all the time, then the positioning coordinates of the mower 1 is continuously recorded until the hand-held terminal 1830 sends a non-mowing area calibration completion command to the mower 1. The controller 240 generates the calibration map of the non-mowing area 1855 of 1856 according to the positioning coordinates of the mower 1 received from the start calibration command to an end calibration command, verifies whether the non-mowing area 1855 or 1856 conflicts with the boundary 1850 of the mowing area (which means that whether it exceeds the boundary 1850 of the mowing area), and correspondingly stores the RTK base station coordinates sent by the RTK base station 1820 simultaneously.

S1 further includes comparing the calibration map of the non-mowing area 1855 or 1856 with the calibration map of the mowing area 1852 to verify whether the non-mowing area 1855 or 1856 is within the boundary of the mowing area 1852.

In an embodiment of FIG. 111, the map calibration and generation process of the disclosure includes:
(1) starting the map calibration;
(2) the mower 1 walking along the boundary 1850 of the mowing area 1852, and the map generation system (such as the map generation and management module of the controller 240) collecting the positioning coordinates of the mower 1 through the Positioning device 1814;
(3) the controller 240 determining whether the positioning system (Positioning device 1814 and the mower 1) is in the high-precision positioning state according to the state information provided by the Positioning device 1814, if so, then continuing to determine whether the mower 1 completes a driving around the boundary 1850, if not, then sending an alarm that the positioning system state is abnormal;
(4) if the controller 240 determines that the mower 1 has completed the driving around the boundary 1850, the hand-held terminal sending a command to store trajectory coordinates of the mower 1 to generate the calibration map, and storing the coordinates of the RTK base station; if the controller 240 determines that the mower 1 has not completed the driving around the boundary 1850, then continuing to return to operation (3);
(5) after storing the trajectory coordinates of the mower 1 to generate the calibration map and storing the coordinates of the RTK base station, the controller 240 determining whether it is necessary to increase the calibration of the non-mowing area (such as the obstacles 1855 and 1856), if necessary, the hand-held terminal 1830 sending the command to calibrate the non-mowing area, and if not, the process being ended (completed);
(6) after the hand-held terminal 1830 sending the command to calibrate the non-mowing area, the controller 240 determining whether the positioning system is in the high-precision positioning state according to the state information monitored by the controller 240, if so, then continuing to determine whether the mower 1 completes a driving around the boundary of the non-mowing area, if not, then sending the alarm that the positioning system state is abnormal;
(7) If the controller 240 determines that the mower 1 has completed the driving around the boundary of the non-mowing area, the controller 240 continuing to verify whether the non-mowing area conflicts with the boundary 1850 of the mowing area (usually means that the non-mowing area has exceeded the boundary 1850 of the mowing area 1852); If so, returning to operation (6), if not, storing the non-mowing area in the calibration map of (4), and then returning to operation (5);
(8) If the controller 240 determines that the mower 1 has not completed the driving around the boundary of the non-mowing area, returning to operation (6).

S2 of the map calibration and the calling method for the mower 1 of the disclosure is a calling process of the calibration map. When the mower 1 performs the mowing operation on the mowing area 1852, the controller 240 calls the stored calibration map from the saving device. When the map is called, the controller 240 of the mower 1 is required to calculate a deviation (which means the difference) between the positioning (position) coordinates of the RTK base station 1820 and the corresponding position coordinates of the RTK base station in the calibration map, and the calibration map of the lawn 185 is offset correspondingly according to the deviation (differences) of the two RTK base stations.

And a preset value of a deviation range of the RTK base station is set according to a standard deviation of a GNSS single-point positioning accuracy. When the deviation exceeds the preset value, the operator is reminded that the position of the base station is abnormal, and the operator needs to check whether the RTK base station is placed on a fixed anchor point.

An embodiment of FIG. 112 includes following operations:
(1) starting to call the calibration map of the lawn 185;
(2) selecting the calibration map for the mowing operations by the saving device containing the calibration map;
(3) the controller 240 determining whether a deviation between the position of the RTK base station in the calibration map and the positioning (position) of the RTK base station of the current RTK base station 1820 is less than the preset value, if yes, then entering the next operation, if not, then reporting that the position of the base station is abnormal to the hand-held terminal 1830 or the server 1840;
(4) the controller 240 offsetting the calibration map according to the deviation between the positioning coordinates of the RTK base station of the calibration map and the positioning coordinates of the current RTK base station 1820, and generating a new map for the mowing operations;
(5) the process being ended (completed).

S3 of the method of the disclosure is a process of offsetting the calibration map. The controller 240 compares RTK base station coordinates in the calibration map with the RTK base station coordinates of the current RTK base station 1820. If a deviation value obtained by the comparison is less than the preset value (for example 1.5 m), then the calibration map is offset accordingly, and the new map is generated for the use of mowing operation. If the deviation value obtained by the comparison is greater than the preset value (for example 1.5 m), the abnormal position of the RTK base station 1820 will be reported as an alarm.

In this disclosure, the saving device calls and sends the calibration map to a control device. The control device calculates the difference between the RTK base station coordinates in the calibration map and the RTK base station coordinates of the current RTK base station, and then adds the coordinates of all points in the calibration map to the calculated difference, thereby generating the new map after the offset. The mower may carry out the mowing operation according to this new map.

The following is an example of an offset method of the calibration map for the disclosure:
when drawing the calibration map, a latitude and longitude coordinates of the RTK base station 1 position are (X0, Y0),
boundaries of the map are {(MX1,MY1), (MX2,MY2), . . . , (MXn, MYn)},
boundaries of the obstacle (non-mowing area) 1 is {(1OX1,1OY1), (1OX2,1OY2), . . . , (1OXn, 1OYn)},
boundaries of the obstacle (non-mowing area) 2 is {(2OX1,2OY1), (2OX2,2OY2), . . . , (2OXn, 2OYn)}, . . .
boundaries of the obstacle (non-mowing area) m is {(mOX1,mOY1), (mOX2,mOY2), . . . , (mOXn, mOYn)},
when mowing next time, the RTK base station coordinates are (X1, Y1), then an offset (difference) that needs to be offset is (detaX, detaY)=((X1-X0), (Y1-Y0)),
The boundaries of the new map generated by the offset while mowing are {((MX1-detaX),(MY1-detaY)),((MX2-detaX),(MY2-detaY)), . . . , ((MXn-detaX),(MYn-detaY))},
The boundaries of the obstacle 1 of the new map are {((1OX1-detaX),(1OY1-detaY)),((1OX2-detaX),(1OY2-detaY)), . . . , ((1OXn-detaX),(1OYn-detaY))},
The boundaries of the obstacle 2 of the new map are {((2OX1-detaX),(2OY1-detaY)),((2OX2-detaX),(2OY2-detaY)), . . . , ((2OXn-detaX),(2OYn-detaY))}, . . . .

The boundaries of the obstacle m of the new map are {((mOX1-detaX),(mOY1-detaY)),((mOX2-detaX),(mOY2-detaY)), . . . , ((mOXn-detaX),(mOYn-detaY))},

Similarly, an example of a map offset method with elevation (altitude) information:
when drawing the calibration map, the latitude coordinate, the longitude coordinate and an altitude coordinate of the RTK base station 1820 position are (X0, Y0, H0),
boundaries of the calibration map are {(MX1, MY1,MH1), (MX2, MY2,MH2), . . . , (MXn, MYn, MHn)},
boundaries of the obstacle (non-mowing area) 1 is {(1OX1, 1OY1,1OH1), (1OX2, 1OY2,1OH2), . . . , (1OXn, 1OYn, 1OHn)},
boundaries of the obstacle (non-mowing area) 2 is {(2OX1, 2OY1,2OH1), (2OX2, 2OY2,2OH2), . . . , (2OXn, 2OYn, 2OHn)}, . . .
boundaries of the obstacle (non-mowing area) m is {(mOX1, mOY1,mOH1), (mOX2, mOY2, mOH2), . . . , (mOXn, mOYn, mOHn)}, . . .
when mowing next time, the RTK base station coordinates are (X1, Y1, H1), then an offset (difference) that needs to be offset is (detaX, detaY, detaH)=((X1-X0), (Y1-Y0), (H1-H0)),

The boundaries of the new map generated after the offset while mowing are {((MX1-detaX), (MY1-detaY), (MH1-detaH)), ((MX2-detaX), (MY2-detaY), (MH2-detaH)), . . . , ((MXn-detaX),(MYn-detaY)), (MHn-detaH))},

The boundaries of the obstacle 1 of the new map are {((1OX1-detaX),(1OY1-detaY), (1OH1-detaH)),((1OX2-detaX),(1OY2-detaY), (1OH2-detaH)), . . . , ((1OXn-detaX),(1OYn-detaY)), (1OHn-detaH))},

The boundaries of the obstacle 2 of the new map are {((2OX1-detaX),(2OY1-detaY), (2OH1-detaH)),((2OX2-detaX),(2OY2-detaY), (2OH2-detaH)), . . . , ((2OXn-detaX),(2OYn-detaY), (2OHn-detaH))}, . . .

The boundaries of the obstacle m of the new map are {((mOX1-detaX),(mOY1-detaY), (mOH1-detaH)),((mOX2-detaX),(mOY2-detaY), (mOH2-detaH)), . . . , ((mOXn-detaX),(mOYn-detaY)), (mOHn-detaH))},

In summary, the disclosure provides a control method for a working device system of (for example the mower 1), which includes following operations:
obtaining original RTK base station coordinates;
controlling the working device to collect positioning coordinate data along the boundary of the working area, and generating a calibration map of the working area according to the collected positioning coordinate data and the original RTK base station coordinate data;
storing the calibration map and the original RTK base station coordinates; and
when the working device works in the working area, calling the calibration map.

In an embodiment, when calling the calibration map,
obtaining current RTK base station coordinates;
comparing the original RTK base station coordinates with the current RTK base station coordinates, if a deviation value obtained by the comparison is less than a preset value, then offsetting the calibration map accordingly, and generating the new map for the operation, if the deviation value obtained by the comparison is greater than the preset value, reporting the abnormal position of the RTK base station as the alarm.

In an embodiment of the disclosure, the disclosure further provides the working device system. It may be used not only for the mower 1, but also for other working devices or cases where a map needs to be calibrated on a certain area of land, and the calibrated map needs to be called later (for example, for navigation). The working device system of the disclosure includes the RTK base station 1820 and the working device 1. The working device 1 may be the mower 1, for example. The working device includes the controller 240, the positioning device 14 and the saving device communicating with the RTK base station 1820. The positioning device 14 collects positioning coordinates of a map calibration and calling system 1 in real time. When the map calibration and calling system 1 performs the map calibration on an area to be calibrated 185, the positioning device 14 applies the differential data from the RTK base station 1820 to correct positioning coordinate data of the map calibration and calling system 1, and sends the corrected positioning coordinate data to controller 240. The controller 240 applies the corrected positioning coordinate data and base station coordinate data from the RTK base station 1820 to generate a calibration map of the area to be calibrated 185, and sends the calibration map to a saving device for storage. When the map calibration and calling system is used to navigate the area to be calibrated 185 (i.e., the working area, or the area to be mowed) or when it is necessary to use a completed calibration map of the area to be calibrated 185, the controller 240 compares RTK base station coordinates in the calibration map with the RTK base station coordinates of the current RTK base station 1820. If a deviation value obtained by the comparison is less than a preset value, then the calibration map is offset accordingly, and a new map is generated for navigation or other purpose. If the deviation value obtained by the comparison is greater than the preset value, the abnormal position of the RTK base station will be reported as an alarm.

The RTK base station 1820 is the portable RTK base station 1820, which may be arranged at a fixed anchor point 20 near the area 185 to be calibrated.

The controller 240 and the positioning device 14 communicate with the RTK base station 1820 through the communication device 1818. The communication device 1818 receives the differential data and RTK base station coordinate data from the RTK base station 1820, and sends the differential data to the positioning device 14 and the RTK base station coordinate data to the controller 240.

The communication device 1818 includes a radio station device mounted on the map calibration and calling system, and the positioning device 14 may be a mobile satellite positioning station.

The map calibration and calling system of the disclosure further includes the terminal control device 3. It may receive the state information fed back by the map calibration and calling system, and send the corresponding control command to the system. The state information includes the positioning state information and alarm information of the map calibration and calling system. The positioning state information includes the high-precision positioning state information and the non-high-precision positioning state information. The high-precision positioning state indicates that the map calibration and calling system is in a centimeter-level positioning state. The alarm information indicates that fault state information of the map calibration and calling system.

When the positioning state information received by the terminal control device 3 is the high-precision positioning state information, the terminal control device 3 sends the corresponding execution command to the map calibration and calling system 1. The execution command may include the command to continue the current state and the command to calibrate the map.

When the positioning state information received by the terminal control device 3 is non-high-precision positioning state information, the terminal control device 3 sends the stop command to the map calibration and calling system. When the terminal control device 3 receives the alarm information, the terminal control device 3 displays the alarm information and notifies the operator, and the operator sends corresponding processing command to the system 1 through the terminal control device 3.

In an embodiment of the disclosure, the communication device 1818 further includes the Bluetooth device 17 and the 4G-GPS module 1816 for wireless communication with the terminal control device 3. The 4G-GPS module 1816 may upload information of the controller 240 to the server 1840. Then the server 1840 may send the information of the controller 240 to the terminal control device 3, and a command of the terminal control device 3 may also be sent to the server 1840 through the mobile network, and further sent to the controller 240.

When the map calibration and calling system 1 draws the calibration map of the area 185 to be calibrated, the system walks along the boundary 1850 of the area 185 to be calibrated, and the positioning device 14 collects the positioning coordinates of the system in real time. The controller 240 monitors whether the system 1 is in the high-precision positioning state in real time. If it is not in the high-precision positioning state, then a feedback that the positioning system is abnormal is sent to the terminal control device 3. If it is in the high-precision positioning state all the time, then the positioning coordinates of the system 1 is continuously recorded until the terminal control device 3 sends a map boundary calibration completion command. The controller 240 generates a calibration map of the area 185 to be calibrated according to the positioning coordinates of the system 1 received from the start calibration command to the end calibration command, stores the calibration map to the saving device, and correspondingly stores the RTK base station coordinates sent by the RTK base station 1820 simultaneously.

When the calibration map of the area 185 to be calibrated is completed, the terminal control device 3 may further send an obstacle calibration command to the system. The system walks along the boundary of the obstacle (which means non-working area, or non-mowing area) 1855, 1856, and the positioning device 14 collects the positioning coordinates of the system 1 in real time. The controller 240 monitors whether the system is in the high-precision positioning state in real time. If it is not in the high-precision positioning state, then a feedback that the positioning system is abnormal is sent to the terminal control device 3. If it is in the high-precision positioning state all the time, then the positioning coordinates of the system 1 is continuously recorded until the terminal control device 3 sends an obstacle calibration completion command to the system. The controller 240 then compares the calibration map of obstacles 1855 and 1856 with the calibration map of the area 185 to be calibrated to verify whether the obstacles 1855 and 1856 are within the boundary 1850 of the area 185 to be calibrated. Then, a calibration map of the obstacle 1855, 1856 is generated and stored according to the positioning coordinates of the system 1 received from the start calibration command to the end calibration command, and stores the RTK base station coordinates sent by the RTK base station 1820 simultaneously.

When the calibration map of the area 185 to be calibrated is offset accordingly, the calibration map is first called by the saving device and sent to the controller 240. The controller 240 calculates the difference between the RTK base station coordinates in the calibration map and the RTK base station coordinates of the current RTK base station 1820, and then adds the coordinates of all points in the calibration map to the calculated difference, thereby generating the new map after the offset. The system may be used for the navigation or other purpose according to this new map.

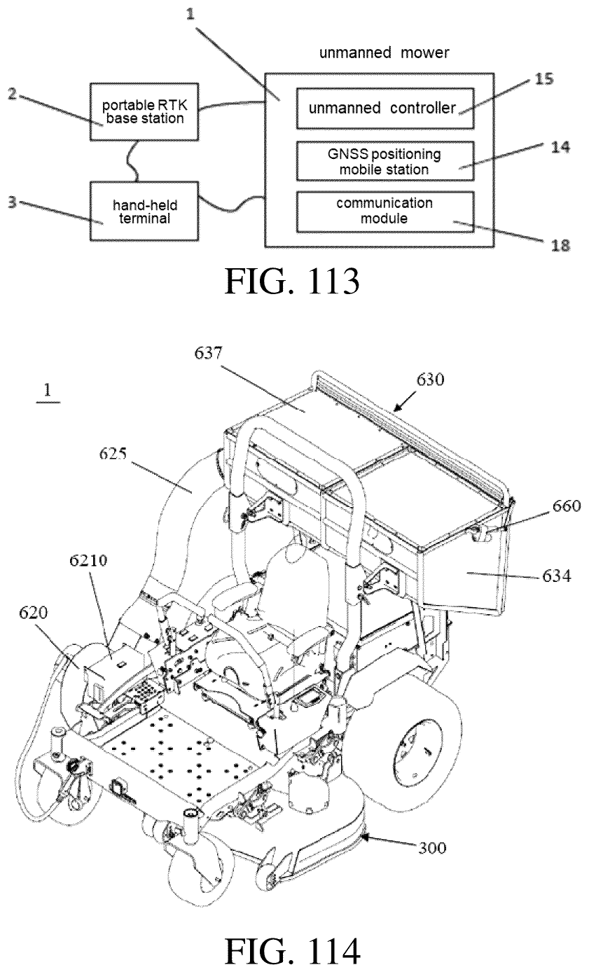

Please refer to FIG. 113. In an embodiment of the disclosure, When the unmanned mower 1 mows the lawn 185 to be mowed, the GNSS positioning mobile station (positioning device) 14 collects the positioning coordinates of the mower 1 in real time. The unmanned controller 240 sends the stored RTK base station coordinates to the RTK base station 1820 through the communication device (module) 18, or the hand-held terminal 1830 sends the RTK base station coordinates to the RTK base station 1820 through wireless communication modes such as Bluetooth or Wi-Fi, and the RTK base station 1820 compares the current coordinates with the received coordinates. If the deviation obtained by comparison is less than the preset value, the received coordinates are set to the RTK base station coordinates, and if the deviation obtained by comparison is greater than the preset value, then the alarm will be issued that the RTK base station location is abnormal.

In summary, the disclosure provides the mower with the RTK base station and the map calibration and calling method and system of the mower. A problem of a position drift of the RTK base station is solved when repositioned each time by offsetting the map of the mowed lawn, and the calibration map of the lawn (including the base station coordinates of the RTK base station) is generated and stored. The mower automatically calls and offsets the calibration map for subsequent mowing operations when the lawn is mowed next time, so that there is no need to manually input new coordinates when a lawn map deviation occurs, and an automation of the lawn mowing operation is realized, which greatly improves work efficiency.

Further, the disclosure provides the working device system mentioned above and the control method thereof. It may be used not only for a calibration and calling the map of the mower, but also for other working devices or cases where a map needs to be mapped on a certain area of land, and the calibrated map needs to be called later (for example, for navigation).

Therefore, the disclosure effectively overcomes some practical problems in the prior art, thereby having high utilization value and use significance. The above embodiments only illustrate principles and effects of the disclosure, but are not intended to limit the disclosure. Anyone familiar with this technology may modify or change the above embodiments without departing from a scope of the disclosure. Therefore, all equivalent modifications or changes made by those with ordinary knowledge in the technical field without departing from the technical ideas disclosed in the disclosure shall still be covered by the claims of the disclosure.

What is claimed is:

1. A mower, comprising:
a frame;
a cutting deck assembly, installed on the frame; and
a walking mechanism, installed on the frame and comprising a front wheel assembly and a rear wheel assembly;
wherein, the frame includes a front frame and a rear frame, the front frame is detachably connected with the rear frame, the front frame is installed with the front wheel assembly, and the rear frame is installed with the rear wheel assembly.

2. The mower according to claim 1, wherein, the front frame comprises a first cross beam and a first connecting part, the first connecting part extends along a forward direction and from two ends of the first cross beam, and two of the first connecting parts are respectively provided with the front wheel assembly.

3. The mower according to claim 2, wherein, a front end of the first connecting part is provided with an assembling tube that is vertically downward, and the front wheel assembly is assembled on the assembling tube so that the front wheel rotates around an axis that is perpendicular to an axis of the assembling tube.

4. The mower according to claim 1, wherein, both sides of a rear end of the front frame are provided with a U-shaped groove, a front end of the rear frame comprises two square tubes, the square tube is inserted into the groove to fix the front frame and the rear frame, two first clamping boards are arranged on both sides of the rear end of the front frame, a bottom surface of the two first clamping boards is provided with a second clamping board, the first clamping boards and the second clamping board enclose the groove, corresponding positions of side walls of the square tube and the first clamping board are provided with a first through hole, and a connecting bolt penetrates through the first through hole to connect and fix the front frame and the rear frame.

5. The mower according to claim 1, wherein, the cutting deck assembly comprises a cutting deck, the cutting deck is installed at a bottom of the frame, and a minimum distance between the cutting deck and the front wheel is from 10 mm to 60 mm.

6. The mower according to claim 1, wherein, the cutting deck assembly comprises a cutting deck, the cutting deck is installed at a bottom of the frame, and a minimum distance between the cutting deck and the rear wheel is from 10 mm to 60 mm.

7. The mower according to claim 1, wherein, the mower further comprises a battery, the frame is provided with a first placing area, the battery is fixed in the first placing area, the first placing area is provided with a plurality of first mounting holes, and batteries with different specifications are matched with different first mounting holes.

8. The mower according to claim 1, wherein, the cutting deck assembly comprises a cutting deck, a height adjustment device and a locking device;
the height adjustment device is connected with the cutting deck and the frame to adjust a height of the cutting deck;
the height adjustment device comprises a first connecting rod and a second connecting rod, the first connecting rod and the second connecting rod are rotatably connected with the frame, and the first connecting rod and the second connecting rod each are rotatably connected with the cutting deck respectively;
after the cutting deck is adjusted to different heights through the height adjustment device, a movement of the cutting deck is limited by the locking device.

9. The mower according to claim 8, wherein, the height adjustment device comprises a self-locking mechanism, the self-locking mechanism comprises:
a self-locking component, rotatably connected with the frame and provided with a self-locking groove; and
a self-locking rod, matched with the self-locking groove to limit the cutting deck from moving downward.

10. The mower according to claim 9, wherein, the self-locking component is rotatably connected with the frame through a rotating shaft, a center of gravity of the self-locking component is located on one side of the rotating shaft close to the self-locking rod, the frame is provided with a limiting device, the limiting device limits the self-locking component from rotating in a direction towards the self-locking rod, the limiting device is a limiting part arranged on the frame, the limiting part extends out to the frame, a bottom of the self-locking component is provided with a protrusion away from the self-locking rod, and the protrusion touches a bottom of the limiting part to limit the self-locking component from rotating toward the self-locking rod.

11. The mower according to claim 8, wherein, the locking device comprises a blocking plate and a limiting board, the limiting board is fixed with the frame, the limiting board is provided with a plurality of limiting holes, the limiting hole is matched with a limiting rod, the limiting rod is inserted into different limiting holes to be matched with the blocking plate to keep the cutting deck at different distances from ground.

12. The mower according to claim 1, wherein, the cutting deck assembly comprises a cutting deck, a cutting part, a cutting baffle;
the cutting deck assembly is installed on the frame;
the cutting part is arranged on the cutting deck, and the cutting part comprises a cutting motor and a cutting blade driven by the cutting motor;
the cutting baffle is detachably fixed at a bottom part of the cutting deck, the cutting baffle encloses a cutter accommodating cavity, and the cutting blade is arranged in the cutter accommodating cavity.

13. The mower according to claim 1, wherein, the mower further comprises:
a driving seat, and
an anti-roll frame, rotatably installed on the frame and switchable between a first position and a second position;
wherein, the anti-roll frame is erected on a side of the driving seat and is higher than a top of a driver's head in an operating state in the first position, so as to protect the driver when the frame rolls over; and the anti-roll frame is folded relative to the frame in the second position, in order to reduce a storage volume of the mower.

14. The mower according to claim 13, wherein, a storage groove is arranged on the frame, and the anti-roll frame is clamped into the storage groove when at the second position.

15. The mower according to claim 1, wherein, the mower further comprises:
a casing, installed on the frame;
a driving seat, installed on the frame;
a battery, installed on the frame and located inside the casing, and at least part of the battery being located below the driving seat; and
a controller, electrically connected with the battery and an electrical equipment of the mower respectively, installed inside the casing and located at a tail of the casing.

16. The mower according to claim 15, wherein, the casing comprises a first housing, the first housing encloses an inner cavity at a tail of the frame, the controller is located in the inner cavity, and the inner cavity is opened upwards to take and place the controller.

17. The mower according to claim 1, wherein, the cutting deck assembly comprises:
a cutting deck;
a motor controller, installed on the cutting deck; and
a plurality of cutting motors, installed on the cutting deck, the plurality of the cutting motors each being electrically connected with the motor controller, and a rotation of each cutting motor being centrally controlled by the motor controller.

18. The mower according to claim 1, wherein, the mower comprises:
a grass collection device;
a grass conveying device, conveying lawn in the cutting deck assembly to the grass collection device; and
a clogging detection device, comprising:
a first movable component, being in a first state when the grass conveying device is working normally and being in a second state when the grass conveying device is clogged, and
a first sensor, configured to detect a state of the first movable component.

19. The mower according to claim 18, wherein, the first sensor is a switch, the first movable component triggers the switch when the first movable component is in the first state, and the first movable component is disconnected from the switch under an action of a gravity of the first movable component when the grass conveying device is clogged.

20. The mower according to claim 1, wherein, a tail of the mower is provided with a first charging port, the first charging port is at an angle of 15 degrees to 30 degrees with a ground, and the first charging port is provided with a reversible charging port cover.
